(19) United States
(12) Patent Application Publication
(10) Pub. No.: US 2013/0180014 A1
(43) Pub. Date: Jul. 11, 2013

(54) Pyridine Compounds for Controlling Invertebrate Pests III

(71) Applicants: Sebastian Soergel, Ludwigshafen (DE); Christian Defieber, Mannheim (DE); Ronan Le Vezouet, Mannheim (DE); Steffen Gross, Ludwigshafen (DE); Karsten Koerber, Eppelheim (DE); Deborah L. Culbertson, Fuquay Varina, NC (US); Douglas D. Anspaugh, Apex, NC (US)

(72) Inventors: Sebastian Soergel, Ludwigshafen (DE); Christian Defieber, Mannheim (DE); Ronan Le Vezouet, Mannheim (DE); Steffen Gross, Ludwigshafen (DE); Karsten Koerber, Eppelheim (DE); Deborah L. Culbertson, Fuquay Varina, NC (US); Douglas D. Anspaugh, Apex, NC (US)

(73) Assignee: BASF SE, Ludwigshafen (DE)

(21) Appl. No.: 13/822,529

(22) PCT Filed: Sep. 12, 2011
(86) PCT No.: PCT/EP2011/065708

§ 371 Date: Mar. 12, 2013

Related U.S. Application Data
(60) Provisional application No. 61/382,053, filed on Sep. 13, 2010.

(51) Int. Cl. A01N 43/40; A01N 43/54; A01N 43/58; A01N 43/60

(52) U.S. Cl. CPC A01N 43/40; A01N 43/60; A01N 43/54; A01N 43/58
USPC 800/298; 514/332; 514/255.05; 514/256; 514/274; 514/252.03

(57) ABSTRACT

The present invention relates to a method for controlling invertebrate pests, in particular arthropod pests and nematodes, by using pyridine compounds of formulae I or II and the salts thereof, the tautomers thereof, the N-oxides thereof and the salts of the tautomers or N-oxides thereof,

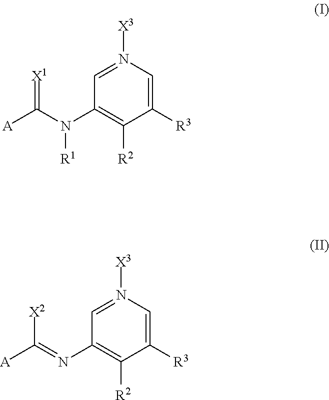

where the radical A is of the formula A,

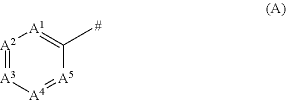

wherein
# denotes the point of attachment to the remainder of formulae I or II, and wherein A¹ is N or C—R^{A1}, A² is N or C—R^{A2}, A³ is N or C—R^{A3}, A⁴ is N or C—R^{A4} and A⁵ is N or C—R^{A5}, provided that one or two of the variables A¹, A², A³, A⁴ or A⁵ is N; R^{A1}, R^{A5}, if present, are H, halogen, CN, NO₂, C₁-C₆-alkyl, C₁-C₆-haloalkyl and the like; R^{A2}, R^{A4}, if present, are H, halogen, CN, NO₂, C₁-C₁₀-alkyl, C₁-C₁₀-haloalkyl and the like; R^{A3}, if present, is H, halogen, CN, NO₂, C₁-C₁₀-alkyl, C₁-C₁₀-haloalkyl and the like; R¹ is H, CN, C₁-C₁₀-alkyl, C₁-C₁₀-haloalkyl and the like; R² is H, halogen, methyl, C₁-haloalkyl and the like; R³ is H, halogen, C₁-C₄-alkyl, C₁-C₃-haloalkyl and the like; X¹ is S, O or NR^{1a}, wherein R^{1a} is H, C₁-C₁₀-alkyl and the like; X² is OR^{2a}, NR^{2b}R^{2c} or S(O)ₘR^{2d}, wherein m is 0, 1 or 2, R^{2a} is C₁-C₄-alkyl, C₁-C₄-haloalkyl and the like, R^{2b} and R^{2c} are H, C₁-C₄-alkyl, C₁-C₄-haloalkyl and the like, or R^{2b} and R^{2c} together with the nitrogen atom to which they are bound form a heterocycle, and R^{2d} is C₁-C₄-alkyl, C₁-C₄-haloalkyl, C₃-C₆-cycloalkyl and the like. The present invention further relates to a method for protecting plant propagation material and/or the plants which grow therefrom, to plant propagation material, comprising at least one compound of formulae I or II, their salts or N-oxides, and to an agricultural composition containing at least one compound of formulae I or II, their salts or N-oxides.

The present invention relates to pyridine compounds, to their salts, to their tautomers, to their N-oxides, and the salts of these N-oxides or tautomers, in particular to their use for combating or controlling invertebrate pests, in particular arthropod pests and nematodes and to a method for controlling invertebrate pests including the use of these pyridine compounds. The invention further relates to a method for protecting plant propagation material and/or the plants which grow therefrom by using these compounds. The present invention further relates to plant propagation material and to agricultural and/or veterinary compositions comprising said compounds.

Invertebrate pests and in particular arthropods and nematodes destroy growing and harvested crops and attack wooden dwelling and commercial structures, thereby causing large economic loss to the food supply and to property. While a large number of pesticidal agents are known, due to the ability of target pests to develop resistance to said agents, there is an ongoing need for new agents for combating invertebrate pests such as insects, arachnids and nematodes. It is therefore an object of the present invention to provide compounds having a good pesticidal activity and showing a broad activity spectrum against a large number of different invertebrate pests, especially against difficult to control insects, arachnids and nematodes.

EP 0480258 describes inter alia N-hetarylcarboxamides of 2-mercapto-nicotinic acids and their use for combating endoparasites.

WO 2002/094765 describes N-(6-membered hetaryl) carboxamides of 6-membered heteroaromatic carboxylic acids, which carry an oxazoline or carboxamide radical in the ortho position. The compounds are mentioned to be useful as insecticides.

WO 2002/070483 and WO 2002/094791 describe inter alia hetarylcarbonylamino substituted (het)arenes which carry a carboxamide group in the ortho-position of the carbonylamino substituent. The compounds are mentioned to be useful for controlling invertebrate pests.

WO 2009/077197 describes hetarylcarbonylamino substituted six-membered hetarenes which carry an isoxazoline moiety in the meta-position of the carbonylamino substituent. The compounds are mentioned to be useful for combating invertebrate pests

WO 2005/073165, WO 2006/137376, WO 2006/137395, WO 2008/000438, WO 2008/031534, WO 2008/074427, WO 2008/075454, WO 2009/049844 and WO 2009/080203 describe inter alia hetarylcarbonylamino substituted six-membered hetarenes which carry a carboxamide group in the meta-position of the carbonylamino substituent. The compounds are mentioned to be useful for combating invertebrate pests.

PCT/EP2010/001925 (WO 2010/112177), which was published after the priority date of the present invention, describes (het)arylcarbonylamino substituted pyridines and pyridazines including their use as insecticides.

It is an object of the present invention to provide methods for controlling invertebrate pests by using compounds that have a good pesticidal activity, in particular insecticidal activity, and show a broad activity spectrum against a large number of different invertebrate pests, especially against difficult to control arthropod pests and/or nematodes.

It has been found that these objectives can be achieved by methods that comprise treatment with compounds of the formulae I and II, as defined below, including any possible stereoisomers of formulae I and II, by their salts, by their tautomers and by their N-oxides and by the salts of said tautomers and N-oxides, in particular their agriculturally or veterinarily acceptable salts.

Therefore, in a first aspect the present invention relates to a method for controlling invertebrate pests which method comprises treating the pests, their food supply, their habitat or their breeding ground or a plant, seed, soil, area, material or environment in which the pests are growing or may grow, or the materials, plants, seeds, soils, surfaces or spaces to be protected from pest attack or infestation with a pesticidally effective amount of a 3-pyridyl compound of the formulae I or II or a salt or an N-oxide thereof:

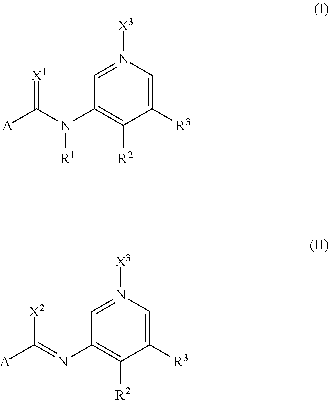

where the radical A is of the formula A:

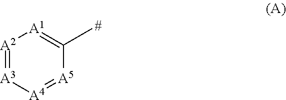

wherein:
# denotes the point of attachment to the remainder of formulae I or II, and wherein
A¹ is N or C—R^{A1};
A² is N or C—R^{A2};
A³ is N or C—R^{A3};
A⁴ is N or C—R^{A4};
A⁵ is N or C—R^{A5};
provided that one or two of the variables A¹, A², A³, A⁴ or A⁵ is N;
R^{A1}, R^{A5} are independently of each other selected from hydrogen, halogen, CN, NO₂, OR^{a1}, C(Y)R^{b1}, S(O)ₖR^{d1} with k being 1 or 2, C₁-C₆-alkyl, C₂-C₆-alkenyl, C₂-C₆-alkynyl, wherein the 3 last mentioned radicals may be unsubstituted or may be partially or fully halogenated,
   C₁-C₅-alkylen-CN, C₁-C₆-alkylen-OR^{a},
   C₁-C₅-alkylen-C(Y)R^{b}, C₁-C₅-alkylen-C(Y)OR^{c}
   C₃-C₁₀-cycloalkyl-C₁₀₅-alkyl, C₅-C₁₀-cycloalkenyl-C₁-C₅-alkyl, 3- to 10-membered heterocyclyl-C₁-C₅-alkyl,
   saturated 3 to 10 membered heterocyclyl, C₃-C₁₀-cycloalkyl and C₅-C₁₀-cycloalkenyl, wherein cycloalkyl, cycloalkenyl and heterocyclyl in the 6 last mentioned radicals may be unsubstituted or may carry 1, 2, 3, 4 or 5 identical or different substituents R^{y};
R^{A2}, R^{A4} are independently of each other selected from hydrogen, halogen, CN, NO₂, OR^{a2}, C(Y)R^{b2}, S(O)ₘR^{d2} with m being 0, 1 or 2, C₁-C₁₀-alkyl, C₂-C₁₀-alkenyl, C₂-C₁₀-alkynyl, wherein the 3 last mentioned radicals may be unsubstituted or may be partially or fully halogenated,
   C₁-C₅-alkylen-CN, C₁-C₅-alkylen-OR^{a},
   C₁-C₅-alkylen-C(Y)R^{b}, C₁-C₅-alkylen-C(Y)OR^{c}
   C₃-C₁₀-cycloalkyl-C₁-C₅-alkyl, C₅-C₁₀-cycloalkenyl-C₁-C₅-alkyl, 3- to 10-membered heterocyclyl-C₁-C₅-alkyl,
   saturated 3 to 10 membered heterocyclyl, C₃-C₁₀-cycloalkyl and C₅-C₁₀-cycloalkenyl, wherein cycloalkyl, cycloalkenyl and heterocyclyl in the 6 last mentioned radicals may be unsubstituted or may carry 1, 2, 3, 4 or 5 identical or different substituents R^{y};
R^{A3} is selected from hydrogen, halogen, CN, NO₂, OR^{a3}, C(Y)R^{b3}, S(O)ₘR^{d3} with m being 0, 1 or 2,
   C₁-C₁₀-alkyl, C₂-C₁₀-alkenyl, C₂-C₁₀-alkynyl, wherein the 3 last mentioned radicals may be unsubstituted or may be partially or fully halogenated,
   C₁-C₅-alkylen-CN, C₁-C₅-alkylen-OR^{a},
   C₁-C₅-alkylen-C(Y)R^{b}, C₁-C₅-alkylen-C(Y)OR^{c}
   C₃-C₁₀-cycloalkyl-C₁-C₅-alkyl, C₅-C₁₀-cycloalkenyl-C₁-C₅-alkyl, 3- to 10-membered heterocyclyl-C₁-C₅-alkyl, saturated 3 to 10 membered heterocyclyl, C₃-C₁₀-cycloalkyl and C₅-C₁₀-cycloalkenyl, wherein cycloalkyl, cycloalkenyl and heterocyclyl in the 6 last mentioned radicals may be unsubstituted or may carry 1, 2, 3, 4 or 5 identical or different substituents R^{y};
X¹ is S, O or NR^{1a}, wherein
   R^{1a} is selected from hydrogen, C₁-C₁₀-alkyl,
      C₁-C₄-haloalkyl, C₃-C₁₀-cycloalkyl, C₃-C₁₀-cycloalkylmethyl, C₃-C₁₀-halocycloalkyl, C₂-C₁₀-alkenyl, C₂-C₁₀-haloalkenyl, C₂-C₁₀-alkynyl, C₁-C₁₀-alkoxy-C₁-C₄-alkyl, OR^{a}, phenyl, hetaryl, heterocyclyl, phenyl-C₁-C₄-alkyl, hetaryl-C₁-C₄-alkyl, heterocyclyl-C₁-C₄-alkyl wherein the ring in the six last mentioned radicals may be unsubstituted or may carry 1, 2, 3, 4 or 5 substituents which, independently of each other, are selected from halogen, cyano, nitro, C₁-C₄-alkyl, C₁-C₄-haloalkyl, C₁-C₄-alkoxy and C₁-C₄-haloalkoxy;
X² is OR^{2a}, NR^{2b}R^{2c}, S(O)ₘR^{2d}, wherein m is 0, 1 or 2, wherein
   R^{2a} is selected from C₁-C₄-alkyl, C₁-C₄-haloalkyl, C₃-C₆-cycloalkyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, phenyl, hetaryl, heterocyclyl, phenyl-C₁-C₄-alkyl, hetaryl-C₁-C₄-alkyl and heterocyclyl-C₁-C₄-alkyl, wherein the ring in the six last mentioned radicals may be unsubstituted or may carry 1, 2, 3, 4 or 5 substituents which, independently of each other, are selected from halogen, cyano, nitro, C₁-C₄-alkyl, C₁-C₄-haloalkyl, C₁-C₄-alkoxy and C₁-C₄-haloalkoxy, and wherein
   R^{2b}, R^{2c} are independently of each other selected from hydrogen,
      C₁-C₄-alkyl, C₁-C₄-haloalkyl, C₃-C₆-cycloalkyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, C₁-C₄-alkylcarbonyl, C₁-C₄-haloalkylcarbonyl, C₁-C₄-alkylsulfonyl, C₁-C₄-haloalkylsulfonyl, phenyl, phenylcarbonyl, phenylsulfonyl, hetaryl, hetarylcarbonyl, hetarylsulfonyl, heterocyclyl, heterocyclylcarbonyl, heterocyclylsulfonyl, phenyl-C₁-C₄-alkyl, hetaryl-C₁-C₄-alkyl and heterocyclyl-C₁-C₄-alkyl wherein the ring in the twelve last mentioned radicals may be unsubstituted or may carry 1, 2, 3, 4 or 5 substituents which, independently of each other, are selected from halogen, cyano, nitro, C₁-C₄-alkyl, C₁-C₄-haloalkyl, C₁-C₄-alkoxy and C₁-C₄-haloalkoxy, or
      R^{2b} and R^{2c} together with the nitrogen atom to which they are bound form a 5- or 6-membered, saturated or unsaturated heterocycle, which may carry a further heteroatom being selected from O, S and N as a ring member atom and wherein the heterocycle may be unsubstituted or may carry 1, 2, 3, 4 or 5 substituents which, independently of each other, are selected from halogen, cyano, nitro, C₁-C₄-alkyl, C₁-C₄-haloalkyl, C₁-C₄-alkoxy and C₁-C₄-haloalkoxy, and wherein
   R^{2d} is selected from C₁-C₄-alkyl, C₁-C₄-haloalkyl, C₃-C₆-cycloalkyl,
      C₃-C₆-halocycloalkyl, C₂-C₄-alkenyl, C₂-C₄-haloalkenyl, C₂-C₄-alkynyl, C₁-C₄-alkoxy-C₁-C₄-alkyl, phenyl, hetaryl, heterocyclyl, phenyl-C₁-C₄-alkyl, hetaryl-C₁-C₄-alkyl and heterocyclyl-C₁-C₄-alkyl, wherein the ring in the six last mentioned radicals may be unsubstituted or may carry 1, 2, 3, 4 or 5 substituents which, independently of each other, are selected from halogen, cyano, nitro, C₁-C₄-alkyl, C₁-C₄-haloalkyl, C₁-C₄-alkoxy and C₁-C₄-haloalkoxy;
X³ is a lone pair or oxygen;
R¹ is hydrogen, CN, C₁-C₁₀-alkyl, C₁-C₁₀-haloalkyl, C₃-C₁₀-cycloalkyl, C₃-C₁₀-halocycloalkyl, C₂-C₁₀-alkenyl, C₂-C₁₀-haloalkenyl, C₂-C₁₀-alkynyl, C₃-C₁₀-haloalkynyl, OR^{a}, C(Y)R^{b}, C(Y)OR^{c}, S(O)₂R^{d}, NR^{e}R^{f}, C(Y)NR^{g}R^{h}, S(O)ₘNR^{e}R^{f}, C(Y)NRⁱNR^{e}R^{f}, C₁-C₅-alkylen-OR^{a}, C₁-C₅-alkylen-CN, C₁-C₅-alkylen-C(Y)R^{b}, C₁-C₅-alkylen-C(Y)OR^{c}, C₁-C₅-alkylen-NR^{e}R^{f},
   C₁-C₅-alkylen-C(Y)NR^{g}R^{h}, C₁-C₅-alkylen-S(O)₂R^{d}, C₁-C₅-alkylen-S(O)ₘNR^{e}R^{d}, C₁-C₅-alkylen-C(Y)NRⁱNR^{e}R^{f},
   phenyl, hetaryl, saturated or partially unsaturated heterocyclyl, phenyl-C₁-C₅-alkyl, hetaryl-C₁-C₅-alkyl, saturated or partially unsaturated heterocyclyl-C₁-C₅-alkyl, C₃-C₁₀-cycloalkyl-C₁-C₅-alkyl and
   C₅-C₁₀-cycloalkenyl-C₁-C₅-alkyl, wherein the ring in the last ten mentioned radicals may be unsubstituted or may carry 1, 2, 3, 4 or 5 identical or different substituents R^{y} and wherein m is 0, 1 or 2 and Y is O or S;
R² is hydrogen, halogen, methyl, halomethyl, methoxy, halomethoxy, methylthio, halomethylthio, methylsulfinyl, halomethylsulfinyl, methylsulfonyl or halomethylsulfonyl;
R³ is hydrogen, halogen, C₁-C₄-alkyl, C₁-C₄-haloalkyl, C₁-C₄-alkoxy, C₁-C₄-haloalkoxy, C₁-C₄-alkylthio, C₁-C₄-haloalkylthio, C₁-C₄-alkylsulfinyl, C₁-C₄-haloalkylsulfinyl, C₁-C₄-alkylsulfonyl, C₁-C₄-haloalkylsulfonyl, C₃-C₆-cycloalkyl, C₃-C₆-halocycloalkyl, C₂-C₄-alkenyl, C₂-C₄-haloalkenyl, C₂-C₄-alkynyl or C₁-C₄-alkoxy-C₁-C₄-alkyl;
R^{a}, R^{b}, R^{c} are independently of each other selected from hydrogen, C₁-C₄-alkyl, C₁-C₄-haloalkyl, C₃-C₆-cycloalkyl, C₃-C₆-cycloalkylmethyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, phenyl, hetaryl, heterocyclyl, phenyl-C₁-C₄-alkyl, hetaryl-C₁-C₄-alkyl and heterocyclyl-C₁-C₄-alkyl, wherein the ring in the six last mentioned radicals may be unsubstituted or may carry 1, 2, 3, 4 or 5 substituents which, independently of each other, are selected from halogen, cyano, nitro, C₁-C₄-alkyl, C₁-C₄-haloalkyl, C₁-C₄-alkoxy and C₁-C₄-haloalkoxy;
R^{d} is selected from C₁-C₄-alkyl, C₁-C₄-haloalkyl, C₃-C₆-cycloalkyl, C₃-C₆-cycloalkylmethyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, phenyl, hetaryl, heterocyclyl, phenyl-C₁-C₄-alkyl, hetaryl-C₁-C₄-alkyl and heterocyclyl-C₁-C₄-alkyl wherein the ring in the six last mentioned radicals may be unsubstituted or may carry 1, 2, 3, 4 or 5 substituents which are independently of each other selected from halogen, cyano, nitro, C₁-C₄-alkyl, C₁-C₄-haloalkyl, C₁-C₄-alkoxy and C₁-C₄-haloalkoxy;
R^{e}, R^{f} are independently of each other selected from hydrogen, C₁-C₄-alkyl, C₁-C₄-haloalkyl, C₃-C₆-cycloalkyl, C₃-C₆-cycloalkylmethyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, C₁-C₄-alkylcarbonyl, C₁-C₄-haloalkylcarbonyl, C₁-C₄-alkylsulfonyl, C₁-C₄-haloalkylsulfonyl, phenyl, phenylcarbonyl, phenylsulfonyl, hetaryl, hetarylcarbonyl, hetarylsulfonyl, heterocyclyl, heterocyclylcarbonyl, heterocyclylsulfonyl, phenyl-C₁-C₄-alkyl, hetaryl-C₁-C₄-alkyl and heterocyclyl-C₁-C₄-alkyl wherein the ring in the twelve last mentioned radicals may be unsubstituted or may carry 1, 2, 3, 4 or 5 substituents which, independently of each other, are selected from halogen, cyano, nitro, C₁-C₄-alkyl, C₁-C₄-haloalkyl, C₁-C₄-alkoxy and C₁-C₄-haloalkoxy; or
R^{e} and R^{f} together with the nitrogen atom to which they are bound form a 5- or 6-membered, saturated or unsaturated heterocycle, which may carry a further heteroatom being selected from O, S and N as a ring member atom and wherein the heterocycle may be unsubstituted or may carry 1, 2, 3, 4 or 5 substituents which are independently of each other selected from halogen, cyano, nitro, C₁-C₄-alkyl, C₁-C₄-haloalkyl, C₁-C₄-alkoxy and C₁-C₄-haloalkoxy;
R^{g}, R^{h} are independently of each other selected from hydrogen, C₁-C₄-alkyl, C₁-C₄-haloalkyl, C₃-C₆-cycloalkyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, phenyl, hetaryl, heterocyclyl, phenyl-C₁-C₄-alkyl, hetaryl-C₁-C₄-alkyl and heterocyclyl-C₁-C₄-alkyl wherein the ring in the six last mentioned radicals may be unsubstituted or may carry 1, 2, 3, 4 or 5 substituents which are independently of each other selected from halogen, cyano, nitro, C₁-C₄-alkyl, C₁-C₄-haloalkyl, C₁-C₄-alkoxy and C₁-C₄-haloalkoxy;
Rⁱ is selected from hydrogen, C₁-C₄-alkyl, C₁-C₄-haloalkyl, C₃-C₆-cycloalkyl, C₃-C₆-cycloalkylmethyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, phenyl and phenyl-C₁-C₄-alkyl wherein the phenyl ring in the two last mentioned radicals may be unsubstituted or may carry 1, 2, 3, 4 or 5 substituents which are independently of each other selected from halogen, cyano, nitro, C₁-C₄-alkyl, C₁-C₄-haloalkyl, C₁-C₄-alkoxy and C₁-C₄-haloalkoxy;
R^{al}, R^{a2} are independently of each other selected from C₁-C₄-alkyl, C₁-C₄-haloalkyl, C₃-C₆-cycloalkyl, C₃-C₆-cycloalkylmethyl, C₃-C₆-halocycloalkyl, C₂-C₄-alkenyl, C₂-C₄-haloalkenyl, C₂-C₄-alkynyl and C₁-C₄-alkoxy-C₁-C₄-alkyl;
R^{b1}, R^{b2} are independently of each other selected from hydrogen, C₁-C₄-alkyl, C₁-C₄-haloalkyl, C₃-C₆-cycloalkyl, C₃-C₆-cycloalkylmethyl, C₃-C₆-halocycloalkyl, C₂-C₄-alkenyl, C₂-C₄-haloalkenyl, C₂-C₄-alkynyl, and C₁-C₄-alkoxy-C₁-C₄-alkyl;
R^{d1}, R^{d2} are independently of each other selected from C₁-C₄-alkyl, C₁-C₄-haloalkyl, C₃-C₆-cycloalkyl, C₃-C₆-cycloalkylmethyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, phenyl, hetaryl, heterocyclyl, phenyl-C₁-C₄-alkyl, hetaryl-C₁-C₄-alkyl and heterocyclyl-C₁-C₄-alkyl, wherein the ring in the six last mentioned radicals may be unsubstituted or may carry 1, 2, 3, 4 or 5 substituents which are independently of each other selected from halogen, cyano, nitro, C₁-C₄-alkyl, C₁-C₄-haloalkyl, C₁-C₄-alkoxy and C₁-C₄-haloalkoxy;
R^{a3} has one of the meanings given for R^{a}, except for hydrogen;
R^{b3} has one of the meanings given for R^{b};
R^{d3} has one of the meanings given for R^{d};
R^{y} is selected from halogen, cyano, nitro, C₁-C₄-alkyl, C₁-C₄-haloalkyl, C₁-C₄-alkoxy, C₁-C₄-haloalkoxy, C₁-C₄-haloalkylthio, C₁-C₄-alkylsulfinyl, C₁-C₄-haloalkylsulfinyl, C₁-C₄-alkylsulfonyl, C₁-C₄-haloalkylsulfonyl, SO₂NH₂, C₁-C₄-alkylaminosulfonyl, di-(C₁-C₄-alkyl)aminosulfonyl, C₁-C₄-haloalkylaminosulfonyl, C₁-C₄-alkylcarbonyl, C₁-C₄-haloalkylcarbonyl, C₁-C₄-alkoxycarbonyl, C₁-C₄-haloalkoxycarbonyl, C₃-C₆-cycloalkyl, C₃-C₆-halocycloalkyl, C₂-C₄-alkenyl, C₂-C₄-haloalkenyl, C₂-C₄-alkynyl and C₁-C₄-alkoxy-C₁-C₄-alkyl.

The methods of the present invention are particularly useful for controlling invertebrate pests, in particular for controlling arthropods and nematodes, especially for controlling insects, in particular for controlling insects of the order homoptera. Therefore, the invention also relates to the use of a 3-pyridyl compound of the formulae I or II, a tautomer or an N-oxide thereof or a salt thereof, in particular an agriculturally or veterinarily acceptable salt thereof, for combating invertebrate pests, in particular for combating arthropod pests and/or nematodes, especially for combating insects, in particular for combating insects of the order homoptera.

A further aspect of the present invention relates to a method for protecting plants from infestation with arthropod pests, which method comprises treating the plants with a pesticidally effective amount of a 3-pyridyl compound of the formulae I or II according to the present invention or an agriculturally acceptable salt, a tautomer or an N-oxide thereof or an agriculturally acceptable salt of said N-oxide or of said tautomer.

A further aspect of the present invention relates to a method for protecting plant propagation material, in particular seed and/or the plants which grow therefrom, which method comprises treating the plant propagation material with a pesticidally effective amount of a 3-pyridyl compound of the formulae I or II according to the present invention or an agriculturally acceptable salt, a tautomer or an N-oxide thereof or an agriculturally acceptable salt of said N-oxide or of said tautomer.

A further aspect of the present invention relates to plant propagation material, comprising at least one 3-pyridyl compound of formulae I or II according to the present invention and/or an agriculturally acceptable salt, a tautomer or an N-oxide thereof or an agriculturally acceptable salt of said N-oxide or of said tautomer.

A further aspect of the present invention relates to methods and uses comprising a 3-pyridyl compound of formulae I or II according to the present invention or a veterinarily acceptable salt thereof or a tautomer or an N-oxide thereof or a salt of said N-oxide or tautomer for the use in a method for treating or protecting a human or in particular a non-human animal from infestation or infection by parasites especially ectoparasites.

A further aspect of the present invention relates to a method for treating or protecting an animal, in particular a non-human animal, from infestation or infection by parasites especially ectoparasites which comprises bringing the animal in contact with a parasiticidally effective amount of a 3-pyridyl compound of the formulae I or II or a veterinarily acceptable salt thereof or an N-oxide or tautomer thereof or with a veterinarily acceptable salt of said tautomer or N-oxide. Bringing the animal in contact with a 3-pyridyl compound of formulae I or II, a tautomer, an N-oxide or salt thereof or with a veterinary composition containing a compound of the invention, means applying or administering it to the animal.

A further aspect of the present invention relates to an agricultural composition containing at least one 3-pyridyl compound of formulae I or II according to the present invention and/or an agriculturally acceptable salt thereof or an N-oxide or tautomer thereof and/or an agriculturally acceptable salt of said N-oxide or said tautomer and at least one liquid or solid carrier.

Depending on the substitution pattern, the compounds of the formulae I or II may have one or more centers of chirality, in which case they are present as mixtures of enantiomers or diastereomers. The invention provides the use according to the invention of both the pure enantiomers or pure diastereomers of the formulae I or II and their mixtures. Suitable compounds of the formulae I or II also include all possible geometrical stereoisomers (cis/trans isomers) and mixtures thereof.

Depending on the substitution pattern, the compounds of the formulae I or II may be present in the form of their tautomers. Hence the invention also relates to methods and uses comprising the tautomers of the formulae I or II and the salts of said tautomers.

The compounds of formulae I or II as well as their N-oxides and tautomers may be amorphous or may exist in one or more different crystalline states (polymorphs) which may have different macroscopic properties such as stability or show different biological properties such as activities. The present invention includes both amorphous and crystalline compounds of formulae I or II, their tautomers or N-oxides, mixtures of different crystalline states of the respective compound of formulae I or II, its tautomers or N-oxides, as well as amorphous or crystalline salts thereof.

Salts of the compounds of the formulae I or II, their tautomers or N-oxides, are preferably agriculturally and veterinarily acceptable salts. They can be formed in a customary method, e.g. by reacting the compound with an acid if the compound of formulae I or II has a basic functionality or by reacting the compound with a suitable base if the compound of formulae I or II has an acidic functionality.

Suitable agriculturally acceptable salts are especially the salts of those cations or the acid addition salts of those acids whose cations and anions, respectively, do not have any adverse effect on the pesticidal action of the compounds according to the present invention. Suitable cations are in particular the ions of the alkali metals, preferably lithium, sodium and potassium, of the alkaline earth metals, preferably calcium, magnesium and barium, and of the transition metals, preferably manganese, copper, zinc and iron, and also ammonium (NH₄⁺) and substituted ammonium in which one to four of the hydrogen atoms are replaced by C₁-C₄-alkyl, C₁-C₄-hydroxyalkyl, C₁-C₄-alkoxy, C₁-C₄-alkoxy-C₁-C₄-alkyl, hydroxy-C₁-C₄-alkoxy-C₁-C₄-alkyl, phenyl or benzyl. Examples of substituted ammonium ions comprise methylammonium, isopropylammonium, dimethylammonium, diisopropylammonium, trimethylammonium, tetramethylammonium, tetraethylammonium, tetrabutylammonium, 2-hydroxyethylammonium, 2-(2-hydroxyethoxy)ethylammonium, bis(2-hydroxyethyl)ammonium, benzyltrimethylammonium and benzl-triethylammonium. Further suitable cations are phosphonium ions, sulfonium ions, preferably tri(C₁-C₄-alkyl)sulfonium, and sulfoxonium ions, preferably tri(C₁-C₄-alkyl)sulfoxonium.

Anions of useful acid addition salts are primarily chloride, bromide, fluoride, hydrogensulfate, sulfate, dihydrogenphosphate, hydrogenphosphate, phosphate, nitrate, bicarbonate, carbonate, hexafluorosilicate, hexafluorophosphate, benzoate, and the anions of C₁-C₄-alkanoic acids, preferably formate, acetate, propionate and butyrate. They can be formed by reacting compounds of formulae I or II with an acid of the corresponding anion, preferably of hydrochloric acid, hydrobromic acid, sulfuric acid, phosphoric acid or nitric acid.

Veterinarily acceptable salts of the compounds of formulae I or II encompass especially the acid addition salts which are known and accepted in the art for the formation of salts for veterinary use. Suitable acid addition salts, e.g. formed by compounds of formulae I or II containing a basic nitrogen atom, e.g. an amino group, include salts with inorganic acids, for example hydrochlorids, sulphates, phosphates, and nitrates and salts of organic acids for example acetic acid, maleic acid, e.g. the monoacid salts or diacid salts of maleic acid, dimaleic acid, fumaric acid, e.g. the monoacid salts or diacid salts of fumaric acid, difumaric acid, methane sulfenic acid, methane sulfonic acid, and succinic acid.

The term “N-oxide” includes any compound of the formulae I or II which has at least one tertiary nitrogen atom that is oxidized to an N-oxide moiety. Apart from that compounds of the formulae I or II, wherein the pyridine nitrogen carries an oxygen, i.e. X³ is O, are also referred to as N-oxides of compounds I or II.

The term “invertebrate pest” as used herein encompasses animal populations, such as arthropode pests, including insects and arachnids, as well as nematodes, which may attack plants thereby causing substantial damage to the plants attacked, as well as ectoparasites which may infest animals, in particular warm blooded animals such as e.g. mammals or birds, or other higher animals such as reptiles, amphibians or fish, thereby causing substantial damage to the animals infested.

The term “plant propagation material” as used herein includes all the generative parts of the plant such as seeds and vegetative plant material such as cuttings and tubers (e.g. potatoes), which can be used for the multiplication of the plant. This includes seeds, roots, fruits, tubers, bulbs, rhizomes, shoots, sprouts and other parts of plants. Seedlings and young plants, which are to be transplanted after germination or after emergence from soil, may also be included. These plant propagation materials may be treated prophylactically with a plant protection compound either at or before planting or transplanting.

The term “plants” comprises any types of plants including “non-cultivated plants” and in particular “cultivated plants”.

The term “non-cultivated plants” refers to any wild type species or related species or related genera of a cultivated plant.

The term “cultivated plants” as used herein includes plants which have been modified by breeding, mutagenesis or genetic engineering. Genetically modified plants are plants, which genetic material has been so modified by the use of recombinant DNA techniques that under natural circumstances cannot readily be obtained by cross breeding, mutations or natural recombination. Typically, one or more genes have been integrated into the genetic material of a genetically modified plant in order to improve certain properties of the plant. Such genetic modifications also include but are not limited to targeted post-translational modification of protein(s) (oligo- or polypeptides) poly for example by glycosylation or polymer additions such as prenylated, acetylated or farnesylated moieties or PEG moieties (e.g. as disclosed in Biotechnol Prog. 2001 July-August; 17(4):720-8., Protein Eng Des Sel. 2004 January; 17(1):57-66, Nat. Protoc. 2007; 2(5):1225-35., Curr. Opin. Chem. Biol. 2006 October; 10(5):487-91. Epub 2006 Aug. 28., Biomaterials. 2001 March; 22(5):405-17, Bioconjug. Chem. 2005 January-February; 16(1):113-21).

The term “cultivated plants” as used herein further includes plants that have been rendered tolerant to applications of specific classes of herbicides, such as hydroxy-phenylpyruvate dioxygenase (HPPD) inhibitors; acetolactate synthase (ALS) inhibitors, such as sulfonyl ureas (see e.g. U.S. Pat. No. 6,222,100, WO 01/82685, WO 00/26390, WO 97/41218, WO 98/02526, WO 98/02527, WO 04/106529, WO 05/20673, WO 03/14357, WO 03/13225, WO 03/14356, WO 04/16073) or imidazolinones (see e.g. U.S. Pat. No. 6,222,100, WO 01/82685, WO 00/26390, WO 97/41218, WO 98/02526, WO 98/02527, WO 04/106529, WO 05/20673, WO 03/14357, WO 03/13225, WO 03/14356, WO 04/16073); enolpyruvylshikimate-3-phosphate synthase (EPSPS) inhibitors, such as glyphosate (see e.g. WO 92/00377); glutamine synthetase (GS) inhibitors, such as glufosinate (see e.g. EP-A-0242236, EP-A-242246) or oxynil herbicides (see e.g. U.S. Pat. No. 5,559,024) as a result of conventional methods of breeding or genetic engineering. Several cultivated plants have been rendered tolerant to herbicides by conventional methods of breeding (mutagenesis), for example Clearfield® summer rape (Canola) being tolerant to imidazolinones, e.g. imazamox. Genetic engineering methods have been used to render cultivated plants, such as soybean, cotton, corn, beets and rape, tolerant to herbicides, such as glyphosate and glufosinate, some of which are commercially available under the trade names RoundupReady® (glyphosate) and LibertyLink® (glufosinate).

The term “cultivated plants” as used herein further includes plants that are by the use of recombinant DNA techniques capable to synthesize one or more insecticidal proteins, especially those known from the bacterial genus bacillus, particularly from bacillus thuringiensis, such as delta-endotoxins, e.g. CryIA(b), CryIA(c), CryIF, CryIF(a2), CryIIA(b), CryIIIA, CryIIB(b1) or Cry9c; vegetative insecticidal proteins (VIP), e.g. VIP1, VIP2, VIP3 or VIP3A; insecticidal proteins of bacteria colonizing nematodes, for example Photorhabdus spp. or Xenorhabdus spp.; toxins produced by animals, such as scorpion toxins, arachnid toxins, wasp toxins, or other insect-specific neurotoxins; toxins produced by fungi, such Streptomycetes toxins, plant lectins, such as pea or barley lectins; agglutinins; proteinase inhibitors, such as trypsin inhibitors, serine protease inhibitors, patatin, cystatin or papain inhibitors; ribosome-inactivating proteins (RIP), such as ricin, maize-RIP, abrin, luffin, saporin or bryodin; steroid metabolism enzymes, such as 3-hydroxysteroid oxidase, ecdysteroid-IDP-glycosyl-transferase, cholesterol oxidases, ecdysone inhibitors or HMG-CoA-reductase; ion channel blockers, such as blockers of sodium or calcium channels; juvenile hormone esterase; diuretic hormone receptors (helicokinin receptors); stilben synthase, bibenzyl synthase, chitinases or glucanases. In the context of the present invention these insecticidal proteins or toxins are to be understood expressly also as pre-toxins, hybrid proteins, truncated or otherwise modified proteins. Hybrid proteins are characterized by a new combination of protein domains, (see, for example WO 02/015701). Further examples of such toxins or genetically-modified plants capable of synthesizing such toxins are disclosed, for example, in EP-A 374 753, WO 93/007278, WO 95/34656, EP-A 427 529, EP-A 451 878, WO 03/018810 and WO 03/052073.

The methods for producing such genetically modified plants are generally known to the person skilled in the art and are described, for example, in the publications mentioned above. These insecticidal proteins contained in the genetically modified plants impart to the plants producing these proteins protection from harmful pests from certain taxonomic groups of arthropods insects, particularly to beetles (Coleoptera), flies (Diptera), and butterflies and moths (Lepidoptera) and to plant parasitic nematodes (Nematoda).

The term “cultivated plants” as used herein further includes plants that are by the use of recombinant DNA techniques capable to synthesize one or more proteins to increase the resistance or tolerance of those plants to bacterial, viral or fungal pathogens. Examples of such proteins are the so-called “pathogenesis-related proteins” (PR proteins, see, for example EP-A 0 392 225), plant disease resistance genes (for example potato cultivars, which express resistance genes acting against Phytophthora infestans derived from the mexican wild potato Solanum bulbocastanum) or T4-lysozym (e.g. potato cultivars capable of synthesizing these proteins with increased resistance against bacteria such as Erwinia amylvora).

The term “cultivated plants” as used herein further includes plants that are by the use of recombinant DNA techniques capable to synthesize one or more proteins to increase the productivity (e.g. bio mass production, grain yield, starch content, oil content or protein content), tolerance to drought, salinity or other growth-limiting environmental factors or tolerance to pests and fungal, bacterial or viral pathogens of those plants.

The term “cultivated plants” as used herein further includes plants that contain by the use of recombinant DNA techniques a modified amount of substances of content or new substances of content, specifically to improve human or animal nutrition, for example oil crops that produce health-promoting long-chain omega-3 fatty acids or unsaturated omega-9 fatty acids (e.g. Nexera® rape).

The term “cultivated plants” as used herein further includes plants that contain by the use of recombinant DNA techniques a modified amount of substances of content or new substances of content, specifically to improve raw material production, for example potatoes that produce increased amounts of amylopectin (e.g. Amflora® potato).

The organic moieties mentioned in the above definitions of the variables are—like the term halogen—collective terms for individual listings of the individual group members.

The prefix Cₙ-Cₘ indicates in each case the possible number of carbon atoms in the group.

The term “halogen” denotes in each case fluorine, bromine, chlorine or iodine, in particular fluorine, chlorine or bromine.

The term “alkyl” as used herein and in the alkyl moieties of alkoxy, alkylcarbonyl, alkylthio, alkylsulfinyl, alkylsulfonyl and alkoxyalkyl denotes in each case a straight-chain or branched alkyl group having usually from 1 to 10 carbon atoms, frequently from 1 to 6 carbon atoms, preferably 1 to 4 carbon atoms and in particular from 1 to 3 carbon atoms. Examples of an alkyl group are methyl, ethyl, n-propyl, iso-propyl, n-butyl, 2-butyl, iso-butyl, tert-butyl, n-pentyl, 1-methylbutyl, 2-methylbutyl, 3-methylbutyl, 2,2-dimethylpropyl, 1-ethylpropyl, n-hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methylpropyl, n-heptyl, 1-methylhexyl, 2-methylhexyl, 3-methylhexyl, 4-methylhexyl, 5-methylhexyl, 1-ethylpentyl, 2-ethylpentyl, 3-ethylpentyl, 1-propylpentyl, n-octyl, 1-methyloctyl, 2-methylheptyl, 1-ethylhexyl, 2-ethylhexyl, 1,2-dimethylhexyl, 1-propylpentyl and 2-propylpentyl.

The term “alkylene” (or alkanediyl) as used herein in each case denotes an alkyl radical as defined above, wherein one hydrogen atom at any position of the carbon backbone is replaced by one further binding site, thus forming a bivalent moiety.

The term “haloalkyl” as used herein and in the haloalkyl moieties of haloalkoxy, haloalkylthio, haloalkylcarbonyl, haloalkylsulfonyl and haloalkylsulfinyl, denotes in each case a straight-chain or branched alkyl group having usually from 1 to 10 carbon atoms, frequently from 1 to 6 carbon atoms, wherein the hydrogen atoms of this group are partially or totally replaced with halogen atoms. Preferred haloalkyl moieties are selected from C₁-C₄-haloalkyl, more preferably from C₁-C₂-haloalkyl, in particular from C₁-C₂-fluoroalkyl such as fluoromethyl, difluoromethyl, trifluoromethyl, 1-fluoroethyl, 2-fluoroethyl, 2,2-difluoroethyl, 2,2,2-trifluoroethyl, pentafluoroethyl, and the like.

The term “alkoxy” as used herein denotes in each case a straight-chain or branched alkyl group usually having from 1 to 10 carbon atoms, frequently from 1 to 6 carbon atoms, preferably 1 to 4 carbon atoms, which is bound to the remainder of the molecule via an oxygen atom. Examples of an alkoxy group are methoxy, ethoxy, n-propoxy, isopropoxy, n-butyloxy, 2-butyloxy, iso-butyloxy, tert.-butyloxy, and the like.

The term “haloalkoxy” as used herein denotes in each case a straight-chain or branched alkoxy group, as defined above, having from 1 to 10 carbon atoms, frequently from 1 to 4 carbon atoms, preferably 1 to 3 carbon atoms, wherein the hydrogen atoms of this group are partially or totally replaced with halogen atoms, in particular fluorine atoms. Preferred haloalkoxy moieties include C₁-C₄-haloalkoxy, in particular C₁-C₂-fluoroalkoxy, such as fluoromethoxy, difluoromethoxy, trifluoromethoxy, 1-fluoroethoxy, 2-fluoroethoxy, 2,2-difluoroethoxy, 2,2,2-trifluoroethoxy, 2-chloro-2-fluoroethoxy, 2-chloro-2,2-difluoro-ethoxy, 2,2-dichloro-2-fluorethoxy, 2,2,2-trichloroethoxy, pentafluoroethoxy and the like.

The term “cycloalkyl” as used herein and in the cycloalkyl moieties of cycloalkoxy and cycloalkylalkyl denotes in each case a mono- or bicyclic cycloaliphatic radical having usually from 3 to 10 carbon atoms or 3 to 6 carbon atoms, such as cyclopropyl, cyclobutyl, cyclopentyl, cyclohexyl, cycloheptyl, cyclooctyl, bicyclo[2.1.1]hexyl, bicyclo[3.1.1]heptyl, bicyclo[2.2.1]heptyl, and bicyclo[2.2.2]octyl.

The term “C₅-C₁₀-cycloalkenyl” as used herein and in the C₅-C₁₀-cycloalkenyl moieties of C₅-C₁₀-cycloalkenyl-C₁-C₅-alkyl denotes in each case an aliphatic ring system radical having 5 to 10 carbon that comprises at least one carbon-carbon double bond in the ring. Examples of cycloalkenyl groups include, but are not limited to, cyclopropenyl, cyclopentenyl, cyclohexenyl, cycloheptenyl, and the like.

The term “Cₙ-Cₘ-cycloalkyl-Cₒ-Cₚ-alkyl” as used herein refers to a cycloalkyl group, as defined above, having n to m carbon atoms, which is bound to the remainder of the molecule via an alkylene group, as defined above, having o to p carbon atoms. Examples are cyclopropylmethyl, cyclopropylethyl, cyclopropylpropyl, cyclobutylmethyl, cyclobutylethyl, cyclobutylpropyl, cyclopentylmethyl, cyclopentylethyl, cyclopentylpropyl, cyclohexylmethyl, cyclohexylethyl, cyclohexylpropyl, and the like.

The term “C₃-C₆-cycloalkoxy” as used herein refers to a cycloalkyl group, as defined above, having 3 to 6 carbon atoms, which is bound to the remainder of the molecule via an oxygen atom. Examples of C₃-C₆-cycloalkoxy groups include cycloproppyloxy, cyclopentyloxy, cyclohexyloxy and the like.

The term “C₅-C₁₀-cycloalkenyl-C₁-C₅-alkyl” refers to cycloalkenyl as defined above which is bound via an alkylene group, as defined above, having 1 to 5 carbon atoms to the remainder of the molecule. Examples include but are not limited to cyclopentenylmethyl, cyclopentenylethyl, cyclohexenylpropyl, cyclohexenylpentyl, cycloheptenylmethyl, and the like.

The term “halocycloalkyl” as used herein and in the halocycloalkyl moieties of halocycloalkylmethyl denotes in each case a mono- or bicyclic cycloaliphatic radical having usually from 3 to 10 carbon atoms or 3 to 6 carbon atoms, wherein at least one, e.g. 1, 2, 3, 4 or 5 of the hydrogen atoms are replaced by halogen, in particular by fluorine or chlorine. Examples are 1- and 2-fluorocyclopropyl, 1,2-, 2,2- and 2,3-difluorocyclopropyl, 1,2,2-trifluorocyclopropyl, 2,2,3,3-tetrafluorocyclpropyl, 1- and 2-chlorocyclopropyl, 1,2-, 2,2- and 2,3-dichlorocyclopropyl, 1,2,2-trichlorocyclopropyl, 2,2,3,3-tetrachlorocyclpropyl, 1-, 2- and 3-fluorocyclopentyl, 1,2-, 2,2-, 2,3-, 3,3-, 3,4-, 2,5-difluorocyclopentyl, 1-, 2- and 3-chlorocyclopentyl, 1,2-, 2,2-, 2,3-, 3,3-, 3,4-, 2,5-dichlorocyclopentyl and the like.

The term “alkenyl” as used herein denotes in each case a singly unsaturated hydrocarbon radical having usually 2 to 10, preferably 2 to 4 carbon atoms, e.g. vinyl, allyl (2-propen-1-yl), 1-propen-1-yl, 2-propen-2-yl, methallyl (2-methylprop-2-en-1-yl), 2-buten-1-yl, 3-buten-1-yl, 2-penten-1-yl, 3-penten-1-yl, 4-penten-1-yl, 1-methylbut-2-en-1-yl, 2-ethylprop-2-en-1-yl and the like.

The term “haloalkenyl” as used herein, which may also expressed as “alkenyl which may be substituted by halogen”, and the haloalkenyl moieties in haloalkenyloxy, haloalkenylcarbonyl and the like refers to unsaturated straight-chain or branched hydrocarbon radicals having 2 to 10 (“C₂-C₁₀-haloalkenyl”) or 2 to 4 (“C₂-C₄-haloalkenyl”) carbon atoms and a double bond in any position, where some or all of the hydrogen atoms in these groups are replaced by halogen atoms as mentioned above, in particular fluorine, chlorine and bromine, for example chlorovinyl, chloroallyl and the like.

The term “alkynyl” as used herein refers to unsaturated straight-chain or branched hydrocarbon radicals having usually 2 to 10, preferably 2 to 4 carbon atoms and one or two triple bonds in any position, e.g. ethynyl, propargyl (2-propyn-1-yl), 1-propyn-1-yl, 1-methylprop-2-yn-1-yl), 2-butyn-1-yl, 3-butyn-1-yl, 1-pentyn-1-yl, 3-pentyn-1-yl, 4-pentyn-1-yl, 1-methylbut-2-yn-1-yl, 1-ethylprop-2-yn-1-yl and the like.

The term “C₃-C₁₀-haloalkynyl” as used herein, which is also expressed as “C₃-C₁₀-alkynyl which may be substituted by halogen”, refers to unsaturated straight-chain or branched hydrocarbon radicals having 3 to 10 carbon atoms and one or two triple bonds in any position (as mentioned above), where some or all of the hydrogen atoms in these groups are replaced by halogen atoms as mentioned above, in particular fluorine, chlorine and bromine;

The term “alkoxyalkyl” as used herein refers to alkyl usually comprising 1 to 4 carbon atoms, wherein 1 carbon atom carries an alkoxy radical usually comprising 1 to 10, in particular 1 to 4, carbon atoms as defined above. Examples are CH₂OCH₃, CH₂—OC₂H₅, n-propoxymethyl, CH₂—OCH(CH₃)₂, n-butoxymethyl, (1-methylpropoxy)-methyl, (2-methylpropoxy)methyl, CH₂—OC(CH₃)₃, 2-(methoxy)ethyl, 2-(ethoxy)ethyl, 2-(n-propoxy)-ethyl, 2-(1-methylethoxy)-ethyl, 2-(n-butoxy)ethyl, 2-(1-methylpropoxy)ethyl, 2-(2-methylpropoxy)-ethyl, 2-(1,1-dimethylethoxy)-ethyl, 2-(methoxy)-propyl, 2-(ethoxy)-propyl, 2-(n-propoxy)-propyl, 2-(1-methylethoxy)-propyl, 2-(n-butoxy)-propyl, 2-(1-methylpropoxy)-propyl, 2-(2-methylpropoxy)-propyl, 2-(1,1-dimethylethoxy)-propyl, 3-(methoxy)-propyl, 3-(ethoxy)-propyl, 3-(n-propoxy)-propyl, 3-(1-methylethoxy)-propyl, 3-(n-butoxy)-propyl, 3-(1-methylpropoxy)-propyl, 3-(2-methylpropoxy)-propyl, 3-(1,1-dimethylethoxy)-propyl, 2-(methoxy)-butyl, 2-(ethoxy)-butyl, 2-(n-propoxy)-butyl, 2-(1-methylethoxy)-butyl, 2-(n-butoxy)-butyl, 2-(1-methylpropoxy)-butyl, 2-(2-methylpropoxy)-butyl, 2-(1,1-dimethylethoxy)-butyl, 3-(methoxy)-butyl, 3-(ethoxy)-butyl, 3-(n-propoxy)-butyl, 3-(1-methylethoxy)-butyl, 3-(n-butoxy)-butyl, 3-(1-methylpropoxy)butyl, 3-(2-methylpropoxy)-butyl, 3-(1,1-dimethylethoxy)-butyl, 4-(methoxy)-butyl, 4-(ethoxy)-butyl, 4-(n-propoxy)-butyl, 4-(1-methylethoxy)-butyl, 4-(n-butoxy)-butyl, 4-(1-methylpropoxy)-butyl, 4-(2-methylpropoxy)-butyl, 4-(1,1-dimethylethoxy)-butyl and the like.

The term “alkylcarbonyl” (alkyl-C(═O)—), as used herein refers to a straight-chain or branched saturated alkyl group as define above comprising 1 to 10 carbon atoms (═C₁-C₁₀-alkylcarbonyl), preferably 1 to 4 carbon atoms (═C₁-C₄-alkylcarbonyl) attached through the carbon atom of the carbonyl group at any position in the alkyl group.

The term “haloalkylcarbonyl” as used herein refers to an alkylcarbonyl group as defined above wherein the hydrogen atoms are partially or fully substituted by fluorine, chlorine, bromine and/or iodine.

The term “alkylthio” (also alkylsulfanyl or alkyl-S—)” as used herein refers to a straight-chain or branched saturated alkyl group comprising 1 to 10 carbon atoms (═C₁-C₁₀-alkylthio), preferably 1 to 4 carbon atoms (═C₁-C₄-alkylthio) as defined above, which is attached via a sulfur atom at any position in the alkyl group.

The term “haloalkylthio” as used herein refers to an alkylthio group as defined above wherein the hydrogen atoms are partially or fully substituted by fluorine, chlorine, bromine and/or iodine.

The term “alkylsulfinyl” (also alkylsulfoxyl or alkyl-S(═O)—), as used herein refers to a straight-chain or branched saturated alkyl group as define above comprising 1 to 10 carbon atoms (═C₁-C₁₀-alkylsulfinyl), preferably 1 to 4 carbon atoms (═C₁-C₄-alkylsulfinyl) attached through the sulfur atom of the sulfinyl group at any position in the alkyl group.

The term “haloalkylsulfinyl” as used herein refers to an alkylsulfinyl group as defined above wherein the hydrogen atoms are partially or fully substituted by fluorine, chlorine, bromine and/or iodine.

The term “alkylsulfonyl” (also alkyl-S(═O)₂—) as used herein refers to a straight-chain or branched saturated alkyl group comprising 1 to 10 carbon atoms (═C₁-C₁₀-alkylsulfonyl), preferably 1 to 4 carbon atoms (═C₁-C₄-alkylsulfonyl), as defined above, which is attached via the sulfur atom of the sulfonyl group at any position in the alkyl group.

The term “haloalkylsulfonyl” as used herein refers to an alkylsulfonyl group as defined above wherein the hydrogen atoms are partially or fully substituted by fluorine, chlorine, bromine and/or iodine.

The term “heterocyclyl” includes in general 3-, 4-, 5-, 6-, 7- or 8-membered, in particular 5-, 6-, 7- or 8-membered monocyclic heterocyclic non-aromatic radicals and 8 to 10 membered bicyclic heterocyclic non-aromatic radicals, the mono- and bicyclic non-aromatic radicals may be saturated or unsaturated. The mono- and bicyclic heterocyclic non-aromatic radicals usually comprise 1, 2, 3 or 4 heteroatoms, in particular 1 or 2 heteroatoms selected from N, O and S as ring members, where S-atoms as ring members may be present as S, SO or SO₂. Examples of saturated or unsaturated 3-, 4-, 5-, 6-, 7- or 8-membered heterocyclic radicals comprise saturated or unsaturated, non-aromatic heterocyclic rings, such as oxiranyl, oxetanyl, thietanyl, thietanyl-S-oxid (S-oxothietanyl), thietanyl-S-dioxid (S-dioxothiethanyl), pyrrolidinyl, pyrazolinyl, imidazolinyl, pyrrolinyl, pyrazolinyl, imidazolinyl, tetrahydrofuranyl, dihydrofuranyl, 1,3-dioxolanyl, dioxolenyl, thiolanyl, S-oxothiolanyl, S-dioxothiolanyl, dihydrothienyl, S-oxodihydrothienyl, S-dioxodihydrothienyl, oxazolidinyl, isoxazolidinyl, oxazolinyl, isoxazolinyl, thiazolinyl, isothiazolinyl, thiazolidinyl, isothiazolidinyl, oxathiolanyl, piperidinyl, piperazinyl, pyranyl, dihydropyranyl, tetrahydropyranyl, 1,3- and 1,4-dioxanyl, thiopyranyl, S-oxothiopyranyl, S-dioxothiopyranyl, dihydrothiopyranyl, S-oxodihydrothiopyranyl, S-dioxodihydrothiopyranyl, tetrahydrothiopyranyl, S-oxotetrahydrothiopyranyl, S-dioxotetrahydrothiopyranyl, morpholinyl, thiomorpholinyl, S-oxothiomorpholinyl, S-dioxothiomorpholinyl, thiazinyl and the like. Examples for heterocyclic ring also comprising 1 or 2 carbonyl groups as ring members comprise pyrrolidin-2-onyl, pyrrolidin-2,5-dionyl, imidazolidin-2-onyl, oxazolidin-2-onyl, thiazolidin-2-onyl and the like.

The term “hetaryl” includes in general 5- or 6-membered unsaturated monocyclic heterocyclic radicals and 8 to 10 membered unsaturated bicyclic heterocyclic radicals which are aromatic, i.e. they comply with Mickel's rule (4n+2 rule). Hetaryl usually comprise 1, 2, 3 or 4 heteroatoms selected from N, O and S as ring members. Examples of 5- or 6-membered heteroaromatic radicals include pyridyl, i.e. 2-, 3-, or 4-pyridyl, pyrimidinyl, i.e. 2-, 4- or 5-pyrimidinyl, pyrazinyl, pyridazinyl, i.e. 3- or 4-pyridazinyl, thienyl, i.e. 2- or 3-thienyl, furyl, i.e. 2- or 3-furyl, pyrrolyl, i.e. 2- or 3-pyrrolyl, oxazolyl, i.e. 2-, 3- or 5-oxazolyl, isoxazolyl, i.e. 3-, 4- or 5-isoxazolyl, thiazolyl, i.e. 2-, 3- or 5-thiazolyl, isothiazolyl, i.e. 3-, 4- or 5-isothiazolyl, pyrazolyl, i.e. 1-, 3-, 4- or 5-pyrazolyl, i.e. 1-, 2-, 4- or 5-imidazolyl, oxadiazolyl, e.g. 2- or 5-[1,3,4]oxadiazolyl, 4- or 5-(1,2,3-oxadiazol)yl, 3- or 5-(1,2,4-oxadiazol)yl, 2- or 5-(1,3,4-thiadiazol)yl, thiadiazolyl, e.g. 2- or 5-(1,3,4-thiadiazol)yl, 4- or 5-(1,2,3-thiadiazol)yl, 3- or 5-(1,2,4-thiadiazol)yl, triazolyl, e.g. 1H-, 2H- or 3H-1,2,3-triazol-4-yl, 2H-triazol-3-yl, 1H-, 2H-, or 4H-1,2,4-triazolyl and tetrazolyl, i.e. 1H- or 2H-tetrazolyl.

The term “hetaryl” also includes bicyclic 8- to 10-membered heteroaromatic radicals comprising as ring members 1, 2 or 3 heteroatoms selected from N, O and S, wherein a 5- or 6-membered heteroaromatic ring is fused to a phenyl ring or to a 5- or 6-membered heteroaromatic radical. Examples of a 5- or 6-membered heteroaromatic ring fused to a phenyl ring or to a 5- or 6-membered heteroaromatic radical include benzofuranyl, benzothienyl, indolyl, indazolyl, benzimidazolyl, benzoxathiazolyl, benzoxadiazolyl, benzothiadiazolyl, benzoxazinyl, chinolinyl, isochinolinyl, purinyl, 1,8-naphthyridyl, pteridyl, pyrido[3,2-d]pyrimidyl or pyridoimidazolyl and the like. These fused hetaryl radicals may be bonded to the remainder of the molecule via any ring atom of 5- or 6-membered heteroaromatic ring or via a carbon atom of the fused phenyl moiety.

The terms “phenylalkyl” and “phenoxyalkyl” refers to phenyl or phenoxy, respectively, which are bound via an alkylene group, in particular a methylene group (=phenylmethyl or phenoxymethyl, respectively), to the remainder of the molecule, examples including benzyl, 1-phenylethyl, 2-phenylethyl, 2-phenoxyethyl and the like.

The terms “heterocyclylalkyl” and “hetarylalkyl” refer to heterocyclyl or hetaryl, respectively, as defined above, which are bound via an alkylene group, in particular a methylene group (=heterocyclylmethyl or hetarylmethyl, respectively) or an 1,1-ethandiyl or 1,2-ethandiylgroup (=1-heterocyclylethyl, 2-heterocyclylethyl, 1-hetarylethyl or 2-hetarylethyl, respectively), to the remainder of the molecule.

The term “phenylcarbonyl” (phenyl-C(═O)—), as used herein refers to a phenyl group that is bound to the remainder of the molecule via the carbon atom of the carbonyl group.

The term “hetarylcarbonyl” (hetaryl-C(═O)—) and “heterocyclylcarbonyl” (heterocyclyl-C(═O)—) refer to a hetaryl or heterocyclyl, respectively, as defined above, which are bound via the carbon atom of the carbonyl group to the remainder of the molecule, wherein the carbon atom of the carbonyl group is attached through any one of the carbon atoms of the hetaryl or heterocyclyl, respectively.

The term “phenylsulfonyl” (also phenyl-S(═O)₂—) as used herein refers to phenyl group that is bound to the remainder of the molecule via the sulfur atom of the sulfonyl group.

The term “hetarylsulfonyl” (hetaryl-S(═O)₂—) and “heterocyclylsulfonyl” (heterocyclylS(═O)₂—) refer to a hetaryl or heterocyclyl, respectively, as defined above, which are bound via the sulfur atom of the sulfonyl group to the remainder of the molecule, wherein the sulfur atom of the sulfonyl group is attached through any one of the carbon atoms of the hetaryl or heterocyclyl, respectively.

The remarks made below as to preferred embodiments of the variables (substituents) of the compounds of formulae I or II are valid on their own as well as preferably in combination with each other.

The remarks made below concerning preferred embodiments of the variables further are valid concerning the compounds of formulae I or II as well as concerning the uses and methods according to the invention and the composition according to the present invention.

A preferred embodiment of the invention relates to methods and uses comprising compounds of the formula I, their salts and/or their N-oxides. Amongst the compounds of the formula I, preference is given to those compounds, wherein X¹ in formula I is oxygen, sulphur or a moiety N—R^{1a}, wherein R^{1a} is as defined above. Particular preference is given to those compounds of the formula I wherein X¹ is oxygen.

In the methods and uses comprising compounds of the formula I, wherein X¹ is NR^{1a}, a particular embodiment relates to those compounds, wherein R^{1a} is C₁-C₆-alkyl, C₁-C₄-haloalkyl, C₃-C₆-cycloalkyl, C₃-C₆-cycloalkylmethyl, C₃-C₆-halocycloalkyl, C₂-C₆-alkenyl, C₂-C₆-haloalkenyl, C₂-C₆-alkynyl, C₁-C₄-alkoxy-C₁-C₄-alkyl, phenyl, hetaryl, phenyl-C₁-C₄-alkyl and hetaryl-C₁-C₄-alkyl, wherein the aromatic ring in the four last mentioned radicals may be unsubstituted or may carry 1, 2, 3, 4 or 5 substituents which, independently of each other, are selected from the group consisting of halogen, cyano, nitro, C₁-C₄-alkyl, C₁-C₄-haloalkyl, C₁-C₄-alkoxy and C₁-C₄-haloalkoxy. In particular, R^{1a} is selected from C₁-C₆-alkyl, C₃-C₆-cycloalkylmethyl, C₃-C₆-alkenyl, C₃-C₆-alkynyl, C₁-C₄-alkoxy-C₁-C₄-alkyl, phenyl and benzyl. Specifically, R^{1a} is C₁-C₄-alkyl, C₃-C₆-cycloalkylmethyl, C₁-C₂-alkoxy-C₂-C₄-alkyl, phenyl or benzyl.

Among the methods and uses according to the present invention, preference is given to the methods and uses, wherein R¹ in formula I is hydrogen, CN, C₁-C₁₀-alkyl, C₁-C₁₀-haloalkyl, C₂-C₁₀-alkenyl, C₂-C₁₀-haloalkenyl, C₂-C₁₀-alkynyl, C₁-C₄-alkylene-CN, phenyl-C₁-C₅-alkyl, heterocyclyl-C₁-C₅-alkyl, hetaryl-C₁-C₅-alkyl, C₃-C₁₀-cycloalkyl-C₁-C₅-alkyl, ORE, C₁-C₅-alkylene-OR^{a}, C₁-C₄-alkylene-C(Y)R^{b}, C₁-C₄-alkylene-C(Y)OR^{b}, C(Y)R^{b}, C(Y)OR^{c} or S(O)₂R^{d}, wherein the variables Y, R^{a}, R^{b}, R^{c} and R^{d} are as defined above. More preference is given to compounds of formula I, wherein R¹ is hydrogen, C₁-C₁₀-alkyl, C₁-C₁₀-haloalkyl, C₁-C₄-alkylene-CN, heterocyclyl-C₁-C₅-alkyl, hetaryl-C₁-C₅-alkyl, C₁-C₅-alkylene-OR^{a} or C₃-C₁₀-cycloalkyl-C₁-C₅-alkyl, in particular hydrogen, C₁-C₄-alkyl, C₁-C₄-haloalkyl, C₁-C₃-alkylene-O—C₁-C₃-alkyl or C₁-C₄-alkylene-CN, especially hydrogen, methyl, ethyl, methoxymethyl or ethoxymethyl.

Another embodiment of the invention relates to methods and uses comprising compounds of the formula I with the exception of the following compounds:
N-pyridin-3-yl-6-chloronicotinamide,
N-pyridin-3-yl-6-{[4-(trifluormethyl)phenyl]sulfanyl}-nicotinamide,
N-pyridin-3-yl-6-(4-methylphenoxy)-nicotinamide,
N-pyridin-3-yl-6-[(6-methylpyridin-3-yl)oxy]-nicotinamide,
N-pyridin-3-yl-6-[(4,6-dimethoxy-1,3,5-triazin-2-yl)sulfanyl]-nicotinamide,
N-pyridin-3-yl-6-[(4-chlorophenyl)sulfanyl]-nicotinamide,
N-methyl-N-pyridin-3-yl-6-chloronicotinamide,
N-ethyl-N-pyridin-3-yl-6-[(4,6-dimethoxy-1,3,5-triazin-2-yl)sulphanyl]-nicotinamide,
N-pyridin-3-yl-6-(2,5-dichlorophenoxy)-nicotinamide,
N-pyridin-3-yl-5-chloro-6-(4-cyanophenoxy)-nicotinamide,
N-pyridin-3-yl-6-(3,4-dichlorophenoxy)-nicotinamide,
N-pyridin-3-yl-6-[(2-chloropyrimidin-4-yl)oxy]-nicotinamide,
N-pyridin-3-yl-6-{[5-(trifluoromethyl)pyridin-2-yl]sulphanyl}-nicotinamide,
N-pyridin-3-yl-6-(quinolin-6-yloxy)-nicotinamide,
N-pyridin-3-yl-6-(quinolin-5-yloxy)-nicotinamide,
N-pyridin-3-yl-6-(2,4-dichlorophenoxy)-nicotinamide,
N-pyridin-3-yl-6-(3,5-dimethylphenoxy)-nicotinamide,
N-pyridin-3-yl-5-chloro-6-[4-(trifluoromethyl)phenoxy]-nicotinamide,
N-pyridin-3-yl-6-[(4,6-dimethylpyrimidin-2-yl)oxy]-nicotinamide,
N-pyridin-3-yl-5-chloro-6-(4-nitrophenoxy)-nicotinamide,
N-pyridin-3-yl-6-[(6-chloropyridin-2-yl)oxy]-nicotinamide,
N-pyridin-3-yl-6-[(2-methoxypyrimidin-4-yl)oxy]-nicotinamide,
N-pyridin-3-yl-6-(2,6-dichlorophenoxy)-nicotinamide,
N-pyridin-3-yl-6-(3,5-dichlorophenoxy)-nicotinamide,
N-pyridin-3-yl-6-[(4-methylphenyl)sulphanyl]-nicotinamide,
N-pyridin-3-yl-6-(2-cyanophenoxy)-nicotinamide,
N-pyridin-3-yl-5-chloro-6-[(4,5,6-trimethylpyrimidin-2-yl)sulphanyl]-nicotinamide,
N-pyridin-3-yl-6-[3,5-bis(trifluoromethyl)phenoxyl]-nicotinamide,
N-pyridin-3-yl-6-tert-butoxypyridin-3-yl-nicotinamide,
N-pyridin-3-yl-5-chloro-6-[4-(trifluoromethoxy)phenoxy]-nicotinamide,
N-pyridin-3-yl-5-chloro-6-[(4,6-dimethylpyrimidin-2-yl)sulphanyl]-nicotinamide,
N-pyridin-3-yl-6-(quinolin-7-yloxy)-nicotinamide,
N-pyridin-3-yl-5-chloro-6-(4-chlorophenoxy)-nicotinamide,
N-pyridin-3-yl-6-(4-chloro-2-cyanophenoxy)-nicotinamide,
N-pyridin-3-yl-6-methoxy-nicotinamide,
N-pyridin-3-yl-6-[(4-methoxyphenyl)sulphanyl]-nicotinamide,
N-pyridin-3-yl-6-ethoxy-nicotinamide,
N-pyridin-3-yl-5-chloro-6-[(4-methylpyrimidin-2-yl)sulphanyl]-nicotinamide,
N-pyridin-3-yl-6-[3-(trifluoromethoxy)phenoxy]-nicotinamide,
N-pyridin-3-yl-6-(3-cyanophenoxy)-nicotinamide,
N-pyridin-3-yl-6-(4-tert-butylphenoxy)-nicotinamide,
N-methyl-N-pyridin-3-yl-6-[(2-chloropyrimidin-4-yl)oxy]-nicotinamide,
N-methyl-N-pyridin-3-yl-6-[(4-nitrophenyl)sulphanyl]-nicotinamide,
N-methyl-N-pyridin-3-yl-6-[(2-methoxypyrimidin-4-yl)oxy]-nicotinamide,
N-methyl-N-pyridin-3-yl-6-(morpholin-4-yl)-nicotinamide,
N-methyl-N-pyridin-3-yl-6-(4-bromophenoxy)-nicotinamide,
N-methyl-N-pyridin-3-yl-6-{[(4,6-dimethoxypyrimidin-2-yl)methyl]sulphanyl}-nicotinamide,
N-methyl-N-pyridin-3-yl-5-methyl-nicotinamide,
N-methyl-N-pyridin-3-yl-6-(piperidin-1-yl)-nicotinamide,
N-methyl-N-pyridin-3-yl-6-(pyrrolidin-1-yl)-nicotinamide,
N-ethyl-N-pyridin-3-yl-6-(2,5-dichlorophenoxy)-nicotinamide,
N-ethyl-N-pyridin-3-yl-6-{[4-(trifluoromethyl)phenyl]sulphanyl}-nicotinamide,
N-ethyl-N-pyridin-3-yl-5-chloro-6-(4-cyanophenoxy)-nicotinamide,
N-ethyl-N-pyridin-3-yl-6-(3,4-dichlorophenoxy)-nicotinamide,
N-ethyl-N-pyridin-3-yl-6-{[5-(trifluoromethyl)pyridin-2-yl]sulphanyl}-nicotinamide,
N-ethyl-N-pyridin-3-yl-6-[(4-nitrophenyl)sulphanyl]-nicotinamide,
N-ethyl-N-pyridin-3-yl-6-(quinolin-6-yloxy)-nicotinamide,
N-ethyl-N-pyridin-3-yl-6-(quinolin-5-yloxy)-nicotinamide,
N-ethyl-N-pyridin-3-yl-6-(2,4-dichlorophenoxy)-nicotinamide,
N-ethyl-N-pyridin-3-yl-6-(3,5-dimethylphenoxy)-nicotinamide,
N-ethyl-N-pyridin-3-yl-5-chloro-6-[4-(trifluoromethyl)phenoxy]-nicotinamide,
N-ethyl-N-pyridin-3-yl-5-chloro-6-(4-nitrophenoxy)-nicotinamide,
N-ethyl-N-pyridin-3-yl-6-[(6-chloropyridin-2-yl)oxy]-nicotinamide,
N-ethyl-N-pyridin-3-yl-6-[(2-methoxypyrimidin-4-yl)oxy]-nicotinamide,
N-ethyl-N-pyridin-3-yl-6-(morpholin-4-yl)-nicotinamide,
N-ethyl-N-pyridin-3-yl-6-(4-bromophenoxy)-nicotinamide,
N-ethyl-N-pyridin-3-yl-6-(2,6-dichlorophenoxy)-nicotinamide,
N-ethyl-N-pyridin-3-yl-6-(3,5-dichlorophenoxy)-nicotinamide,
N-ethyl-N-pyridin-3-yl-6-methyl-nicotinamide,
N-ethyl-N-pyridin-3-yl-6-[(4-methylphenyl)sulphanyl]-nicotinamide,
N-ethyl-N-pyridin-3-yl-6-{[(4,6-dimethoxypyrimidin-2-yl)methyl]sulphanyl}-nicotinamide,
N-ethyl-N-pyridin-3-yl-6-(2-cyanophenoxy)-nicotinamide,
N-ethyl-N-pyridin-3-yl-6-(methylsulphanyl)-nicotinamide,
N-ethyl-N-pyridin-3-yl-6-(heptafluoropropyl)-nicotinamide,
N-ethyl-N-pyridin-3-yl-6-{[2-(trifluoromethyl)pyrimidin-5-yl]oxy}-nicotinamide,
N-ethyl-N-pyridin-3-yl-5-chloro-6-[(4,5,6-trimethylpyrimidin-2-yl)sulphanyl]-nicotinamide,
N-ethyl-N-pyridin-3-yl-6-[3,5-bis(trifluoromethyl)phenoxy]-nicotinamide,
N-ethyl-N-pyridin-3-yl-6-(4-methoxyphenoxy)-nicotinamide,
N-ethyl-N-pyridin-3-yl-6-tert-butoxy-nicotinamide,
N-ethyl-N-pyridin-3-yl-5-chloro-6-[4-(trifluoromethoxy)phenoxy]-nicotinamide,
N-ethyl-N-pyridin-3-yl-6-(2-chlorophenoxy)-nicotinamide,
N-ethyl-N-pyridin-3-yl-5-methyl-nicotinamide,
N-ethyl-N-pyridin-3-yl-5-chloro-6-[(4,6-dimethylpyrimidin-2-yl)sulphanyl]-nicotinamide,
N-ethyl-N-pyridin-3-yl-6-(quinolin-7-yloxy)-nicotinamide,
N-ethyl-N-pyridin-3-yl-5-chloro-6-(4-chlorophenoxy)-nicotinamide,
N-ethyl-N-pyridin-3-yl-6-(4-methylphenoxy)-nicotinamide,
N-ethyl-N-pyridin-3-yl-6-(4-chloro-2-cyanophenoxy)-nicotinamide,
N-ethyl-N-pyridin-3-yl-6-(2-methylphenoxy)-nicotinamide,
N-ethyl-N-pyridin-3-yl-6-methoxy-nicotinamide,
N-ethyl-N-pyridin-3-yl-6-[(4-methoxyphenyl)sulphanyl]-nicotinamide,
N-ethyl-N-pyridin-3-yl-6-(3-chlorophenoxy)-nicotinamide,
N-ethyl-N-pyridin-3-yl-6-[(4-chlorophenyl)sulphanyl]-nicotinamide,
N-ethyl-N-pyridin-3-yl-6-(piperidin-1-yl)-nicotinamide,
N-ethyl-N-pyridin-3-yl-6-ethoxy-nicotinamide,
N-ethyl-N-pyridin-3-yl-5-chloro-6-[(4-methylpyrimidin-2-yl)sulphanyl]-nicotinamide,
N-ethyl-N-pyridin-3-yl-6-(3-methylphenoxy)-nicotinamide,
N-ethyl-N-pyridin-3-yl-6-[3-(trifluoromethoxy)phenoxy]-nicotinamide,
N-ethyl-N-pyridin-3-yl-6-(3-cyanophenoxy)-nicotinamide,
N-ethyl-N-pyridin-3-yl-6-(pyrrolidin-1yl)-nicotinamide,
N-ethyl-N-pyridin-3-yl-6-(4-tert-butylphenoxy)-nicotinamide,
N-pyridin-3-yl-5-methyl-nicotinamide,
N-pyridin-3-yl-6-(heptafluoropropyl)-nicotinamide,
N-pyridin-3-yl-6-methyl-nicotinamide,
N-methyl-N-pyridin-3-yl-6-methyl-nicotinamide,
N-methyl-N-pyridin-3-yl-6-(heptafluoropropyl)-nicotinamide,
N-methyl-N-pyridin-3-yl-6-[(6-methylpyridin-3-yl)oxy]-nicotinamide,
N-pyridin-3-yl-6-(4-methoxyphenoxy)-nicotinamide,
N-pyridin-3-yl-6-(2-chlorophenoxy)-nicotinamide,
N-pyridin-3-yl-6-(3-chlorophenoxy)-nicotinamide,
N-pyridin-3-yl-6-(4-bromophenoxy)-nicotinamide,
N-pyridin-3-yl-6-(2-methylphenoxy)-nicotinamide,
N-pyridin-3-yl-6-(3-methylphenoxy)-nicotinamide,
N-pyridin-3-yl-6-(3-trifluoromethylphenoxy)-nicotinamide,
N-methyl-N-pyridin-3-yl-6-(4-cyanophenoxy)-nicotinamide,
N-methyl-N-pyridin-3-yl-6-(4-chlorophenoxy)-nicotinamide,
N-methyl-N-pyridin-3-yl-6-(4-methoxyphenoxy)-nicotinamide,
N-methyl-N-pyridin-3-yl-6-(4-nitrophenoxy)-nicotinamide,
N-methyl-N-pyridin-3-yl-6-(4-trifluoromethoxyphenoxy)-nicotinamide,
N-methyl-N-pyridin-3-yl-6-(2-methylphenoxy)-nicotinamide,
N-methyl-N-pyridin-3-yl-6-(3-methylphenoxy)-nicotinamide,
N-methyl-N-pyridin-3-yl-6-(2-chlorophenoxy)-nicotinamide,
N-methyl-N-pyridin-3-yl-6-(3-chlorophenoxy)-nicotinamide,
N-methyl-N-pyridin-3-yl-6-(3-trifluoromethylphenoxy)-nicotinamide,
N-methyl-N-pyridin-3-yl-6-(4-methylphenoxy)-nicotinamide,
N-methyl-N-pyridin-3-yl-6-[(4,6-dimethylpyrimidin-2-yl)sulfanyl]-nicotinamide,
N-methyl-N-pyridin-3-yl-6-[(4-methylphenyl)sulfanyl]-nicotinamide,
N-methyl-N-pyridin-3-yl-6-[(4-methoxyphenyl)sulfanyl]-nicotinamide,
N-methyl-N-pyridin-3-yl-6-[(4-chlorophenyl)sulfanyl]-nicotinamide,
N-pyridin-3-yl-6-(4-methylsulfanyl)-nicotinamide,
N-pyridin-3-yl-6-(4-trifluoromethylphenoxy)-nicotinamide,
N-methyl-N-pyridin-3-yl-6-(4-methylsulfanyl)-nicotinamide,
N-methyl-N-pyridin-3-yl-6-(2-cyanophenoxy)-nicotinamide,
N-methyl-N-pyridin-3-yl-6-(3-cyanophenoxy)-nicotinamide,
N-methyl-N-pyridin-3-yl-6-(2-cyano-4-chlorophenoxy)-nicotinamide,
N-methyl-N-pyridin-3-yl-6-(2,4-dichlorophenoxy)-nicotinamide,
N-methyl-N-pyridin-3-yl-6-(3,4-dichlorophenoxy)-nicotinamide,
N-methyl-N-pyridin-3-yl-6-(4-trifluoromethylphenoxy)-nicotinamide,
N-methyl-N-pyridin-3-yl-6-[(4-trifluoromethylphenyl)sulfanyl]-nicotinamide,
N-methyl-N-pyridin-3-yl-6-[(5-trifluoromethyl-pyridin-2-yl)sulfanyl]-nicotinamide,
N-methyl-N-pyridin-3-yl-6-(3,5-dimethylphenoxy)-nicotinamide,
N-methyl-N-pyridin-3-yl-6-(2,4-dichlorophenoxy)-nicotinamide,
N-methyl-N-pyridin-3-yl-6-(2,5-dichlorophenoxy)-nicotinamide,
N-methyl-N-pyridin-3-yl-6-(3,5-dichlorophenoxy)-nicotinamide,
N-methyl-N-pyridin-3-yl-6-(3,5-di-trifluoromethyl-phenoxy)-nicotinamide,
N-methyl-N-pyridin-3-yl-6-(3-trifluoromethoxy-phenoxy)-nicotinamide,
N-pyridin-3-yl-6-(4-trifluoromethoxy-phenoxy)-nicotinamide,
N-methyl-N-pyridin-3-yl-6-(4-tert-butyl-phenoxy)-nicotinamide,
N-ethyl-N-pyridin-3-yl-6-(4-trifluoromethoxy-phenoxy)-nicotinamide,
N-propyl-N-pyridin-3-yl-6-(4-trifluoromethoxy-phenoxy)-nicotinamide,
N-allyl-N-pyridin-3-yl-6-(4-trifluoromethoxy-phenoxy)-nicotinamide,
N-propagyl-N-pyridin-3-yl-6-(4-trifluoromethoxy-phenoxy)-nicotinamide,
N-methyl-N-pyridin-3-yl-5-chloro-6-[(pyrimidin-2-yl)sulphanyl]-nicotinamide,
N-methyl-N-pyridin-3-yl-5-chloro-6-[(4-methyl-pyrimidin-2-yl)sulphanyl]-nicotinamide,
N-methyl-N-pyridin-3-yl-5-chloro-6-[(4,5,6-trimethyl-pyrimidin-2-yl)sulphanyl]-nicotinamide,
N-methyl-N-pyridin-3-yl-6-(quinolin-7-oxy)-nicotinamide,
N-methyl-N-pyridin-3-yl-6-(quinolin-5-oxy)-nicotinamide,
N-methyl-N-pyridin-3-yl-6-(quinolin-6-oxy)-nicotinamide,
N-methyl-N-pyridin-3-yl-6-[(4,6-dimethylpyrimidin-2-yl)oxy]-nicotinamide,
N-methyl-N-pyridin-3-yl-6-[(4,6-dimethoxypyrimidin-2-yl)oxy]-nicotinamide,
N-methyl-N-pyridin-3-yl-5-chloro-6-(4-trifluoromethyl-phenoxy)-nicotinamide,
N-methyl-N-pyridin-3-yl-5-chloro-6-(4-trifluoromethoxy-phenoxy)-nicotinamide,
N-methyl-N-pyridin-3-yl-5-chloro-6-(4-cyanophenoxy)-nicotinamide,
N-methyl-N-pyridin-3-yl-5-chloro-6-(4-chlorophenoxy)-nicotinamide,
N-methyl-N-pyridin-3-yl-5-chloro-6-(4-nitrophenoxy)-nicotinamide,
N-methyl-N-pyridin-3-yl-5-chloro-6-[(4,6-dimethylpyrimidin-2-yl)sulfanyl]-nicotinamide,
N-methyl-N-pyridin-3-yl-6-tert-butoxy-nicotinamide,
N-methyl-N-pyridin-3-yl-6-methoxy-nicotinamide,
N-methyl-N-pyridin-3-yl-6-ethoxy-nicotinamide,
N-ethyl-N-pyridin-3-yl-6-(4-trifluoromethyl-phenoxy)-nicotinamide,
N-pyridin-3-yl-6-[(4-nitrophenyl)sulfanyl]-nicotinamide,
N-pyridin-3-yl-6-[(4,6-dimethyl-pyrimidin-2-yl)sulphanyl]-nicotinamide,
N-pyridin-3-yl-6-(4-chlorophenoxy)-nicotinamide,
N-ethyl-N-pyridin-3-yl-6-(4-chlorophenoxy)-nicotinamide,
N-pyridin-3-yl-6-(4-nitrophenoxy)-nicotinamide,
N-ethyl-N-pyridin-3-yl-6-(4-nitrophenoxy)-nicotinamide,
N-pyridin-3-yl-6-(4-cyanophenoxy)-nicotinamide,
N-ethyl-N-pyridin-3-yl-6-(4-cyanophenoxy)-nicotinamide,
N-methyl-N-pyridin-3-yl-5-chloro-6-[(4-methyl-pyrimidin-2-yl)sulphanyl]-nicotinamide,
N-methyl-N-pyridin-3-yl-5-chloro-6-[(4,5,6-trimethyl-pyrimidin-2-yl)sulfanyl]-nicotinamide,
N-pyridin-3-yl-6-[(4,6-dimethoxy-pyrimidin-2-yl)oxy]-nicotinamide,
N-ethyl-N-pyridin-3-yl-6-[(4,6-dimethoxy-pyrimidin-2-yl)oxy]-nicotinamide,
N-pyridin-3-yl-6-[(4,6-dimethoxy-pyrimidin-2-yl)sulfanyl]-nicotinamide,
N-methyl-N-pyridin-3-yl-6-[(4,6-dimethoxy-pyrimidin-2-yl)sulfanyl]-nicotinamide,
N-ethyl-N-pyridin-3-yl-6-[(4,6-dimethoxy-pyrimidin-2-yl)sulfanyl]-nicotinamide,
N-pyridin-3-yl-6-[(2-trifluoromethyl-pyrimidin-5-yl)oxy]-nicotinamide,
N-methyl-N-pyridin-3-yl-6-[(2-trifluoromethyl-pyrimidin-5-yl)oxy]-nicotinamide,
N-ethyl-N-pyridin-3-yl-6-[(4,6-dimethyl-pyrimidin-2-yl)oxy]-nicotinamide,
N-ethyl-N-pyridin-3-yl-6-chloro-nicotinamide,
N-ethyl-N-pyridin-3-yl-6-[(4,6-dimethyl-pyrimidin-2-yl)sulfanyl]-nicotinamide,
N-ethyl-N-pyridin-3-yl-6-[(6-methyl-pyridin-3-yl)oxy]-nicotinamide,
N-pyridin-3-yl-6-[(pyrimidin-2-yl)sulfanyl]-nicotinamide,
N-pyridin-3-yl-6-[(4-methyl-pyrimidin-2-yl)sulfanyl]-nicotinamide,
N-ethyl-N-pyridin-3-yl-6-[(pyrimidin-2-yl)sulfanyl]-nicotinamide,
N-ethyl-N-pyridin-3-yl-6-[(4-methyl-pyrimidin-2-yl)sulfanyl]-nicotinamide,
N-methyl-N-pyridin-3-yl-6-[(4,6-dimethoxy-1,3,5-triazin-2-yl)sulfanyl]-nicotinamide,
N-pyridin-3-yl-6-(piperidin-1-yl)-nicotinamide,
N-pyridin-3-yl-6-(pyrrolidin-1yl)-nicotinamide,
N-pyridin-3-yl-6-(morpholin-1-yl)-nicotinamide,
N-pyridin-3-yl-6-{[(4,6-dimethoxypyrimidin-2-yl)methyl]sulfanyl}-nicotinamide,
N-pyridin-3-yl-6-[(4,5,6-trimethyl-pyrimidin-2-yl)sulfanyl]-nicotinamide,
N-ethyl-N-pyridin-3-yl-6-[(4,5,6-trimethyl-pyrimidin-2-yl)sulfanyl]-nicotinamide,
N-ethyl-N-pyridin-3-yl-6-(3-trifluoromethyl-phenoxy)-nicotinamide,
N-allyl-N-pyridin-3-yl-6-[(4,6-dimethyl-pyrimidin-2-yl)sulfanyl]-nicotinamide,
N-propargyl-N-pyridin-3-yl-6-[(4,6-dimethyl-pyrimidin-2-yl)sulfanyl]-nicotinamide,
N-but-2-inyl-N-pyridin-3-yl-6-[(4,6-dimethyl-pyrimidin-2-yl)sulfanyl]-nicotinamide,
N-benzyl-N-pyridin-3-yl-6-[(4,6-dimethyl-pyrimidin-2-yl)sulfanyl]-nicotinamide,
N-(4-cyanobenzyl)-N-pyridin-3-yl-6-[(4,6-dimethyl-pyrimidin-2-yl)sulfanyl]-nicotinamide,
N-(4-nitrobenzyl)-N-pyridin-3-yl-6-[(4,6-dimethyl-pyrimidin-2-yl)sulfanyl]-nicotinamide,
N-(4-trifluoromethoxybenzyl)-N-pyridin-3-yl-6-[(4,6-dimethyl-pyrimidin-2-yl)sulfanyl]-nicotinamide,
N-allyl-N-pyridin-3-yl-6-chloro-nicotinamide, and
N-propargyl-N-pyridin-3-yl-6-chloro-nicotinamide.

Another embodiment of the invention relates to methods and uses comprising compounds of the formula II, their salts and/or their N-oxides. In the compounds of the formula II, preference is given to those compounds, wherein X² in formula II is OR^{2a} or SR^{2d}. In these compounds R^{2a} and R^{2d} are preferably C₁-C₄-alkyl, C₃-C₄-alkenyl, C₃-C₄-alkynyl, C₁-C₄-alkoxy-C₁-C₄-alkyl, phenyl or benzyl. Another embodiment relates to compounds of the formula II, wherein X² is NR^{2b}R^{2c}. In these compounds R^{2b} and R^{2c} are preferably selected, independently of each other, from hydrogen, C₁-C₄-alkyl, C₁-C₄-alkoxy-C₁-C₄-alkyl, phenyl and benzyl, or R^{2b} and R^{2c}, together with the nitrogen atom to which they are bound form a saturated, nitrogen-bound 5- or 6-membered heterocycle which may comprise a further heteroatom selected from O, S and N, e.g. NR^{2b}R^{2c} being 1-pyrrolidinyl, 1-piperidinyl, 1-piperazinyl, 4-morpholinyl or 4-thiomorpholinyl.

Among the methods and uses according to the present invention, preference is given to the methods and uses, wherein R² in formulae I and II is selected from hydrogen, fluorine, chlorine, bromine, methyl, difluoromethyl, trifluoromethyl, methoxy, difluoromethoxy and trifluoromethoxy, and in particular from hydrogen, methyl, difluoromethyl, trifluoromethyl, methoxy, difluoromethoxy and trifluoromethoxy. More preferably R² is hydrogen.

Among the methods and uses according to the present invention, preference is given to the methods and uses, wherein R³ in formulae I and II is selected from hydrogen, fluorine, chlorine, bromine, methyl, difluoromethyl, trifluoromethyl, methoxy, difluoromethoxy and trifluoromethoxy, and in particular from hydrogen, methyl, difluoromethyl, trifluoromethyl, methoxy, difluoromethoxy and trifluoromethoxy. More preferably R³ is hydrogen.

In particular, at least one of the radicals R² or R³ in formulae I and II is hydrogen. A very preferred embodiment of the invention relates to method and uses comprising compounds of the formulae I or II, or their salts, wherein both R² and R³ are hydrogen.

Another preferred embodiment of the invention relates to methods and uses comprising compounds of the formulae I or II, their salts or their N-oxides, wherein R² is hydrogen and R³ is selected from hydrogen, fluorine, chlorine, bromine, methyl, difluoromethyl, trifluoromethyl, methoxy, difluoromethoxy and trifluoromethoxy.

Among the methods and uses according to the present invention, preference is given to the methods and uses, wherein X³ in formulae I or II is a lone pair.

Among the methods and uses according to the present invention, preference is given to the methods and uses comprising compounds of formulae I or II, wherein 1, 2 or 3 of the variables A¹, A², A³, A⁴ or A⁵ of the heterocyclic radical A are N and the remaining groups are C—R^{A1}, C—R^{A2}, C—R^{A3}, C—R^{A4} or C—R^{A5}. Examples of such compounds are compounds of formulae I or II, wherein the heterocycle A is selected from the radicals pyrazine-2-yl, pyridazine-3-yl, pyridazine-4-yl, pyrimidine-5-yl, pyrimidine-4-yl, pyrimidine-2-yl, 1,2,3-triazine-4-yl, 1,2,3-triazine-5-yl, 1,2,4-triazine-3-yl, 1,2,4-triazine-5-yl and 1,2,4-triazine-6-yl, wherein these radicals are substituted with variables R^{A1}, R^{A2}, R^{A3}, R^{A4} and R^{A5} at their respective carbon atoms.

Among the methods and uses according to the present invention, preference is given to the methods and uses comprising compounds of formulae I or II, wherein 1 or 2 of the variables A¹, A², A³, A⁴ or A⁵ of the heterocyclic radical A in formulae I and II are N and the remaining groups are C—R^{A1}, C—R^{A2}, C—R^{A3}, C—R^{A4} or C—R^{A5}. Examples of such compounds are compounds of formulae I or II, wherein the heterocycle A is selected from the radicals pyrazine-2-yl, pyridazine-3-yl, pyridazine-4-yl, pyrimidine-5-yl, pyrimidine-4-yl and pyrimidine-2-yl, wherein these radicals are substituted with variables R^{A1}, R^{A2}, R^{A3}, R^{A4} and R^{A5} at their respective carbon atoms.

Among the methods and uses according to the present invention, preference is given to the methods and uses comprising compounds of formulae I or II, wherein R^{A1} and R^{A5}, if present, are different from a radical SR^{d1}, and wherein R^{A1} and R^{A5} are preferably selected independently of each other from hydrogen, halogen, CN, NO₂, C₁-C₄-alkyl, C₁-C₄-haloalkyl, C₁-C₄-alkoxy, C₁-C₄-haloalkoxy, C₁-C₄-alkylsulfinyl, C₁-C₄-haloalkylsulfinyl, C₁-C₄-alkylsulfonyl, C₁-C₄-haloalkylsulfonyl, C₁-C₅-alkylen-CN, C₁-C₅-alkylen-OR^{a}, C₁-C₅-alkylen-C(Y)R^{b} and C₁-C₅-alkylen-C(Y)OR^{c}, C₃-C₁₀-cycloalkyl, C₅-C₁₀-cycloalkenyl, saturated 3- to 10-membered heterocyclyl, C₃-C₁₀-cycloalkyl-C₁-C₅-alkyl, C₅-C₁₀-cycloalkenyl-C₁-C₅-alkyl, 3- to 10-membered heterocyclyl-C₁-C₅-alkyl, wherein cycloalkyl, cycloalkenyl and heterocyclyl in the 6 last mentioned radicals may be unsubstituted or may carry 1, 2, 3, 4 or 5 identical or different substituents R^{y}, wherein Y is defined herein and in particular is oxygen, wherein R^{a}, R^{b} and R^{c} are as defined herein and in particular are selected independently of each other from the group consisting of hydrogen, C₁-C₄-alkyl, C₁-C₄-haloalkyl, C₁-C₄-alkoxy-C₁-C₄-alkyl, heterocyclyl-C₁-C₄-alkyl and hetaryl-C₁-C₄-alkyl, more preferably from the group consisting of hydrogen, C₁-C₄-alkyl and C₁-C₄-alkoxy-C₁-C₂-alkyl, and most preferably from the group consisting of hydrogen, methyl and ethyl, and wherein the substituents R^{y} are as defined herein and in particular are selected independently of each other from halogen, NO₂, C₁-C₄-alkyl, C₁-C₄-haloalkyl, C₁-C₄-alkoxy, C₁-C₄-haloalkoxy, C₁-C₄-alkylsulfonyl and C₁-C₄-haloalkylsulfonyl.

More preferably R^{A1} and R^{A5}, if present, are selected independently of each other from hydrogen, halogen, C₁-C₄-alkyl, C₁-C₄-haloalkyl, C₁-C₄-alkoxy, C₁-C₄-haloalkoxy, C₁-C₃-alkylen-CN, C₁-C₃-alkylen-OR^{a}, C₃-C₇-cycloalkyl, C₃-C₇-cycloalkyl-C₁-C₃-alkyl, and 3- to 7-membered saturated heterocyclyl-C₁-C₃-alkyl, wherein cycloalkyl and heterocyclyl in the 3 last mentioned radicals may be unsubstituted or may carry 1, 2, 3, 4 or 5 identical or different substituents R^{y}, wherein R^{a} is as defined herein and in particular is selected from the group consisting of hydrogen, C₁-C₄-alkyl, C₁-C₄-haloalkyl and C₁-C₄-alkoxy-C₁-C₂-alkyl, and specifically from the group consisting of hydrogen, methyl, ethyl, difluormethyl and trifluoromethyl, and wherein the substituents R^{y} are as defined herein and in particular are selected independently of each other from halogen, NO₂, C₁-C₄-alkyl, C₁-C₄-haloalkyl, C₁-C₄-alkoxy, C₁-C₄-haloalkoxy, C₁-C₄-alkylsulfonyl and C₁-C₄-haloalkylsulfonyl.

In a particular preferred embodiment of the invention R^{A1} and R^{A5}, if present, are selected independently of each other from hydrogen, fluorine, chlorine, bromine, methyl, ethyl, n-propyl, isopropyl, cyclopropyl, isobutyl, cyclopropylmethyl, fluoromethyl, difluoromethyl, trifluoromethyl, 1-fluoroethyl, 2-fluoroethyl, 2,2,2-trifluoroethyl, methoxymethyl, difluoromethoxymethyl, trifluoromethoxymethyl, cyanomethyl, 2-methoxy-1-ethyl, 2-difluoromethoxy-1-ethyl, 2-trifluoromethoxy-1-ethyl, and 2-cyano-1-ethyl.

Among the methods and uses according to the present invention, preference is given to the methods and uses comprising compounds of formulae I or II, wherein R^{A2} and R^{A4}, if present, are selected independently of each other from hydrogen, halogen, CN, NO₂, C₁-C₄-alkyl, C₁-C₄-haloalkyl, C₁-C₄-alkoxy, C₁-C₄-haloalkoxy, C₁-C₄-alkylthio, C₁-C₄-haloalkylthio, C₁-C₄-alkylsulfinyl, C₁-C₄-haloalkylsulfinyl, C₁-C₄-alkylsulfonyl, C₁-C₄-haloalkylsulfonyl, C₁-C₅-alkylen-CN, C₁-C₅-alkylen-OR^{a}, C₁-C₅-alkylen-C(Y)R^{b}, C₁-C₅-alkylen-C(Y)OR^{c}, C₃-C₁₀-cycloalkyl, C₅-C₁₀-cycloalkenyl, saturated 3- to 10-membered heterocyclyl, C₃-C₁₀-cycloalkyl-C₁-C₅-alkyl, C₅-C₁₀-cycloalkenyl-C₁-C₅-alkyl, saturated or partially unsaturated 3- to 10-membered heterocyclyl-C₁-C₅-alkyl, wherein cycloalkyl, cycloalkenyl and heterocyclyl in the 6 last mentioned radicals may be unsubstituted or may carry 1, 2, 3, 4 or 5 identical or different substituents R^{y}, wherein Y is defined herein and in particular is oxygen, wherein R^{a}, R^{b} and R^{c} are as defined herein and in particular are selected independently of each other from the group consisting of hydrogen, C₁-C₄-alkyl, C₁-C₄-haloalkyl, C₁-C₄-alkoxy-C₁-C₄-alkyl, heterocyclyl-C₁-C₄-alkyl and hetaryl-C₁-C₄-alkyl, more preferably from the group consisting of hydrogen, C₁-C₄-alkyl and C₁-C₄-alkoxy-C₁-C₂-alkyl, and most preferably from the group consisting of hydrogen, methyl and ethyl, and wherein the substituents R^{y} are as defined herein and in particular are selected independently of each other from halogen, NO₂, C₁-C₄-alkyl, C₁-C₄-haloalkyl, C₁-C₄-alkoxy, C₁-C₄-haloalkoxy, C₁-C₄-alkylsulfonyl and C₁-C₄-haloalkylsulfonyl.

More preferably R^{A2} and R^{A4}, if present, are selected independently of each other from hydrogen, halogen, C₁-C₄-alkyl, C₁-C₄-haloalkyl, C₁-C₄-alkoxy, C₁-C₄-haloalkoxy, C₁-C₃-alkylen-CN, C₁-C₃-alkylen-OR^{a}, C₃-C₇-cycloalkyl, C₃-C₇-cycloalkyl-C₁-C₃-alkyl, and 3- to 7-membered saturated heterocyclyl-C₁-C₃-alkyl, wherein cycloalkyl and heterocyclyl in the 3 last mentioned radicals may be unsubstituted or may carry 1, 2, 3, 4 or 5 identical or different substituents R^{y}, wherein R^{a} is as defined herein and in particular is selected from the group consisting of hydrogen, C₁-C₄-alkyl, C₁-C₄-haloalkyl and C₁-C₄-alkoxy-C₁-C₂-alkyl, and specifically from the group consisting of hydrogen, methyl, ethyl, difluormethyl and trifluoromethyl, and wherein the substituents R^{y} are as defined herein and in particular are selected independently of each other from halogen, NO₂, C₁-C₄-alkyl, C₁-C₄-haloalkyl, C₁-C₄-alkoxy, C₁-C₄-haloalkoxy, C₁-C₄-alkylsulfonyl and C₁-C₄-haloalkylsulfonyl.

In a particular preferred embodiment of the invention R^{A2} and R^{A4}, if present, are selected independently of each other from hydrogen, fluorine, chlorine, bromine, methyl, ethyl, n-propyl, isopropyl, cyclopropyl, isobutyl, cyclopropylmethyl, fluoromethyl, difluoromethyl, trifluoromethyl, 1-fluoroethyl, 2-fluoroethyl, 2,2,2-trifluoroethyl, methoxymethyl, difluoromethoxymethyl, trifluoromethoxymethyl, cyanomethyl, 2-methoxy-1-ethyl, 2-difluoromethoxy-1-ethyl, 2-trifluoromethoxy-1-ethyl, and 2-cyano-1-ethyl.

Among the methods and uses according to the present invention, preference is given to the methods and uses comprising compounds of formulae I or II, wherein R^{A3}, if present, is selected from hydrogen, halogen, CN, NO₂, C₁-C₄-alkyl, C₁-C₄-haloalkyl, C₁-C₄-alkoxy, C₁-C₄-haloalkoxy, C₁-C₄-alkylthio, C₁-C₄-haloalkylthio, C₁-C₄-alkylsulfinyl, C₁-C₄-haloalkylsulfinyl, C₁-C₄-alkylsulfonyl, C₁-C₄-haloalkylsulfonyl, C₁-C₅-alkylen-CN, C₁-C₅-alkylen-OR^{a}, C₁-C₅-alkylen-C(Y)R^{b}, C₁-C₅-alkylen-C(Y)OR^{c}, C₃-C₁₀-cycloalkyl, C₅-C₁₀-cycloalkenyl, saturated 3 to 10 membered heterocyclyl, C₃-C₁₀-cycloalkyl-C₁-C₅-alkyl, C₅-C₁₀-cycloalkenyl-C₁-C₅-alkyl and 3- to 10-membered heterocyclyl-C₁-C₅-alkyl, wherein cycloalkyl, cycloalkenyl and heterocyclyl in the 6 last mentioned radicals may be unsubstituted or may carry 1, 2, 3, 4 or 5 identical or different substituents R^{y}, wherein Y is defined herein and in particular is oxygen, wherein R^{a}, R^{b} and R^{c} are as defined herein and in particular are selected independently of each other from the group consisting of hydrogen, C₁-C₄-alkyl, C₁-C₄-haloalkyl, C₁-C₄-alkoxy-C₁-C₄-alkyl, heterocyclyl-C₁-C₄-alkyl and hetaryl-C₁-C₄-alkyl, more preferably from the group consisting of hydrogen, C₁-C₄-alkyl and C₁-C₄-alkoxy-C₁-C₂-alkyl, and most preferably from the group consisting of hydrogen, methyl and ethyl, and wherein the substituents R^{y} are as defined herein and in particular are selected independently of each other from halogen, NO₂, C₁-C₄-alkyl, C₁-C₄-haloalkyl, C₁-C₄-alkoxy, C₁-C₄-haloalkoxy, C₁-C₄-alkylsulfonyl and C₁-C₄-haloalkylsulfonyl.

More preferably R^{A3}, if present, is selected from hydrogen, halogen, C₁-C₄-alkyl, C₁-C₄-haloalkyl, C₁-C₄-alkoxy, C₁-C₄-haloalkoxy, C₁-C₃-alkylen-CN, C₁-C₃-alkylen-OR^{a}, C₃-C₇-cycloalkyl, C₃-C₇-cycloalkyl-C₁-C₃-alkyl, and 3- to 7-membered saturated heterocyclyl-C₁-C₃-alkyl, wherein cycloalkyl and heterocyclyl in the 3 last mentioned radicals may be unsubstituted or may carry 1, 2, 3, 4 or 5 identical or different substituents R^{y}, wherein R^{a} is as defined herein and in particular is selected from the group consisting of hydrogen, C₁-C₄-alkyl, C₁-C₄-haloalkyl and C₁-C₄-alkoxy-C₁-C₂-alkyl, and specifically from the group consisting of hydrogen, methyl, ethyl, difluormethyl and trifluoromethyl, and wherein the substituents R^{y} are as defined herein and in particular are selected independently of each other from halogen, NO₂, C₁-C₄-alkyl, C₁-C₄-haloalkyl, C₁-C₄-alkoxy, C₁-C₄-haloalkoxy, C₁-C₄-alkylsulfonyl and C₁-C₄-haloalkylsulfonyl.

In a particular preferred embodiment of the invention R^{A3}, if present, is selected from hydrogen, fluorine, chlorine, bromine, methyl, ethyl, n-propyl, isopropyl, cyclopropyl, isobutyl, cyclopropylmethyl, fluoromethyl, difluoromethyl, trifluoromethyl, 1-fluoroethyl, 2-fluoroethyl, 2,2,2-trifluoroethyl, methoxymethyl, difluoromethoxymethyl, trifluoromethoxymethyl, cyanomethyl, 2-methoxy-1-ethyl, 2-difluoromethoxy-1-ethyl, 2-trifluoromethoxy-1-ethyl, and 2-cyano-1-ethyl.

Another preferred embodiment of the invention relates to methods and uses comprising 3-pyridiyl compounds of the formulae I or II, the salts thereof, the N-oxides thereof or the salts of the N-oxides thereof, wherein X¹, X², X³, R¹, R² and R³ are as defined above and in particular have one of the preferred meanings and wherein A is a radical A-1,

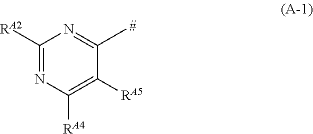

wherein #, R^{A2}, R^{A4} and R^{A5} are as defined herein.

Among the methods and uses comprising compounds of formulae I or II wherein A is A-1, preference is given to those methods and uses, wherein R^{A5} is selected from hydrogen, halogen, CN, NO₂, C₁-C₄-alkyl, C₁-C₄-haloalkyl, C₁-C₄-alkoxy, C₁-C₄-haloalkoxy, C₁-C₄-alkylsulfinyl, C₁-C₄-haloalkylsulfinyl, C₁-C₄-alkylsulfonyl, C₁-C₄-haloalkylsulfonyl, C₁-C₅-alkylen-CN, C₁-C₅-alkylen-OR^{a}, C₁-C₅-alkylen-C(Y)R^{b} and C₁-C₅-alkylen-C(Y)OR^{c}, C₃-C₁₀-cycloalkyl, C₅-C₁₀-cycloalkenyl, saturated 3- to 10-membered heterocyclyl, C₃-C₁₀-cycloalkyl-C₁-C₅-alkyl, C₅-C₁₀-cycloalkenyl-C₁-C₅-alkyl, 3- to 10-membered heterocyclyl-C₁-C₅-alkyl, wherein cycloalkyl, cycloalkenyl and heterocyclyl in the 6 last mentioned radicals may be unsubstituted or may carry 1, 2, 3, 4 or 5 identical or different substituents R^{y}, wherein Y is defined herein and in particular is oxygen, wherein R^{a}, R^{b} and R^{c} are as defined herein and in particular are selected independently of each other from the group consisting of hydrogen, C₁-C₄-alkyl, C₁-C₄-haloalkyl, C₁-C₄-alkoxy-C₁-C₄-alkyl, heterocyclyl-C₁-C₄-alkyl and hetaryl-C₁-C₄-alkyl, more preferably from the group consisting of hydrogen, C₁-C₄-alkyl and C₁-C₄-alkoxy-C₁-C₂-alkyl, and most preferably from the group consisting of hydrogen, methyl and ethyl, and wherein the substituents R^{y} are as defined herein and in particular are selected independently of each other from halogen, NO₂, C₁-C₄-alkyl, C₁-C₄-haloalkyl, C₁-C₄-alkoxy, C₁-C₄-haloalkoxy, C₁-C₄-alkylsulfonyl and C₁-C₄-haloalkylsulfonyl.

More preferably R^{A5} is selected from hydrogen, halogen, C₁-C₄-alkyl, C₁-C₄-haloalkyl, C₁-C₄-alkoxy, C₁-C₄-haloalkoxy, C₁-C₃-alkylen-CN, C₁-C₃-alkylen-OR^{a}, C₃-C₇-cycloalkyl, C₃-C₇-cycloalkyl-C₁-C₃-alkyl, and 3- to 7-membered saturated heterocyclyl-C₁-C₃-alkyl, wherein cycloalkyl and heterocyclyl in the 3 last mentioned radicals may be unsubstituted or may carry 1, 2, 3, 4 or 5 identical or different substituents R^{y}, wherein R^{a} is as defined herein and in particular is selected from the group consisting of hydrogen, C₁-C₄-alkyl, C₁-C₄-haloalkyl and C₁-C₄-alkoxy-C₁-C₂-alkyl, and specifically from the group consisting of hydrogen, methyl, ethyl, difluormethyl and trifluoromethyl, and wherein the substituents R^{y} are as defined herein and in particular are selected independently of each other from halogen, NO₂, C₁-C₄-alkyl, C₁-C₄-haloalkyl, C₁-C₄-alkoxy, C₁-C₄-haloalkoxy, C₁-C₄-alkylsulfonyl and C₁-C₄-haloalkylsulfonyl.

Even more preferably R^{A5} is selected from hydrogen, fluorine, chlorine, bromine, methyl, ethyl, n-propyl, isopropyl, cyclopropyl, isobutyl, cyclopropylmethyl, fluoromethyl, difluoromethyl, trifluoromethyl, 1-fluoroethyl, 2-fluoroethyl, 2,2,2-trifluoroethyl, methoxymethyl, difluoromethoxymethyl, trifluoromethoxymethyl, cyanomethyl, 2-methoxy-1-ethyl, 2-difluoromethoxy-1-ethyl, 2-trifluoromethoxy-1-ethyl, and 2-cyano-1-ethyl.

Among the methods and uses comprising compounds of formulae I or II wherein A is A-1, preference is further given to those methods and uses, wherein R^{A2} and R^{A4} are selected independently of each other from hydrogen, halogen, CN, NO₂, C₁-C₄-alkyl, C₁-C₄-haloalkyl, C₁-C₄-alkoxy, C₁-C₄-haloalkoxy, C₁-C₄-alkylthio, C₁-C₄-haloalkylthio, C₁-C₄-alkylsulfinyl, C₁-C₄-haloalkylsulfinyl, C₁-C₄-alkylsulfonyl, C₁-C₄-haloalkylsulfonyl, C₁-C₅-alkylen-CN, C₁-C₅-alkylen-OR^{a}, C₁-C₅-alkylen-C(Y)R^{b}, C₁-C₅-alkylen-C(Y)OR^{c}, C₃-C₁₀-cycloalkyl, C₅-C₁₀-cycloalkenyl, saturated 3- to 10-membered heterocyclyl, C₃-C₁₀-cycloalkyl-C₁-C₅-alkyl, C₅-C₁₀-cycloalkenyl-C₁-C₅-alkyl, saturated or partially unsaturated 3- to 10-membered heterocyclyl-C₁-C₅-alkyl, wherein cycloalkyl, cycloalkenyl and heterocyclyl in the 6 last mentioned radicals may be unsubstituted or may carry 1, 2, 3, 4 or 5 identical or different substituents R^{y}, wherein Y is defined herein and in particular is oxygen, wherein R^{a}, R^{b} and R^{c} are as defined herein and in particular are selected independently of each other from the group consisting of hydrogen, C₁-C₄-alkyl, C₁-C₄-haloalkyl, C₁-C₄-alkoxy-C₁-C₄-alkyl, heterocyclyl-C₁-C₄-alkyl and hetaryl-C₁-C₄-alkyl, more preferably from the group consisting of hydrogen, C₁-C₄-alkyl and C₁-C₄-alkoxy-C₁-C₂-alkyl, and most preferably from the group consisting of hydrogen, methyl and ethyl, and wherein the substituents R^{y} are as defined herein and in particular are selected independently of each other from halogen, NO₂, C₁-C₄-alkyl, C₁-C₄-haloalkyl, C₁-C₄-alkoxy, C₁-C₄-haloalkoxy, C₁-C₄-alkylsulfonyl and C₁-C₄-haloalkylsulfonyl.

More preferably R^{A2} and R^{A4} are selected independently of each other from hydrogen, halogen, C₁-C₄-alkyl, C₁-C₄-haloalkyl, C₁-C₄-alkoxy, C₁-C₄-haloalkoxy, C₁-C₃-alkylen-CN, C₁-C₃-alkylen-OR^{a}, C₃-C₇-cycloalkyl, C₃-C₇-cycloalkyl-C₁-C₃-alkyl, and 3- to 7-membered saturated heterocyclyl-C₁-C₃-alkyl, wherein cycloalkyl and heterocyclyl in the 3 last mentioned radicals may be unsubstituted or may carry 1, 2, 3, 4 or 5 identical or different substituents R^{y}, wherein R^{a} is as defined herein and in particular is selected from the group consisting of hydrogen, C₁-C₄-alkyl, C₁-C₄-haloalkyl and C₁-C₄-alkoxy-C₁-C₂-alkyl, and specifically from the group consisting of hydrogen, methyl, ethyl, difluormethyl and trifluoromethyl, and wherein the substituents R^{y} are as defined herein and in particular are selected independently of each other from halogen, NO₂, C₁-C₄-alkyl, C₁-C₄-haloalkyl, C₁-C₄-alkoxy, C₁-C₄-haloalkoxy, C₁-C₄-alkylsulfonyl and C₁-C₄-haloalkylsulfonyl.

Even more preferably R^{A2} and R^{A4}, are selected independently of each other from hydrogen, fluorine, chlorine, bromine, methyl, ethyl, n-propyl, isopropyl, cyclopropyl, isobutyl, cyclopropylmethyl, fluoromethyl, difluoromethyl, trifluoromethyl, 1-fluoroethyl, 2-fluoroethyl, 2,2,2-trifluoroethyl, methoxymethyl, difluoromethoxymethyl, trifluoromethoxymethyl, cyanomethyl, 2-methoxy-1-ethyl, 2-difluoromethoxy-1-ethyl, 2-trifluoromethoxy-1-ethyl, and 2-cyano-1-ethyl.

Preferably one or two of the substituents R^{A2}, R^{A4} and R^{A5} are hydrogen.

Examples of suitable radicals A-1 are the radicals of formulae A-1.1 to A-1.173, as defined in Table A1.

TABLE A1

| | |
|---|---|
| 4-Pyrimidinyl | (A-1.1) |
| 2-Chloro-4-pyrimidinyl | (A-1.2) |
| 2-Bromo-4-pyrimidinyl | (A-1.3) |
| 2-Methyl-4-pyrimidinyl | (A-1.4) |
| 2-Ethyl-4-pyrimidinyl | (A-1.5) |
| 2-Cyclopropyl-4-pyrimidinyl | (A-1.6) |
| 2-Isopropyl-4-pyrimidinyl | (A-1.7) |
| 2-Isobutyl-4-pyrimidinyl | (A-1.8) |
| 2-Cyclopropylmethyl-4-pyrimidinyl | (A-1.9) |
| 2-Difluoromethyl-4-pyrimidinyl | (A-1.10) |
| 2-Trifluoromethyl-4-pyrimidinyl | (A-1.11) |
| 2-(2,2,2-Trifluoroeth-1-yl)-4-pyrimidinyl | (A-1.12) |
| 2-Methoxymethyl-4-pyrimidinyl | (A-1.13) |
| 2-Difluoromethoxymethyl-4-pyrimidinyl | (A-1.14) |
| 2-Trifluoromethoxymethyl-4-pyrimidinyl | (A-1.15) |
| 2-Cyanomethyl-4-pyrimidinyl | (A-1.16) |
| 2-Methoxyethyl-4-pyrimidinyl | (A-1.17) |
| 2-Methoxy-4-pyrimidinyl | (A-1.18) |
| 2-Trifluoromethoxy-4-pyrimidinyl | (A-1.19) |
| 5,6-Dimethyl-4-pyrimidinyl | (A-1.20) |
| 5-Methyl-6-ethyl-4-pyrimidinyl | (A-1.21) |
| 6-Methyl-5-ethyl-4-pyrimidinyl | (A-1.22) |
| 5,6-Diethyl-4-pyrimidinyl | (A-1.23) |
| 2,5,6-Trimethyl-4-pyrimidinyl | (A-1.24) |
| 2,5-Dimethyl-6-ethyl-4-pyrimidinyl | (A-1.25) |
| 2,6-Dimethyl-5-ethyl-4-pyrimidinyl | (A-1.26) |
| 2-Methyl-5,6-diethyl-4-pyrimidinyl | (A-1.27) |
| 2-Trifluoromethyl-5,6-dimethyl-4-pyrimidinyl | (A-1.28) |
| 2-Trifluoromethyl-5-methyl-6-ethyl-4-pyrimidinyl | (A-1.29) |
| 2-Trifluoromethyl-6-methyl-5-ethyl-4-pyrimidinyl | (A-1.30) |
| 2-Trifluoromethyl-5,6-diethyl-4-pyrimidinyl | (A-1.31) |
| 2-Cyclopropyl-5,6-dimethyl-4-pyrimidinyl | (A-1.32) |
| 2-Cyclopropyl-5-methyl-6-ethyl-4-pyrimidinyl | (A-1.33) |
| 2-Cyclopropyl-6-methyl-5-ethyl-4-pyrimidinyl | (A-1.34) |
| 2-Cyclopropyl-5,6-diethyl-4-pyrimidinyl | (A-1.35) |
| 2-Isopropyl-5,6-dimethyl-4-pyrimidinyl | (A-1.36) |
| 2-Isopropyl-5-methyl-6-ethyl-4-pyrimidinyl | (A-1.37) |
| 2-Isopropyl-6-methyl-5-ethyl-4-pyrimidinyl | (A-1.38) |
| 2-Isopropyl-5,6-diethyl-4-pyrimidinyl | (A-1.39) |
| 2-Isobutyl-5,6-dimethyl-4-pyrimidinyl | (A-1.40) |
| 2-Isobutyl-5-methyl-6-ethyl-4-pyrimidinyl | (A-1.41) |
| 2-Isobutyl-6-methyl-5-ethyl-4-pyrimidinyl | (A-1.42) |
| 2-Isobutyl-5,6-diethyl-4-pyrimidinyl | (A-1.43) |
| 2-Cyclopropylmethyl-5,6-dimethyl-4-pyrimidinyl | (A-1.44) |
| 2-Cyclopropylmethyl-5-methyl-6-ethyl-4-pyrimidinyl | (A-1.45) |
| 2-Cyclopropylmethyl-6-methyl-5-ethyl-4-pyrimidinyl | (A-1.46) |
| 2-Cyclopropylmethyl-5,6-diethyl-4-pyrimidinyl | (A-1.47) |
| 6-Methyl-4-pyrimidinyl | (A-1.48) |
| 2-Methyl-6-methyl-4-pyrimidinyl | (A-1.49) |
| 2-Trifluoromethyl-6-methyl-4-pyrimidinyl | (A-1.50) |
| 2-Cyclopropyl-6-methyl-4-pyrimidinyl | (A-1.51) |
| 2-Isopropyl-6-methyl-4-pyrimidinyl | (A-1.52) |
| 2-Isobutyl-6-methyl-4-pyrimidinyl | (A-1.53) |
| 2-Cyclopropylmetyl-6-methyl-4-pyrimidinyl | (A-1.54) |
| 6-Ethyl-4-pyrimidinyl | (A-1.55) |
| 2-Methyl-6-ethyl-4-pyrimidinyl | (A-1.56) |
| 2-Trifluoromethyl-6-ethyl-4-pyrimidinyl | (A-1.57) |
| 2-Cyclopropyl-6-ethyl-4-pyrimidinyl | (A-1.58) |
| 2-Isopropyl-6-ethyl-4-pyrimidinyl | (A-1.59) |
| 2-Isobutyl-6-ethyl-4-pyrimidinyl | (A-1.60) |
| 2-Cyclopropylmethyl-6-ethyl-4-pyrimidinyl | (A-1.61) |
| 6-Trifluoromethyl-4-pyrimidinyl | (A-1.62) |
| 2-Methyl-6-trifluoromethyl-4-pyrimidinyl | (A-1.63) |
| 2-Trifluoromethyl-6-trifluoromethyl-4-pyrimidinyl | (A-1.64) |
| 2-Cyclopropyl-6-trifluoromethyl-4-pyrimidinyl | (A-1.65) |
| 2-Isopropyl-6-trifluoromethyl-4-pyrimidinyl | (A-1.66) |
| 2-Isobutyl-6-trifluoromethyl-4-pyrimidinyl | (A-1.67) |
| 2-Cyclopropylmethyl-6-trifluoromethyl-4-pyrimidinyl | (A-1.68) |
| 6-Difluoromethyl-4-pyrimidinyl | (A-1.69) |
| 2-Methyl-6-difluoromethyl-4-pyrimidinyl | (A-1.70) |
| 2-Trifluoromethyl-6-difluoromethyl-4-pyrimidinyl | (A-1.71) |
| 2-Cyclopropyl-6-difluoromethyl-4-pyrimidinyl | (A-1.72) |
| 2-Isopropyl-6-difluoromethyl-4-pyrimidinyl | (A-1.73) |
| 2-Isobutyl-6-difluoromethyl-4-pyrimidinyl | (A-1.74) |
| 2-Cyclopropylmethyl-6-difluoromethyl-4-pyrimidinyl | (A-1.75) |
| 6-(2,2,2-Trifluoroeth-1-yl)-4-pyrimidinyl | (A-1.76) |
| 6-Methoxymethyl-4-pyrimidinyl | (A-1.77) |
| 6-Difluoromethoxymethyl-4-pyrimidinyl | (A-1.78) |
| 6-Trifluoromethoxymethyl-4-pyrimidinyl | (A-1.79) |
| 6-Cyanomethyl-4-pyrimidinyl | (A-1.80) |
| 6-Methoxyethyl-4-pyrimidinyl | (A-1.81) |
| 2-Methyl-6-(2,2,2-trifluoroeth-1-yl)-4-pyrimidinyl | (A-1.82) |
| 2-Methyl-6-methoxymethyl-4-pyrimidinyl | (A-1.83) |
| 2-Methyl-6-difluoromethoxymethyl-4-pyrimidinyl | (A-1.84) |
| 2-Methyl-6-trifluoromethoxymethyl-4-pyrimidinyl | (A-1.85) |
| 2-Methyl-6-cyanomethyl-4-pyrimidinyl | (A-1.86) |
| 2-Methyl-6-methoxyethyl-4-pyrimidinyl | (A-1.87) |
| 2-Trifluoromethyl-6-(2,2,2-trifluoro- | (A-1.88) |
| eth-1-yl)-4-pyrimidinyl | |
| 2-Trifluoromethyl-6-methoxymethyl-4-pyrimidinyl | (A-1.89) |
| 2-Trifluoromethyl-6-difluoromethoxy- | (A-1.90) |
| methyl-4-pyrimidinyl | |
| 2-Trifluoromethyl-6-trifluoromethoxy- | (A-1.91) |
| methyl-4-pyrimidinyl | |
| 2-Trifluoromethyl-6-cyanomethyl-4-pyrimidinyl | (A-1.92) |
| 2-Trifluoromethyl-6-methoxyethyl-4-pyrimidinyl | (A-1.93) |
| 2-Cyclopropyl-6-(2,2,2-trifluoro- | (A-1.94) |
| eth-1-yl)-4-pyrimidinyl | |
| 2-Cyclopropyl-6-methoxymethyl-4-pyrimidinyl | (A-1.95) |
| 2-Cyclopropyl-6-difluoromethoxymethyl-4-pyrimidinyl | (A-1.96) |
| 2-Cyclopropyl-6-trifluoromethoxymethyl-4-pyrimidinyl | (A-1.97) |
| 2-Cyclopropyl-6-cyanomethyl-4-pyrimidinyl | (A-1.98) |
| 2-Cyclopropyl-6-methoxyethyl-4-pyrimidinyl | (A-1.99) |
| 2-Isopropyl-6-(2,2,2-trifluoroeth-1-yl)-4-pyrimidinyl | (A-1.100) |
| 2-Isopropyl-6-methoxymethyl-4-pyrimidinyl | (A-1.101) |
| 2-Isopropyl-6-difluoromethoxymethyl-4-pyrimidinyl | (A-1.102) |
| 2-Isopropyl-6-trifluoromethoxymethyl-4-pyrimidinyl | (A-1.103) |
| 2-Isopropyl-6-cyanomethyl-4-pyrimidinyl | (A-1.104) |
| 2-Isopropyl-6-methoxyethyl-4-pyrimidinyl | (A-1.105) |
| 2-Isobutyl-6-(2,2,2-trifluoroeth-1-yl)-4-pyrimidinyl | (A-1.106) |
| 2-Isobutyl-6-methoxymethyl-4-pyrimidinyl | (A-1.107) |
| 2-Isobutyl-6-difluoromethoxymethyl-4-pyrimidinyl | (A-1.108) |
| 2-Isobutyl-6-trifluoromethoxymethyl-4-pyrimidinyl | (A-1.109) |
| 2-Isobutyl-6-cyanomethyl-4-pyrimidinyl | (A-1.110) |
| 2-Isobutyl-6-methoxyethyl-4-pyrimidinyl | (A-1.111) |
| 2-Cyclopropylmethyl-6-(2,2,2-trifluoro- | (A-1.112) |
| eth-1-yl)-4-pyrimidinyl | |
| 2-Cyclopropylmethyl-6-methoxymethyl-4-pyrimidinyl | (A-1.113) |
| 2-Cyclopropylmethyl-6-difluoromethoxy- | (A-1.114) |
| methyl-4-pyrimidinyl | |
| 2-Cyclopropylmethyl-6-trifluoromethoxy- | (A-1.115) |
| methyl-4-pyrimidinyl | |
| 2-Cyclopropylmethyl-6-cyanomethyl-4-pyrimidinyl | (A-1.116) |
| 2-Cyclopropylmethyl-6-methoxyethyl-4-pyrimidinyl | (A-1.117) |
| 6-Chloro-4-pyrimidinyl | (A-1.118) |
| 2-Methyl-6-chloro-4-pyrimidinyl | (A-1.119) |
| 2-Trifluoromethyl-6-chloro-4-pyrimidinyl | (A-1.120) |
| 2-Cyclopropyl-6-chloro-4-pyrimidinyl | (A-1.121) |
| 2-Isoopropyl-6-chloro-4-pyrimidinyl | (A-1.122) |
| 2-Isobutyl-6-chloro-4-pyrimidinyl | (A-1.123) |
| 2-Cyclopropylmethyl-6-chloro-4-pyrimidinyl | (A-1.124) |
| 6-Bromo-4-pyrimidinyl | (A-1.125) |
| 2-Methyl-6-bromo-4-pyrimidinyl | (A-1.126) |
| 2-Trifluoromethyl-6-bromo-4-pyrimidinyl | (A-1.127) |
| 2-Cyclopropyl-6-bromo-4-pyrimidinyl | (A-1.128) |
| 2-Isopropyl-6-bromo-4-pyrimidinyl | (A-1.129) |
| 2-Isobutyl-6-bromo-4-pyrimidinyl | (A-1.130) |
| 2-Cyclopropylmethyl-6-bromo-4-pyrimidinyl | (A-1.131) |
| 6-Cyclopropyl-4-pyrimidinyl | (A-1.132) |
| 6-Isopropyl-4-pyrimidinyl | (A-1.133) |
| 6-Isobutyl-4-pyrimidinyl | (A-1.134) |
| 6-Cyclopropylmethyl-4-pyrimidinyl | (A-1.135) |
| 2-Methyl-6-cyclopropyl-4-pyrimidinyl | (A-1.136) |
| 2-Methyl-6-isopropyl-4-pyrimidinyl | (A-1.137) |
| 2-Methyl-6-isobutyl-4-pyrimidinyl | (A-1.138) |
| 2-Methyl-6-cyclopropylmethyl-4-pyrimidinyl | (A-1.139) |
| 2-Trifluoromethyl-6-cyclopropyl-4-pyrimidinyl | (A-1.140) |
| 2-Trifluoromethyl-6-isopropyl-4-pyrimidinyl | (A-1.141) |
| 2-Trifluoromethyl-6-isobutyl-4-pyrimidinyl | (A-1.142) |
| 2-Trifluoromethyl-6-cyclopropyl- | (A-1.143) |
| methyl-4-pyrimidinyl | |
| 2-Cyclopropyl-6-cyclopropyl-4-pyrimidinyl | (A-1.144) |
| 2-Cyclopropyl-6-isopropyl-4-pyrimidinyl | (A-1.145) |
| 2-Cyclopropyl-6-isobutyl-4-pyrimidinyl | (A-1.146) |
| 2-Cyclopropyl-6-cyclopropylmethyl-4-pyrimidinyl | (A-1.147) |
| 2-Isopropyl-6-cyclopropyl-4-pyrimidinyl | (A-1.148) |
| 2-Isopropyl-6-isopropyl-4-pyrimidinyl | (A-1.149) |
| 2-Isopropyl-6-isobutyl-4-pyrimidinyl | (A-1.150) |
| 2-Isopropyl-6-cyclopropylmethyl-4-pyrimidinyl | (A-1.151) |
| 2-Isobutyl-6-cyclopropyl-4-pyrimidinyl | (A-1.152) |
| 2-Isobutyl-6-isopropyl-4-pyrimidinyl | (A-1.153) |
| 2-Isobutyl-6-isobutyl-4-pyrimidinyl | (A-1.154) |
| 2-Isobutyl-6-cyclopropylmethyl-4-pyrimidinyl | (A-1.155) |
| 2-Cyclopropylmethyl-6-cyclopropyl-4-pyrimidinyl | (A-1.156) |
| 2-Cyclopropylmethyl-6-isopropyl-4-pyrimidinyl | (A-1.157) |
| 2-Cyclopropylmethyl-6-isobutyl-4-pyrimidinyl | (A-1.158) |
| 2-Cyclopropylmethyl-6-cyclopropyl- | (A-1.159) |
| methyl-4-pyrimidinyl | |
| 6-Methoxy-4-pyrimidinyl | (A-1.160) |
| 2-Methyl-6-methoxy-4-pyrimidinyl | (A-1.161) |
| 2-Trifluoromethyl-6-methoxy-4-pyrimidinyl | (A-1.162) |
| 2-Cyclopropyl-6-methoxy-4-pyrimidinyl | (A-1.163) |
| 2-Isopropyl-6-methoxy-4-pyrimidinyl | (A-1.164) |
| 2-Isobutyl-6-methoxy-4-pyrimidinyl | (A-1.165) |
| 2-Cyclopropylmethyl-6-methoxy-4-pyrimidinyl | (A-1.166) |
| 6-Difluoromethoxy-4-pyrimidinyl | (A-1.167) |
| 2-Methyl-6-difluoromethoxy-4-pyrimidinyl | (A-1.168) |
| 2-Trifluoromethyl-6-difluoromethoxy-4-pyrimidinyl | (A-1.169) |
| 2-Cyclopropyl-6-difluoromethoxy-4-pyrimidinyl | (A-1.170) |
| 2-Isopropyl-6-difluoromethoxy-4-pyrimidinyl | (A-1.171) |
| 2-Isobutyl-6-difluoromethoxy-4-pyrimidinyl | (A-1.172) |
| 2-Cyclopropylmethyl-6-difluoro- | (A-1.173) |
| methoxy-4-pyrimidinyl | |

Another preferred embodiment of the invention relates to methods and uses comprising 3-pyridiyl compounds of the formulae I or II, the salts thereof, the N-oxides thereof or the salts of the N-oxides thereof, wherein X¹, X², X³, R¹, R² and R³ are as defined above and in particular have one of the preferred meanings and wherein A is a radical A-2,

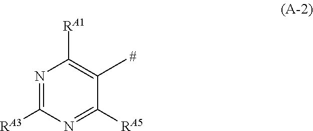

wherein #, R^{A1}, R^{A3} and R^{A5} are as defined herein.

Among the methods and uses comprising compounds of formulae I or II wherein A is A-2, preference is given to those methods and uses, wherein R^{A1} and R^{A5} are selected independently of each other from hydrogen, halogen, CN, NO₂, C₁-C₄-alkyl, C₁-C₄-haloalkyl, C₁-C₄-alkoxy, C₁-C₄-haloalkoxy, C₁-C₄-alkylsulfinyl, C₁-C₄-haloalkylsulfinyl, C₁-C₄-alkylsulfonyl, C₁-C₄-haloalkylsulfonyl, C₁-C₅-alkylen-CN, C₁-C₅-alkylen-OR^{a}, C₁-C₅-alkylen-C(Y)R^{b} and C₁-C₅-alkylen-C(Y)OR^{c}, C₃-C₁₀-cycloalkyl, C₅-C₁₀-cycloalkenyl, saturated 3- to 10-membered heterocyclyl, C₃-C₁₀-cycloalkyl-C₁-C₅-alkyl, C₅-C₁₀-cycloalkenyl-C₁-C₅-alkyl, 3- to 10-membered heterocyclyl-C₁-C₅-alkyl, wherein cycloalkyl, cycloalkenyl and heterocyclyl in the 6 last mentioned radicals may be unsubstituted or may carry 1, 2, 3, 4 or 5 identical or different substituents R^{y}, wherein Y is defined herein and in particular is oxygen, wherein R^{a}, R^{b} and R^{c} are as defined herein and in particular are selected independently of each other from the group consisting of hydrogen, C₁-C₄-alkyl, C₁-C₄-haloalkyl, C₁-C₄-alkoxy-C₁-C₄-alkyl, heterocyclyl-C₁-C₄-alkyl and hetaryl-C₁-C₄-alkyl, more preferably from the group consisting of hydrogen, C₁-C₄-alkyl and C₁-C₄-alkoxy-C₁-C₂-alkyl, and most preferably from the group consisting of hydrogen, methyl and ethyl, and wherein the substituents R^{y} are as defined herein and in particular are selected independently of each other from halogen, NO₂, C₁-C₄-alkyl, C₁-C₄-haloalkyl, C₁-C₄-alkoxy, C₁-C₄-haloalkoxy, C₁-C₄-alkylsulfonyl and C₁-C₄-haloalkylsulfonyl.

More preferably R^{A1} and R^{A5} are selected independently of each other from hydrogen, halogen, C₁-C₄-alkyl, C₁-C₄-haloalkyl, C₁-C₄-alkoxy, C₁-C₄-haloalkoxy, C₁-C₃-alkylen-CN, C₁-C₃-alkylen-OR^{a}, C₃-C₇-cycloalkyl, C₃-C₇-cycloalkyl-C₁-C₃-alkyl, and 3- to 7-membered saturated heterocyclyl-C₁-C₃-alkyl, wherein cycloalkyl and heterocyclyl in the 3 last mentioned radicals may be unsubstituted or may carry 1, 2, 3, 4 or 5 identical or different substituents R^{y}, wherein R^{a} is as defined herein and in particular is selected from the group consisting of hydrogen, C₁-C₄-alkyl, C₁-C₄-haloalkyl and C₁-C₄-alkoxy-C₁-C₂-alkyl, and specifically from the group consisting of hydrogen, methyl, ethyl, difluormethyl and trifluoromethyl, and wherein the substituents R^{y} are as defined herein and in particular are selected independently of each other from halogen, NO₂, C₁-C₄-alkyl, C₁-C₄-haloalkyl, C₁-C₄-alkoxy, C₁-C₄-haloalkoxy, C₁-C₄-alkylsulfonyl and C₁-C₄-haloalkylsulfonyl.

Even more preferably R^{A1} and R^{A5} are selected independently of each other from hydrogen, fluorine, chlorine, bromine, methyl, ethyl, n-propyl, isopropyl, cyclopropyl, isobutyl, cyclopropylmethyl, fluoromethyl, difluoromethyl, trifluoromethyl, 1-fluoroethyl, 2-fluoroethyl, 2,2,2-trifluoroethyl, methoxymethyl, difluoromethoxymethyl, trifluoromethoxymethyl, cyanomethyl, 2-methoxy-1-ethyl, 2-difluoromethoxy-1-ethyl, 2-trifluoromethoxy-1-ethyl, and 2-cyano-1-ethyl.

Among the methods and uses comprising compounds of formulae I or II wherein A is A-2, preference is further given to those methods and uses, wherein R^{A3} is selected from hydrogen, halogen, CN, NO₂, C₁-C₄-alkyl, C₁-C₄-haloalkyl, C₁-C₄-alkoxy, C₁-C₄-haloalkoxy, C₁-C₄-alkylthio, C₁-C₄-haloalkylthio, C₁-C₄-alkylsulfinyl, C₁-C₄-haloalkylsulfinyl, C₁-C₄-alkylsulfonyl, C₁-C₄-haloalkylsulfonyl, C₁-C₅-alkylen-CN, C₁-C₅-alkylen-OR^{a}, C₁-C₅-alkylen-C(Y)R^{b}, C₁-C₅-alkylen-C(Y)OR^{c}, C₃-C₁₀-cycloalkyl, C₅-C₁₀-cycloalkenyl, saturated 3 to 10 membered heterocyclyl, C₃-C₁₀-cycloalkyl-C₁-C₅-alkyl, C₅-C₁₀-cycloalkenyl-C₁-C₅-alkyl and 3- to 10-membered heterocyclyl-C₁-C₅-alkyl, wherein cycloalkyl, cycloalkenyl and heterocyclyl in the 6 last mentioned radicals may be unsubstituted or may carry 1, 2, 3, 4 or 5 identical or different substituents R^{y}, wherein Y is defined herein and in particular is oxygen, wherein R^{a}, R^{b} and R^{c} are as defined herein and in particular are selected independently of each other from the group consisting of hydrogen, C₁-C₄-alkyl, C₁-C₄-haloalkyl, C₁-C₄-alkoxy-C₁-C₄-alkyl, heterocyclyl-C₁-C₄-alkyl and hetaryl-C₁-C₄-alkyl, more preferably from the group consisting of hydrogen, C₁-C₄-alkyl and C₁-C₄-alkoxy-C₁-C₂-alkyl, and most preferably from the group consisting of hydrogen, methyl and ethyl, and wherein the substituents R^{y} are as defined herein and in particular are selected independently of each other from halogen, NO₂, C₁-C₄-alkyl, C₁-C₄-haloalkyl, C₁-C₄-alkoxy, C₁-C₄-haloalkoxy, C₁-C₄-alkylsulfonyl and C₁-C₄-haloalkylsulfonyl.

More preferably R^{A3} is selected from hydrogen, halogen, C₁-C₄-alkyl, C₁-C₄-haloalkyl, C₁-C₄-alkoxy, C₁-C₄-haloalkoxy, C₁-C₃-alkylen-CN, C₁-C₃-alkylen-OR^{a}, C₃-C₇-cycloalkyl, C₃-C₇-cycloalkyl-C₁-C₃-alkyl, and 3- to 7-membered saturated heterocyclyl-C₁-C₃-alkyl, wherein cycloalkyl and heterocyclyl in the 3 last mentioned radicals may be unsubstituted or may carry 1, 2, 3, 4 or 5 identical or different substituents R^{y}, wherein R^{a} is as defined herein and in particular is selected from the group consisting of hydrogen, C₁-C₄-alkyl, C₁-C₄-haloalkyl and C₁-C₄-alkoxy-C₁-C₂-alkyl, and specifically from the group consisting of hydrogen, methyl, ethyl, difluormethyl and trifluoromethyl, and wherein the substituents R^{y} are as defined herein and in particular are selected independently of each other from halogen, NO₂, C₁-C₄-alkyl, C₁-C₄-haloalkyl, C₁-C₄-alkoxy, C₁-C₄-haloalkoxy, C₁-C₄-alkylsulfonyl and C₁-C₄-haloalkylsulfonyl.

Even more preferably R^{A3} is selected from hydrogen, fluorine, chlorine, bromine, methyl, ethyl, n-propyl, isopropyl, cyclopropyl, isobutyl, cyclopropylmethyl, fluoromethyl, difluoromethyl, trifluoromethyl, 1-fluoroethyl, 2-fluoroethyl, 2,2,2-trifluoroethyl, methoxymethyl, difluoromethoxymethyl, trifluoromethoxymethyl, cyanomethyl, 2-methoxy-1-ethyl, 2-difluoromethoxy-1-ethyl, 2-trifluoromethoxy-1-ethyl, and 2-cyano-1-ethyl.

Preferably one or two of the substituents R^{A1}, R^{A3} and R^{A5} are hydrogen.

Examples of suitable radicals A-1 are the radicals of formulae A-2.1 to A-2.131, as defined in Table A2.

TABLE A2

| | |
|---|---|
| 5-Pyrimidinyl | (A-2.1) |
| 2-Chloro-5-pyrimidinyl | (A-2.2) |
| 2-Bromo-5-pyrimidinyl | (A-2.3) |
| 2-Methyl-5-pyrimidinyl | (A-2.4) |
| 2-Ethyl-5-pyrimidinyl | (A-2.5) |
| 2-Cyclopropyl-5-pyrimidinyl | (A-2.6) |
| 2-Isopropyl-5-pyrimidinyl | (A-2.7) |
| 2-Isobutyl-5-pyrimidinyl | (A-2.8) |
| 2-Cyclopropylmethyl-5-pyrimidinyl | (A-2.9) |
| 2-Difluoromethyl-5-pyrimidinyl | (A-2.10) |
| 2-Trifluoromethyl-5-pyrimidinyl | (A-2.11) |
| 2-(2,2,2-Trifluoroeth-1-yl)-5-pyrimidinyl | (A-2.12) |
| 2-Methoxymethyl-5-pyrimidinyl | (A-2.13) |
| 2-Difluoromethoxymethyl-5-pyrimidinyl | (A-2.14) |
| 2-Trifluoromethoxymethyl-5-pyrimidinyl | (A-2.15) |
| 2-Cyanomethyl-5-pyrimidinyl | (A-2.16) |
| 2-Methoxyethyl-5-pyrimidinyl | (A-2.17) |
| 2-Methoxy-5-pyrimidinyl | (A-2.18) |
| 2-Ethoxy-5-pyrimidinyl | (A-2.19) |
| 2-Chloro-4-methyl-5-pyrimidinyl | (A-2.20) |
| 2-Bromo-4-methyl-5-pyrimidinyl | (A-2.21) |
| 2-Methyl-4-methyl-5-pyrimidinyl | (A-2.22) |
| 2-Ethyl-4-methyl-5-pyrimidinyl | (A-2.23) |
| 2-Cyclopropyl-4-methyl-5-pyrimidinyl | (A-2.24) |
| 2-Isopropyl-4-methyl-5-pyrimidinyl | (A-2.25) |
| 2-Isobutyl-4-methyl-5-pyrimidinyl | (A-2.26) |
| 2-Cyclopropylmethyl-4-methyl-5-pyrimidinyl | (A-2.27) |
| 2-Difluoromethyl-4-methyl-5-pyrimidinyl | (A-2.28) |
| 2-Trifluoromethyl-4-methyl-5-pyrimidinyl | (A-2.29) |
| 2-(2,2,2-Trifluoroeth-1-yl)-4-methyl-5-pyrimidinyl | (A-2.30) |
| 2-Methoxymethyl-4-methyl-5-pyrimidinyl | (A-2.31) |
| 2-Difluoromethoxymethyl-4-methyl-5-pyrimidinyl | (A-2.32) |
| 2-Trifluoromethoxymethyl-4-methyl-5-pyrimidinyl | (A-2.33) |
| 2-Cyanomethyl-4-methyl-5-pyrimidinyl | (A-2.34) |
| 2-Methoxyethyl-4-methyl-5-pyrimidinyl | (A-2.35) |
| 2-Methoxy-4-methyl-5-pyrimidinyl | (A-2.36) |
| 2-Ethoxy-4-methyl-5-pyrimidinyl | (A-2.37) |
| 2-Chloro-4-trifluoromethyl-5-pyrimidinyl | (A-2.38) |
| 2-Bromo-4-trifluoromethyl-5-pyrimidinyl | (A-2.39) |
| 2-Methyl-4-trifluoromethyl-5-pyrimidinyl | (A-2.40) |
| 2-Ethyl-4-trifluoromethyl-5-pyrimidinyl | (A-2.41) |
| 2-Cyclopropyl-4-trifluoromethyl-5-pyrimidinyl | (A-2.42) |
| 2-Isopropyl-4-trifluoromethyl-5-pyrimidinyl | (A-2.43) |
| 2-Isobutyl-4-trifluoromethyl-5-pyrimidinyl | (A-2.44) |
| 2-Cyclopropylmethyl-4-trifluoro- | (A-2.45) |
| methyl-5-pyrimidinyl | |
| 2-Difluoromethyl-4-trifluoro- | (A-2.46) |
| methyl-5-pyrimidinyl | |
| 2-Trifluoromethyl-4-trifluoro- | (A-2.47) |
| methyl-5-pyrimidinyl | |
| 2-(2,2,2-Trifluoroeth-1-yl)-4-trifluoro- | (A-2.48) |
| methyl-5-pyrimidinyl | |
| 2-Methoxymethyl-4-trifluoromethyl-5-pyrimidinyl | (A-2.49) |
| 2-Difluoromethoxymethyl-4-trifluoro- | (A-2.50) |
| methyl-5-pyrimidinyl | |
| 2-Trifluoromethoxymethyl-4-trifluoro- | (A-2.51) |
| methyl-5-pyrimidinyl | |
| 2-Cyanomethyl-4-trifluoromethyl-5-pyrimidinyl | (A-2.52) |
| 2-Methoxyethyl-4-trifluoromethyl-5-pyrimidinyl | (A-2.53) |
| 2-Methoxy-4-trifluoromethyl-5-pyrimidinyl | (A-2.54) |
| 2-Ethoxy-4-trifluoromethyl-5-pyrimidinyl | (A-2.55) |
| 2,4-dichloro-5-pyrimidinyl | (A-2.56) |
| 2-Methyl-4-chloro-5-pyrimidinyl | (A-2.57) |
| 2-Ethyl-4-chloro-5-pyrimidinyl | (A-2.58) |
| 2-Cyclopropyl-4-chloro-5-pyrimidinyl | (A-2.59) |
| 2-Isopropyl-4-chloro-5-pyrimidinyl | (A-2.60) |
| 2-Isobutyl-4-chloro-5-pyrimidinyl | (A-2.61) |
| 2-Cyclopropylmethyl-4-chloro-5-pyrimidinyl | (A-2.62) |
| 2-Difluoromethyl-4-chloro-5-pyrimidinyl | (A-2.63) |
| 2-Trifluoromethyl-4-chloro-5-pyrimidinyl | (A-2.64) |
| 2-(2,2,2-Trifluoroeth-1-yl)-4-chloro-5-pyrimidinyl | (A-2.65) |
| 2-Methoxymethyl-4-chloro-5-pyrimidinyl | (A-2.66) |
| 2-Difluoromethoxymethyl-4-chloro-5-pyrimidinyl | (A-2.67) |
| 2-Trifluoromethoxymethyl-4-chloro-5-pyrimidinyl | (A-2.68) |
| 2-Cyanomethyl-4-chloro-5-pyrimidinyl | (A-2.69) |
| 2-Methoxyethyl-4-chloro-5-pyrimidinyl | (A-2.70) |
| 2-Methoxy-4-chloro-5-pyrimidinyl | (A-2.71) |
| 2-Ethoxy-4-chloro-5-pyrimidinyl | (A-2.72) |
| 2-Chloro-4-ethyl-5-pyrimidinyl | (A-2.73) |
| 2,4-dibromo-5-pyrimidinyl | (A-2.74) |
| 2-Methyl-4-bromo-5-pyrimidinyl | (A-2.75) |
| 2-Ethyl-4-bromo-5-pyrimidinyl | (A-2.76) |
| 2-Cyclopropyl-4-bromo-5-pyrimidinyl | (A-2.77) |
| 2-Isopropyl-4-bromo-5-pyrimidinyl | (A-2.78) |
| 2-Isobutyl-4-bromo-5-pyrimidinyl | (A-2.79) |
| 2-Cyclopropylmethyl-4-bromo-5-pyrimidinyl | (A-2.80) |
| 2-Difluoromethyl-4-bromo-5-pyrimidinyl | (A-2.81) |
| 2-Trifluoromethyl-4-bromo-5-pyrimidinyl | (A-2.82) |
| 2-(2,2,2-Trifluoroeth-1-yl)-4-bromo-5-pyrimidinyl | (A-2.83) |
| 2-Methoxymethyl-4-bromo-5-pyrimidinyl | (A-2.84) |
| 2-Difluoromethoxymethyl-4-bromo-5-pyrimidinyl | (A-2.85) |
| 2-Trifluoromethoxymethyl-4-bromo-5-pyrimidinyl | (A-2.86) |
| 2-Cyanomethyl-4-bromo-5-pyrimidinyl | (A-2.87) |
| 2-Methoxyethyl-4-bromo-5-pyrimidinyl | (A-2.88) |
| 2-Methoxy-4-bromo-5-pyrimidinyl | (A-2.89) |
| 2-Ethoxy-4-bromo-5-pyrimidinyl | (A-2.90) |
| 2-Bromo-4-ethyl-5-pyrimidinyl | (A-2.91) |
| 2-Methyl-4-ethyl-5-pyrimidinyl | (A-2.92) |
| 2-Ethyl-4-ethyl-5-pyrimidinyl | (A-2.93) |
| 2-Cyclopropyl-4-ethyl-5-pyrimidinyl | (A-2.94) |
| 2-Isopropyl-4-ethyl-5-pyrimidinyl | (A-2.95) |
| 2-Isobutyl-4-ethyl-5-pyrimidinyl | (A-2.96) |
| 2-Cyclopropylmethyl-4-ethyl-5-pyrimidinyl | (A-2.97) |
| 2-Difluoromethyl-4-ethyl-5-pyrimidinyl | (A-2.98) |
| 2-Trifluoromethyl-4-ethyl-5-pyrimidinyl | (A-2.99) |
| 2-(2,2,2-Trifluoroeth-1-yl)-4-ethyl-5-pyrimidinyl | (A-2.100) |
| 2-Methoxymethyl-4-ethyl-5-pyrimidinyl | (A-2.101) |
| 2-Difluoromethoxymethyl-4-ethyl-5-pyrimidinyl | (A-2.102) |
| 2-Trifluoromethoxymethyl-4-ethyl-5-pyrimidinyl | (A-2.103) |
| 2-Cyanomethyl-4-ethyl-5-pyrimidinyl | (A-2.104) |
| 2-Methoxyethyl-4-ethyl-5-pyrimidinyl | (A-2.105) |
| 2-Methoxy-4-ethyl-5-pyrimidinyl | (A-2.106) |
| 2-Ethoxy-4-ethyl-5-pyrimidinyl | (A-2.107) |
| 2-Chloro-4-difluoromethyl-5-pyrimidinyl | (A-2.108) |
| 2-Bromo-4-difluoromethyl-5-pyrimidinyl | (A-2.109) |
| 2-Methyl-4-difluoromethyl-5-pyrimidinyl | (A-2.110) |
| 2-Ethyl-4-difluoromethyl-5-pyrimidinyl | (A-2.111) |
| 2-Cyclopropyl-4-difluoromethyl-5-pyrimidinyl | (A-2.112) |
| 2-Isopropyl-4-difluoromethyl-5-pyrimidinyl | (A-2.113) |
| 2-Isobutyl-4-difluoromethyl-5-pyrimidinyl | (A-2.114) |
| 2-Cyclopropylmethyl-4-difluoromethyl-5-pyrimidinyl | (A-2.115) |
| 2-Difluoromethyl-4-difluoromethyl-5-pyrimidinyl | (A-2.116) |
| 2-Trifluoromethyl-4-difluoromethyl-5-pyrimidinyl | (A-2.117) |
| 2-(2,2,2-Trifluoroeth-1-yl)-4-difluoro- | (A-2.118) |
| methyl-5-pyrimidinyl | |
| 2-Methoxymethyl-4-difluoromethyl-5-pyrimidinyl | (A-2.119) |
| 2-Difluoromethoxymethyl-4-difluoro- | (A-2.120) |
| methyl-5-pyrimidinyl | |
| 2-Trifluoromethoxymethyl-4-difluoro- | (A-2.121) |
| methyl-5-pyrimidinyl | |
| 2-Cyanomethyl-4-difluoromethyl-5-pyrimidinyl | (A-2.122) |
| 2-Methoxyethyl-4-difluoromethyl-5-pyrimidinyl | (A-2.123) |
| 2-Methoxy-4-difluoromethyl-5-pyrimidinyl | (A-2.124) |
| 2-Ethoxy-4-difluoromethyl-5-pyrimidinyl | (A-2.125) |
| 4-Methyl-5-pyrimidinyl | (A-2.126) |
| 4-Trifluoromethyl-5-pyrimidinyl | (A-2.127) |
| 4-Chloro-5-pyrimidinyl | (A-2.128) |
| 4-Bromo-5-pyrimidinyl | (A-2.129) |
| 4-Ethyl-5-pyrimidinyl | (A-2.130) |
| 4-Difluoromethyl-5-pyrimidinyl | (A-2.131) |

Another preferred embodiment of the invention relates to methods and uses comprising 3-pyridiyl compounds of the formulae I or II, the salts thereof, the N-oxides thereof or the salts of the N-oxides thereof, wherein X¹, X², X³, R¹, R² and R³ are as defined above and in particular have one of the preferred meanings and wherein A is a radical A-3,

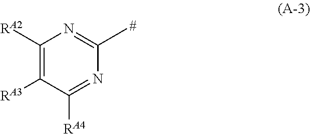

wherein #, R^{A2}, R^{A3} and R^{A4} are as defined herein.

Among the methods and uses comprising compounds of formulae I or II wherein A is A-3, preference is given to those methods and uses, wherein R^{A2} and R^{A4} are selected independently of each other from hydrogen, halogen, CN, NO₂, C₁-C₄-alkyl, C₁-C₄-haloalkyl, C₁-C₄-alkoxy, C₁-C₄-haloalkoxy, C₁-C₄-alkylthio, C₁-C₄-haloalkylthio, C₁-C₄-alkylsulfinyl, C₁-C₄-haloalkylsulfinyl, C₁-C₄-alkylsulfonyl, C₁-C₄-haloalkylsulfonyl, C₁-C₅-alkylen-CN, C₁-C₅-alkylen-OR^{a}, C₁-C₅-alkylen-C(Y)R^{b}, C₁-C₅-alkylen-C(Y)OR^{c}, C₃-C₁₀-cycloalkyl, C₅-C₁₀-cycloalkenyl, saturated 3- to 10-membered heterocyclyl, C₃-C₁₀-cycloalkyl-C₁-C₅-alkyl, C₅-C₁₀-cycloalkenyl-C₁-C₅-alkyl, saturated or partially unsaturated 3- to 10-membered heterocyclyl-C₁-C₅-alkyl, wherein cycloalkyl, cycloalkenyl and heterocyclyl in the 6 last mentioned radicals may be unsubstituted or may carry 1, 2, 3, 4 or 5 identical or different substituents R^{y}, wherein Y is defined herein and in particular is oxygen, wherein R^{a}, R^{b} and R^{c} are as defined herein and in particular are selected independently of each other from the group consisting of hydrogen, C₁-C₄-alkyl, C₁-C₄-haloalkyl, C₁-C₄-alkoxy-C₁-C₄-alkyl, heterocyclyl-C₁-C₄-alkyl and hetaryl-C₁-C₄-alkyl, more preferably from the group consisting of hydrogen, C₁-C₄-alkyl and C₁-C₄-alkoxy-C₁-C₂-alkyl, and most preferably from the group consisting of hydrogen, methyl and ethyl, and wherein the substituents R^{y} are as defined herein and in particular are selected independently of each other from halogen, NO₂, C₁-C₄-alkyl, C₁-C₄-haloalkyl, C₁-C₄-alkoxy, C₁-C₄-haloalkoxy, C₁-C₄-alkylsulfonyl and C₁-C₄-haloalkylsulfonyl.

More preferably R^{A2} and R^{A4} are selected independently of each other from hydrogen, halogen, C₁-C₄-alkyl, C₁-C₄-haloalkyl, C₁-C₄-alkoxy, C₁-C₄-haloalkoxy, C₁-C₃-alkylen-CN, C₁-C₃-alkylen-OR^{a}, C₃-C₇-cycloalkyl, C₃-C₇-cycloalkyl-C₁-C₃-alkyl, and 3- to 7-membered saturated heterocyclyl-C₁-C₃-alkyl, wherein cycloalkyl and heterocyclyl in the 3 last mentioned radicals may be unsubstituted or may carry 1, 2, 3, 4 or 5 identical or different substituents R^{y}, wherein R^{a} is as defined herein and in particular is selected from the group consisting of hydrogen, C₁-C₄-alkyl, C₁-C₄-haloalkyl and C₁-C₄-alkoxy-C₁-C₂-alkyl, and specifically from the group consisting of hydrogen, methyl, ethyl, difluormethyl and trifluoromethyl, and wherein the substituents R^{y} are as defined herein and in particular are selected independently of each other from halogen, NO₂, C₁-C₄-alkyl, C₁-C₄-haloalkyl, C₁-C₄-alkoxy, C₁-C₄-haloalkoxy, C₁-C₄-alkylsulfonyl and C₁-C₄-haloalkylsulfonyl.

Even more preferably R^{A2} and R^{A4} are selected independently of each other from hydrogen, fluorine, chlorine, bromine, methyl, ethyl, n-propyl, isopropyl, cyclopropyl, isobutyl, cyclopropylmethyl, fluoromethyl, difluoromethyl, trifluoromethyl, 1-fluoroethyl, 2-fluoroethyl, 2,2,2-trifluoroethyl, methoxymethyl, difluoromethoxymethyl, trifluoromethoxymethyl, cyanomethyl, 2-methoxy-1-ethyl, 2-difluoromethoxy-1-ethyl, 2-trifluoromethoxy-1-ethyl, and 2-cyano-1-ethyl.

Among the methods and uses comprising compounds of formulae I or II wherein A is A-3, preference is further given to those methods and uses, wherein R^{A3} is selected from hydrogen, halogen, CN, NO₂, C₁-C₄-alkyl, C₁-C₄-haloalkyl, C₁-C₄-alkoxy, C₁-C₄-haloalkoxy, C₁-C₄-alkylthio, C₁-C₄-haloalkylthio, C₁-C₄-alkylsulfinyl, C₁-C₄-haloalkylsulfinyl, C₁-C₄-alkylsulfonyl, C₁-C₄-haloalkylsulfonyl, C₁-C₅-alkylen-CN, C₁-C₅-alkylen-OR^{a}, C₁-C₅-alkylen-C(Y)R^{b}, C₁-C₅-alkylen-C(Y)OR^{c}, C₃-C₁₀-cycloalkyl, C₅-C₁₀-cycloalkenyl, saturated 3 to 10 membered heterocyclyl, C₃-C₁₀-cycloalkyl-C₁-C₅-alkyl, C₅-C₁₀-cycloalkenyl-C₁-C₅-alkyl and 3- to 10-membered heterocyclyl-C₁-C₅-alkyl, wherein cycloalkyl, cycloalkenyl and heterocyclyl in the 6 last mentioned radicals may be unsubstituted or may carry 1, 2, 3, 4 or 5 identical or different substituents R^{y}, wherein Y is defined herein and in particular is oxygen, wherein R^{a}, R^{b} and R^{c} are as defined herein and in particular are selected independently of each other from the group consisting of hydrogen, C₁-C₄-alkyl, C₁-C₄-haloalkyl, C₁-C₄-alkoxy-C₁-C₄-alkyl, heterocyclyl-C₁-C₄-alkyl and hetaryl-C₁-C₄-alkyl, more preferably from the group consisting of hydrogen, C₁-C₄-alkyl and C₁-C₄-alkoxy-C₁-C₂-alkyl, and most preferably from the group consisting of hydrogen, methyl and ethyl, and wherein the substituents R^{y} are as defined herein and in particular are selected independently of each other from halogen, NO₂, C₁-C₄-alkyl, C₁-C₄-haloalkyl, C₁-C₄-alkoxy, C₁-C₄-haloalkoxy, C₁-C₄-alkylsulfonyl and C₁-C₄-haloalkylsulfonyl.

More preferably R^{A3} is selected from hydrogen, halogen, C₁-C₄-alkyl, C₁-C₄-haloalkyl, C₁-C₄-alkoxy, C₁-C₄-haloalkoxy, C₁-C₃-alkylen-CN, C₁-C₃-alkylen-OR^{a}, C₃-C₇-cycloalkyl, C₃-C₇-cycloalkyl-C₁-C₃-alkyl, and 3- to 7-membered saturated heterocyclyl-C₁-C₃-alkyl, wherein cycloalkyl and heterocyclyl in the 3 last mentioned radicals may be unsubstituted or may carry 1, 2, 3, 4 or 5 identical or different substituents R^{y}, wherein R^{a} is as defined herein and in particular is selected from the group consisting of hydrogen, C₁-C₄-alkyl, C₁-C₄-haloalkyl and C₁-C₄-alkoxy-C₁-C₂-alkyl, and specifically from the group consisting of hydrogen, methyl, ethyl, difluormethyl and trifluoromethyl, and wherein the substituents R^{y} are as defined herein and in particular are selected independently of each other from halogen, NO₂, C₁-C₄-alkyl, C₁-C₄-haloalkyl, C₁-C₄-alkoxy, C₁-C₄-haloalkoxy, C₁-C₄-alkylsulfonyl and C₁-C₄-haloalkylsulfonyl.

Even more preferably R^{A3} is selected from hydrogen, fluorine, chlorine, bromine, methyl, ethyl, n-propyl, isopropyl, cyclopropyl, isobutyl, cyclopropylmethyl, fluoromethyl, difluoromethyl, trifluoromethyl, 1-fluoroethyl, 2-fluoroethyl, 2,2,2-trifluoroethyl, methoxymethyl, difluoromethoxymethyl, trifluoromethoxymethyl, cyanomethyl, 2-methoxy-1-ethyl, 2-difluoromethoxy-1-ethyl, 2-trifluoromethoxy-1-ethyl, and 2-cyano-1-ethyl.

Preferably one or two of the substituents R^{A2}, R^{A3} and R^{A4} are hydrogen.

Examples of suitable radicals A-3 are the radicals of formulae A-3.1 to A-3.13, as defined in Table A3.

TABLE A3

| | |
|---|---|
| 2-Pyrimidinyl | (A-3.1) |
| 4-Methyl-2-pyrimidinyl | (A-3.2) |
| 5-Methyl-2-pyrimidinyl | (A-3.3) |
| 4-Ethyl-2-pyrimidinyl | (A-3.4) |
| 5-Ethyl-2-pyrimidinyl | (A-3.5) |
| 4-Trifluoromethyl-2-pyrimidinyl | (A-3.6) |
| 5-Trifluoromethyl-2-pyrimidinyl | (A-3.7) |
| 4,5-Dimethyl-2-pyrimidinyl | (A-3.8) |
| 4,5,6-Trimethyl-2-pyrimidinyl | (A-3.9) |
| 4-Ethyl-5-methyl-2-pyrimidinyl | (A-3.10) |
| 4-Methyl-5-ethyl-2-pyrimidinyl | (A-3.11) |
| 4-Trifluoromethyl-5-methyl-2-pyrimidinyl | (A-3.12) |
| 4-Methyl-5-trifluoromethyl-2-pyrimidinyl | (A-3.13) |

Another preferred embodiment of the invention relates to methods and uses comprising 3-pyridiyl compounds of the formulae I or II, the salts thereof, the N-oxides thereof or the salts of the N-oxides thereof, wherein X¹, X², X³, R¹, R² and R³ are as defined above and in particular have one of the preferred meanings and wherein A is a radical A-4,

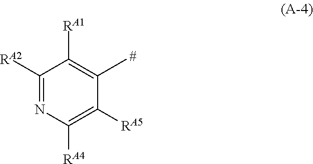

wherein #, R^{A1}, R^{A2}, R^{A4} and R^{A5} are as defined herein.

Among the methods and uses comprising compounds of formulae I or II wherein A is A-4, preference is given to those methods and uses, wherein R^{A1} and R^{A5} are selected independently of each other from hydrogen, halogen, CN, NO₂, C₁-C₄-alkyl, C₁-C₄-haloalkyl, C₁-C₄-alkoxy, C₁-C₄-haloalkoxy, C₁-C₄-alkylsulfinyl, C₁-C₄-haloalkylsulfinyl, C₁-C₄-alkylsulfonyl, C₁-C₄-haloalkylsulfonyl, C₁-C₅-alkylen-CN, C₁-C₅-alkylen-OR^{a}, C₁-C₅-alkylen-C(Y)R^{b} and C₁-C₅-alkylen-C(Y)OR^{c}, C₃-C₁₀-cycloalkyl, C₅-C₁₀-cycloalkenyl, saturated 3- to 10-membered heterocyclyl, C₃-C₁₀-cycloalkyl-C₁-C₅-alkyl, C₅-C₁₀-cycloalkenyl-C₁-C₅-alkyl, 3- to 10-membered heterocyclyl-C₁-C₅-alkyl, wherein cycloalkyl, cycloalkenyl and heterocyclyl in the 6 last mentioned radicals may be unsubstituted or may carry 1, 2, 3, 4 or 5 identical or different substituents R^{y}, wherein Y is defined herein and in particular is oxygen, wherein R^{a}, R^{b} and R^{c} are as defined herein and in particular are selected independently of each other from the group consisting of hydrogen, C₁-C₄-alkyl, C₁-C₄-haloalkyl, C₁-C₄-alkoxy-C₁-C₄-alkyl, heterocyclyl-C₁-C₄-alkyl and hetaryl-C₁-C₄-alkyl, more preferably from the group consisting of hydrogen, C₁-C₄-alkyl and C₁-C₄-alkoxy-C₁-C₂-alkyl, and most preferably from the group consisting of hydrogen, methyl and ethyl, and wherein the substituents R^{y} are as defined herein and in particular are selected independently of each other from halogen, NO₂, C₁-C₄-alkyl, C₁-C₄-haloalkyl, C₁-C₄-alkoxy, C₁-C₄-haloalkoxy, C₁-C₄-alkylsulfonyl and C₁-C₄-haloalkylsulfonyl.

More preferably R^{A1} and R^{A5} are selected independently of each other from hydrogen, halogen, C₁-C₄-alkyl, C₁-C₄-haloalkyl, C₁-C₄-alkoxy, C₁-C₄-haloalkoxy, C₁-C₃-alkylen-CN, C₁-C₃-alkylen-OR^{a}, C₃-C₇-cycloalkyl, C₃-C₇-cycloalkyl-C₁-C₃-alkyl, and 3- to 7-membered saturated heterocyclyl-C₁-C₃-alkyl, wherein cycloalkyl and heterocyclyl in the 3 last mentioned radicals may be unsubstituted or may carry 1, 2, 3, 4 or 5 identical or different substituents R^{y}, wherein R^{a} is as defined herein and in particular is selected from the group consisting of hydrogen, C₁-C₄-alkyl, C₁-C₄-haloalkyl and C₁-C₄-alkoxy-C₁-C₂-alkyl, and specifically from the group consisting of hydrogen, methyl, ethyl, difluormethyl and trifluoromethyl, and wherein the substituents R^{y} are as defined herein and in particular are selected independently of each other from halogen, NO₂, C₁-C₄-alkyl, C₁-C₄-haloalkyl, C₁-C₄-alkoxy, C₁-C₄-haloalkoxy, C₁-C₄-alkylsulfonyl and C₁-C₄-haloalkylsulfonyl.

Even more preferably R^{A1} and R^{A5} are selected independently of each other from hydrogen, fluorine, chlorine, bromine, methyl, ethyl, n-propyl, isopropyl, cyclopropyl, isobutyl, cyclopropylmethyl, fluoromethyl, difluoromethyl, trifluoromethyl, 1-fluoroethyl, 2-fluoroethyl, 2,2,2-trifluoroethyl, methoxymethyl, difluoromethoxymethyl, trifluoromethoxymethyl, cyanomethyl, 2-methoxy-1-ethyl, 2-difluoromethoxy-1-ethyl, 2-trifluoromethoxy-1-ethyl, and 2-cyano-1-ethyl.

Among the methods and uses comprising compounds of formulae I or II wherein A is A-4, preference is further given to those methods and uses, wherein R^{A2} and R^{A4} are selected independently of each other from hydrogen, halogen, CN, NO₂, C₁-C₄-alkyl, C₁-C₄-haloalkyl, C₁-C₄-alkoxy, C₁-C₄-haloalkoxy, C₁-C₄-alkylthio, C₁-C₄-haloalkylthio, C₁-C₄-alkylsulfinyl, C₁-C₄-haloalkylsulfinyl, C₁-C₄-alkylsulfonyl, C₁-C₄-haloalkylsulfonyl, C₁-C₅-alkylen-CN, C₁-C₅-alkylen-OR^{a}, C₁-C₅-alkylen-C(Y)R^{b}, C₁-C₅-alkylen-C(Y)OR^{c}, C₃-C₁₀-cycloalkyl, C₅-C₁₀-cycloalkenyl, saturated 3- to 10-membered heterocyclyl, C₃-C₁₀-cycloalkyl-C₁-C₅-alkyl, C₅-C₁₀-cycloalkenyl-C₁-C₅-alkyl, saturated or partially unsaturated 3- to 10-membered heterocyclyl-C₁-C₅-alkyl, wherein cycloalkyl, cycloalkenyl and heterocyclyl in the 6 last mentioned radicals may be unsubstituted or may carry 1, 2, 3, 4 or 5 identical or different substituents R^{y}, wherein Y is defined herein and in particular is oxygen, wherein R^{a}, R^{b} and R^{c} are as defined herein and in particular are selected independently of each other from the group consisting of hydrogen, C₁-C₄-alkyl, C₁-C₄-haloalkyl, C₁-C₄-alkoxy-C₁-C₄-alkyl, heterocyclyl-C₁-C₄-alkyl and hetaryl-C₁-C₄-alkyl, more preferably from the group consisting of hydrogen, C₁-C₄-alkyl and C₁-C₄-alkoxy-C₁-C₂-alkyl, and most preferably from the group consisting of hydrogen, methyl and ethyl, and wherein the substituents R^{y} are as defined herein and in particular are selected independently of each other from halogen, NO₂, C₁-C₄-alkyl, C₁-C₄-haloalkyl, C₁-C₄-alkoxy, C₁-C₄-haloalkoxy, C₁-C₄-alkylsulfonyl and C₁-C₄-haloalkylsulfonyl.

More preferably R^{A2} and R^{A4} are selected independently of each other from hydrogen, halogen, C₁-C₄-alkyl, C₁-C₄-haloalkyl, C₁-C₄-alkoxy, C₁-C₄-haloalkoxy, C₁-C₃-alkylen-CN, C₁-C₃-alkylen-OR^{a}, C₃-C₇-cycloalkyl, C₃-C₇-cycloalkyl-C₁-C₃-alkyl, and 3- to 7-membered saturated heterocyclyl-C₁-C₃-alkyl, wherein cycloalkyl and heterocyclyl in the 3 last mentioned radicals may be unsubstituted or may carry 1, 2, 3, 4 or 5 identical or different substituents R^{y}, wherein R^{a} is as defined herein and in particular is selected from the group consisting of hydrogen, C₁-C₄-alkyl, C₁-C₄-haloalkyl and C₁-C₄-alkoxy-C₁-C₂-alkyl, and specifically from the group consisting of hydrogen, methyl, ethyl, difluormethyl and trifluoromethyl, and wherein the substituents R^{y} are as defined herein and in particular are selected independently of each other from halogen, NO₂, C₁-C₄-alkyl, C₁-C₄-haloalkyl, C₁-C₄-alkoxy, C₁-C₄-haloalkoxy, C₁-C₄-alkylsulfonyl and C₁-C₄-haloalkylsulfonyl.

Even more preferably R^{A2} and R^{A4} are selected independently of each other from hydrogen, fluorine, chlorine, bromine, methyl, ethyl, n-propyl, isopropyl, cyclopropyl, isobutyl, cyclopropylmethyl, fluoromethyl, difluoromethyl, trifluoromethyl, 1-fluoroethyl, 2-fluoroethyl, 2,2,2-trifluoroethyl, methoxymethyl, difluoromethoxymethyl, trifluoromethoxymethyl, cyanomethyl, 2-methoxy-1-ethyl, 2-difluoromethoxy-1-ethyl, 2-trifluoromethoxy-1-ethyl, and 2-cyano-1-ethyl.

Preferably two or three of the substituents R^{A1}, R^{A2}, R^{A4} and R^{A5} are hydrogen.

Examples of suitable radicals A-4 are the radicals of formulae A-4.1 to A-4.11, as defined in Table A4.

TABLE A4

| | |
|---|---|
| 4-Pyridyl | (A-4.1) |
| 2-Methyl-4-pyridyl | (A-4.2) |
| 2-Chloro-4-pyridyl | (A-4.3) |
| 2-Methoxy-4-pyridyl | (A-4.4) |
| 2-Nitro-4-pyridyl | (A-4.5) |
| 2-Trifluoromethyl-4-pyridyl | (A-4.6) |
| 2-Bromo-4-pyridyl | (A-4.7) |
| 2,3-Dimethyl-4-pyridyl | (A-4.8) |
| 2,5-Dimethyl-4-pyridyl | (A-4.9) |
| 2,6-Dimethyl-4-pyridyl | (A-4.10) |
| 3-Trifluoromethyl-4-pyridyl | (A-4.11) |

Another preferred embodiment of the invention relates to methods and uses comprising 3-pyridiyl compounds of the formulae I or II, the salts thereof, the N-oxides thereof or the salts of the N-oxides thereof, wherein X¹, X², X³, R¹, R² and R³ are as defined above and in particular have one of the preferred meanings and wherein A is a radical A-5,

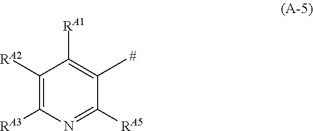

wherein #, R^{A1}, R^{A2}, R^{A3} and R^{A5} are as defined herein.

Among the methods and uses comprising compounds of formulae I or II wherein A is A-5, preference is given to those methods and uses, wherein R^{A1} and R^{A5} are selected independently of each other from hydrogen, halogen, CN, NO₂, C₁-C₄-alkyl, C₁-C₄-haloalkyl, C₁-C₄-alkoxy, C₁-C₄-haloalkoxy, C₁-C₄-alkylsulfinyl, C₁-C₄-haloalkylsulfinyl, C₁-C₄-alkylsulfonyl, C₁-C₄-haloalkylsulfonyl, C₁-C₅-alkylen-CN, C₁-C₅-alkylen-OR^{a}, C₁-C₅-alkylen-C(Y)R^{b} and C₁-C₅-alkylen-C(Y)OR^{b}, C₃-C₁₀-cycloalkyl, C₅-C₁₀-cycloalkenyl, saturated 3- to 10-membered heterocyclyl, C₃-C₁₀-cycloalkyl-C₁-C₅-alkyl, C₅-C₁₀-cycloalkenyl-C₁-C₅-alkyl, 3- to 10-membered heterocyclyl-C₁-C₅-alkyl, wherein cycloalkyl, cycloalkenyl and heterocyclyl in the 6 last mentioned radicals may be unsubstituted or may carry 1, 2, 3, 4 or 5 identical or different substituents R^{y}, wherein Y is defined herein and in particular is oxygen, wherein R^{a}, R^{b} and R^{c} are as defined herein and in particular are selected independently of each other from the group consisting of hydrogen, C₁-C₄-alkyl, C₁-C₄-haloalkyl, C₁-C₄-alkoxy-C₁-C₄-alkyl, heterocyclyl-C₁-C₄-alkyl and hetaryl-C₁-C₄-alkyl, more preferably from the group consisting of hydrogen, C₁-C₄-alkyl and C₁-C₄-alkoxy-C₁-C₂-alkyl, and most preferably from the group consisting of hydrogen, methyl and ethyl, and wherein the substituents R^{y} are as defined herein and in particular are selected independently of each other from halogen, NO₂, C₁-C₄-alkyl, C₁-C₄-haloalkyl, C₁-C₄-alkoxy, C₁-C₄-haloalkoxy, C₁-C₄-alkylsulfonyl and C₁-C₄-haloalkylsulfonyl.

More preferably R^{A1} and R^{A5} are selected independently of each other from hydrogen, halogen, C₁-C₄-alkyl, C₁-C₄-haloalkyl, C₁-C₄-alkoxy, C₁-C₄-haloalkoxy, C₁-C₃-alkylen-CN, C₁-C₃-alkylen-OR^{a}, C₃-C₇-cycloalkyl, C₃-C₇-cycloalkyl-C₁-C₃-alkyl, and 3- to 7-membered saturated heterocyclyl-C₁-C₃-alkyl, wherein cycloalkyl and heterocyclyl in the 3 last mentioned radicals may be unsubstituted or may carry 1, 2, 3, 4 or 5 identical or different substituents R^{y}, wherein R^{a} is as defined herein and in particular is selected from the group consisting of hydrogen, C₁-C₄-alkyl, C₁-C₄-haloalkyl and C₁-C₄-alkoxy-C₁-C₂-alkyl, and specifically from the group consisting of hydrogen, methyl, ethyl, difluormethyl and trifluoromethyl, and wherein the substituents R^{y} are as defined herein and in particular are selected independently of each other from halogen, NO₂, C₁-C₄-alkyl, C₁-C₄-haloalkyl, C₁-C₄-alkoxy, C₁-C₄-haloalkoxy, C₁-C₄-alkylsulfonyl and C₁-C₄-haloalkylsulfonyl.

Even more preferably R^{A1} and R^{A5} are selected independently of each other from hydrogen, fluorine, chlorine, bromine, methyl, ethyl, n-propyl, isopropyl, cyclopropyl, isobutyl, cyclopropylmethyl, fluoromethyl, difluoromethyl, trifluoromethyl, 1-fluoroethyl, 2-fluoroethyl, 2,2,2-trifluoroethyl, methoxymethyl, difluoromethoxymethyl, trifluoromethoxymethyl, cyanomethyl, 2-methoxy-1-ethyl, 2-difluoromethoxy-1-ethyl, 2-trifluoromethoxy-1-ethyl, and 2-cyano-1-ethyl.

Among the methods and uses comprising compounds of formulae I or II wherein A is A-5, preference is further given to those methods and uses, wherein R^{A2} is selected from hydrogen, halogen, CN, NO₂, C₁-C₄-alkyl, C₁-C₄-haloalkyl, C₁-C₄-alkoxy, C₁-C₄-haloalkoxy, C₁-C₄-alkylthio, C₁-C₄-haloalkylthio, C₁-C₄-alkylsulfinyl, C₁-C₄-haloalkylsulfinyl, C₁-C₄-alkylsulfonyl, C₁-C₄-haloalkylsulfonyl, C₁-C₅-alkylen-CN, C₁-C₅-alkylen-OR^{a}, C₁-C₅-alkylen-C(Y)R^{b}, C₁-C₅-alkylen-C(Y)OR^{c}, C₃-C₁₀-cycloalkyl, C₅-C₁₀-cycloalkenyl, saturated 3- to 10-membered heterocyclyl, C₃-C₁₀-cycloalkyl-C₁-C₅-alkyl, C₅-C₁₀-cycloalkenyl-C₁-C₅-alkyl, saturated or partially unsaturated 3- to 10-membered heterocyclyl-C₁-C₅-alkyl, wherein cycloalkyl, cycloalkenyl and heterocyclyl in the 6 last mentioned radicals may be unsubstituted or may carry 1, 2, 3, 4 or 5 identical or different substituents R^{y}, wherein Y is defined herein and in particular is oxygen, wherein R^{a}, R^{b} and R^{c} are as defined herein and in particular are selected independently of each other from the group consisting of hydrogen, C₁-C₄-alkyl, C₁-C₄-haloalkyl, C₁-C₄-alkoxy-C₁-C₄-alkyl, heterocyclyl-C₁-C₄-alkyl and hetaryl-C₁-C₄-alkyl, more preferably from the group consisting of hydrogen, C₁-C₄-alkyl and C₁-C₄-alkoxy-C₁-C₂-alkyl, and most preferably from the group consisting of hydrogen, methyl and ethyl, and wherein the substituents R^{y} are as defined herein and in particular are selected independently of each other from halogen, NO₂, C₁-C₄-alkyl, C₁-C₄-haloalkyl, C₁-C₄-alkoxy, C₁-C₄-haloalkoxy, C₁-C₄-alkylsulfonyl and C₁-C₄-haloalkylsulfonyl.

More preferably R^{A2} is selected from hydrogen, halogen, C₁-C₄-alkyl, C₁-C₄-haloalkyl, C₁-C₄-alkoxy, C₁-C₄-haloalkoxy, C₁-C₃-alkylen-CN, C₁-C₃-alkylen-OR^{a}, C₃-C₇-cycloalkyl, C₃-C₇-cycloalkyl-C₁-C₃-alkyl, and 3- to 7-membered saturated heterocyclyl-C₁-C₃-alkyl, wherein cycloalkyl and heterocyclyl in the 3 last mentioned radicals may be unsubstituted or may carry 1, 2, 3, 4 or 5 identical or different substituents R^{y}, wherein R^{a} is as defined herein and in particular is selected from the group consisting of hydrogen, C₁-C₄-alkyl, C₁-C₄-haloalkyl and C₁-C₄-alkoxy-C₁-C₂-alkyl, and specifically from the group consisting of hydrogen, methyl, ethyl, difluormethyl and trifluoromethyl, and wherein the substituents R^{y} are as defined herein and in particular are selected independently of each other from halogen, NO₂, C₁-C₄-alkyl, C₁-C₄-haloalkyl, C₁-C₄-alkoxy, C₁-C₄-haloalkoxy, C₁-C₄-alkylsulfonyl and C₁-C₄-haloalkylsulfonyl.

Even more preferably R^{A2} is selected from hydrogen, fluorine, chlorine, bromine, methyl, ethyl, n-propyl, isopropyl, cyclopropyl, isobutyl, cyclopropylmethyl, fluoromethyl, difluoromethyl, trifluoromethyl, 1-fluoroethyl, 2-fluoroethyl, 2,2,2-trifluoroethyl, methoxymethyl, difluoromethoxymethyl, trifluoromethoxymethyl, cyanomethyl, 2-methoxy-1-ethyl, 2-difluoromethoxy-1-ethyl, 2-trifluoromethoxy-1-ethyl, and 2-cyano-1-ethyl.

Among the methods and uses comprising compounds of formulae I or II wherein A is A-5, preference is further given to those methods and uses, wherein R^{A3} is selected from hydrogen, halogen, CN, NO₂, C₁-C₄-alkyl, C₁-C₄-haloalkyl, C₁-C₄-alkoxy, C₁-C₄-haloalkoxy, C₁-C₄-alkylthio, C₁-C₄-haloalkylthio, C₁-C₄-alkylsulfinyl, C₁-C₄-haloalkylsulfinyl, C₁-C₄-alkylsulfonyl, C₁-C₄-haloalkylsulfonyl, C₁-C₅-alkylen-CN, C₁-C₅-alkylen-OR^{a}, C₁-C₅-alkylen-C(Y)R^{b}, C₁-C₅-alkylen-C(Y)OR^{c}, C₃-C₁₀-cycloalkyl, C₅-C₁₀-cycloalkenyl, saturated 3 to 10 membered heterocyclyl, C₃-C₁₀-cycloalkyl-C₁-C₅-alkyl, C₅-C₁₀-cycloalkenyl-C₁-C₅-alkyl and 3- to 10-membered heterocyclyl-C₁-C₅-alkyl, wherein cycloalkyl, cycloalkenyl and heterocyclyl in the 6 last mentioned radicals may be unsubstituted or may carry 1, 2, 3, 4 or 5 identical or different substituents R^{y}, wherein Y is defined herein and in particular is oxygen, wherein R^{a}, R^{b} and R^{c} are as defined herein and in particular are selected independently of each other from the group consisting of hydrogen, C₁-C₄-alkyl, C₁-C₄-haloalkyl, C₁-C₄-alkoxy-C₁-C₄-alkyl, heterocyclyl-C₁-C₄-alkyl and hetaryl-C₁-C₄-alkyl, more preferably from the group consisting of hydrogen, C₁-C₄-alkyl and C₁-C₄-alkoxy-C₁-C₂-alkyl, and most preferably from the group consisting of hydrogen, methyl and ethyl, and wherein the substituents R^{y} are as defined herein and in particular are selected independently of each other from halogen, NO₂, C₁-C₄-alkyl, C₁-C₄-haloalkyl, C₁-C₄-alkoxy, C₁-C₄-haloalkoxy, C₁-C₄-alkylsulfonyl and C₁-C₄-haloalkylsulfonyl.

More preferably R^{A3} is selected from hydrogen, halogen, C₁-C₄-alkyl, C₁-C₄-haloalkyl, C₁-C₄-alkoxy, C₁-C₄-haloalkoxy, C₁-C₃-alkylen-CN, C₁-C₃-alkylen-OR^{a}, C₃-C₇-cycloalkyl, C₃-C₇-cycloalkyl-C₁-C₃-alkyl, and 3- to 7-membered saturated heterocyclyl-C₁-C₃-alkyl, wherein cycloalkyl and heterocyclyl in the 3 last mentioned radicals may be unsubstituted or may carry 1, 2, 3, 4 or 5 identical or different substituents R^{y}, wherein R^{a} is as defined herein and in particular is selected from the group consisting of hydrogen, C₁-C₄-alkyl, C₁-C₄-haloalkyl and C₁-C₄-alkoxy-C₁-C₂-alkyl, and specifically from the group consisting of hydrogen, methyl, ethyl, difluormethyl and trifluoromethyl, and wherein the substituents R^{y} are as defined herein and in particular are selected independently of each other from halogen, NO₂, C₁-C₄-alkyl, C₁-C₄-haloalkyl, C₁-C₄-alkoxy, C₁-C₄-haloalkoxy, C₁-C₄-alkylsulfonyl and C₁-C₄-haloalkylsulfonyl.

Even more preferably R^{A3} is selected from hydrogen, fluorine, chlorine, bromine, methyl, ethyl, n-propyl, isopropyl, cyclopropyl, isobutyl, cyclopropylmethyl, fluoromethyl, difluoromethyl, trifluoromethyl, 1-fluoroethyl, 2-fluoroethyl, 2,2,2-trifluoroethyl, methoxymethyl, difluoromethoxymethyl, trifluoromethoxymethyl, cyanomethyl, 2-methoxy-1-ethyl, 2-difluoromethoxy-1-ethyl, 2-trifluoromethoxy-1-ethyl, and 2-cyano-1-ethyl.

Preferably two or three of the substituents R^{A1}, R^{A2}, R^{A3} and R^{A5} are hydrogen.

Examples of suitable radicals A-5 are the radicals of formulae A-5.1 to A-5.49, as defined in Table A5.

TABLE A5

| | |
|---|---|
| 3-Pyridyl | (A-5.1) |
| 2-Methyl-3-pyridyl | (A-5.2) |
| 2-Chloro-3-pyridyl | (A-5.3) |
| 2-Methoxy-3-pyridyl | (A-5.4) |
| 2-Nitro-3-pyridyl | (A-5.5) |
| 2-Trifluoromethyl-3-pyridyl | (A-5.6) |
| 4-Bromo-3-pyridyl | (A-5.7) |
| 4-Methyl-3-pyridyl | (A-5.8) |
| 4-Chloro-3-pyridyl | (A-5.9) |
| 4-Methoxy-3-pyridyl | (A-5.10) |
| 4-Nitro-3-pyridyl | (A-5.11) |
| 4-Trifluoromethyl-3-pyridyl | (A-5.12) |
| 4-Bromo-3-pyridyl | (A-5.13) |
| 5-Methyl-3-pyridyl | (A-5.14) |
| 5-Chloro-3-pyridyl | (A-5.15) |
| 5-Methoxy-3-pyridyl | (A-5.16) |
| 5-Nitro-3-pyridyl | (A-5.17) |
| 5-Trifluoromethyl-3-pyridyl | (A-5.18) |
| 5-Bromo-3-pyridyl | (A-5.19) |
| 6-Methyl-3-pyridyl | (A-5.20) |
| 6-Chloro-3-pyridyl | (A-5.21) |
| 6-Methoxy-3-pyridyl | (A-5.22) |
| 6-Nitro-3-pyridyl | (A-5.23) |
| 6-Trifluoromethyl-3-pyridyl | (A-5.24) |
| 6-Bromo-3-pyridyl | (A-5.25) |
| 2,4-Dimethyl-3-pyridyl | (A-5.26) |
| 2,5-Dimethyl-3-pyridyl | (A-5.27) |
| 2,6-Dimethyl-3-pyridyl | (A-5.28) |
| 2,4-Dichloro-3-pyridyl | (A-5.29) |
| 2,5-Dichloro-3-pyridyl | (A-5.30) |
| 2,6-Dichloro-3-pyridyl | (A-5.31) |
| 2-Methyl-4-chloro-3-pyridyl | (A-5.32) |
| 2-Methyl-5-chloro-3-pyridyl | (A-5.33) |
| 2-Methyl-6-chloro-3-pyridyl | (A-5.34) |
| 2-Chloro-4-methyl-3-pyridyl | (A-5.35) |
| 2-Chloro-5-methyl-3-pyridyl | (A-5.36) |
| 2-Chloro-6-methyl-3-pyridyl | (A-5.37) |
| 2-Chloro-4-trifluoromethyl-3-pyridyl | (A-5.38) |
| 2-Chloro-5-trifluoromethyl-3-pyridyl | (A-5.39) |
| 2-Chloro-6-trifluormethyl-3-pyridyl | (A-5.40) |
| 2-Methyl-4-trifluormethyl-3-pyridyl | (A-5.41) |
| 2-Methyl-5-trifluormethyl-3-pyridyl | (A-5.42) |
| 2-Methyl-6-trifluormethyl-3-pyridyl | (A-5.43) |
| 6-Chloro-2-trifluoromethyl-3-pyridyl | (A-5.44) |
| 6-Chloro-4-trifluoromethyl-3-pyridyl | (A-5.45) |
| 6-Chloro-5-trifluormethyl-3-pyridyl | (A-5.45) |
| 6-Chloro-2-methyl-3-pyridyl | (A-5.47) |
| 6-Chloro-4-methyl-3-pyridyl | (A-5.48) |
| 6-Chloro-5-methyl-3-pyridyl | (A-5.49) |

Another preferred embodiment of the invention relates to methods and uses comprising 3-pyridiyl compounds of the formulae I or II, the salts thereof, the N-oxides thereof or the salts of the N-oxides thereof, wherein X¹, X², X³, R¹, R² and R³ are as defined above and in particular have one of the preferred meanings and wherein A is a radical A-6,

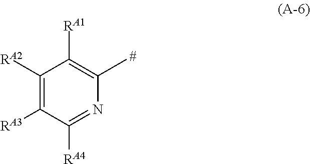

wherein #, R^{A1}, R^{A2}, R^{A3} and R^{A4} are as defined herein.

Among the methods and uses comprising compounds of formulae I or II wherein A is A-6, preference is given to those methods and uses, wherein R^{A1} is selected from hydrogen, halogen, CN, NO₂, C₁-C₄-alkyl, C₁-C₄-haloalkyl, C₁-C₄-alkoxy, C₁-C₄-haloalkoxy, C₁-C₄-alkylsulfinyl, C₁-C₄-haloalkylsulfinyl, C₁-C₄-alkylsulfonyl, C₁-C₄-haloalkylsulfonyl, C₁-C₅-alkylen-CN, C₁-C₅-alkylen-OR^{a}, C₁-C₅-alkylen-C(Y)R^{b} and C₁-C₅-alkylen-C(Y)OR^{c}, C₃-C₁₀-cycloalkyl, C₅-C₁₀-cycloalkenyl, saturated 3- to 10-membered heterocyclyl, C₃-C₁₀-cycloalkyl-C₁-C₅-alkyl, C₅-C₁₀-cycloalkenyl-C₁-C₅-alkyl, 3- to 10-membered heterocyclyl-C₁-C₅-alkyl, wherein cycloalkyl, cycloalkenyl and heterocyclyl in the 6 last mentioned radicals may be unsubstituted or may carry 1, 2, 3, 4 or 5 identical or different substituents R^{y}, wherein Y is defined herein and in particular is oxygen, wherein R^{a}, R^{b} and R^{c} are as defined herein and in particular are selected independently of each other from the group consisting of hydrogen, C₁-C₄-alkyl, C₁-C₄-haloalkyl, C₁-C₄-alkoxy-C₁-C₄-alkyl, heterocyclyl-C₁-C₄-alkyl and hetaryl-C₁-C₄-alkyl, more preferably from the group consisting of hydrogen, C₁-C₄-alkyl and C₁-C₄-alkoxy-C₁-C₂-alkyl, and most preferably from the group consisting of hydrogen, methyl and ethyl, and wherein the substituents R^{y} are as defined herein and in particular are selected independently of each other from halogen, NO₂, C₁-C₄-alkyl, C₁-C₄-haloalkyl, C₁-C₄-alkoxy, C₁-C₄-haloalkoxy, C₁-C₄-alkylsulfonyl and C₁-C₄-haloalkylsulfonyl.

More preferably R^{A1} is selected from hydrogen, halogen, C₁-C₄-alkyl, C₁-C₄-haloalkyl, C₁-C₄-alkoxy, C₁-C₄-haloalkoxy, C₁-C₃-alkylen-CN, C₁-C₃-alkylen-OR^{a}, C₃-C₇-cycloalkyl, C₃-C₇-cycloalkyl-C₁-C₃-alkyl, and 3- to 7-membered saturated heterocyclyl-C₁-C₃-alkyl, wherein cycloalkyl and heterocyclyl in the 3 last mentioned radicals may be unsubstituted or may carry 1, 2, 3, 4 or 5 identical or different substituents R^{y}, wherein R R^{a} is as defined herein and in particular is selected from the group consisting of hydrogen, C₁-C₄-alkyl, C₁-C₄-haloalkyl and C₁-C₄-alkoxy-C₁-C₂-alkyl, and specifically from the group consisting of hydrogen, methyl, ethyl, difluormethyl and trifluoromethyl, and wherein the substituents R^{y} are as defined herein and in particular are selected independently of each other from halogen, NO₂, C₁-C₄-alkyl, C₁-C₄-haloalkyl, C₁-C₄-alkoxy, C₁-C₄-haloalkoxy, C₁-C₄-alkylsulfonyl and C₁-C₄-haloalkylsulfonyl.

Even more preferably R^{A1} is selected from hydrogen, fluorine, chlorine, bromine, methyl, ethyl, n-propyl, isopropyl, cyclopropyl, isobutyl, cyclopropylmethyl, fluoromethyl, difluoromethyl, trifluoromethyl, 1-fluoroethyl, 2-fluoroethyl, 2,2,2-trifluoroethyl, methoxymethyl, difluoromethoxymethyl, trifluoromethoxymethyl, cyanomethyl, 2-methoxy-1-ethyl, 2-difluoromethoxy-1-ethyl, 2-trifluoromethoxy-1-ethyl, and 2-cyano-1-ethyl.

Among the methods and uses comprising compounds of formulae I or II wherein A is A-6, preference is further given to those methods and uses, wherein R^{A2} and R^{A4} are selected independently of each other from hydrogen, halogen, CN, NO₂, C₁-C₄-alkyl, C₁-C₄-haloalkyl, C₁-C₄-alkoxy, C₁-C₄-haloalkoxy, C₁-C₄-alkylthio, C₁-C₄-haloalkylthio, C₁-C₄-alkylsulfinyl, C₁-C₄-haloalkylsulfinyl, C₁-C₄-alkylsulfonyl, C₁-C₄-haloalkylsulfonyl, C₁-C₅-alkylen-CN, C₁-C₅-alkylen-OR^{a}, C₁-C₅-alkylen-C(Y)R^{b}, C₁-C₅-alkylen-C(Y)OR^{c}, C₃-C₁₀-cycloalkyl, C₅-C₁₀-cycloalkenyl, saturated 3- to 10-membered heterocyclyl, C₃-C₁₀-cycloalkyl-C₁-C₅-alkyl, C₅-C₁₀-cycloalkenyl-C₁-C₅-alkyl, saturated or partially unsaturated 3- to 10-membered heterocyclyl-C₁-C₅-alkyl, wherein cycloalkyl, cycloalkenyl and heterocyclyl in the 6 last mentioned radicals may be unsubstituted or may carry 1, 2, 3, 4 or 5 identical or different substituents R^{y}, wherein Y is defined herein and in particular is oxygen, wherein R^{a}, R^{b} and R^{c} are as defined herein and in particular are selected independently of each other from the group consisting of hydrogen, C₁-C₄-alkyl, C₁-C₄-haloalkyl, C₁-C₄-alkoxy-C₁-C₄-alkyl, heterocyclyl-C₁-C₄-alkyl and hetaryl-C₁-C₄-alkyl, more preferably from the group consisting of hydrogen, C₁-C₄-alkyl and C₁-C₄-alkoxy-C₁-C₂-alkyl, and most preferably from the group consisting of hydrogen, methyl and ethyl, and wherein the substituents R^{y} are as defined herein and in particular are selected independently of each other from halogen, NO₂, C₁-C₄-alkyl, C₁-C₄-haloalkyl, C₁-C₄-alkoxy, C₁-C₄-haloalkoxy, C₁-C₄-alkylsulfonyl and C₁-C₄-haloalkylsulfonyl.

More preferably R^{A2} and R^{A4} are selected independently of each other from hydrogen, halogen, C₁-C₄-alkyl, C₁-C₄-haloalkyl, C₁-C₄-alkoxy, C₁-C₄-haloalkoxy, C₁-C₃-alkylen-CN, C₁-C₃-alkylen-OR^{a}, C₃-C₇-cycloalkyl, C₃-C₇-cycloalkyl-C₁-C₃-alkyl, and 3- to 7-membered saturated heterocyclyl-C₁-C₃-alkyl, wherein cycloalkyl and heterocyclyl in the 3 last mentioned radicals may be unsubstituted or may carry 1, 2, 3, 4 or 5 identical or different substituents R^{y}, wherein R^{a} is as defined herein and in particular is selected from the group consisting of hydrogen, C₁-C₄-alkyl, C₁-C₄-haloalkyl and C₁-C₄-alkoxy-C₁-C₂-alkyl, and specifically from the group consisting of hydrogen, methyl, ethyl, difluormethyl and trifluoromethyl, and wherein the substituents R^{y} are as defined herein and in particular are selected independently of each other from halogen, NO₂, C₁-C₄-alkyl, C₁-C₄-haloalkyl, C₁-C₄-alkoxy, C₁-C₄-haloalkoxy, C₁-C₄-alkylsulfonyl and C₁-C₄-haloalkylsulfonyl.

Even more preferably R^{A2} and R^{A4} are selected independently of each other from hydrogen, fluorine, chlorine, bromine, methyl, ethyl, n-propyl, isopropyl, cyclopropyl, isobutyl, cyclopropylmethyl, fluoromethyl, difluoromethyl, trifluoromethyl, 1-fluoroethyl, 2-fluoroethyl, 2,2,2-trifluoroethyl, methoxymethyl, difluoromethoxymethyl, trifluoromethoxymethyl, cyanomethyl, 2-methoxy-1-ethyl, 2-difluoromethoxy-1-ethyl, 2-trifluoromethoxy-1-ethyl, and 2-cyano-1-ethyl.

Among the methods and uses comprising compounds of formulae I or II wherein A is A-6, preference is further given to those methods and uses, wherein R^{A3} is selected from hydrogen, halogen, CN, NO₂, C₁-C₄-alkyl, C₁-C₄-haloalkyl, C₁-C₄-alkoxy, C₁-C₄-haloalkoxy, C₁-C₄-alkylthio, C₁-C₄-haloalkylthio, C₁-C₄-alkylsulfinyl, C₁-C₄-haloalkylsulfinyl, C₁-C₄-alkylsulfonyl, C₁-C₄-haloalkylsulfonyl, C₁-C₅-alkylen-CN, C₁-C₅-alkylen-OR^{a}, C₁-C₅-alkylen-C(Y)R^{b}, C₁-C₅-alkylen-C(Y)OR^{c}, C₃-C₁₀-cycloalkyl, C₅-C₁₀-cycloalkenyl, saturated 3 to 10 membered heterocyclyl, C₃-C₁₀-cycloalkyl-C₁-C₅-alkyl, C₅-C₁₀-cycloalkenyl-C₁-C₅-alkyl and 3- to 10-membered heterocyclyl-C₁-C₅-alkyl, wherein cycloalkyl, cycloalkenyl and heterocyclyl in the 6 last mentioned radicals may be unsubstituted or may carry 1, 2, 3, 4 or 5 identical or different substituents R^{y}, wherein Y is defined herein and in particular is oxygen, wherein R^{a}, R^{b} and R^{c} are as defined herein and in particular are selected independently of each other from the group consisting of hydrogen, C₁-C₄-alkyl, C₁-C₄-haloalkyl, C₁-C₄-alkoxy-C₁-C₄-alkyl, heterocyclyl-C₁-C₄-alkyl and hetaryl-C₁-C₄-alkyl, more preferably from the group consisting of hydrogen, C₁-C₄-alkyl and C₁-C₄-alkoxy-C₁-C₂-alkyl, and most preferably from the group consisting of hydrogen, methyl and ethyl, and wherein the substituents R^{y} are as defined herein and in particular are selected independently of each other from halogen, NO₂, C₁-C₄-alkyl, C₁-C₄-haloalkyl, C₁-C₄-alkoxy, C₁-C₄-haloalkoxy, C₁-C₄-alkylsulfonyl and C₁-C₄-haloalkylsulfonyl.

More preferably R^{A3} is selected from hydrogen, halogen, C₁-C₄-alkyl, C₁-C₄-haloalkyl, C₁-C₄-alkoxy, C₁-C₄-haloalkoxy, C₁-C₃-alkylen-CN, C₁-C₃-alkylen-OR^{a}, C₃-C₇-cycloalkyl, C₃-C₇-cycloalkyl-C₁-C₃-alkyl, and 3- to 7-membered saturated heterocyclyl-C₁-C₃-alkyl, wherein cycloalkyl and heterocyclyl in the 3 last mentioned radicals may be unsubstituted or may carry 1, 2, 3, 4 or 5 identical or different substituents R^{y}, wherein R^{a} is as defined herein and in particular is selected from the group consisting of hydrogen, C₁-C₄-alkyl, C₁-C₄-haloalkyl and C₁-C₄-alkoxy-C₁-C₂-alkyl, and specifically from the group consisting of hydrogen, methyl, ethyl, difluormethyl and trifluoromethyl, and wherein the substituents R^{y} are as defined herein and in particular are selected independently of each other from halogen, NO₂, C₁-C₄-alkyl, C₁-C₄-haloalkyl, C₁-C₄-alkoxy, C₁-C₄-haloalkoxy, C₁-C₄-alkylsulfonyl and C₁-C₄-haloalkylsulfonyl.

Even more preferably R^{A3} is selected from hydrogen, fluorine, chlorine, bromine, methyl, ethyl, n-propyl, isopropyl, cyclopropyl, isobutyl, cyclopropylmethyl, fluoromethyl, difluoromethyl, trifluoromethyl, 1-fluoroethyl, 2-fluoroethyl, 2,2,2-trifluoroethyl, methoxymethyl, difluoromethoxymethyl, trifluoromethoxymethyl, cyanomethyl, 2-methoxy-1-ethyl, 2-difluoromethoxy-1-ethyl, 2-trifluoromethoxy-1-ethyl, and 2-cyano-1-ethyl.

Preferably two or three of the substituents R^{A1}, R^{A2}, R^{A3} and R^{A4} are hydrogen.

Examples of suitable radicals A-6 are the radicals of formulae A-6.1 to A-6.46, as defined in Table A6.

TABLE A6

| | |
|---|---|
| 2-Pyridyl | (A-6.1) |
| 4-Methyl-2-pyridyl | (A-6.2) |
| 4-Chloro-2-pyridyl | (A-6.3) |
| 4-Methoxy-2-pyridyl | (A-6.4) |
| 4-Nitro-2-pyridyl | (A-6.5) |
| 4-Trifluoromethyl-2-pyridyl | (A-6.6) |
| 4-Methoxy-2-pyridyl | (A-6.7) |
| 5-Methyl-2-pyridyl | (A-6.8) |
| 5-Chloro-2-pyridyl | (A-6.9) |
| 5-Methoxy-2-pyridyl | (A-6.10) |
| 5-Nitro-2-pyridyl | (A-6.11) |
| 5-Trifluoromethyl-2-pyridyl | (A-6.12) |
| 5-Methoxy-2-pyridyl | (A-6.13) |
| 6-Methyl-2-pyridyl | (A-6.14) |
| 6-Chloro-2-pyridyl | (A-6.15) |
| 6-Methoxy-2-pyridyl | (A-6.16) |
| 6-Nitro-2-pyridyl | (A-6.17) |
| 6-Trifluoromethyl-2-pyridyl | (A-6.18) |
| 6-Methoxy-2-pyridyl | (A-6.19) |
| 4,5-Dimethyl-2-pyridyl | (A-6.20) |
| 5,6-Dimethyl-2-pyridyl | (A-6.21) |
| 4,6-Dimethyl-2-pyridyl | (A-6.22) |
| 4,5-Dichloro-2-pyridyl | (A-6.23) |
| 5,6-Dichloro-2-pyridyl | (A-6.24) |
| 4,6-Dichloro-2-pyridyl | (A-6.25) |
| 4-Methyl-5-chloro-2-pyridyl | (A-6.26) |
| 5-Methyl-6-chloro-2-pyridyl | (A-6.27) |
| 4-Methyl-6-chloro-2-pyridyl | (A-6.28) |
| 4-Chloro-5-methyl-2-pyridyl | (A-6.29) |
| 5-Chloro-6-methyl-2-pyridyl | (A-6.30) |
| 4-Chloro-6-methyl-2-pyridyl | (A-6.31) |
| 4-Fluoro-2-pyridyl | (A-6.32) |
| 5-Fluoro-2-pyridyl | (A-6.33) |
| 6-Fluoro-2-pyridyl | (A-6.34) |
| 4-butyl-2-pyridyl | (A-6.35) |
| 5-butyl-2-pyridyl | (A-6.36) |
| 6-butyl-2-pyridyl | (A-6.37) |
| 4-(1-fluoroethyl)-2-pyridyl | (A-6.38) |
| 5-(1-fluoroethyl)-2-pyridyl | (A-6.39) |
| 6-(1-fluoroethyl)-2-pyridyl | (A-6.40) |
| 4-(1,1-difluoroethyl)-2-pyridyl | (A-6.41) |
| 5-(1,1-difluoroethyl)-2-pyridyl | (A-6.42) |
| 6-(1,1-difluoroethyl)-2-pyridyl | (A-6.43) |
| 4-(2,2-difluoroethyl)-2-pyridyl | (A-6.44) |
| 5-(2,2-difluoroethyl)-2-pyridyl | (A-6.45) |
| 6-(2,2-difluoroethyl)-2-pyridyl | (A-6.46) |

Another preferred embodiment of the invention relates to methods and uses comprising 3-pyridiyl compounds of the formulae I or II, the salts thereof, the N-oxides thereof or the salts of the N-oxides thereof, wherein X¹, X², X³, R¹, R² and R³ are as defined above and in particular have one of the preferred meanings and wherein A is a radical A-7,

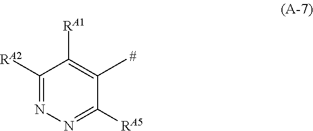

wherein #, R^{A1}, R^{A2} and R^{A5} are as defined herein.

Among the methods and uses comprising compounds of formulae I or II wherein A is A-7, preference is given to those methods and uses, wherein R^{A1} and R^{A5} are selected independently of each other from hydrogen, halogen, CN, NO₂, C₁-C₄-alkyl, C₁-C₄-haloalkyl, C₁-C₄-alkoxy, C₁-C₄-haloalkoxy, C₁-C₄-alkylsulfinyl, C₁-C₄-haloalkylsulfinyl, C₁-C₄-alkylsulfonyl, C₁-C₄-haloalkylsulfonyl, C₁-C₅-alkylen-CN, C₁-C₅-alkylen-OR^{a}, C₁-C₅-alkylen-C(Y)R^{b} and C₁-C₅-alkylen-C(Y)OR^{c}, C₃-C₁₀-cycloalkyl, C₅-C₁₀-cycloalkenyl, saturated 3- to 10-membered heterocyclyl, C₃-C₁₀-cycloalkyl-C₁-C₅-alkyl, C₅-C₁₀-cycloalkenyl-C₁-C₅-alkyl, 3- to 10-membered heterocyclyl-C₁-C₅-alkyl, wherein cycloalkyl, cycloalkenyl and heterocyclyl in the 6 last mentioned radicals may be unsubstituted or may carry 1, 2, 3, 4 or 5 identical or different substituents R^{y}, wherein Y is defined herein and in particular is oxygen, wherein R^{a}, R^{b} and R^{c} are as defined herein and in particular are selected independently of each other from the group consisting of hydrogen, C₁-C₄-alkyl, C₁-C₄-haloalkyl, C₁-C₄-alkoxy-C₁-C₄-alkyl, heterocyclyl-C₁-C₄-alkyl and hetaryl-C₁-C₄-alkyl, more preferably from the group consisting of hydrogen, C₁-C₄-alkyl and C₁-C₄-alkoxy-C₁-C₂-alkyl, and most preferably from the group consisting of hydrogen, methyl and ethyl, and wherein the substituents R^{y} are as defined herein and in particular are selected independently of each other from halogen, NO₂, C₁-C₄-alkyl, C₁-C₄-haloalkyl, C₁-C₄-alkoxy, C₁-C₄-haloalkoxy, C₁-C₄-alkylsulfonyl and C₁-C₄-haloalkylsulfonyl.

More preferably R^{A1} and R^{A5} are selected independently of each other from hydrogen, halogen, C₁-C₄-alkyl, C₁-C₄-haloalkyl, C₁-C₄-alkoxy, C₁-C₄-haloalkoxy, C₁-C₃-alkylen-CN, C₁-C₃-alkylen-OR^{a}, C₃-C₇-cycloalkyl, C₃-C₇-cycloalkyl-C₁-C₃-alkyl, and 3- to 7-membered saturated heterocyclyl-C₁-C₃-alkyl, wherein cycloalkyl and heterocyclyl in the 3 last mentioned radicals may be unsubstituted or may carry 1, 2, 3, 4 or 5 identical or different substituents R^{y}, wherein R^{a} is as defined herein and in particular is selected from the group consisting of hydrogen, C₁-C₄-alkyl, C₁-C₄-haloalkyl and C₁-C₄-alkoxy-C₁-C₂-alkyl, and specifically from the group consisting of hydrogen, methyl, ethyl, difluormethyl and trifluoromethyl, and wherein the substituents R^{y} are as defined herein and in particular are selected independently of each other from halogen, NO₂, C₁-C₄-alkyl, C₁-C₄-haloalkyl, C₁-C₄-alkoxy, C₁-C₄-haloalkoxy, C₁-C₄-alkylsulfonyl and C₁-C₄-haloalkylsulfonyl.

Even more preferably R^{A1} and R^{A5} are selected independently of each other from hydrogen, fluorine, chlorine, bromine, methyl, ethyl, n-propyl, isopropyl, cyclopropyl, isobutyl, cyclopropylmethyl, fluoromethyl, difluoromethyl, trifluoromethyl, 1-fluoroethyl, 2-fluoroethyl, 2,2,2-trifluoroethyl, methoxymethyl, difluoromethoxymethyl, trifluoromethoxymethyl, cyanomethyl, 2-methoxy-1-ethyl, 2-difluoromethoxy-1-ethyl, 2-trifluoromethoxy-1-ethyl, and 2-cyano-1-ethyl.

Among the methods and uses comprising compounds of formulae I or II wherein A is A-7, preference is further given to those methods and uses, wherein R^{A2} is selected from hydrogen, halogen, CN, NO₂, C₁-C₄-alkyl, C₁-C₄-haloalkyl, C₁-C₄-alkoxy, C₁-C₄-haloalkoxy, C₁-C₄-alkylthio, C₁-C₄-haloalkylthio, C₁-C₄-alkylsulfinyl, C₁-C₄-haloalkylsulfinyl, C₁-C₄-alkylsulfonyl, C₁-C₄-haloalkylsulfonyl, C₁-C₅-alkylen-CN, C₁-C₅-alkylen-OR^{a}, C₁-C₅-alkylen-C(Y)R^{b}, C₁-C₅-alkylen-C(Y)OR^{b}, C₃-C₁₀-cycloalkyl, C₅-C₁₀-cycloalkenyl, saturated 3- to 10-membered heterocyclyl, C₃-C₁₀-cycloalkyl-C₁-C₅-alkyl, C₅-C₁₀-cycloalkenyl-C₁-C₅-alkyl, saturated or partially unsaturated 3- to 10-membered heterocyclyl-C₁-C₅-alkyl, wherein cycloalkyl, cycloalkenyl and heterocyclyl in the 6 last mentioned radicals may be unsubstituted or may carry 1, 2, 3, 4 or 5 identical or different substituents R^{y}, wherein Y is defined herein and in particular is oxygen, wherein R^{a}, R^{b} and R^{c} are as defined herein and in particular are selected independently of each other from the group consisting of hydrogen, C₁-C₄-alkyl, C₁-C₄-haloalkyl, C₁-C₄-alkoxy-C₁-C₄-alkyl, heterocyclyl-C₁-C₄-alkyl and hetaryl-C₁-C₄-alkyl, more preferably from the group consisting of hydrogen, C₁-C₄-alkyl and C₁-C₄-alkoxy-C₁-C₂-alkyl, and most preferably from the group consisting of hydrogen, methyl and ethyl, and wherein the substituents R^{y} are as defined herein and in particular are selected independently of each other from halogen, NO₂, C₁-C₄-alkyl, C₁-C₄-haloalkyl, C₁-C₄-alkoxy, C₁-C₄-haloalkoxy, C₁-C₄-alkylsulfonyl and C₁-C₄-haloalkylsulfonyl.

More preferably R^{A2} is selected from hydrogen, halogen, C₁-C₄-alkyl, C₁-C₄-haloalkyl, C₁-C₄-alkoxy, C₁-C₄-haloalkoxy, C₁-C₃-alkylen-CN, C₁-C₃-alkylen-OR^{a}, C₃-C₇-cycloalkyl, C₃-C₇-cycloalkyl-C₁-C₃-alkyl, and 3- to 7-membered saturated heterocyclyl-C₁-C₃-alkyl, wherein cycloalkyl and heterocyclyl in the 3 last mentioned radicals may be unsubstituted or may carry 1, 2, 3, 4 or 5 identical or different substituents R^{y}, wherein R^{a} is as defined herein and in particular is selected from the group consisting of hydrogen, C₁-C₄-alkyl, C₁-C₄-haloalkyl and C₁-C₄-alkoxy-C₁-C₂-alkyl, and specifically from the group consisting of hydrogen, methyl, ethyl, difluormethyl and trifluoromethyl, and wherein the substituents R^{y} are as defined herein and in particular are selected independently of each other from halogen, NO₂, C₁-C₄-alkyl, C₁-C₄-haloalkyl, C₁-C₄-alkoxy, C₁-C₄-haloalkoxy, C₁-C₄-alkylsulfonyl and C₁-C₄-haloalkylsulfonyl.

Even more preferably R^{A2} is selected from hydrogen, fluorine, chlorine, bromine, methyl, ethyl, n-propyl, isopropyl, cyclopropyl, isobutyl, cyclopropylmethyl, fluoromethyl, difluoromethyl, trifluoromethyl, 1-fluoroethyl, 2-fluoroethyl, 2,2,2-trifluoroethyl, methoxymethyl, difluoromethoxymethyl, trifluoromethoxymethyl, cyanomethyl, 2-methoxy-1-ethyl, 2-difluoromethoxy-1-ethyl, 2-trifluoromethoxy-1-ethyl, and 2-cyano-1-ethyl.

Preferably one or two of the substituents R^{A1}, R^{A2} and R^{A5} are hydrogen.

Examples of suitable radicals A-7 are the radicals of formulae A-7.1 to A-7.19, as defined in Table A7.

TABLE A7

| | |
|---|---|
| 4-Pyridazinyl | (A-7.1) |
| 5-Chloro-4-pyridazinyl | (A-7.2) |
| 5-Methyl-4-pyridazinyl | (A-7.3) |
| 5-Ethyl-4-pyridazinyl | (A-7.4) |
| 5-Cyclopropyl-4-pyridazinyl | (A-7.5) |
| 5-Difluoromethyl-4-pyridazinyl | (A-7.6) |
| 5-Trifluoromethyl-4-pyridazinyl | (A-7.7) |
| 5-Methoxy-4-pyridazinyl | (A-7.8) |
| 6-Chloro-4-pyridazinyl | (A-7.9) |
| 6-Methyl-4-pyridazinyl | (A-7.10) |
| 6-Ethyl-4-pyridazinyl | (A-7.11) |
| 6-Cyclopropyl-4-pyridazinyl | (A-7.12) |
| 6-Difluoromethyl-4-pyridazinyl | (A-7.13) |
| 6-Trifluoromethyl-4-pyridazinyl | (A-7.14) |
| 6-Methoxy-4-pyridazinyl | (A-7.15) |
| 5,6-Dimethyl-4-pyridazinyl | (A-7.16) |
| 5,6-Dichloro-4-pyridazinyl | (A-7.17) |
| 5-Methyl-6-chloro-4-pyridazinyl | (A-7.18) |
| 5-Chloro-6-methyl-4-pyridazinyl | (A-7.19) |

Another preferred embodiment of the invention relates to methods and uses comprising 3-pyridiyl compounds of the formulae I or II, the salts thereof, the N-oxides thereof or the salts of the N-oxides thereof, wherein X¹, X², X³, R¹, R² and R³ are as defined above and in particular have one of the preferred meanings and wherein A is a radical A-8,

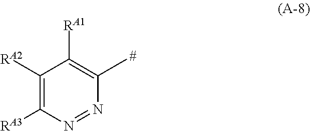

wherein #, R^{A1}, R^{A2} and R^{A3} are as defined herein.

Among the methods and uses comprising compounds of formulae I or II wherein A is A-8, preference is given to those methods and uses, wherein R^{A1} is selected from hydrogen, halogen, CN, NO₂, C₁-C₄-alkyl, C₁-C₄-haloalkyl, C₁-C₄-alkoxy, C₁-C₄-haloalkoxy, C₁-C₄-alkylsulfinyl, C₁-C₄-haloalkylsulfinyl, C₁-C₄-alkylsulfonyl, C₁-C₄-haloalkylsulfonyl, C₁-C₅-alkylen-CN, C₁-C₅-alkylen-OR^{a}, C₁-C₅-alkylen-C(Y)R^{b} and C₁-C₅-alkylen-C(Y)OR^{c}, C₃-C₁₀-cycloalkyl, C₅-C₁₀-cycloalkenyl, saturated 3- to 10-membered heterocyclyl, C₃-C₁₀-cycloalkyl-C₁-C₅-alkyl, C₅-C₁₀-cycloalkenyl-C₁-C₅-alkyl, 3- to 10-membered heterocyclyl-C₁-C₅-alkyl, wherein cycloalkyl, cycloalkenyl and heterocyclyl in the 6 last mentioned radicals may be unsubstituted or may carry 1, 2, 3, 4 or 5 identical or different substituents R^{y}, wherein Y is defined herein and in particular is oxygen, wherein R^{a}, R^{b} and R^{c} are as defined herein and in particular are selected independently of each other from the group consisting of hydrogen, C₁-C₄-alkyl, C₁-C₄-haloalkyl, C₁-C₄-alkoxy-C₁-C₄-alkyl, heterocyclyl-C₁-C₄-alkyl and hetaryl-C₁-C₄-alkyl, more preferably from the group consisting of hydrogen, C₁-C₄-alkyl and C₁-C₄-alkoxy-C₁-C₂-alkyl, and most preferably from the group consisting of hydrogen, methyl and ethyl, and wherein the substituents R^{y} are as defined herein and in particular are selected independently of each other from halogen, NO₂, C₁-C₄-alkyl, C₁-C₄-haloalkyl, C₁-C₄-alkoxy, C₁-C₄-haloalkoxy, C₁-C₄-alkylsulfonyl and C₁-C₄-haloalkylsulfonyl.

More preferably R^{A1} is selected from hydrogen, halogen, C₁-C₄-alkyl, C₁-C₄-haloalkyl, C₁-C₄-alkoxy, C₁-C₄-haloalkoxy, C₁-C₃-alkylen-CN, C₁-C₃-alkylen-OR^{a}, C₃-C₇-cycloalkyl, C₃-C₇-cycloalkyl-C₁-C₃-alkyl, and 3- to 7-membered saturated heterocyclyl-C₁-C₃-alkyl, wherein cycloalkyl and heterocyclyl in the 3 last mentioned radicals may be unsubstituted or may carry 1, 2, 3, 4 or 5 identical or different substituents R^{y}, wherein R^{a} is as defined herein and in particular is selected from the group consisting of hydrogen, C₁-C₄-alkyl, C₁-C₄-haloalkyl and C₁-C₄-alkoxy-C₁-C₂-alkyl, and specifically from the group consisting of hydrogen, methyl, ethyl, difluormethyl and trifluoromethyl, and wherein the substituents R^{y} are as defined herein and in particular are selected independently of each other from halogen, NO₂, C₁-C₄-alkyl, C₁-C₄-haloalkyl, C₁-C₄-alkoxy, C₁-C₄-haloalkoxy, C₁-C₄-alkylsulfonyl and C₁-C₄-haloalkylsulfonyl.

Even more preferably R^{A1} is selected from hydrogen, fluorine, chlorine, bromine, methyl, ethyl, n-propyl, isopropyl, cyclopropyl, isobutyl, cyclopropylmethyl, fluoromethyl, difluoromethyl, trifluoromethyl, 1-fluoroethyl, 2-fluoroethyl, 2,2,2-trifluoroethyl, methoxymethyl, difluoromethoxymethyl, trifluoromethoxymethyl, cyanomethyl, 2-methoxy-1-ethyl, 2-difluoromethoxy-1-ethyl, 2-trifluoromethoxy-1-ethyl, and 2-cyano-1-ethyl.

Among the methods and uses comprising compounds of formulae I or II wherein A is A-8, preference is further given to those methods and uses, wherein R^{A2} is selected from hydrogen, halogen, CN, NO₂, C₁-C₄-alkyl, C₁-C₄-haloalkyl, C₁-C₄-alkoxy, C₁-C₄-haloalkoxy, C₁-C₄-alkylthio, C₁-C₄-haloalkylthio, C₁-C₄-alkylsulfinyl, C₁-C₄-haloalkylsulfinyl, C₁-C₄-alkylsulfonyl, C₁-C₄-haloalkylsulfonyl, C₁-C₅-alkylen-CN, C₁-C₅-alkylen-OR^{a}, C₁-C₅-alkylen-C(Y)R^{b}, C₁-C₅-alkylen-C(Y)OR^{c}, C₃-C₁₀-cycloalkyl, C₅-C₁₀-cycloalkenyl, saturated 3- to 10-membered heterocyclyl, C₃-C₁₀-cycloalkyl-C₁-C₅-alkyl, C₅-C₁₀-cycloalkenyl-C₁-C₅-alkyl, saturated or partially unsaturated 3- to 10-membered heterocyclyl-C₁-C₅-alkyl, wherein cycloalkyl, cycloalkenyl and heterocyclyl in the 6 last mentioned radicals may be unsubstituted or may carry 1, 2, 3, 4 or 5 identical or different substituents R^{y}, wherein Y is defined herein and in particular is oxygen, wherein R^{a}, R^{b} and R^{c} are as defined herein and in particular are selected independently of each other from the group consisting of hydrogen, C₁-C₄-alkyl, C₁-C₄-haloalkyl, C₁-C₄-alkoxy-C₁-C₄-alkyl, heterocyclyl-C₁-C₄-alkyl and hetaryl-C₁-C₄-alkyl, more preferably from the group consisting of hydrogen, C₁-C₄-alkyl and C₁-C₄-alkoxy-C₁-C₂-alkyl, and most preferably from the group consisting of hydrogen, methyl and ethyl, and wherein the substituents R^{y} are as defined herein and in particular are selected independently of each other from halogen, NO₂, C₁-C₄-alkyl, C₁-C₄-haloalkyl, C₁-C₄-alkoxy, C₁-C₄-haloalkoxy, C₁-C₄-alkylsulfonyl and C₁-C₄-haloalkylsulfonyl.

More preferably R^{A2} is selected from hydrogen, halogen, C₁-C₄-alkyl, C₁-C₄-haloalkyl, C₁-C₄-alkoxy, C₁-C₄-haloalkoxy, C₁-C₃-alkylen-CN, C₁-C₃-alkylen-OR^{a}, C₃-C₇-cycloalkyl, C₃-C₇-cycloalkyl-C₁-C₃-alkyl, and 3- to 7-membered saturated heterocyclyl-C₁-C₃-alkyl, wherein cycloalkyl and heterocyclyl in the 3 last mentioned radicals may be unsubstituted or may carry 1, 2, 3, 4 or 5 identical or different substituents R^{y}, wherein R^{a} is as defined herein and in particular is selected from the group consisting of hydrogen, C₁-C₄-alkyl, C₁-C₄-haloalkyl and C₁-C₄-alkoxy-C₁-C₂-alkyl, and specifically from the group consisting of hydrogen, methyl, ethyl, difluormethyl and trifluoromethyl, and wherein the substituents R^{y} are as defined herein and in particular are selected independently of each other from halogen, NO₂, C₁-C₄-alkyl, C₁-C₄-haloalkyl, C₁-C₄-alkoxy, C₁-C₄-haloalkoxy, C₁-C₄-alkylsulfonyl and C₁-C₄-haloalkylsulfonyl.

Even more preferably R^{A2} is selected from hydrogen, fluorine, chlorine, bromine, methyl, ethyl, n-propyl, isopropyl, cyclopropyl, isobutyl, cyclopropylmethyl, fluoromethyl, difluoromethyl, trifluoromethyl, 1-fluoroethyl, 2-fluoroethyl, 2,2,2-trifluoroethyl, methoxymethyl, difluoromethoxymethyl, trifluoromethoxymethyl, cyanomethyl, 2-methoxy-1-ethyl, 2-difluoromethoxy-1-ethyl, 2-trifluoromethoxy-1-ethyl, and 2-cyano-1-ethyl.

Among the methods and uses comprising compounds of formulae I or II wherein A is A-8, preference is further given to those methods and uses, wherein R^{A3} is selected from hydrogen, halogen, CN, NO₂, C₁-C₄-alkyl, C₁-C₄-haloalkyl, C₁-C₄-alkoxy, C₁-C₄-haloalkoxy, C₁-C₄-alkylthio, C₁-C₄-haloalkylthio, C₁-C₄-alkylsulfinyl, C₁-C₄-haloalkylsulfinyl, C₁-C₄-alkylsulfonyl, C₁-C₄-haloalkylsulfonyl, C₁-C₅-alkylen-CN, C₁-C₅-alkylen-OR^{a}, C₁-C₅-alkylen-C(Y)R^{b}, C₁-C₅-alkylen-C(Y)OR^{c}, C₃-C₁₀-cycloalkyl, C₅-C₁₀-cycloalkenyl, saturated 3 to 10 membered heterocyclyl, C₃-C₁₀-cycloalkyl-C₁-C₅-alkyl, C₅-C₁₀-cycloalkenyl-C₁-C₅-alkyl and 3- to 10-membered heterocyclyl-C₁-C₅-alkyl, wherein cycloalkyl, cycloalkenyl and heterocyclyl in the 6 last mentioned radicals may be unsubstituted or may carry 1, 2, 3, 4 or 5 identical or different substituents R^{y}, wherein Y is defined herein and in particular is oxygen, wherein R^{a}, R^{b} and R^{c} are as defined herein and in particular are selected independently of each other from the group consisting of hydrogen, C₁-C₄-alkyl, C₁-C₄-haloalkyl, C₁-C₄-alkoxy-C₁-C₄-alkyl, heterocyclyl-C₁-C₄-alkyl and hetaryl-C₁-C₄-alkyl, more preferably from the group consisting of hydrogen, C₁-C₄-alkyl and C₁-C₄-alkoxy-C₁-C₂-alkyl, and most preferably from the group consisting of hydrogen, methyl and ethyl, and wherein the substituents R^{y} are as defined herein and in particular are selected independently of each other from halogen, NO₂, C₁-C₄-alkyl, C₁-C₄-haloalkyl, C₁-C₄-alkoxy, C₁-C₄-haloalkoxy, C₁-C₄-alkylsulfonyl and C₁-C₄-haloalkylsulfonyl.

More preferably R^{A3} is selected from hydrogen, halogen, C₁-C₄-alkyl, C₁-C₄-haloalkyl, C₁-C₄-alkoxy, C₁-C₄-haloalkoxy, C₁-C₃-alkylen-CN, C₁-C₃-alkylen-OR^{a}, C₃-C₇-cycloalkyl, C₃-C₇-cycloalkyl-C₁-C₃-alkyl, and 3- to 7-membered saturated heterocyclyl-C₁-C₃-alkyl, wherein cycloalkyl and heterocyclyl in the 3 last mentioned radicals may be unsubstituted or may carry 1, 2, 3, 4 or 5 identical or different substituents R^{y}, wherein R^{a} is as defined herein and in particular is selected from the group consisting of hydrogen, C₁-C₄-alkyl, C₁-C₄-haloalkyl and C₁-C₄-alkoxy-C₁-C₂-alkyl, and specifically from the group consisting of hydrogen, methyl, ethyl, difluormethyl and trifluoromethyl, and wherein the substituents R^{y} are as defined herein and in particular are selected independently of each other from halogen, NO₂, C₁-C₄-alkyl, C₁-C₄-haloalkyl, C₁-C₄-alkoxy, C₁-C₄-haloalkoxy, C₁-C₄-alkylsulfonyl and C₁-C₄-haloalkylsulfonyl.

Even more preferably R^{A3} is selected from hydrogen, fluorine, chlorine, bromine, methyl, ethyl, n-propyl, isopropyl, cyclopropyl, isobutyl, cyclopropylmethyl, fluoromethyl, difluoromethyl, trifluoromethyl, 1-fluoroethyl, 2-fluoroethyl, 2,2,2-trifluoroethyl, methoxymethyl, difluoromethoxymethyl, trifluoromethoxymethyl, cyanomethyl, 2-methoxy-1-ethyl, 2-difluoromethoxy-1-ethyl, 2-trifluoromethoxy-1-ethyl, and 2-cyano-1-ethyl.

Preferably one or two of the substituents R^{A1}, R^{A2} and R^{A3} are hydrogen.

Examples of suitable radicals A-8 are the radicals of formulae A-8.1 to A-8.30, as defined in Table A8.

TABLE A8

| | |
|---|---|
| 3-Pyridazinyl | (A-8.1) |
| 4-Chloro-3-pyridazinyl | (A-8.2) |
| 4-Methyl-3-pyridazinyl | (A-8.3) |
| 4-Ethyl-3-pyridazinyl | (A-8.4) |
| 4-Cyclopropyl-3-pyridazinyl | (A-8.5) |
| 4-Difluoromethyl-3-pyridazinyl | (A-8.6) |
| 4-Trifluoromethyl-3-pyridazinyl | (A-8.7) |
| 4-Methoxy-3-pyridazinyl | (A-8.8) |
| 5-Chloro-3-pyridazinyl | (A-8.9) |
| 5-Methyl-3-pyridazinyl | (A-8.10) |
| 5-Ethyl-3-pyridazinyl | (A-8.11) |
| 5-Cyclopropyl-3-pyridazinyl | (A-8.12) |
| 5-Difluoromethyl-3-pyridazinyl | (A-8.13) |
| 5-Trifluoromethyl-3-pyridazinyl | (A-8.14) |
| 5-Methoxy-3-pyridazinyl | (A-8.15) |
| 6-Chloro-3-pyridazinyl | (A-8.16) |
| 6-Methyl-3-pyridazinyl | (A-8.17) |
| 6-Ethyl-3-pyridazinyl | (A-8.18) |
| 6-Cyclopropyl-3-pyridazinyl | (A-8.19) |
| 6-Difluoromethyl-3-pyridazinyl | (A-8.20) |
| 6-Trifluoromethyl-3-pyridazinyl | (A-8.21) |
| 6-Methoxy-3-pyridazinyl | (A-8.22) |
| 5,6-Dimethyl-3-pyridazinyl | (A-8.23) |
| 5,6-Dichloro-3-pyridazinyl | (A-8.24) |
| 4,6-Dimethyl-3-pyridazinyl | (A-8.25) |
| 4,6-Dichloro-3-pyridazinyl | (A-8.26) |
| 5-Methyl-6-chloro-3-pyridazinyl | (A-8.27) |
| 5-Chloro-6-methyl-3-pyridazinyl | (A-8.28) |
| 4-Methyl-6-chloro-3-pyridazinyl | (A-8.29) |
| 4-Chloro-6-methyl-3-pyridazinyl | (A-8.30) |

Another preferred embodiment of the invention relates to methods and uses comprising 3-pyridiyl compounds of the formulae I or II, the salts thereof, the N-oxides thereof or the salts of the N-oxides thereof, wherein X¹, X², X³, R¹, R² and R³ are as defined above and in particular have one of the preferred meanings and wherein A is a radical A-9,

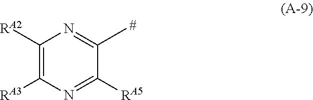

wherein #, R^{A2}, R^{A3} and R^{A5} are as defined herein.

Among the methods and uses comprising compounds of formulae I or II wherein A is A-9, preference is given to those methods and uses, wherein R^{A5} is selected from hydrogen, halogen, CN, NO₂, C₁-C₄-alkyl, C₁-C₄-haloalkyl, C₁-C₄-alkoxy, C₁-C₄-haloalkoxy, C₁-C₄-alkylsulfinyl, C₁-C₄-haloalkylsulfinyl, C₁-C₄-alkylsulfonyl, C₁-C₄-haloalkylsulfonyl, C₁-C₅-alkylen-CN, C₁-C₅-alkylen-OR^{a}, C₁-C₅-alkylen-C(Y)R^{b} and C₁-C₅-alkylen-C(Y)OR^{c}, C₃-C₁₀-cycloalkyl, C₅-C₁₀-cycloalkenyl, saturated 3- to 10-membered heterocyclyl, C₃-C₁₀-cycloalkyl-C₁-C₅-alkyl, C₅-C₁₀-cycloalkenyl-C₁-C₅-alkyl, 3- to 10-membered heterocyclyl-C₁-C₅-alkyl, wherein cycloalkyl, cycloalkenyl and heterocyclyl in the 6 last mentioned radicals may be unsubstituted or may carry 1, 2, 3, 4 or 5 identical or different substituents R^{y}, wherein Y is defined herein and in particular is oxygen, wherein R^{a}, R^{b} and R^{c} are as defined herein and in particular are selected independently of each other from the group consisting of hydrogen, C₁-C₄-alkyl, C₁-C₄-haloalkyl, C₁-C₄-alkoxy-C₁-C₄-alkyl, heterocyclyl-C₁-C₄-alkyl and hetaryl-C₁-C₄-alkyl, more preferably from the group consisting of hydrogen, C₁-C₄-alkyl and C₁-C₄-alkoxy-C₁-C₂-alkyl, and most preferably from the group consisting of hydrogen, methyl and ethyl, and wherein the substituents R^{y} are as defined herein and in particular are selected independently of each other from halogen, NO₂, C₁-C₄-alkyl, C₁-C₄-haloalkyl, C₁-C₄-alkoxy, C₁-C₄-haloalkoxy, C₁-C₄-alkylsulfonyl and C₁-C₄-haloalkylsulfonyl.

More preferably R^{A5} is selected from hydrogen, halogen, C₁-C₄-alkyl, C₁-C₄-haloalkyl, C₁-C₄-alkoxy, C₁-C₄-haloalkoxy, C₁-C₃-alkylen-CN, C₁-C₃-alkylen-OR^{a}, C₃-C₇-cycloalkyl, C₃-C₇-cycloalkyl-C₁-C₃-alkyl, and 3- to 7-membered saturated heterocyclyl-C₁-C₃-alkyl, wherein cycloalkyl and heterocyclyl in the 3 last mentioned radicals may be unsubstituted or may carry 1, 2, 3, 4 or 5 identical or different substituents R^{y}, wherein R^{a} is as defined herein and in particular is selected from the group consisting of hydrogen, C₁-C₄-alkyl, C₁-C₄-haloalkyl and C₁-C₄-alkoxy-C₁-C₂-alkyl, and specifically from the group consisting of hydrogen, methyl, ethyl, difluormethyl and trifluoromethyl, and wherein the substituents R^{y} are as defined herein and in particular are selected independently of each other from halogen, NO₂, C₁-C₄-alkyl, C₁-C₄-haloalkyl, C₁-C₄-alkoxy, C₁-C₄-haloalkoxy, C₁-C₄-alkylsulfonyl and C₁-C₄-haloalkylsulfonyl.

Even more preferably R^{A5} is selected from hydrogen, fluorine, chlorine, bromine, methyl, ethyl, n-propyl, isopropyl, cyclopropyl, isobutyl, cyclopropylmethyl, fluoromethyl, difluoromethyl, trifluoromethyl, 1-fluoroethyl, 2-fluoroethyl, 2,2,2-trifluoroethyl, methoxymethyl, difluoromethoxymethyl, trifluoromethoxymethyl, cyanomethyl, 2-methoxy-1-ethyl, 2-difluoromethoxy-1-ethyl, 2-trifluoromethoxy-1-ethyl, and 2-cyano-1-ethyl.

Among the methods and uses comprising compounds of formulae I or II wherein A is A-9, preference is further given to those methods and uses, wherein R^{A2} is selected from hydrogen, halogen, CN, NO₂, C₁-C₄-alkyl, C₁-C₄-haloalkyl, C₁-C₄-alkoxy, C₁-C₄-haloalkoxy, C₁-C₄-alkylthio, C₁-C₄-haloalkylthio, C₁-C₄-alkylsulfinyl, C₁-C₄-haloalkylsulfinyl, C₁-C₄-alkylsulfonyl, C₁-C₄-haloalkylsulfonyl, C₁-C₅-alkylen-CN, C₁-C₅-alkylen-OR^{a}, C₁-C₅-alkylen-C(Y)R^{b}, C₁-C₅-alkylen-C(Y)OR^{b}, C₃-C₁₀-cycloalkyl, C₅-C₁₀-cycloalkenyl, saturated 3- to 10-membered heterocyclyl, C₃-C₁₀-cycloalkyl-C₁-C₅-alkyl, C₅-C₁₀-cycloalkenyl-C₁-C₅-alkyl, saturated or partially unsaturated 3- to 10-membered heterocyclyl-C₁-C₅-alkyl, wherein cycloalkyl, cycloalkenyl and heterocyclyl in the 6 last mentioned radicals may be unsubstituted or may carry 1, 2, 3, 4 or 5 identical or different substituents R^{y}, wherein Y is defined herein and in particular is oxygen, wherein R^{a}, R^{b} and R^{c} are as defined herein and in particular are selected independently of each other from the group consisting of hydrogen, C₁-C₄-alkyl, C₁-C₄-haloalkyl, C₁-C₄-alkoxy-C₁-C₄-alkyl, heterocyclyl-C₁-C₄-alkyl and hetaryl-C₁-C₄-alkyl, more preferably from the group consisting of hydrogen, C₁-C₄-alkyl and C₁-C₄-alkoxy-C₁-C₂-alkyl, and most preferably from the group consisting of hydrogen, methyl and ethyl, and wherein the substituents R^{y} are as defined herein and in particular are selected independently of each other from halogen, NO₂, C₁-C₄-alkyl, C₁-C₄-haloalkyl, C₁-C₄-alkoxy, C₁-C₄-haloalkoxy, C₁-C₄-alkylsulfonyl and C₁-C₄-haloalkylsulfonyl.

More preferably R^{A2} is selected from hydrogen, halogen, C₁-C₄-alkyl, C₁-C₄-haloalkyl, C₁-C₄-alkoxy, C₁-C₄-haloalkoxy, C₁-C₃-alkylen-CN, C₁-C₃-alkylen-OR^{a}, C₃-C₇-cycloalkyl, C₃-C₇-cycloalkyl-C₁-C₃-alkyl, and 3- to 7-membered saturated heterocyclyl-C₁-C₃-alkyl, wherein cycloalkyl and heterocyclyl in the 3 last mentioned radicals may be unsubstituted or may carry 1, 2, 3, 4 or 5 identical or different substituents R^{y}, wherein R^{a} is as defined herein and in particular is selected from the group consisting of hydrogen, C₁-C₄-alkyl, C₁-C₄-haloalkyl and C₁-C₄-alkoxy-C₁-C₂-alkyl, and specifically from the group consisting of hydrogen, methyl, ethyl, difluormethyl and trifluoromethyl, and wherein the substituents R^{y} are as defined herein and in particular are selected independently of each other from halogen, NO₂, C₁-C₄-alkyl, C₁-C₄-haloalkyl, C₁-C₄-alkoxy, C₁-C₄-haloalkoxy, C₁-C₄-alkylsulfonyl and C₁-C₄-haloalkylsulfonyl.

Even more preferably R^{A2} is selected from hydrogen, fluorine, chlorine, bromine, methyl, ethyl, n-propyl, isopropyl, cyclopropyl, isobutyl, cyclopropylmethyl, fluoromethyl, difluoromethyl, trifluoromethyl, 1-fluoroethyl, 2-fluoroethyl, 2,2,2-trifluoroethyl, methoxymethyl, difluoromethoxymethyl, trifluoromethoxymethyl, cyanomethyl, 2-methoxy-1-ethyl, 2-difluoromethoxy-1-ethyl, 2-trifluoromethoxy-1-ethyl, and 2-cyano-1-ethyl.

Among the methods and uses comprising compounds of formulae I or II wherein A is A-9, preference is given to those methods and uses, wherein R^{A3} is selected from hydrogen, halogen, CN, NO₂, C₁-C₄-alkyl, C₁-C₄-haloalkyl, C₁-C₄-alkoxy, C₁-C₄-haloalkoxy, C₁-C₄-alkylthio, C₁-C₄-haloalkylthio, C₁-C₄-alkylsulfinyl, C₁-C₄-haloalkylsulfinyl, C₁-C₄-alkylsulfonyl, C₁-C₄-haloalkylsulfonyl, C₁-C₅-alkylen-CN, C₁-C₅-alkylen-OR^{a}, C₁-C₅-alkylen-C(Y)R^{b}, C₁-C₅-alkylen-C(Y)OR^{c}, C₃-C₁₀-cycloalkyl, C₅-C₁₀-cycloalkenyl, saturated 3 to 10 membered heterocyclyl, C₃-C₁₀-cycloalkyl-C₁-C₅-alkyl, C₅-C₁₀-cycloalkenyl-C₁-C₅-alkyl and 3- to 10-membered heterocyclyl-C₁-C₅-alkyl, wherein cycloalkyl, cycloalkenyl and heterocyclyl in the 6 last mentioned radicals may be unsubstituted or may carry 1, 2, 3, 4 or 5 identical or different substituents R^{y}, wherein Y is defined herein and in particular is oxygen, wherein R^{a}, R^{b} and R^{c} are as defined herein and in particular are selected independently of each other from the group consisting of hydrogen, C₁-C₄-alkyl, C₁-C₄-haloalkyl, C₁-C₄-alkoxy-C₁-C₄-alkyl, heterocyclyl-C₁-C₄-alkyl and hetaryl-C₁-C₄-alkyl, more preferably from the group consisting of hydrogen, C₁-C₄-alkyl and C₁-C₄-alkoxy-C₁-C₂-alkyl, and most preferably from the group consisting of hydrogen, methyl and ethyl, and wherein the substituents R^{y} are as defined herein and in particular are selected independently of each other from halogen, NO₂, C₁-C₄-alkyl, C₁-C₄-haloalkyl, C₁-C₄-alkoxy, C₁-C₄-haloalkoxy, C₁-C₄-alkylsulfonyl and C₁-C₄-haloalkylsulfonyl.

More preferably R^{A3} is selected from hydrogen, halogen, C₁-C₄-alkyl, C₁-C₄-haloalkyl, C₁-C₄-alkoxy, C₁-C₄-haloalkoxy, C₁-C₃-alkylen-CN, C₁-C₃-alkylen-OR^{a}, C₃-C₇-cycloalkyl, C₃-C₇-cycloalkyl-C₁-C₃-alkyl, and 3- to 7-membered saturated heterocyclyl-C₁-C₃-alkyl, wherein cycloalkyl and heterocyclyl in the 3 last mentioned radicals may be unsubstituted or may carry 1, 2, 3, 4 or 5 identical or different substituents R^{y}, wherein R^{a} is as defined herein and in particular is selected from the group consisting of hydrogen, C₁-C₄-alkyl, C₁-C₄-haloalkyl and C₁-C₄-alkoxy-C₁-C₂-alkyl, and specifically from the group consisting of hydrogen, methyl, ethyl, difluormethyl and trifluoromethyl, and wherein the substituents R^{y} are as defined herein and in particular are selected independently of each other from halogen, NO₂, C₁-C₄-alkyl, C₁-C₄-haloalkyl, C₁-C₄-alkoxy, C₁-C₄-haloalkoxy, C₁-C₄-alkylsulfonyl and C₁-C₄-haloalkylsulfonyl.

Even more preferably R^{A3} is selected from hydrogen, fluorine, chlorine, bromine, methyl, ethyl, n-propyl, isopropyl, cyclopropyl, isobutyl, cyclopropylmethyl, fluoromethyl, difluoromethyl, trifluoromethyl, 1-fluoroethyl, 2-fluoroethyl, 2,2,2-trifluoroethyl, methoxymethyl, difluoromethoxymethyl, trifluoromethoxymethyl, cyanomethyl, 2-methoxy-1-ethyl, 2-difluoromethoxy-1-ethyl, 2-trifluoromethoxy-1-ethyl, and 2-cyano-1-ethyl.

Preferably one or two of the substituents R^{A2}, R^{A3} and R^{A5} are hydrogen.

Examples of suitable radicals A-9 are the radicals of formulae A-9.1 to A-9.25, as defined in Table A9.

TABLE A9

| | |
|---|---|
| 2-Pyrazinyl | (A-9.1) |
| 5-Chloro-2-pyrazinyl | (A-9.2) |
| 5-Methyl-2-pyrazinyl | (A-9.3) |
| 5-Trifluoromethyl-2-pyrazinyl | (A-9.4) |
| 5-Methoxy-2-pyrazinyl | (A-9.5) |
| 6-Chloro-2-pyrazinyl | (A-9.6) |
| 6-Methyl-2-pyrazinyl | (A-9.7) |
| 6-Trifluoromethyl-2-pyrazinyl | (A-9.8) |
| 6-Methoxy-2-pyrazinyl | (A-9.9) |
| 3-Chloro-2-pyrazinyl | (A-9.10) |
| 3-Methyl-2-pyrazinyl | (A-9.11) |
| 3-Trifluoromethyl-2-pyrazinyl | (A-9.12) |
| 3-Methoxy-2-pyrazinyl | (A-9.13) |
| 5,6-Dimethyl-2-pyrazinyl | (A-9.14) |
| 5,6-Dichloro-2-pyrazinyl | (A-9.15) |
| 3,5-Dimethyl-2-pyrazinyl | (A-9.16) |
| 3,5-Dichloro-2-pyrazinyl | (A-9.17) |
| 3,6-Dimethyl-2-pyrazinyl | (A-9.18) |
| 3,6-Dichloro-2-pyrazinyl | (A-9.19) |
| 5-Methyl-6-chloro-2-pyrazinyl | (A-9.20) |
| 5-Chloro-6-methyl-2-pyrazinyl | (A-9.21) |
| 3-Methyl-5-chloro-2-pyrazinyl | (A-9.22) |
| 3-Chloro-5-methyl-2-pyrazinyl | (A-9.23) |
| 3-Methyl-6-chloro-2-pyrazinyl | (A-9.24) |
| 3-Chloro-6-methyl-2-pyrazinyl | (A-9.25) |

Apart from that, the variables Y, R^{a}, R^{a1}, R^{a2}, R^{a3}, R^{b}, R^{b1}, R^{b2}, R^{b3}, R^{c}, R^{d}, R^{d1}, R^{d2}, R^{d3}, R^{e}, R^{f}, R^{g}, R^{h}, Rⁱ and R^{y}, independently of each other, preferably have one of the following meanings:
Y is O;
R^{a}, R^{a1}, R^{a2}, R^{a3} independently of each other hydrogen, C₁-C₄-alkyl or C₁-C₄-haloalkyl;
R^{b}, R^{b1}, R^{b2}, R^{b3} independently of each other C₁-C₄-alkyl, C₁-C₄-haloalkyl, C₃-C₆-cycloalkyl or C₃-C₆-cycloalkylmethyl;
R^{c} hydrogen, C₁-C₄-alkyl, C₃-C₆-cycloalkyl or C₃-C₆-cycloalkylmethyl;
R^{d}, R^{d1}, R^{d2}, R^{d3} independently of each other C₁-C₄-alkyl or C₁-C₄-haloalkyl;
R^{e} hydrogen or C₁-C₄-alkyl;
R^{f} hydrogen, C₁-C₄-alkyl, benzyl, C₃-C₆-cycloalkyl or C₃-C₆-cycloalkylmethyl;
R^{g} hydrogen or C₁-C₄-alkyl;
R^{h} hydrogen, C₁-C₄-alkyl, benzyl or C₃-C₆-cycloalkyl;
Rⁱ hydrogen or C₁-C₄-alkyl;
R^{y} is selected from the group consisting of halogen, cyano, nitro, C₁-C₄-alkyl, C₁-C₄-alkoxy, C₁-C₄-haloalkoxy, C₁-C₄-alkylsulfonyl and C₁-C₄-haloalkylsulfonyl.

A very preferred embodiment of the invention relates to methods and uses comprising compounds of the formula I, the salts thereof, the N-oxides thereof or the salts of the N-oxides thereof, wherein X¹ is O and X³ is a lone pair. These compounds are hereinafter also referred to as compounds Ia.

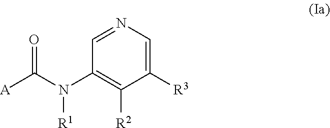

In formula Ia, the variables A, R¹, R² and R³ are as defined herein.

Among the methods and uses comprising compounds of the formula Ia, preference is given to those methods and uses, wherein at least one of the radicals R¹, R² and R³, preferably at least two of the radicals R¹, R² and R³, and more preferably all of the radicals R¹, R² and R³ have one of the preferred meanings.

Among the methods and uses comprising compounds of the formula Ia, preference is further given to those methods and uses, wherein A is a radical selected from the radicals A-1, A-2, A-3, A-4, A-5, A-6, A-7, A-8 and A-9, and particularly selected from the radicals A-1.1 to A-1.173, A-2.1 to A-2.131, A-3.1 to A-3.13, A-4.1 to A-4.11, A-5.1 to A-5.49, A-6.1 to A-6.46, A-7.1 to A-7.19, A-8.1 to A-8.30 and A-9.1 to A-9.25. Among the methods and uses comprising compounds of the formula Ia, particular preference is further given to those methods and uses, wherein A is a radical selected from the radicals A-1, A-2 and A-3, and particularly selected from the radicals A-1.1 to A-1.173, A-2.1 to A-2.131 and A-3.1 to A-3.13. Among the compounds of the formula Ia particular preference is further given to those compounds, wherein A is a radical selected from the radicals A-4, A-5 and A-6, and particularly selected from the radicals A-4.1 to A-4.11, A-5.1 to A-5.49 and A-6.1 to A-6.46.

Among the methods and uses comprising compounds of the formula Ia, preference is further given to those methods and uses, wherein the radicals R¹, R² and R³ have one of the preferred meanings and in particular have one of the following meanings:
R¹ is hydrogen, C₁-C₁₀-alkyl, C₁-C₁₀-haloalkyl, C₁-C₄-alkylene-CN, heterocyclyl-C₁-C₅-alkyl, hetaryl-C₁-C₅-alkyl, C₁-C₅-alkylen-OR^{a} or C₃-C₁₀-cycloalkyl-C₁-C₅-alkyl, wherein the variable R^{a} is as defined above, in particular C₁-C₄-alkyl, C₁-C₄-haloalkyl, C₁-C₄-alkylene-CN, heterocyclylmethyl, hetarylmethyl, C₁-C₃-alkylen-O—C₁-C₃-alkyl or C₃-C₁₀-cycloalkylmethyl, specifically is hydrogen, C₁-C₄-alkyl, C₁-C₃-alkylen-O—C₁-C₃-alkyl or C₁-C₄-alkylene-CN, most preferably is hydrogen, methyl, ethyl, methoxymethyl or ethoxymethyl;
R² is selected from hydrogen, fluorine, chlorine, bromine, methyl, difluoromethyl, trifluoromethyl, methoxy, difluoromethoxy and trifluoromethoxy, and in particular is hydrogen; and
R³ is selected from hydrogen, fluorine, chlorine, bromine, methyl, difluoromethyl, trifluoromethyl, methoxy, difluoromethoxy and trifluoromethoxy; and wherein preferably one or both radicals R² and R³ are hydrogen.

A particularly preferred embodiment of the invention relates to methods and uses comprising compounds of the formula Ia that are selected from compounds of the formula Ia′, including their salts, their N-oxides and the salts of their N-oxides,

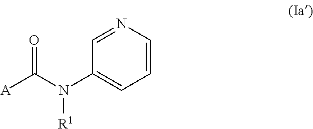

wherein the variables A and R¹ are as defined herein.

In the formula Ia′ the radical R¹ is preferably selected from the group consisting of hydrogen, CN, C₁-C₁₀-alkyl, C₁-C₁₀-haloalkyl, C₂-C₁₀-alkenyl, C₂-C₁₀-haloalkenyl, C₂-C₁₀-alkynyl, C₁-C₄-alkylene-CN, OR^{a}, C(Y)R^{b}, C(Y)OR^{c}, S(O)₂R^{d}, C₁-C₄-alkylen-C(Y)R^{b}, C₁-C₄-alkylen-OR^{a}, C₁-C₄-alkylen-NR^{e}R^{f}, C₁-C₄-alkylen-C(Y)NR^{g}R^{h}, phenyl-C₁-C₄-alkyl, heterocyclyl-C₁-C₄-alkyl and hetaryl-C₁-C₄-alkyl, wherein the last three mentioned radicals may be unsubstituted or may carry 1, 2, 3, 4 or 5 radicals R^{y}, which are as defined above and which are preferably selected from halogen, NO₂, C₁-C₄-alkyl, C₁-C₄-haloalkyl, C₁-C₄-alkoxy, C₁-C₄-haloalkoxy, C₁-C₄-alkylsulfonyl and C₁-C₄-haloalkylsulfonyl,

wherein R^{a}, R^{b}, R^{c}, R^{e} and R^{f} are as defined herein; and in particular selected from the group consisting of hydrogen, C₁-C₄-alkyl, C₁-C₄-haloalkyl, C₁-C₄-alkoxy-C₁-C₄-alkyl, heterocyclyl-C₁-C₄-alkyl and hetaryl-C₁-C₄-alkyl; more preferably from the group consisting of hydrogen, C₁-C₄-alkyl and C₁-C₄-alkoxy-C₁-C₂-alkyl, most preferably from the group consisting of hydrogen, methyl and ethyl, and wherein R^{d} is as defined herein; and in particular selected from the group consisting of C₁-C₄-alkyl, C₁-C₄-haloalkyl, C₁-C₄-alkoxy-C₁-C₄-alkyl, heterocyclyl-C₁-C₄-alkyl and hetaryl-C₁-C₄-alkyl; more preferably from the group consisting of C₁-C₄-alkyl and C₁-C₄-alkoxy-C₁-C₂-alkyl, most preferably from the group consisting of methyl, ethyl, methoxymethyl and ethoxymethyl.

In the formula Ia′ the radical R¹ is in particular selected from hydrogen, C₁-C₁₀-alkyl, C₁-C₁₀-haloalkyl, C₁-C₄-alkylene-CN, C₁-C₅-alkylen-OR^{a}, hetaryl-C₁-C₅-alkyl, heterocyclyl-C₁-C₅-alkyl and C₃-C₁₀-cycloalkyl-C₁-C₅-alkyl, wherein R^{a} is as defined herein and is preferably selected from hydrogen, C₁-C₄-alkyl, C₁-C₄-haloalkyl and C₁-C₄-alkoxy-C₁-C₂-alkyl, and more preferably from hydrogen, methyl, ethyl, difluoromethyl, trifluoromethyl, methoxymethyl and ethoxymethyl.

In the formula Ia′ the radical R¹ is especially selected from hydrogen, C₁-C₃-alkyl, C₁-C₃-haloalkyl and C₁-C₃-alkoxy-C₁-C₃-alkyl.

In the formula Ia′ the radical A has the aforementioned meanings, in particular a preferred meaning. In the formula Ia′ the radical A is preferably a radical selected from the radicals A-1, A-2, A-3, A-4, A-5, A-6, A-7, A-8 and A-9, and particularly selected from the radicals A-1.1 to A-1.173, A-2.1 to A-2.131, A-3.1 to A-3.13, A-4.1 to A-4.11, A-5.1 to A-5.49, A-6.1 to A-6.46, A-7.1 to A-7.19, A-8.1 to A-8.30 and A-9.1 to A-9.25. Among the compounds of the formula Ia′ particular preference is further given to those compounds, wherein A is a radical selected from the radicals A-1, A-2 and A-3, and particularly selected from the radicals A-1.1 to A-1.173, A-2.1 to A-2.131 and A-3.1 to A-3.13. Among the compounds of the formula Ia′ particular preference is further given to those compounds, wherein A is a radical selected from the radicals A-4, A-5 and A-6, and particularly selected from the radicals A-4.1 to A-4.11, A-5.1 to A-5.49 and A-6.1 to A-6.46.

A further particularly preferred embodiment of the invention relates to methods and uses comprising compounds of the formula Ia that are selected from compounds of the formula Ia″, including their salts, their N-oxides and the salts of their N-oxides,

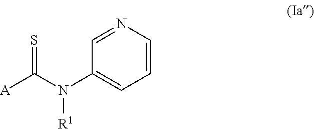

wherein the variables A and R¹ are as defined herein and in particular as defined in connection with formula Ia′.

Examples of for compounds of the formula Ia′ which are suitable in the methods and uses of the present invention are the compounds given in the following tables 1 to 497 and their salts. Tables 1 to 497 themselves represent particular embodiments of compounds for formula Ia′ of the invention with regard to R¹ and B.
Table 1: Methods and uses comprising compounds of the formulae Ia′, or their salts, their N-oxides or the salts of their N-oxides, wherein A is a radical A-1.1 and R¹ has one of the meanings given in Table B.
Table 2: Methods and uses comprising compounds of the formula Ia′, their salts, their N-oxides or the salts of their N-oxides, wherein A is a radical A-1.2 and R¹ has one of the meanings given in Table B.
Table 3: Methods and uses comprising compounds of the formula Ia′, their salts, their N-oxides or the salts of their N-oxides, wherein A is a radical A-1.3 and R¹ has one of the meanings given in Table B.
Table 4: Methods and uses comprising compounds of the formula Ia′, their salts, their N-oxides or the salts of their N-oxides, wherein A is a radical A-1.4 and R¹ has one of the meanings given in Table B.
Table 5: Methods and uses comprising compounds of the formula Ia′, their salts, their N-oxides or the salts of their N-oxides, wherein A is a radical A-1.5 and R¹ has one of the meanings given in Table B.
Table 6: Methods and uses comprising compounds of the formula Ia′, their salts, their N-oxides or the salts of their N-oxides, wherein A is a radical A-1.6 and R¹ has one of the meanings given in Table B.
Table 7: Methods and uses comprising compounds of the formula Ia′, their salts, their N-oxides or the salts of their N-oxides, wherein A is a radical A-1.7 and R¹ has one of the meanings given in Table B.
Table 8: Methods and uses comprising compounds of the formula Ia′, their salts, their N-oxides or the salts of their N-oxides, wherein A is a radical A-1.8 and R¹ has one of the meanings given in Table B.
Table 9: Methods and uses comprising compounds of the formula Ia′, their salts, their N-oxides or the salts of their N-oxides, wherein A is a radical A-1.9 and R¹ has one of the meanings given in Table B.
Table 10: Methods and uses comprising compounds of the formula Ia′, their salts, their N-oxides or the salts of their N-oxides, wherein A is a radical A-1.10 and R¹ has one of the meanings given in Table B.
Table 11: Methods and uses comprising compounds of the formula Ia′, their salts, their N-oxides or the salts of their N-oxides, wherein A is a radical A-1.11 and R¹ has one of the meanings given in Table B.
Table 12: Methods and uses comprising compounds of the formula Ia′, their salts, their N-oxides or the salts of their N-oxides, wherein A is a radical A-1.12 and R¹ has one of the meanings given in Table B.
Table 13: Methods and uses comprising compounds of the formula Ia′, their salts, their N-oxides or the salts of their N-oxides, wherein A is a radical A-1.13 and R¹ has one of the meanings given in Table B. Table 14: Methods and uses comprising compounds of the formula Ia′, their salts, their N-oxides or the salts of their N-oxides, wherein A is a radical A-1.14 and R¹ has one of the meanings given in Table B.
Table 15: Methods and uses comprising compounds of the formula Ia′, their salts, their N-oxides or the salts of their N-oxides, wherein A is a radical A-1.15 and R¹ has one of the meanings given in Table B.
Table 16: Methods and uses comprising compounds of the formula Ia′, their salts, their N-oxides or the salts of their N-oxides, wherein A is a radical A-1.16 and R¹ has one of the meanings given in Table B.
Table 17: Methods and uses comprising compounds of the formula Ia′, their salts, their N-oxides or the salts of their N-oxides, wherein A is a radical A-1.17 and R¹ has one of the meanings given in Table B.
Table 18: Methods and uses comprising compounds of the formula Ia′, their salts, their N-oxides or the salts of their N-oxides, wherein A is a radical A-1.18 and R¹ has one of the meanings given in Table B.
Table 19: Methods and uses comprising compounds of the formula Ia′, their salts, their N-oxides or the salts of their N-oxides, wherein A is a radical A-1.19 and R¹ has one of the meanings given in Table B.
Table 20: Methods and uses comprising compounds of the formula Ia′, their salts, their N-oxides or the salts of their N-oxides, wherein A is a radical A-1.20 and R¹ has one of the meanings given in Table B.
Table 21: Methods and uses comprising compounds of the formula Ia′, their salts, their N-oxides or the salts of their N-oxides, wherein A is a radical A-1.21 and R¹ has one of the meanings given in Table B.
Table 22: Methods and uses comprising compounds of the formula Ia′, their salts, their N-oxides or the salts of their N-oxides, wherein A is a radical A-1.22 and R¹ has one of the meanings given in Table B.
Table 23: Methods and uses comprising compounds of the formula Ia′, their salts, their N-oxides or the salts of their N-oxides, wherein A is a radical A-1.23 and R¹ has one of the meanings given in Table B.
Table 24: Methods and uses comprising compounds of the formula Ia′, their salts, their N-oxides or the salts of their N-oxides, wherein A is a radical A-1.24 and R¹ has one of the meanings given in Table B.
Table 25: Methods and uses comprising compounds of the formula Ia′, their salts, their N-oxides or the salts of their N-oxides, wherein A is a radical A-1.25 and R¹ has one of the meanings given in Table B.
Table 26: Methods and uses comprising compounds of the formula Ia′, their salts, their N-oxides or the salts of their N-oxides, wherein A is a radical A-1.26 and R¹ has one of the meanings given in Table B.
Table 27: Methods and uses comprising compounds of the formula Ia′, their salts, their N-oxides or the salts of their N-oxides, wherein A is a radical A-1.27 and R¹ has one of the meanings given in Table B.
Table 28: Methods and uses comprising compounds of the formula Ia′, their salts, their N-oxides or the salts of their N-oxides, wherein A is a radical A-1.28 and R¹ has one of the meanings given in Table B.
Table 29: Methods and uses comprising compounds of the formula Ia′, their salts, their N-oxides or the salts of their N-oxides, wherein A is a radical A-1.29 and R¹ has one of the meanings given in Table B.
Table 30: Methods and uses comprising compounds of the formula Ia′, their salts, their N-oxides or the salts of their N-oxides, wherein A is a radical A-1.30 and R¹ has one of the meanings given in Table B.
Table 31: Methods and uses comprising compounds of the formula Ia′, their salts, their N-oxides or the salts of their N-oxides, wherein A is a radical A-1.31 and R¹ has one of the meanings given in Table B.
Table 32: Methods and uses comprising compounds of the formula Ia′, their salts, their N-oxides or the salts of their N-oxides, wherein A is a radical A-1.32 and R¹ has one of the meanings given in Table B.
Table 33: Methods and uses comprising compounds of the formula Ia′, their salts, their N-oxides or the salts of their N-oxides, wherein A is a radical A-1.33 and R¹ has one of the meanings given in Table B.
Table 34: Methods and uses comprising compounds of the formula Ia′, their salts, their N-oxides or the salts of their N-oxides, wherein A is a radical A-1.34 and R¹ has one of the meanings given in Table B.
Table 35: Methods and uses comprising compounds of the formula Ia′, their salts, their N-oxides or the salts of their N-oxides, wherein A is a radical A-1.35 and R¹ has one of the meanings given in Table B.
Table 36: Methods and uses comprising compounds of the formula Ia′, their salts, their N-oxides or the salts of their N-oxides, wherein A is a radical A-1.36 and R¹ has one of the meanings given in Table B.
Table 37: Methods and uses comprising compounds of the formula Ia′, their salts, their N-oxides or the salts of their N-oxides, wherein A is a radical A-1.37 and R¹ has one of the meanings given in Table B.
Table 38: Methods and uses comprising compounds of the formula Ia′, their salts, their N-oxides or the salts of their N-oxides, wherein A is a radical A-1.38 and R¹ has one of the meanings given in Table B.
Table 39: Methods and uses comprising compounds of the formula Ia′, their salts, their N-oxides or the salts of their N-oxides, wherein A is a radical A-1.39 and R¹ has one of the meanings given in Table B.
Table 40: Methods and uses comprising compounds of the formula Ia′, their salts, their N-oxides or the salts of their N-oxides, wherein A is a radical A-1.40 and R¹ has one of the meanings given in Table B.
Table 41: Methods and uses comprising compounds of the formula Ia′, their salts, their N-oxides or the salts of their N-oxides, wherein A is a radical A-1.41 and R¹ has one of the meanings given in Table B.
Table 42: Methods and uses comprising compounds of the formula Ia′, their salts, their N-oxides or the salts of their N-oxides, wherein A is a radical A-1.42 and R¹ has one of the meanings given in Table B.
Table 43: Methods and uses comprising compounds of the formula Ia′, their salts, their N-oxides or the salts of their N-oxides, wherein A is a radical A-1.43 and R¹ has one of the meanings given in Table B.
Table 44: Methods and uses comprising compounds of the formula Ia′, their salts, their N-oxides or the salts of their N-oxides, wherein A is a radical A-1.44 and R¹ has one of the meanings given in Table B.
Table 45: Methods and uses comprising compounds of the formula Ia′, their salts, their N-oxides or the salts of their N-oxides, wherein A is a radical A-1.45 and R¹ has one of the meanings given in Table B.
Table 46: Methods and uses comprising compounds of the formula Ia′, their salts, their N-oxides or the salts of their N-oxides, wherein A is a radical A-1.46 and R¹ has one of the meanings given in Table B.
Table 47: Methods and uses comprising compounds of the formula Ia′, their salts, their N-oxides or the salts of their N-oxides, wherein A is a radical A-1.47 and R¹ has one of the meanings given in Table B.
Table 48: Methods and uses comprising compounds of the formula Ia′, their salts, their N-oxides or the salts of their N-oxides, wherein A is a radical A-1.48 and R¹ has one of the meanings given in Table B.
Table 49: Methods and uses comprising compounds of the formula Ia′, their salts, their N-oxides or the salts of their N-oxides, wherein A is a radical A-1.49 and R¹ has one of the meanings given in Table B.
Table 50: Methods and uses comprising compounds of the formula Ia′, their salts, their N-oxides or the salts of their N-oxides, wherein A is a radical A-1.50 and R¹ has one of the meanings given in Table B.
Table 51: Methods and uses comprising compounds of the formula Ia′, their salts, their N-oxides or the salts of their N-oxides, wherein A is a radical A-1.51 and R¹ has one of the meanings given in Table B.
Table 52: Methods and uses comprising compounds of the formula Ia′, their salts, their N-oxides or the salts of their N-oxides, wherein A is a radical A-1.52 and R¹ has one of the meanings given in Table B.
Table 53: Methods and uses comprising compounds of the formula Ia′, their salts, their N-oxides or the salts of their N-oxides, wherein A is a radical A-1.53 and R¹ has one of the meanings given in Table B.
Table 54: Methods and uses comprising compounds of the formula Ia′, their salts, their N-oxides or the salts of their N-oxides, wherein A is a radical A-1.54 and R¹ has one of the meanings given in Table B.
Table 55: Methods and uses comprising compounds of the formula Ia′, their salts, their N-oxides or the salts of their N-oxides, wherein A is a radical A-1.55 and R¹ has one of the meanings given in Table B.
Table 56: Methods and uses comprising compounds of the formula Ia′, their salts, their N-oxides or the salts of their N-oxides, wherein A is a radical A-1.56 and R¹ has one of the meanings given in Table B.
Table 57: Methods and uses comprising compounds of the formula Ia′, their salts, their N-oxides or the salts of their N-oxides, wherein A is a radical A-1.57 and R¹ has one of the meanings given in Table B.
Table 58: Methods and uses comprising compounds of the formula Ia′, their salts, their N-oxides or the salts of their N-oxides, wherein A is a radical A-1.58 and R¹ has one of the meanings given in Table B.
Table 59: Methods and uses comprising compounds of the formula Ia′, their salts, their N-oxides or the salts of their N-oxides, wherein A is a radical A-1.59 and R¹ has one of the meanings given in Table B.
Table 60: Methods and uses comprising compounds of the formula Ia′, their salts, their N-oxides or the salts of their N-oxides, wherein A is a radical A-1.60 and R¹ has one of the meanings given in Table B.
Table 61: Methods and uses comprising compounds of the formula Ia′, their salts, their N-oxides or the salts of their N-oxides, wherein A is a radical A-1.61 and R¹ has one of the meanings given in Table B.
Table 62: Methods and uses comprising compounds of the formula Ia′, their salts, their N-oxides or the salts of their N-oxides, wherein A is a radical A-1.62 and R¹ has one of the meanings given in Table B.
Table 63: Methods and uses comprising compounds of the formula Ia′, their salts, their N-oxides or the salts of their N-oxides, wherein A is a radical A-1.63 and R¹ has one of the meanings given in Table B.
Table 64: Methods and uses comprising compounds of the formula Ia′, their salts, their N-oxides or the salts of their N-oxides, wherein A is a radical A-1.64 and R¹ has one of the meanings given in Table B.
Table 65: Methods and uses comprising compounds of the formula Ia′, their salts, their N-oxides or the salts of their N-oxides, wherein A is a radical A-1.65 and R¹ has one of the meanings given in Table B.
Table 66: Methods and uses comprising compounds of the formula Ia′, their salts, their N-oxides or the salts of their N-oxides, wherein A is a radical A-1.66 and R¹ has one of the meanings given in Table B.
Table 67: Methods and uses comprising compounds of the formula Ia′, their salts, their N-oxides or the salts of their N-oxides, wherein A is a radical A-1.67 and R¹ has one of the meanings given in Table B.
Table 68: Methods and uses comprising compounds of the formula Ia′, their salts, their N-oxides or the salts of their N-oxides, wherein A is a radical A-1.68 and R¹ has one of the meanings given in Table B.
Table 69: Methods and uses comprising compounds of the formula Ia′, their salts, their N-oxides or the salts of their N-oxides, wherein A is a radical A-1.69 and R¹ has one of the meanings given in Table B.
Table 70: Methods and uses comprising compounds of the formula Ia′, their salts, their N-oxides or the salts of their N-oxides, wherein A is a radical A-1.70 and R¹ has one of the meanings given in Table B.
Table 71: Methods and uses comprising compounds of the formula Ia′, their salts, their N-oxides or the salts of their N-oxides, wherein A is a radical A-1.71 and R¹ has one of the meanings given in Table B.
Table 72: Methods and uses comprising compounds of the formula Ia′, their salts, their N-oxides or the salts of their N-oxides, wherein A is a radical A-1.72 and R¹ has one of the meanings given in Table B.
Table 73: Methods and uses comprising compounds of the formula Ia′, their salts, their N-oxides or the salts of their N-oxides, wherein A is a radical A-1.73 and R¹ has one of the meanings given in Table B.
Table 74: Methods and uses comprising compounds of the formula Ia′, their salts, their N-oxides or the salts of their N-oxides, wherein A is a radical A-1.74 and R¹ has one of the meanings given in Table B.
Table 75: Methods and uses comprising compounds of the formula Ia′, their salts, their N-oxides or the salts of their N-oxides, wherein A is a radical A-1.75 and R¹ has one of the meanings given in Table B.
Table 76: Methods and uses comprising compounds of the formula Ia′, their salts, their N-oxides or the salts of their N-oxides, wherein A is a radical A-1.76 and R¹ has one of the meanings given in Table B.
Table 77: Methods and uses comprising compounds of the formula Ia′, their salts, their N-oxides or the salts of their N-oxides, wherein A is a radical A-1.77 and R¹ has one of the meanings given in Table B.
Table 78: Methods and uses comprising compounds of the formula Ia′, their salts, their N-oxides or the salts of their N-oxides, wherein A is a radical A-1.78 and R¹ has one of the meanings given in Table B.
Table 79: Methods and uses comprising compounds of the formula Ia′, their salts, their N-oxides or the salts of their N-oxides, wherein A is a radical A-1.79 and R¹ has one of the meanings given in Table B.
Table 80: Methods and uses comprising compounds of the formula Ia′, their salts, their N-oxides or the salts of their N-oxides, wherein A is a radical A-1.80 and R¹ has one of the meanings given in Table B.
Table 81: Methods and uses comprising compounds of the formula Ia′, their salts, their N-oxides or the salts of their N-oxides, wherein A is a radical A-1.81 and R¹ has one of the meanings given in Table B.
Table 82: Methods and uses comprising compounds of the formula Ia′, their salts, their N-oxides or the salts of their N-oxides, wherein A is a radical A-1.82 and R¹ has one of the meanings given in Table B.
Table 83: Methods and uses comprising compounds of the formula Ia′, their salts, their N-oxides or the salts of their N-oxides, wherein A is a radical A-1.83 and R¹ has one of the meanings given in Table B.
Table 84: Methods and uses comprising compounds of the formula Ia′, their salts, their N-oxides or the salts of their N-oxides, wherein A is a radical A-1.84 and R¹ has one of the meanings given in Table B.
Table 85: Methods and uses comprising compounds of the formula Ia′, their salts, their N-oxides or the salts of their N-oxides, wherein A is a radical A-1.85 and R¹ has one of the meanings given in Table B.
Table 86: Methods and uses comprising compounds of the formula Ia′, their salts, their N-oxides or the salts of their N-oxides, wherein A is a radical A-1.86 and R¹ has one of the meanings given in Table B.
Table 87: Methods and uses comprising compounds of the formula Ia′, their salts, their N-oxides or the salts of their N-oxides, wherein A is a radical A-1.87 and R¹ has one of the meanings given in Table B.
Table 88: Methods and uses comprising compounds of the formula Ia′, their salts, their N-oxides or the salts of their N-oxides, wherein A is a radical A-1.88 and R¹ has one of the meanings given in Table B.
Table 89: Methods and uses comprising compounds of the formula Ia′, their salts, their N-oxides or the salts of their N-oxides, wherein A is a radical A-1.89 and R¹ has one of the meanings given in Table B.
Table 90: Methods and uses comprising compounds of the formula Ia′, their salts, their N-oxides or the salts of their N-oxides, wherein A is a radical A-1.90 and R¹ has one of the meanings given in Table B.
Table 91: Methods and uses comprising compounds of the formula Ia′, their salts, their N-oxides or the salts of their N-oxides, wherein A is a radical A-1.91 and R¹ has one of the meanings given in Table B.
Table 92: Methods and uses comprising compounds of the formula Ia′, their salts, their N-oxides or the salts of their N-oxides, wherein A is a radical A-1.92 and R¹ has one of the meanings given in Table B.
Table 93: Methods and uses comprising compounds of the formula Ia′, their salts, their N-oxides or the salts of their N-oxides, wherein A is a radical A-1.93 and R¹ has one of the meanings given in Table B.
Table 94: Methods and uses comprising compounds of the formula Ia′, their salts, their N-oxides or the salts of their N-oxides, wherein A is a radical A-1.94 and R¹ has one of the meanings given in Table B.
Table 95: Methods and uses comprising compounds of the formula Ia′, their salts, their N-oxides or the salts of their N-oxides, wherein A is a radical A-1.95 and R¹ has one of the meanings given in Table B.
Table 96: Methods and uses comprising compounds of the formula Ia′, their salts, their N-oxides or the salts of their N-oxides, wherein A is a radical A-1.96 and R¹ has one of the meanings given in Table B.
Table 97: Methods and uses comprising compounds of the formula Ia′, their salts, their N-oxides or the salts of their N-oxides, wherein A is a radical A-1.97 and R¹ has one of the meanings given in Table B.
Table 98: Methods and uses comprising compounds of the formula Ia′, their salts, their N-oxides or the salts of their N-oxides, wherein A is a radical A-1.98 and R¹ has one of the meanings given in Table B.
Table 99: Methods and uses comprising compounds of the formula Ia′, their salts, their N-oxides or the salts of their N-oxides, wherein A is a radical A-1.99 and R¹ has one of the meanings given in Table B.
Table 100: Methods and uses comprising compounds of the formula Ia′, their salts, their N-oxides or the salts of their N-oxides, wherein A is a radical A-1.100 and R¹ has one of the meanings given in Table B.
Table 101: Methods and uses comprising compounds of the formula Ia′, their salts, their N-oxides or the salts of their N-oxides, wherein A is a radical A-1.101 and R¹ has one of the meanings given in Table B.
Table 102: Methods and uses comprising compounds of the formula Ia′, their salts, their N-oxides or the salts of their N-oxides, wherein A is a radical A-1.102 and R¹ has one of the meanings given in Table B.
Table 103: Methods and uses comprising compounds of the formula Ia′, their salts, their N-oxides or the salts of their N-oxides, wherein A is a radical A-1.103 and R¹ has one of the meanings given in Table B.
Table 104: Methods and uses comprising compounds of the formula Ia′, their salts, their N-oxides or the salts of their N-oxides, wherein A is a radical A-1.104 and R¹ has one of the meanings given in Table B.
Table 105: Methods and uses comprising compounds of the formula Ia′, their salts, their N-oxides or the salts of their N-oxides, wherein A is a radical A-1.105 and R¹ has one of the meanings given in Table B.
Table 106: Methods and uses comprising compounds of the formula Ia′, their salts, their N-oxides or the salts of their N-oxides, wherein A is a radical A-1.106 and R¹ has one of the meanings given in Table B.
Table 107: Methods and uses comprising compounds of the formula Ia′, their salts, their N-oxides or the salts of their N-oxides, wherein A is a radical A-1.107 and R¹ has one of the meanings given in Table B.
Table 108: Methods and uses comprising compounds of the formula Ia′, their salts, their N-oxides or the salts of their N-oxides, wherein A is a radical A-1.108 and R¹ has one of the meanings given in Table B.
Table 109: Methods and uses comprising compounds of the formula Ia′, their salts, their N-oxides or the salts of their N-oxides, wherein A is a radical A-1.109 and R¹ has one of the meanings given in Table B.
Table 110: Methods and uses comprising compounds of the formula Ia′, their salts, their N-oxides or the salts of their N-oxides, wherein A is a radical A-1.110 and R¹ has one of the meanings given in Table B.
Table 111: Methods and uses comprising compounds of the formula Ia′, their salts, their N-oxides or the salts of their N-oxides, wherein A is a radical A-1.111 and R¹ has one of the meanings given in Table B.
Table 112: Methods and uses comprising compounds of the formula Ia′, their salts, their N-oxides or the salts of their N-oxides, wherein A is a radical A-1.112 and R¹ has one of the meanings given in Table B.
Table 113: Methods and uses comprising compounds of the formula Ia′, their salts, their N-oxides or the salts of their N-oxides, wherein A is a radical A-1.113 and R¹ has one of the meanings given in Table B.
Table 114: Methods and uses comprising compounds of the formula Ia′, their salts, their N-oxides or the salts of their N-oxides, wherein A is a radical A-1.114 and R¹ has one of the meanings given in Table B.
Table 115: Methods and uses comprising compounds of the formula Ia′, their salts, their N-oxides or the salts of their N-oxides, wherein A is a radical A-1.115 and R¹ has one of the meanings given in Table B.
Table 116: Methods and uses comprising compounds of the formula Ia′, their salts, their N-oxides or the salts of their N-oxides, wherein A is a radical A-1.116 and R¹ has one of the meanings given in Table B.
Table 117: Methods and uses comprising compounds of the formula Ia′, their salts, their N-oxides or the salts of their N-oxides, wherein A is a radical A-1.117 and R¹ has one of the meanings given in Table B.
Table 118: Methods and uses comprising compounds of the formula Ia′, their salts, their N-oxides or the salts of their N-oxides, wherein A is a radical A-1.118 and R¹ has one of the meanings given in Table B.
Table 119: Methods and uses comprising compounds of the formula Ia′, their salts, their N-oxides or the salts of their N-oxides, wherein A is a radical A-1.119 and R¹ has one of the meanings given in Table B.
Table 120: Methods and uses comprising compounds of the formula Ia′, their salts, their N-oxides or the salts of their N-oxides, wherein A is a radical A-1.120 and R¹ has one of the meanings given in Table B.
Table 121: Methods and uses comprising compounds of the formula Ia′, their salts, their N-oxides or the salts of their N-oxides, wherein A is a radical A-1.121 and R¹ has one of the meanings given in Table B.
Table 122: Methods and uses comprising compounds of the formula Ia′, their salts, their N-oxides or the salts of their N-oxides, wherein A is a radical A-1.122 and R¹ has one of the meanings given in Table B.
Table 123: Methods and uses comprising compounds of the formula Ia′, their salts, their N-oxides or the salts of their N-oxides, wherein A is a radical A-1.123 and R¹ has one of the meanings given in Table B.
Table 124: Methods and uses comprising compounds of the formula Ia′, their salts, their N-oxides or the salts of their N-oxides, wherein A is a radical A-1.124 and R¹ has one of the meanings given in Table B.
Table 125: Methods and uses comprising compounds of the formula Ia′, their salts, their N-oxides or the salts of their N-oxides, wherein A is a radical A-1.125 and R¹ has one of the meanings given in Table B.
Table 126: Methods and uses comprising compounds of the formula Ia′, their salts, their N-oxides or the salts of their N-oxides, wherein A is a radical A-1.126 and R¹ has one of the meanings given in Table B.
Table 127: Methods and uses comprising compounds of the formula Ia′, their salts, their N-oxides or the salts of their N-oxides, wherein A is a radical A-1.127 and R¹ has one of the meanings given in Table B.
Table 128: Methods and uses comprising compounds of the formula Ia′, their salts, their N-oxides or the salts of their N-oxides, wherein A is a radical A-1.128 and R¹ has one of the meanings given in Table B.
Table 129: Methods and uses comprising compounds of the formula Ia′, their salts, their N-oxides or the salts of their N-oxides, wherein A is a radical A-1.129 and R¹ has one of the meanings given in Table B.
Table 130: Methods and uses comprising compounds of the formula Ia′, their salts, their N-oxides or the salts of their N-oxides, wherein A is a radical A-1.130 and R¹ has one of the meanings given in Table B.
Table 131: Methods and uses comprising compounds of the formula Ia′, their salts, their N-oxides or the salts of their N-oxides, wherein A is a radical A-1.131 and R¹ has one of the meanings given in Table B.
Table 132: Methods and uses comprising compounds of the formula Ia′, their salts, their N-oxides or the salts of their N-oxides, wherein A is a radical A-1.132 and R¹ has one of the meanings given in Table B.
Table 133: Methods and uses comprising compounds of the formula Ia′, their salts, their N-oxides or the salts of their N-oxides, wherein A is a radical A-1.133 and R¹ has one of the meanings given in Table B.
Table 134: Methods and uses comprising compounds of the formula Ia′, their salts, their N-oxides or the salts of their N-oxides, wherein A is a radical A-1.134 and R¹ has one of the meanings given in Table B.
Table 135: Methods and uses comprising compounds of the formula Ia′, their salts, their N-oxides or the salts of their N-oxides, wherein A is a radical A-1.135 and R¹ has one of the meanings given in Table B.
Table 136: Methods and uses comprising compounds of the formula Ia′, their salts, their N-oxides or the salts of their N-oxides, wherein A is a radical A-1.136 and R¹ has one of the meanings given in Table B.
Table 137: Methods and uses comprising compounds of the formula Ia′, their salts, their N-oxides or the salts of their N-oxides, wherein A is a radical A-1.137 and R¹ has one of the meanings given in Table B.
Table 138: Methods and uses comprising compounds of the formula Ia′, their salts, their N-oxides or the salts of their N-oxides, wherein A is a radical A-1.138 and R¹ has one of the meanings given in Table B.
Table 139: Methods and uses comprising compounds of the formula Ia′, their salts, their N-oxides or the salts of their N-oxides, wherein A is a radical A-1.139 and R¹ has one of the meanings given in Table B.
Table 140: Methods and uses comprising compounds of the formula Ia′, their salts, their N-oxides or the salts of their N-oxides, wherein A is a radical A-1.140 and R¹ has one of the meanings given in Table B.
Table 141: Methods and uses comprising compounds of the formula Ia′, their salts, their N-oxides or the salts of their N-oxides, wherein A is a radical A-1.141 and R¹ has one of the meanings given in Table B.
Table 142: Methods and uses comprising compounds of the formula Ia′, their salts, their N-oxides or the salts of their N-oxides, wherein A is a radical A-1.142 and R¹ has one of the meanings given in Table B.
Table 143: Methods and uses comprising compounds of the formula Ia′, their salts, their N-oxides or the salts of their N-oxides, wherein A is a radical A-1.143 and R¹ has one of the meanings given in Table B.
Table 144: Methods and uses comprising compounds of the formula Ia′, their salts, their N-oxides or the salts of their N-oxides, wherein A is a radical A-1.144 and R¹ has one of the meanings given in Table B.
Table 145: Methods and uses comprising compounds of the formula Ia′, their salts, their N-oxides or the salts of their N-oxides, wherein A is a radical A-1.145 and R¹ has one of the meanings given in Table B.
Table 146: Methods and uses comprising compounds of the formula Ia′, their salts, their N-oxides or the salts of their N-oxides, wherein A is a radical A-1.146 and R¹ has one of the meanings given in Table B.
Table 147: Methods and uses comprising compounds of the formula Ia′, their salts, their N-oxides or the salts of their N-oxides, wherein A is a radical A-1.147 and R¹ has one of the meanings given in Table B.
Table 148: Methods and uses comprising compounds of the formula Ia′, their salts, their N-oxides or the salts of their N-oxides, wherein A is a radical A-1.148 and R¹ has one of the meanings given in Table B.
Table 149: Methods and uses comprising compounds of the formula Ia′, their salts, their N-oxides or the salts of their N-oxides, wherein A is a radical A-1.149 and R¹ has one of the meanings given in Table B.
Table 150: Methods and uses comprising compounds of the formula Ia′, their salts, their N-oxides or the salts of their N-oxides, wherein A is a radical A-1.150 and R¹ has one of the meanings given in Table B.
Table 151: Methods and uses comprising compounds of the formula Ia′, their salts, their N-oxides or the salts of their N-oxides, wherein A is a radical A-1.151 and R¹ has one of the meanings given in Table B.
Table 152: Methods and uses comprising compounds of the formula Ia′, their salts, their N-oxides or the salts of their N-oxides, wherein A is a radical A-1.152 and R¹ has one of the meanings given in Table B.
Table 153: Methods and uses comprising compounds of the formula Ia′, their salts, their N-oxides or the salts of their N-oxides, wherein A is a radical A-1.153 and R¹ has one of the meanings given in Table B.
Table 154: Methods and uses comprising compounds of the formula Ia′, their salts, their N-oxides or the salts of their N-oxides, wherein A is a radical A-1.154 and R¹ has one of the meanings given in Table B.
Table 155: Methods and uses comprising compounds of the formula Ia′, their salts, their N-oxides or the salts of their N-oxides, wherein A is a radical A-1.155 and R¹ has one of the meanings given in Table B.
Table 156: Methods and uses comprising compounds of the formula Ia′, their salts, their N-oxides or the salts of their N-oxides, wherein A is a radical A-1.156 and R¹ has one of the meanings given in Table B.
Table 157: Methods and uses comprising compounds of the formula Ia′, their salts, their N-oxides or the salts of their N-oxides, wherein A is a radical A-1.157 and R¹ has one of the meanings given in Table B.
Table 158: Methods and uses comprising compounds of the formula Ia′, their salts, their N-oxides or the salts of their N-oxides, wherein A is a radical A-1.158 and R¹ has one of the meanings given in Table B.
Table 159: Methods and uses comprising compounds of the formula Ia′, their salts, their N-oxides or the salts of their N-oxides, wherein A is a radical A-1.159 and R¹ has one of the meanings given in Table B.
Table 160: Methods and uses comprising compounds of the formula Ia′, their salts, their N-oxides or the salts of their N-oxides, wherein A is a radical A-1.160 and R¹ has one of the meanings given in Table B.
Table 161: Methods and uses comprising compounds of the formula Ia′, their salts, their N-oxides or the salts of their N-oxides, wherein A is a radical A-1.161 and R¹ has one of the meanings given in Table B.
Table 162: Methods and uses comprising compounds of the formula Ia′, their salts, their N-oxides or the salts of their N-oxides, wherein A is a radical A-1.162 and R¹ has one of the meanings given in Table B.
Table 163: Methods and uses comprising compounds of the formula Ia′, their salts, their N-oxides or the salts of their N-oxides, wherein A is a radical A-1.163 and R¹ has one of the meanings given in Table B.
Table 164: Methods and uses comprising compounds of the formula Ia′, their salts, their N-oxides or the salts of their N-oxides, wherein A is a radical A-1.164 and R¹ has one of the meanings given in Table B.
Table 165: Methods and uses comprising compounds of the formula Ia′, their salts, their N-oxides or the salts of their N-oxides, wherein A is a radical A-1.165 and R¹ has one of the meanings given in Table B.
Table 166: Methods and uses comprising compounds of the formula Ia′, their salts, their N-oxides or the salts of their N-oxides, wherein A is a radical A-1.166 and R¹ has one of the meanings given in Table B.
Table 167: Methods and uses comprising compounds of the formula Ia′, their salts, their N-oxides or the salts of their N-oxides, wherein A is a radical A-1.167 and R¹ has one of the meanings given in Table B.
Table 168: Methods and uses comprising compounds of the formula Ia′, their salts, their N-oxides or the salts of their N-oxides, wherein A is a radical A-1.168 and R¹ has one of the meanings given in Table B.
Table 169: Methods and uses comprising compounds of the formula Ia′, their salts, their N-oxides or the salts of their N-oxides, wherein A is a radical A-1.169 and R¹ has one of the meanings given in Table B.
Table 170: Methods and uses comprising compounds of the formula Ia′, their salts, their N-oxides or the salts of their N-oxides, wherein A is a radical A-1.170 and R¹ has one of the meanings given in Table B.
Table 171: Methods and uses comprising compounds of the formula Ia′, their salts, their N-oxides or the salts of their N-oxides, wherein A is a radical A-1.171 and R¹ has one of the meanings given in Table B.
Table 172: Methods and uses comprising compounds of the formula Ia′, their salts, their N-oxides or the salts of their N-oxides, wherein A is a radical A-1.172 and R¹ has one of the meanings given in Table B.
Table 173: Methods and uses comprising compounds of the formula Ia′, their salts, their N-oxides or the salts of their N-oxides, wherein A is a radical A-1.173 and R¹ has one of the meanings given in Table B.
Table 174: Methods and uses comprising compounds of the formula Ia′, their salts, their N-oxides or the salts of their N-oxides, wherein A is a radical A-2.1 and R¹ has one of the meanings given in Table B.
Table 175: Methods and uses comprising compounds of the formula Ia′, their salts, their N-oxides or the salts of their N-oxides, wherein A is a radical A-2.2 and R¹ has one of the meanings given in Table B.
Table 176: Methods and uses comprising compounds of the formula Ia′, their salts, their N-oxides or the salts of their N-oxides, wherein A is a radical A-2.3 and R¹ has one of the meanings given in Table B.
Table 177: Methods and uses comprising compounds of the formula Ia′, their salts, their N-oxides or the salts of their N-oxides, wherein A is a radical A-2.4 and R¹ has one of the meanings given in Table B.
Table 178: Methods and uses comprising compounds of the formula Ia′, their salts, their N-oxides or the salts of their N-oxides, wherein A is a radical A-2.5 and R¹ has one of the meanings given in Table B.
Table 179: Methods and uses comprising compounds of the formula Ia′, their salts, their N-oxides or the salts of their N-oxides, wherein A is a radical A-2.6 and R¹ has one of the meanings given in Table B.
Table 180: Methods and uses comprising compounds of the formula Ia′, their salts, their N-oxides or the salts of their N-oxides, wherein A is a radical A-2.7 and R¹ has one of the meanings given in Table B.
Table 181: Methods and uses comprising compounds of the formula Ia′, their salts, their N-oxides or the salts of their N-oxides, wherein A is a radical A-2.8 and R¹ has one of the meanings given in Table B.
Table 182: Methods and uses comprising compounds of the formula Ia′, their salts, their N-oxides or the salts of their N-oxides, wherein A is a radical A-2.9 and R¹ has one of the meanings given in Table B.
Table 183: Methods and uses comprising compounds of the formula Ia′, their salts, their N-oxides or the salts of their N-oxides, wherein A is a radical A-2.10 and R¹ has one of the meanings given in Table B.
Table 184: Methods and uses comprising compounds of the formula Ia′, their salts, their N-oxides or the salts of their N-oxides, wherein A is a radical A-2.11 and R¹ has one of the meanings given in Table B.
Table 185: Methods and uses comprising compounds of the formula Ia′, their salts, their N-oxides or the salts of their N-oxides, wherein A is a radical A-2.12 and R¹ has one of the meanings given in Table B.
Table 186: Methods and uses comprising compounds of the formula Ia′, their salts, their N-oxides or the salts of their N-oxides, wherein A is a radical A-2.13 and R¹ has one of the meanings given in Table B.
Table 187: Methods and uses comprising compounds of the formula Ia′, their salts, their N-oxides or the salts of their N-oxides, wherein A is a radical A-2.14 and R¹ has one of the meanings given in Table B.
Table 188: Methods and uses comprising compounds of the formula Ia′, their salts, their N-oxides or the salts of their N-oxides, wherein A is a radical A-2.15 and R¹ has one of the meanings given in Table B.
Table 189: Methods and uses comprising compounds of the formula Ia′, their salts, their N-oxides or the salts of their N-oxides, wherein A is a radical A-2.16 and R¹ has one of the meanings given in Table B.
Table 190: Methods and uses comprising compounds of the formula Ia′, their salts, their N-oxides or the salts of their N-oxides, wherein A is a radical A-2.17 and R¹ has one of the meanings given in Table B.
Table 191: Methods and uses comprising compounds of the formula Ia′, their salts, their N-oxides or the salts of their N-oxides, wherein A is a radical A-2.18 and R¹ has one of the meanings given in Table B.
Table 192: Methods and uses comprising compounds of the formula Ia′, their salts, their N-oxides or the salts of their N-oxides, wherein A is a radical A-2.19 and R¹ has one of the meanings given in Table B.
Table 193: Methods and uses comprising compounds of the formula Ia′, their salts, their N-oxides or the salts of their N-oxides, wherein A is a radical A-2.20 and R¹ has one of the meanings given in Table B.
Table 194: Methods and uses comprising compounds of the formula Ia′, their salts, their N-oxides or the salts of their N-oxides, wherein A is a radical A-2.21 and R¹ has one of the meanings given in Table B.
Table 195: Methods and uses comprising compounds of the formula Ia′, their salts, their N-oxides or the salts of their N-oxides, wherein A is a radical A-2.22 and R¹ has one of the meanings given in Table B.
Table 196: Methods and uses comprising compounds of the formula Ia′, their salts, their N-oxides or the salts of their N-oxides, wherein A is a radical A-2.23 and R¹ has one of the meanings given in Table B.
Table 197: Methods and uses comprising compounds of the formula Ia′, their salts, their N-oxides or the salts of their N-oxides, wherein A is a radical A-2.24 and R¹ has one of the meanings given in Table B.
Table 198: Methods and uses comprising compounds of the formula Ia′, their salts, their N-oxides or the salts of their N-oxides, wherein A is a radical A-2.25 and R¹ has one of the meanings given in Table B.
Table 199: Methods and uses comprising compounds of the formula Ia′, their salts, their N-oxides or the salts of their N-oxides, wherein A is a radical A-2.26 and R¹ has one of the meanings given in Table B.
Table 200: Methods and uses comprising compounds of the formula Ia′, their salts, their N-oxides or the salts of their N-oxides, wherein A is a radical A-2.27 and R¹ has one of the meanings given in Table B.
Table 201: Methods and uses comprising compounds of the formula Ia′, their salts, their N-oxides or the salts of their N-oxides, wherein A is a radical A-2.28 and R¹ has one of the meanings given in Table B.
Table 202: Methods and uses comprising compounds of the formula Ia′, their salts, their N-oxides or the salts of their N-oxides, wherein A is a radical A-2.29 and R¹ has one of the meanings given in Table B.
Table 203: Methods and uses comprising compounds of the formula Ia′, their salts, their N-oxides or the salts of their N-oxides, wherein A is a radical A-2.30 and R¹ has one of the meanings given in Table B.
Table 204: Methods and uses comprising compounds of the formula Ia′, their salts, their N-oxides or the salts of their N-oxides, wherein A is a radical A-2.31 and R¹ has one of the meanings given in Table B.
Table 205: Methods and uses comprising compounds of the formula Ia′, their salts, their N-oxides or the salts of their N-oxides, wherein A is a radical A-2.32 and R¹ has one of the meanings given in Table B.
Table 206: Methods and uses comprising compounds of the formula Ia′, their salts, their N-oxides or the salts of their N-oxides, wherein A is a radical A-2.33 and R¹ has one of the meanings given in Table B.
Table 207: Methods and uses comprising compounds of the formula Ia′, their salts, their N-oxides or the salts of their N-oxides, wherein A is a radical A-2.34 and R¹ has one of the meanings given in Table B.
Table 208: Methods and uses comprising compounds of the formula Ia′, their salts, their N-oxides or the salts of their N-oxides, wherein A is a radical A-2.35 and R¹ has one of the meanings given in Table B.
Table 209: Methods and uses comprising compounds of the formula Ia′, their salts, their N-oxides or the salts of their N-oxides, wherein A is a radical A-2.36 and R¹ has one of the meanings given in Table B.
Table 210: Methods and uses comprising compounds of the formula Ia′, their salts, their N-oxides or the salts of their N-oxides, wherein A is a radical A-2.37 and R¹ has one of the meanings given in Table B.
Table 211: Methods and uses comprising compounds of the formula Ia′, their salts, their N-oxides or the salts of their N-oxides, wherein A is a radical A-2.38 and R¹ has one of the meanings given in Table B.
Table 212: Methods and uses comprising compounds of the formula Ia′, their salts, their N-oxides or the salts of their N-oxides, wherein A is a radical A-2.39 and R¹ has one of the meanings given in Table B.
Table 213: Methods and uses comprising compounds of the formula Ia′, their salts, their N-oxides or the salts of their N-oxides, wherein A is a radical A-2.40 and R¹ has one of the meanings given in Table B.
Table 214: Methods and uses comprising compounds of the formula Ia′, their salts, their N-oxides or the salts of their N-oxides, wherein A is a radical A-2.41 and R¹ has one of the meanings given in Table B.
Table 215: Methods and uses comprising compounds of the formula Ia′, their salts, their N-oxides or the salts of their N-oxides, wherein A is a radical A-2.42 and R¹ has one of the meanings given in Table B.
Table 216: Methods and uses comprising compounds of the formula Ia′, their salts, their N-oxides or the salts of their N-oxides, wherein A is a radical A-2.43 and R¹ has one of the meanings given in Table B.
Table 217: Methods and uses comprising compounds of the formula Ia′, their salts, their N-oxides or the salts of their N-oxides, wherein A is a radical A-2.44 and R¹ has one of the meanings given in Table B.
Table 218: Methods and uses comprising compounds of the formula Ia′, their salts, their N-oxides or the salts of their N-oxides, wherein A is a radical A-2.45 and R¹ has one of the meanings given in Table B.
Table 219: Methods and uses comprising compounds of the formula Ia′, their salts, their N-oxides or the salts of their N-oxides, wherein A is a radical A-2.46 and R¹ has one of the meanings given in Table B.
Table 220: Methods and uses comprising compounds of the formula Ia′, their salts, their N-oxides or the salts of their N-oxides, wherein A is a radical A-2.47 and R¹ has one of the meanings given in Table B.
Table 221: Methods and uses comprising compounds of the formula Ia′, their salts, their N-oxides or the salts of their N-oxides, wherein A is a radical A-2.48 and R¹ has one of the meanings given in Table B.
Table 222: Methods and uses comprising compounds of the formula Ia′, their salts, their N-oxides or the salts of their N-oxides, wherein A is a radical A-2.49 and R¹ has one of the meanings given in Table B.
Table 223: Methods and uses comprising compounds of the formula Ia′, their salts, their N-oxides or the salts of their N-oxides, wherein A is a radical A-2.50 and R¹ has one of the meanings given in Table B.
Table 224: Methods and uses comprising compounds of the formula Ia′, their salts, their N-oxides or the salts of their N-oxides, wherein A is a radical A-2.51 and R¹ has one of the meanings given in Table B.
Table 225: Methods and uses comprising compounds of the formula Ia′, their salts, their N-oxides or the salts of their N-oxides, wherein A is a radical A-2.52 and R¹ has one of the meanings given in Table B.
Table 226: Methods and uses comprising compounds of the formula Ia′, their salts, their N-oxides or the salts of their N-oxides, wherein A is a radical A-2.53 and R¹ has one of the meanings given in Table B.
Table 227: Methods and uses comprising compounds of the formula Ia′, their salts, their N-oxides or the salts of their N-oxides, wherein A is a radical A-2.54 and R¹ has one of the meanings given in Table B.
Table 228: Methods and uses comprising compounds of the formula Ia′, their salts, their N-oxides or the salts of their N-oxides, wherein A is a radical A-2.55 and R¹ has one of the meanings given in Table B.
Table 229: Methods and uses comprising compounds of the formula Ia′, their salts, their N-oxides or the salts of their N-oxides, wherein A is a radical A-2.56 and R¹ has one of the meanings given in Table B.
Table 230: Methods and uses comprising compounds of the formula Ia′, their salts, their N-oxides or the salts of their N-oxides, wherein A is a radical A-2.57 and R¹ has one of the meanings given in Table B.
Table 231: Methods and uses comprising compounds of the formula Ia′, their salts, their N-oxides or the salts of their N-oxides, wherein A is a radical A-2.58 and R¹ has one of the meanings given in Table B.
Table 232: Methods and uses comprising compounds of the formula Ia′, their salts, their N-oxides or the salts of their N-oxides, wherein A is a radical A-2.59 and R¹ has one of the meanings given in Table B.
Table 233: Methods and uses comprising compounds of the formula Ia′, their salts, their N-oxides or the salts of their N-oxides, wherein A is a radical A-2.60 and R¹ has one of the meanings given in Table B.
Table 234: Methods and uses comprising compounds of the formula Ia′, their salts, their N-oxides or the salts of their N-oxides, wherein A is a radical A-2.61 and R¹ has one of the meanings given in Table B.
Table 235: Methods and uses comprising compounds of the formula Ia′, their salts, their N-oxides or the salts of their N-oxides, wherein A is a radical A-2.62 and R¹ has one of the meanings given in Table B.
Table 236: Methods and uses comprising compounds of the formula Ia′, their salts, their N-oxides or the salts of their N-oxides, wherein A is a radical A-2.63 and R¹ has one of the meanings given in Table B.
Table 237: Methods and uses comprising compounds of the formula Ia′, their salts, their N-oxides or the salts of their N-oxides, wherein A is a radical A-2.64 and R¹ has one of the meanings given in Table B.
Table 238: Methods and uses comprising compounds of the formula Ia′, their salts, their N-oxides or the salts of their N-oxides, wherein A is a radical A-2.65 and R¹ has one of the meanings given in Table B.
Table 239: Methods and uses comprising compounds of the formula Ia′, their salts, their N-oxides or the salts of their N-oxides, wherein A is a radical A-2.66 and R¹ has one of the meanings given in Table B.
Table 240: Methods and uses comprising compounds of the formula Ia′, their salts, their N-oxides or the salts of their N-oxides, wherein A is a radical A-2.67 and R¹ has one of the meanings given in Table B.
Table 241: Methods and uses comprising compounds of the formula Ia′, their salts, their N-oxides or the salts of their N-oxides, wherein A is a radical A-2.68 and R¹ has one of the meanings given in Table B.
Table 242: Methods and uses comprising compounds of the formula Ia′, their salts, their N-oxides or the salts of their N-oxides, wherein A is a radical A-2.69 and R¹ has one of the meanings given in Table B.
Table 243: Methods and uses comprising compounds of the formula Ia′, their salts, their N-oxides or the salts of their N-oxides, wherein A is a radical A-2.70 and R¹ has one of the meanings given in Table B.
Table 244: Methods and uses comprising compounds of the formula Ia′, their salts, their N-oxides or the salts of their N-oxides, wherein A is a radical A-2.71 and R¹ has one of the meanings given in Table B.
Table 245: Methods and uses comprising compounds of the formula Ia′, their salts, their N-oxides or the salts of their N-oxides, wherein A is a radical A-2.72 and R¹ has one of the meanings given in Table B.
Table 246: Methods and uses comprising compounds of the formula Ia′, their salts, their N-oxides or the salts of their N-oxides, wherein A is a radical A-2.73 and R¹ has one of the meanings given in Table B.
Table 247: Methods and uses comprising compounds of the formula Ia′, their salts, their N-oxides or the salts of their N-oxides, wherein A is a radical A-2.74 and R¹ has one of the meanings given in Table B.
Table 248: Methods and uses comprising compounds of the formula Ia′, their salts, their N-oxides or the salts of their N-oxides, wherein A is a radical A-2.75 and R¹ has one of the meanings given in Table B.
Table 249: Methods and uses comprising compounds of the formula Ia′, their salts, their N-oxides or the salts of their N-oxides, wherein A is a radical A-2.76 and R¹ has one of the meanings given in Table B.
Table 250: Methods and uses comprising compounds of the formula Ia′, their salts, their N-oxides or the salts of their N-oxides, wherein A is a radical A-2.77 and R¹ has one of the meanings given in Table B.
Table 251: Methods and uses comprising compounds of the formula Ia′, their salts, their N-oxides or the salts of their N-oxides, wherein A is a radical A-2.78 and R¹ has one of the meanings given in Table B.
Table 252: Methods and uses comprising compounds of the formula Ia′, their salts, their N-oxides or the salts of their N-oxides, wherein A is a radical A-2.79 and R¹ has one of the meanings given in Table B.
Table 253: Methods and uses comprising compounds of the formula Ia′, their salts, their N-oxides or the salts of their N-oxides, wherein A is a radical A-2.80 and R¹ has one of the meanings given in Table B.
Table 254: Methods and uses comprising compounds of the formula Ia′, their salts, their N-oxides or the salts of their N-oxides, wherein A is a radical A-2.81 and R¹ has one of the meanings given in Table B.
Table 255: Methods and uses comprising compounds of the formula Ia′, their salts, their N-oxides or the salts of their N-oxides, wherein A is a radical A-2.82 and R¹ has one of the meanings given in Table B.
Table 256: Methods and uses comprising compounds of the formula Ia′, their salts, their N-oxides or the salts of their N-oxides, wherein A is a radical A-2.83 and R¹ has one of the meanings given in Table B.
Table 257: Methods and uses comprising compounds of the formula Ia′, their salts, their N-oxides or the salts of their N-oxides, wherein A is a radical A-2.84 and R¹ has one of the meanings given in Table B.
Table 258: Methods and uses comprising compounds of the formula Ia′, their salts, their N-oxides or the salts of their N-oxides, wherein A is a radical A-2.85 and R¹ has one of the meanings given in Table B.
Table 259: Methods and uses comprising compounds of the formula Ia′, their salts, their N-oxides or the salts of their N-oxides, wherein A is a radical A-2.86 and R¹ has one of the meanings given in Table B.
Table 260: Methods and uses comprising compounds of the formula Ia′, their salts, their N-oxides or the salts of their N-oxides, wherein A is a radical A-2.87 and R¹ has one of the meanings given in Table B.
Table 261: Methods and uses comprising compounds of the formula Ia′, their salts, their N-oxides or the salts of their N-oxides, wherein A is a radical A-2.88 and R¹ has one of the meanings given in Table B.
Table 262: Methods and uses comprising compounds of the formula Ia′, their salts, their N-oxides or the salts of their N-oxides, wherein A is a radical A-2.89 and R¹ has one of the meanings given in Table B.
Table 263: Methods and uses comprising compounds of the formula Ia′, their salts, their N-oxides or the salts of their N-oxides, wherein A is a radical A-2.90 and R¹ has one of the meanings given in Table B.
Table 264: Methods and uses comprising compounds of the formula Ia′, their salts, their N-oxides or the salts of their N-oxides, wherein A is a radical A-2.91 and R¹ has one of the meanings given in Table B.
Table 265: Methods and uses comprising compounds of the formula Ia′, their salts, their N-oxides or the salts of their N-oxides, wherein A is a radical A-2.92 and R¹ has one of the meanings given in Table B.
Table 266: Methods and uses comprising compounds of the formula Ia′, their salts, their N-oxides or the salts of their N-oxides, wherein A is a radical A-2.93 and R¹ has one of the meanings given in Table B.
Table 267: Methods and uses comprising compounds of the formula Ia′, their salts, their N-oxides or the salts of their N-oxides, wherein A is a radical A-2.94 and R¹ has one of the meanings given in Table B.
Table 268: Methods and uses comprising compounds of the formula Ia′, their salts, their N-oxides or the salts of their N-oxides, wherein A is a radical A-2.95 and R¹ has one of the meanings given in Table B.
Table 269: Methods and uses comprising compounds of the formula Ia′, their salts, their N-oxides or the salts of their N-oxides, wherein A is a radical A-2.96 and R¹ has one of the meanings given in Table B.
Table 270: Methods and uses comprising compounds of the formula Ia′, their salts, their N-oxides or the salts of their N-oxides, wherein A is a radical A-2.97 and R¹ has one of the meanings given in Table B.
Table 271: Methods and uses comprising compounds of the formula Ia′, their salts, their N-oxides or the salts of their N-oxides, wherein A is a radical A-2.98 and R¹ has one of the meanings given in Table B.
Table 272: Methods and uses comprising compounds of the formula Ia′, their salts, their N-oxides or the salts of their N-oxides, wherein A is a radical A-2.99 and R¹ has one of the meanings given in Table B.
Table 273: Methods and uses comprising compounds of the formula Ia′, their salts, their N-oxides or the salts of their N-oxides, wherein A is a radical A-2.100 and R¹ has one of the meanings given in Table B.
Table 274: Methods and uses comprising compounds of the formula Ia′, their salts, their N-oxides or the salts of their N-oxides, wherein A is a radical A-2.101 and R¹ has one of the meanings given in Table B.
Table 275: Methods and uses comprising compounds of the formula Ia′, their salts, their N-oxides or the salts of their N-oxides, wherein A is a radical A-2.102 and R¹ has one of the meanings given in Table B.
Table 276: Methods and uses comprising compounds of the formula Ia′, their salts, their N-oxides or the salts of their N-oxides, wherein A is a radical A-2.103 and R¹ has one of the meanings given in Table B.
Table 277: Methods and uses comprising compounds of the formula Ia′, their salts, their N-oxides or the salts of their N-oxides, wherein A is a radical A-2.104 and R¹ has one of the meanings given in Table B.
Table 278: Methods and uses comprising compounds of the formula Ia′, their salts, their N-oxides or the salts of their N-oxides, wherein A is a radical A-2.105 and R¹ has one of the meanings given in Table B.
Table 279: Methods and uses comprising compounds of the formula Ia′, their salts, their N-oxides or the salts of their N-oxides, wherein A is a radical A-2.106 and R¹ has one of the meanings given in Table B.
Table 280: Methods and uses comprising compounds of the formula Ia′, their salts, their N-oxides or the salts of their N-oxides, wherein A is a radical A-2.107 and R¹ has one of the meanings given in Table B.
Table 281: Methods and uses comprising compounds of the formula Ia′, their salts, their N-oxides or the salts of their N-oxides, wherein A is a radical A-2.108 and R¹ has one of the meanings given in Table B.
Table 282: Methods and uses comprising compounds of the formula Ia′, their salts, their N-oxides or the salts of their N-oxides, wherein A is a radical A-2.109 and R¹ has one of the meanings given in Table B.
Table 283: Methods and uses comprising compounds of the formula Ia′, their salts, their N-oxides or the salts of their N-oxides, wherein A is a radical A-2.110 and R¹ has one of the meanings given in Table B.
Table 284: Methods and uses comprising compounds of the formula Ia′, their salts, their N-oxides or the salts of their N-oxides, wherein A is a radical A-2.111 and R¹ has one of the meanings given in Table B.
Table 285: Methods and uses comprising compounds of the formula Ia′, their salts, their N-oxides or the salts of their N-oxides, wherein A is a radical A-2.112 and R¹ has one of the meanings given in Table B.
Table 286: Methods and uses comprising compounds of the formula Ia′, their salts, their N-oxides or the salts of their N-oxides, wherein A is a radical A-2.113 and R¹ has one of the meanings given in Table B.
Table 287: Methods and uses comprising compounds of the formula Ia′, their salts, their N-oxides or the salts of their N-oxides, wherein A is a radical A-2.114 and R¹ has one of the meanings given in Table B.
Table 288: Methods and uses comprising compounds of the formula Ia′, their salts, their N-oxides or the salts of their N-oxides, wherein A is a radical A-2.115 and R¹ has one of the meanings given in Table B.
Table 289: Methods and uses comprising compounds of the formula Ia′, their salts, their N-oxides or the salts of their N-oxides, wherein A is a radical A-2.116 and R¹ has one of the meanings given in Table B.
Table 290: Methods and uses comprising compounds of the formula Ia′, their salts, their N-oxides or the salts of their N-oxides, wherein A is a radical A-2.17 and R¹ has one of the meanings given in Table B.
Table 291: Methods and uses comprising compounds of the formula Ia′, their salts, their N-oxides or the salts of their N-oxides, wherein A is a radical A-2.118 and R¹ has one of the meanings given in Table B.
Table 292: Methods and uses comprising compounds of the formula Ia′, their salts, their N-oxides or the salts of their N-oxides, wherein A is a radical A-2.119 and R¹ has one of the meanings given in Table B.
Table 293: Methods and uses comprising compounds of the formula Ia′, their salts, their N-oxides or the salts of their N-oxides, wherein A is a radical A-2.120 and R¹ has one of the meanings given in Table B.
Table 294: Methods and uses comprising compounds of the formula Ia′, their salts, their N-oxides or the salts of their N-oxides, wherein A is a radical A-2.121 and R¹ has one of the meanings given in Table B.
Table 295: Methods and uses comprising compounds of the formula Ia′, their salts, their N-oxides or the salts of their N-oxides, wherein A is a radical A-2.122 and R¹ has one of the meanings given in Table B.
Table 296: Methods and uses comprising compounds of the formula Ia′, their salts, their N-oxides or the salts of their N-oxides, wherein A is a radical A-2.123 and R¹ has one of the meanings given in Table B.
Table 297: Methods and uses comprising compounds of the formula Ia′, their salts, their N-oxides or the salts of their N-oxides, wherein A is a radical A-2.124 and R¹ has one of the meanings given in Table B.
Table 298: Methods and uses comprising compounds of the formula Ia′, their salts, their N-oxides or the salts of their N-oxides, wherein A is a radical A-2.125 and R¹ has one of the meanings given in Table B.
Table 299: Methods and uses comprising compounds of the formula Ia′, their salts, their N-oxides or the salts of their N-oxides, wherein A is a radical A-2.126 and R¹ has one of the meanings given in Table B.
Table 300: Methods and uses comprising compounds of the formula Ia′, their salts, their N-oxides or the salts of their N-oxides, wherein A is a radical A-2.127 and R¹ has one of the meanings given in Table B.
Table 301: Methods and uses comprising compounds of the formula Ia′, their salts, their N-oxides or the salts of their N-oxides, wherein A is a radical A-2.128 and R¹ has one of the meanings given in Table B.
Table 302: Methods and uses comprising compounds of the formula Ia′, their salts, their N-oxides or the salts of their N-oxides, wherein A is a radical A-2.129 and R¹ has one of the meanings given in Table B.
Table 303: Methods and uses comprising compounds of the formula Ia′, their salts, their N-oxides or the salts of their N-oxides, wherein A is a radical A-2.130 and R¹ has one of the meanings given in Table B.
Table 304: Methods and uses comprising compounds of the formula Ia′, their salts, their N-oxides or the salts of their N-oxides, wherein A is a radical A-2.131 and R¹ has one of the meanings given in Table B.
Table 305: Methods and uses comprising compounds of the formula Ia′, their salts, their N-oxides or the salts of their N-oxides, wherein A is a radical A-3.1 and R¹ has one of the meanings given in Table B.
Table 306: Methods and uses comprising compounds of the formula Ia′, their salts, their N-oxides or the salts of their N-oxides, wherein A is a radical A-3.2 and R¹ has one of the meanings given in Table B.
Table 307: Methods and uses comprising compounds of the formula Ia′, their salts, their N-oxides or the salts of their N-oxides, wherein A is a radical A-3.3 and R¹ has one of the meanings given in Table B.
Table 308: Methods and uses comprising compounds of the formula Ia′, their salts, their N-oxides or the salts of their N-oxides, wherein A is a radical A-3.4 and R¹ has one of the meanings given in Table B.
Table 309: Methods and uses comprising compounds of the formula Ia′, their salts, their N-oxides or the salts of their N-oxides, wherein A is a radical A-3.5 and R¹ has one of the meanings given in Table B.
Table 310: Methods and uses comprising compounds of the formula Ia′, their salts, their N-oxides or the salts of their N-oxides, wherein A is a radical A-3.6 and R¹ has one of the meanings given in Table B.
Table 311: Methods and uses comprising compounds of the formula Ia′, their salts, their N-oxides or the salts of their N-oxides, wherein A is a radical A-3.7 and R¹ has one of the meanings given in Table B.
Table 312: Methods and uses comprising compounds of the formula Ia′, their salts, their N-oxides or the salts of their N-oxides, wherein A is a radical A-3.8 and R¹ has one of the meanings given in Table B.
Table 313: Methods and uses comprising compounds of the formula Ia′, their salts, their N-oxides or the salts of their N-oxides, wherein A is a radical A-3.9 and R¹ has one of the meanings given in Table B.
Table 314: Methods and uses comprising compounds of the formula Ia′, their salts, their N-oxides or the salts of their N-oxides, wherein A is a radical A-3.10 and R¹ has one of the meanings given in Table B.
Table 315: Methods and uses comprising compounds of the formula Ia′, their salts, their N-oxides or the salts of their N-oxides, wherein A is a radical A-3.11 and R¹ has one of the meanings given in Table B.
Table 316: Methods and uses comprising compounds of the formula Ia′, their salts, their N-oxides or the salts of their N-oxides, wherein A is a radical A-3.12 and R¹ has one of the meanings given in Table B.
Table 317: Methods and uses comprising compounds of the formula Ia′, their salts, their N-oxides or the salts of their N-oxides, wherein A is a radical A-3.13 and R¹ has one of the meanings given in Table B.
Table 318: Methods and uses comprising compounds of the formula Ia′, their salts, their N-oxides or the salts of their N-oxides, wherein A is a radical A-4.1 and R¹ has one of the meanings given in Table B.
Table 319: Methods and uses comprising compounds of the formula Ia′, their salts, their N-oxides or the salts of their N-oxides, wherein A is a radical A-4.2 and R¹ has one of the meanings given in Table B.
Table 320: Methods and uses comprising compounds of the formula Ia′, their salts, their N-oxides or the salts of their N-oxides, wherein A is a radical A-4.3 and R¹ has one of the meanings given in Table B.
Table 321: Methods and uses comprising compounds of the formula Ia′, their salts, their N-oxides or the salts of their N-oxides, wherein A is a radical A-4.4 and R¹ has one of the meanings given in Table B.
Table 322: Methods and uses comprising compounds of the formula Ia′, their salts, their N-oxides or the salts of their N-oxides, wherein A is a radical A-4.5 and R¹ has one of the meanings given in Table B.
Table 323: Methods and uses comprising compounds of the formula Ia′, their salts, their N-oxides or the salts of their N-oxides, wherein A is a radical A-4.6 and R¹ has one of the meanings given in Table B.
Table 324: Methods and uses comprising compounds of the formula Ia′, their salts, their N-oxides or the salts of their N-oxides, wherein A is a radical A-4.7 and R¹ has one of the meanings given in Table B.
Table 325: Methods and uses comprising compounds of the formula Ia′, their salts, their N-oxides or the salts of their N-oxides, wherein A is a radical A-4.8 and R¹ has one of the meanings given in Table B.
Table 326: Methods and uses comprising compounds of the formula Ia′, their salts, their N-oxides or the salts of their N-oxides, wherein A is a radical A-4.9 and R¹ has one of the meanings given in Table B.
Table 327: Methods and uses comprising compounds of the formula Ia′, their salts, their N-oxides or the salts of their N-oxides, wherein A is a radical A-4.10 and R¹ has one of the meanings given in Table B.
Table 328: Methods and uses comprising compounds of the formula Ia′, their salts, their N-oxides or the salts of their N-oxides, wherein A is a radical A-4.11 and R¹ has one of the meanings given in Table B.
Table 329: Methods and uses comprising compounds of the formula Ia′, their salts, their N-oxides or the salts of their N-oxides, wherein A is a radical A-5.1 and R¹ has one of the meanings given in Table B.
Table 330: Methods and uses comprising compounds of the formula Ia′, their salts, their N-oxides or the salts of their N-oxides, wherein A is a radical A-5.2 and R¹ has one of the meanings given in Table B.
Table 331: Methods and uses comprising compounds of the formula Ia′, their salts, their N-oxides or the salts of their N-oxides, wherein A is a radical A-5.3 and R¹ has one of the meanings given in Table B.
Table 332: Methods and uses comprising compounds of the formula Ia′, their salts, their N-oxides or the salts of their N-oxides, wherein A is a radical A-5.4 and R¹ has one of the meanings given in Table B.
Table 333: Methods and uses comprising compounds of the formula Ia′, their salts, their N-oxides or the salts of their N-oxides, wherein A is a radical A-5.5 and R¹ has one of the meanings given in Table B.
Table 334: Methods and uses comprising compounds of the formula Ia′, their salts, their N-oxides or the salts of their N-oxides, wherein A is a radical A-5.6 and R¹ has one of the meanings given in Table B.
Table 335: Methods and uses comprising compounds of the formula Ia′, their salts, their N-oxides or the salts of their N-oxides, wherein A is a radical A-5.7 and R¹ has one of the meanings given in Table B.
Table 336: Methods and uses comprising compounds of the formula Ia′, their salts, their N-oxides or the salts of their N-oxides, wherein A is a radical A-5.8 and R¹ has one of the meanings given in Table B.
Table 337: Methods and uses comprising compounds of the formula Ia′, their salts, their N-oxides or the salts of their N-oxides, wherein A is a radical A-5.9 and R¹ has one of the meanings given in Table B.
Table 338: Methods and uses comprising compounds of the formula Ia′, their salts, their N-oxides or the salts of their N-oxides, wherein A is a radical A-5.10 and R¹ has one of the meanings given in Table B.
Table 339: Methods and uses comprising compounds of the formula Ia′, their salts, their N-oxides or the salts of their N-oxides, wherein A is a radical A-5.11 and R¹ has one of the meanings given in Table B.
Table 340: Methods and uses comprising compounds of the formula Ia′, their salts, their N-oxides or the salts of their N-oxides, wherein A is a radical A-5.12 and R¹ has one of the meanings given in Table B.
Table 341: Methods and uses comprising compounds of the formula Ia′, their salts, their N-oxides or the salts of their N-oxides, wherein A is a radical A-5.13 and R¹ has one of the meanings given in Table B.
Table 342: Methods and uses comprising compounds of the formula Ia′, their salts, their N-oxides or the salts of their N-oxides, wherein A is a radical A-5.14 and R¹ has one of the meanings given in Table B.
Table 343: Methods and uses comprising compounds of the formula Ia′, their salts, their N-oxides or the salts of their N-oxides, wherein A is a radical A-5.15 and R¹ has one of the meanings given in Table B.
Table 344: Methods and uses comprising compounds of the formula Ia′, their salts, their N-oxides or the salts of their N-oxides, wherein A is a radical A-5.16 and R¹ has one of the meanings given in Table B.
Table 345: Methods and uses comprising compounds of the formula Ia′, their salts, their N-oxides or the salts of their N-oxides, wherein A is a radical A-5.17 and R¹ has one of the meanings given in Table B.
Table 346: Methods and uses comprising compounds of the formula Ia′, their salts, their N-oxides or the salts of their N-oxides, wherein A is a radical A-5.18 and R¹ has one of the meanings given in Table B.
Table 347: Methods and uses comprising compounds of the formula Ia′, their salts, their N-oxides or the salts of their N-oxides, wherein A is a radical A-5.19 and R¹ has one of the meanings given in Table B.
Table 348: Methods and uses comprising compounds of the formula Ia′, their salts, their N-oxides or the salts of their N-oxides, wherein A is a radical A-5.20 and R¹ has one of the meanings given in Table B.
Table 349: Methods and uses comprising compounds of the formula Ia′, their salts, their N-oxides or the salts of their N-oxides, wherein A is a radical A-5.21 and R¹ has one of the meanings given in Table B.
Table 350: Methods and uses comprising compounds of the formula Ia′, their salts, their N-oxides or the salts of their N-oxides, wherein A is a radical A-5.22 and R¹ has one of the meanings given in Table B.
Table 351: Methods and uses comprising compounds of the formula Ia′, their salts, their N-oxides or the salts of their N-oxides, wherein A is a radical A-5.23 and R¹ has one of the meanings given in Table B.
Table 352: Methods and uses comprising compounds of the formula Ia′, their salts, their N-oxides or the salts of their N-oxides, wherein A is a radical A-5.24 and R¹ has one of the meanings given in Table B.
Table 353: Methods and uses comprising compounds of the formula Ia′, their salts, their N-oxides or the salts of their N-oxides, wherein A is a radical A-5.25 and R¹ has one of the meanings given in Table B.
Table 354: Methods and uses comprising compounds of the formula Ia′, their salts, their N-oxides or the salts of their N-oxides, wherein A is a radical A-5.26 and R¹ has one of the meanings given in Table B.
Table 355: Methods and uses comprising compounds of the formula Ia′, their salts, their N-oxides or the salts of their N-oxides, wherein A is a radical A-5.27 and R¹ has one of the meanings given in Table B.
Table 356: Methods and uses comprising compounds of the formula Ia′, their salts, their N-oxides or the salts of their N-oxides, wherein A is a radical A-5.28 and R¹ has one of the meanings given in Table B.
Table 357: Methods and uses comprising compounds of the formula Ia′, their salts, their N-oxides or the salts of their N-oxides, wherein A is a radical A-5.29 and R¹ has one of the meanings given in Table B.
Table 358: Methods and uses comprising compounds of the formula Ia′, their salts, their N-oxides or the salts of their N-oxides, wherein A is a radical A-5.30 and R¹ has one of the meanings given in Table B.
Table 359: Methods and uses comprising compounds of the formula Ia′, their salts, their N-oxides or the salts of their N-oxides, wherein A is a radical A-5.31 and R¹ has one of the meanings given in Table B.
Table 360: Methods and uses comprising compounds of the formula Ia′, their salts, their N-oxides or the salts of their N-oxides, wherein A is a radical A-5.32 and R¹ has one of the meanings given in Table B.
Table 361: Methods and uses comprising compounds of the formula Ia′, their salts, their N-oxides or the salts of their N-oxides, wherein A is a radical A-5.33 and R¹ has one of the meanings given in Table B.
Table 362: Methods and uses comprising compounds of the formula Ia′, their salts, their N-oxides or the salts of their N-oxides, wherein A is a radical A-5.34 and R¹ has one of the meanings given in Table B.
Table 363: Methods and uses comprising compounds of the formula Ia′, their salts, their N-oxides or the salts of their N-oxides, wherein A is a radical A-5.35 and R¹ has one of the meanings given in Table B.
Table 364: Methods and uses comprising compounds of the formula Ia′, their salts, their N-oxides or the salts of their N-oxides, wherein A is a radical A-5.36 and R¹ has one of the meanings given in Table B.
Table 365: Methods and uses comprising compounds of the formula Ia′, their salts, their N-oxides or the salts of their N-oxides, wherein A is a radical A-5.37 and R¹ has one of the meanings given in Table B.
Table 366: Methods and uses comprising compounds of the formula Ia′, their salts, their N-oxides or the salts of their N-oxides, wherein A is a radical A-5.38 and R¹ has one of the meanings given in Table B.
Table 367: Methods and uses comprising compounds of the formula Ia′, their salts, their N-oxides or the salts of their N-oxides, wherein A is a radical A-5.39 and R¹ has one of the meanings given in Table B.
Table 368: Methods and uses comprising compounds of the formula Ia′, their salts, their N-oxides or the salts of their N-oxides, wherein A is a radical A-5.40 and R¹ has one of the meanings given in Table B.
Table 369: Methods and uses comprising compounds of the formula Ia′, their salts, their N-oxides or the salts of their N-oxides, wherein A is a radical A-5.41 and R¹ has one of the meanings given in Table B.
Table 370: Methods and uses comprising compounds of the formula Ia′, their salts, their N-oxides or the salts of their N-oxides, wherein A is a radical A-5.42 and R¹ has one of the meanings given in Table B.
Table 371: Methods and uses comprising compounds of the formula Ia′, their salts, their N-oxides or the salts of their N-oxides, wherein A is a radical A-5.43 and R¹ has one of the meanings given in Table B.
Table 372: Methods and uses comprising compounds of the formula Ia′, their salts, their N-oxides or the salts of their N-oxides, wherein A is a radical A-5.44 and R¹ has one of the meanings given in Table B.
Table 373: Methods and uses comprising compounds of the formula Ia′, their salts, their N-oxides or the salts of their N-oxides, wherein A is a radical A-5.45 and R¹ has one of the meanings given in Table B.
Table 374: Methods and uses comprising compounds of the formula Ia′, their salts, their N-oxides or the salts of their N-oxides, wherein A is a radical A-5.46 and R¹ has one of the meanings given in Table B.
Table 375: Methods and uses comprising compounds of the formula Ia′, their salts, their N-oxides or the salts of their N-oxides, wherein A is a radical A-5.47 and R¹ has one of the meanings given in Table B.
Table 376: Methods and uses comprising compounds of the formula Ia′, their salts, their N-oxides or the salts of their N-oxides, wherein A is a radical A-5.48 and R¹ has one of the meanings given in Table B.
Table 377: Methods and uses comprising compounds of the formula Ia′, their salts, their N-oxides or the salts of their N-oxides, wherein A is a radical A-5.49 and R¹ has one of the meanings given in Table B.
Table 378: Methods and uses comprising compounds of the formula Ia′, their salts, their N-oxides or the salts of their N-oxides, wherein A is a radical A-6.1 and R¹ has one of the meanings given in Table B.
Table 379: Methods and uses comprising compounds of the formula Ia′, their salts, their N-oxides or the salts of their N-oxides, wherein A is a radical A-6.2 and R¹ has one of the meanings given in Table B.
Table 380: Methods and uses comprising compounds of the formula Ia′, their salts, their N-oxides or the salts of their N-oxides, wherein A is a radical A-6.3 and R¹ has one of the meanings given in Table B.
Table 381: Methods and uses comprising compounds of the formula Ia′, their salts, their N-oxides or the salts of their N-oxides, wherein A is a radical A-6.4 and R¹ has one of the meanings given in Table B.
Table 382: Methods and uses comprising compounds of the formula Ia′, their salts, their N-oxides or the salts of their N-oxides, wherein A is a radical A-6.5 and R¹ has one of the meanings given in Table B.
Table 383: Methods and uses comprising compounds of the formula Ia′, their salts, their N-oxides or the salts of their N-oxides, wherein A is a radical A-6.6 and R¹ has one of the meanings given in Table B.
Table 384: Methods and uses comprising compounds of the formula Ia′, their salts, their N-oxides or the salts of their N-oxides, wherein A is a radical A-6.7 and R¹ has one of the meanings given in Table B.
Table 385: Methods and uses comprising compounds of the formula Ia′, their salts, their N-oxides or the salts of their N-oxides, wherein A is a radical A-6.8 and R¹ has one of the meanings given in Table B.
Table 386: Methods and uses comprising compounds of the formula Ia′, their salts, their N-oxides or the salts of their N-oxides, wherein A is a radical A-6.9 and R¹ has one of the meanings given in Table B.
Table 387: Methods and uses comprising compounds of the formula Ia′, their salts, their N-oxides or the salts of their N-oxides, wherein A is a radical A-6.10 and R¹ has one of the meanings given in Table B.
Table 388: Methods and uses comprising compounds of the formula Ia′, their salts, their N-oxides or the salts of their N-oxides, wherein A is a radical A-6.11 and R¹ has one of the meanings given in Table B.
Table 389: Methods and uses comprising compounds of the formula Ia′, their salts, their N-oxides or the salts of their N-oxides, wherein A is a radical A-6.12 and R¹ has one of the meanings given in Table B.
Table 390: Methods and uses comprising compounds of the formula Ia′, their salts, their N-oxides or the salts of their N-oxides, wherein A is a radical A-6.13 and R¹ has one of the meanings given in Table B.
Table 391: Methods and uses comprising compounds of the formula Ia′, their salts, their N-oxides or the salts of their N-oxides, wherein A is a radical A-6.14 and R¹ has one of the meanings given in Table B.
Table 392: Methods and uses comprising compounds of the formula Ia′, their salts, their N-oxides or the salts of their N-oxides, wherein A is a radical A-6.15 and R¹ has one of the meanings given in Table B.
Table 393: Methods and uses comprising compounds of the formula Ia′, their salts, their N-oxides or the salts of their N-oxides, wherein A is a radical A-6.16 and R¹ has one of the meanings given in Table B.
Table 394: Methods and uses comprising compounds of the formula Ia′, their salts, their N-oxides or the salts of their N-oxides, wherein A is a radical A-6.17 and R¹ has one of the meanings given in Table B.
Table 395: Methods and uses comprising compounds of the formula Ia′, their salts, their N-oxides or the salts of their N-oxides, wherein A is a radical A-6.18 and R¹ has one of the meanings given in Table B.
Table 396: Methods and uses comprising compounds of the formula Ia′, their salts, their N-oxides or the salts of their N-oxides, wherein A is a radical A-6.19 and R¹ has one of the meanings given in Table B.
Table 397: Methods and uses comprising compounds of the formula Ia′, their salts, their N-oxides or the salts of their N-oxides, wherein A is a radical A-6.20 and R¹ has one of the meanings given in Table B.
Table 398: Methods and uses comprising compounds of the formula Ia′, their salts, their N-oxides or the salts of their N-oxides, wherein A is a radical A-6.21 and R¹ has one of the meanings given in Table B.
Table 399: Methods and uses comprising compounds of the formula Ia′, their salts, their N-oxides or the salts of their N-oxides, wherein A is a radical A-6.22 and R¹ has one of the meanings given in Table B.
Table 400: Methods and uses comprising compounds of the formula Ia′, their salts, their N-oxides or the salts of their N-oxides, wherein A is a radical A-6.23 and R¹ has one of the meanings given in Table B.
Table 401: Methods and uses comprising compounds of the formula Ia′, their salts, their N-oxides or the salts of their N-oxides, wherein A is a radical A-6.24 and R¹ has one of the meanings given in Table B.
Table 402: Methods and uses comprising compounds of the formula Ia′, their salts, their N-oxides or the salts of their N-oxides, wherein A is a radical A-6.25 and R¹ has one of the meanings given in Table B.
Table 403: Methods and uses comprising compounds of the formula Ia′, their salts, their N-oxides or the salts of their N-oxides, wherein A is a radical A-6.26 and R¹ has one of the meanings given in Table B.
Table 404: Methods and uses comprising compounds of the formula Ia′, their salts, their N-oxides or the salts of their N-oxides, wherein A is a radical A-6.27 and R¹ has one of the meanings given in Table B.
Table 405: Methods and uses comprising compounds of the formula Ia′, their salts, their N-oxides or the salts of their N-oxides, wherein A is a radical A-6.28 and R¹ has one of the meanings given in Table B.
Table 406: Methods and uses comprising compounds of the formula Ia′, their salts, their N-oxides or the salts of their N-oxides, wherein A is a radical A-6.29 and R¹ has one of the meanings given in Table B.
Table 407: Methods and uses comprising compounds of the formula Ia′, their salts, their N-oxides or the salts of their N-oxides, wherein A is a radical A-6.30 and R¹ has one of the meanings given in Table B.
Table 408: Methods and uses comprising compounds of the formula Ia′, their salts, their N-oxides or the salts of their N-oxides, wherein A is a radical A-6.31 and R¹ has one of the meanings given in Table B.
Table 409: Methods and uses comprising compounds of the formula Ia′, their salts, their N-oxides or the salts of their N-oxides, wherein A is a radical A-6.32 and R¹ has one of the meanings given in Table B.
Table 410: Methods and uses comprising compounds of the formula Ia′, their salts, their N-oxides or the salts of their N-oxides, wherein A is a radical A-6.33 and R¹ has one of the meanings given in Table B.
Table 411: Methods and uses comprising compounds of the formula Ia′, their salts, their N-oxides or the salts of their N-oxides, wherein A is a radical A-6.34 and R¹ has one of the meanings given in Table B.
Table 412: Methods and uses comprising compounds of the formula Ia′, their salts, their N-oxides or the salts of their N-oxides, wherein A is a radical A-6.35 and R¹ has one of the meanings given in Table B.
Table 413: Methods and uses comprising compounds of the formula Ia′, their salts, their N-oxides or the salts of their N-oxides, wherein A is a radical A-6.36 and R¹ has one of the meanings given in Table B.
Table 414: Methods and uses comprising compounds of the formula Ia′, their salts, their N-oxides or the salts of their N-oxides, wherein A is a radical A-6.37 and R¹ has one of the meanings given in Table B.
Table 415: Methods and uses comprising compounds of the formula Ia′, their salts, their N-oxides or the salts of their N-oxides, wherein A is a radical A-6.38 and R¹ has one of the meanings given in Table B.
Table 416: Methods and uses comprising compounds of the formula Ia′, their salts, their N-oxides or the salts of their N-oxides, wherein A is a radical A-6.39 and R¹ has one of the meanings given in Table B.
Table 417: Methods and uses comprising compounds of the formula Ia′, their salts, their N-oxides or the salts of their N-oxides, wherein A is a radical A-6.40 and R¹ has one of the meanings given in Table B.
Table 418: Methods and uses comprising compounds of the formula Ia′, their salts, their N-oxides or the salts of their N-oxides, wherein A is a radical A-6.41 and R¹ has one of the meanings given in Table B.
Table 419: Methods and uses comprising compounds of the formula Ia′, their salts, their N-oxides or the salts of their N-oxides, wherein A is a radical A-6.42 and R¹ has one of the meanings given in Table B.
Table 420: Methods and uses comprising compounds of the formula Ia′, their salts, their N-oxides or the salts of their N-oxides, wherein A is a radical A-6.43 and R¹ has one of the meanings given in Table B.
Table 421: Methods and uses comprising compounds of the formula Ia′, their salts, their N-oxides or the salts of their N-oxides, wherein A is a radical A-6.44 and R¹ has one of the meanings given in Table B.
Table 422: Methods and uses comprising compounds of the formula Ia′, their salts, their N-oxides or the salts of their N-oxides, wherein A is a radical A-6.45 and R¹ has one of the meanings given in Table B.
Table 423: Methods and uses comprising compounds of the formula Ia′, their salts, their N-oxides or the salts of their N-oxides, wherein A is a radical A-6.46 and R¹ has one of the meanings given in Table B.
Table 424: Methods and uses comprising compounds of the formula Ia′, their salts, their N-oxides or the salts of their N-oxides, wherein A is a radical A-7.1 and R¹ has one of the meanings given in Table B.
Table 425: Methods and uses comprising compounds of the formula Ia′, their salts, their N-oxides or the salts of their N-oxides, wherein A is a radical A-7.2 and R¹ has one of the meanings given in Table B.
Table 426: Methods and uses comprising compounds of the formula Ia′, their salts, their N-oxides or the salts of their N-oxides, wherein A is a radical A-7.3 and R¹ has one of the meanings given in Table B.
Table 427: Methods and uses comprising compounds of the formula Ia′, their salts, their N-oxides or the salts of their N-oxides, wherein A is a radical A-7.4 and R¹ has one of the meanings given in Table B.
Table 428: Methods and uses comprising compounds of the formula Ia′, their salts, their N-oxides or the salts of their N-oxides, wherein A is a radical A-7.5 and R¹ has one of the meanings given in Table B.
Table 429: Methods and uses comprising compounds of the formula Ia′, their salts, their N-oxides or the salts of their N-oxides, wherein A is a radical A-7.6 and R¹ has one of the meanings given in Table B.
Table 430: Methods and uses comprising compounds of the formula Ia′, their salts, their N-oxides or the salts of their N-oxides, wherein A is a radical A-7.7 and R¹ has one of the meanings given in Table B.
Table 431: Methods and uses comprising compounds of the formula Ia′, their salts, their N-oxides or the salts of their N-oxides, wherein A is a radical A-7.8 and R¹ has one of the meanings given in Table B.
Table 432: Methods and uses comprising compounds of the formula Ia′, their salts, their N-oxides or the salts of their N-oxides, wherein A is a radical A-7.9 and R¹ has one of the meanings given in Table B.
Table 433: Methods and uses comprising compounds of the formula Ia′, their salts, their N-oxides or the salts of their N-oxides, wherein A is a radical A-7.10 and R¹ has one of the meanings given in Table B.
Table 434: Methods and uses comprising compounds of the formula Ia′, their salts, their N-oxides or the salts of their N-oxides, wherein A is a radical A-7.11 and R¹ has one of the meanings given in Table B.
Table 435: Methods and uses comprising compounds of the formula Ia′, their salts, their N-oxides or the salts of their N-oxides, wherein A is a radical A-7.12 and R¹ has one of the meanings given in Table B.
Table 436: Methods and uses comprising compounds of the formula Ia′, their salts, their N-oxides or the salts of their N-oxides, wherein A is a radical A-7.13 and R¹ has one of the meanings given in Table B.
Table 437: Methods and uses comprising compounds of the formula Ia′, their salts, their N-oxides or the salts of their N-oxides, wherein A is a radical A-7.14 and R¹ has one of the meanings given in Table B.
Table 438: Methods and uses comprising compounds of the formula Ia′, their salts, their N-oxides or the salts of their N-oxides, wherein A is a radical A-7.15 and R¹ has one of the meanings given in Table B.
Table 439: Methods and uses comprising compounds of the formula Ia′, their salts, their N-oxides or the salts of their N-oxides, wherein A is a radical A-7.16 and R¹ has one of the meanings given in Table B.
Table 440: Methods and uses comprising compounds of the formula Ia′, their salts, their N-oxides or the salts of their N-oxides, wherein A is a radical A-7.17 and R¹ has one of the meanings given in Table B.
Table 441: Methods and uses comprising compounds of the formula Ia′, their salts, their N-oxides or the salts of their N-oxides, wherein A is a radical A-7.18 and R¹ has one of the meanings given in Table B.
Table 442: Methods and uses comprising compounds of the formula Ia′, their salts, their N-oxides or the salts of their N-oxides, wherein A is a radical A-7.19 and R¹ has one of the meanings given in Table B.
Table 443: Methods and uses comprising compounds of the formula Ia′, their salts, their N-oxides or the salts of their N-oxides, wherein A is a radical A-8.1 and R¹ has one of the meanings given in Table B.
Table 444: Methods and uses comprising compounds of the formula Ia′, their salts, their N-oxides or the salts of their N-oxides, wherein A is a radical A-8.2 and R¹ has one of the meanings given in Table B.
Table 445: Methods and uses comprising compounds of the formula Ia′, their salts, their N-oxides or the salts of their N-oxides, wherein A is a radical A-8.3 and R¹ has one of the meanings given in Table B.
Table 446: Methods and uses comprising compounds of the formula Ia′, their salts, their N-oxides or the salts of their N-oxides, wherein A is a radical A-8.4 and R¹ has one of the meanings given in Table B.
Table 447: Methods and uses comprising compounds of the formula Ia′, their salts, their N-oxides or the salts of their N-oxides, wherein A is a radical A-8.5 and R¹ has one of the meanings given in Table B.
Table 448: Methods and uses comprising compounds of the formula Ia′, their salts, their N-oxides or the salts of their N-oxides, wherein A is a radical A-8.6 and R¹ has one of the meanings given in Table B.
Table 449: Methods and uses comprising compounds of the formula Ia′, their salts, their N-oxides or the salts of their N-oxides, wherein A is a radical A-8.7 and R¹ has one of the meanings given in Table B.
Table 450: Methods and uses comprising compounds of the formula Ia′, their salts, their N-oxides or the salts of their N-oxides, wherein A is a radical A-8.8 and R¹ has one of the meanings given in Table B.
Table 451: Methods and uses comprising compounds of the formula Ia′, their salts, their N-oxides or the salts of their N-oxides, wherein A is a radical A-8.9 and R¹ has one of the meanings given in Table B.
Table 452: Methods and uses comprising compounds of the formula Ia′, their salts, their N-oxides or the salts of their N-oxides, wherein A is a radical A-8.10 and R¹ has one of the meanings given in Table B.
Table 453: Methods and uses comprising compounds of the formula Ia′, their salts, their N-oxides or the salts of their N-oxides, wherein A is a radical A-8.11 and R¹ has one of the meanings given in Table B.
Table 454: Methods and uses comprising compounds of the formula Ia′, their salts, their N-oxides or the salts of their N-oxides, wherein A is a radical A-8.12 and R¹ has one of the meanings given in Table B.
Table 455: Methods and uses comprising compounds of the formula Ia′, their salts, their N-oxides or the salts of their N-oxides, wherein A is a radical A-8.13 and R¹ has one of the meanings given in Table B.
Table 456: Methods and uses comprising compounds of the formula Ia′, their salts, their N-oxides or the salts of their N-oxides, wherein A is a radical A-8.14 and R¹ has one of the meanings given in Table B.
Table 457: Methods and uses comprising compounds of the formula Ia′, their salts, their N-oxides or the salts of their N-oxides, wherein A is a radical A-8.15 and R¹ has one of the meanings given in Table B.
Table 458: Methods and uses comprising compounds of the formula Ia′, their salts, their N-oxides or the salts of their N-oxides, wherein A is a radical A-8.16 and R¹ has one of the meanings given in Table B.
Table 459: Methods and uses comprising compounds of the formula Ia′, their salts, their N-oxides or the salts of their N-oxides, wherein A is a radical A-8.17 and R¹ has one of the meanings given in Table B.
Table 460: Methods and uses comprising compounds of the formula Ia′, their salts, their N-oxides or the salts of their N-oxides, wherein A is a radical A-8.18 and R¹ has one of the meanings given in Table B.
Table 461: Methods and uses comprising compounds of the formula Ia′, their salts, their N-oxides or the salts of their N-oxides, wherein A is a radical A-8.19 and R¹ has one of the meanings given in Table B.
Table 462: Methods and uses comprising compounds of the formula Ia′, their salts, their N-oxides or the salts of their N-oxides, wherein A is a radical A-8.20 and R¹ has one of the meanings given in Table B.
Table 463: Methods and uses comprising compounds of the formula Ia′, their salts, their N-oxides or the salts of their N-oxides, wherein A is a radical A-8.21 and R¹ has one of the meanings given in Table B.
Table 464: Methods and uses comprising compounds of the formula Ia′, their salts, their N-oxides or the salts of their N-oxides, wherein A is a radical A-8.22 and R¹ has one of the meanings given in Table B.
Table 465: Methods and uses comprising compounds of the formula Ia′, their salts, their N-oxides or the salts of their N-oxides, wherein A is a radical A-8.23 and R¹ has one of the meanings given in Table B.
Table 466: Methods and uses comprising compounds of the formula Ia′, their salts, their N-oxides or the salts of their N-oxides, wherein A is a radical A-8.24 and R¹ has one of the meanings given in Table B.
Table 467: Methods and uses comprising compounds of the formula Ia′, their salts, their N-oxides or the salts of their N-oxides, wherein A is a radical A-8.25 and R¹ has one of the meanings given in Table B.
Table 468: Methods and uses comprising compounds of the formula Ia′, their salts, their N-oxides or the salts of their N-oxides, wherein A is a radical A-8.26 and R¹ has one of the meanings given in Table B.
Table 469: Methods and uses comprising compounds of the formula Ia′, their salts, their N-oxides or the salts of their N-oxides, wherein A is a radical A-8.27 and R¹ has one of the meanings given in Table B.
Table 470: Methods and uses comprising compounds of the formula Ia′, their salts, their N-oxides or the salts of their N-oxides, wherein A is a radical A-8.28 and R¹ has one of the meanings given in Table B.
Table 471: Methods and uses comprising compounds of the formula Ia′, their salts, their N-oxides or the salts of their N-oxides, wherein A is a radical A-8.29 and R¹ has one of the meanings given in Table B.
Table 472: Methods and uses comprising compounds of the formula Ia′, their salts, their N-oxides or the salts of their N-oxides, wherein A is a radical A-8.30 and R¹ has one of the meanings given in Table B.
Table 473: Methods and uses comprising compounds of the formula Ia′, their salts, their N-oxides or the salts of their N-oxides, wherein A is a radical A-9.1 and R¹ has one of the meanings given in Table B.
Table 474: Methods and uses comprising compounds of the formula Ia′, their salts, their N-oxides or the salts of their N-oxides, wherein A is a radical A-9.2 and R¹ has one of the meanings given in Table B.
Table 475: Methods and uses comprising compounds of the formula Ia′, their salts, their N-oxides or the salts of their N-oxides, wherein A is a radical A-9.3 and R¹ has one of the meanings given in Table B.
Table 476: Methods and uses comprising compounds of the formula Ia′, their salts, their N-oxides or the salts of their N-oxides, wherein A is a radical A-9.4 and R¹ has one of the meanings given in Table B.
Table 477: Methods and uses comprising compounds of the formula Ia′, their salts, their N-oxides or the salts of their N-oxides, wherein A is a radical A-9.5 and R¹ has one of the meanings given in Table B.
Table 478: Methods and uses comprising compounds of the formula Ia′, their salts, their N-oxides or the salts of their N-oxides, wherein A is a radical A-9.6 and R¹ has one of the meanings given in Table B.
Table 479: Methods and uses comprising compounds of the formula Ia′, their salts, their N-oxides or the salts of their N-oxides, wherein A is a radical A-9.7 and R¹ has one of the meanings given in Table B.
Table 480: Methods and uses comprising compounds of the formula Ia′, their salts, their N-oxides or the salts of their N-oxides, wherein A is a radical A-9.8 and R¹ has one of the meanings given in Table B.
Table 481: Methods and uses comprising compounds of the formula Ia′, their salts, their N-oxides or the salts of their N-oxides, wherein A is a radical A-9.9 and R¹ has one of the meanings given in Table B.
Table 482: Methods and uses comprising compounds of the formula Ia′, their salts, their N-oxides or the salts of their N-oxides, wherein A is a radical A-9.10 and R¹ has one of the meanings given in Table B.
Table 483: Methods and uses comprising compounds of the formula Ia′, their salts, their N-oxides or the salts of their N-oxides, wherein A is a radical A-9.11 and R¹ has one of the meanings given in Table B.
Table 484: Methods and uses comprising compounds of the formula Ia′, their salts, their N-oxides or the salts of their N-oxides, wherein A is a radical A-9.12 and R¹ has one of the meanings given in Table B.
Table 485: Methods and uses comprising compounds of the formula Ia′, their salts, their N-oxides or the salts of their N-oxides, wherein A is a radical A-9.13 and R¹ has one of the meanings given in Table B.
Table 486: Methods and uses comprising compounds of the formula Ia′, their salts, their N-oxides or the salts of their N-oxides, wherein A is a radical A-9.14 and R¹ has one of the meanings given in Table B.
Table 487: Methods and uses comprising compounds of the formula Ia′, their salts, their N-oxides or the salts of their N-oxides, wherein A is a radical A-9.15 and R¹ has one of the meanings given in Table B.
Table 488: Methods and uses comprising compounds of the formula Ia′, their salts, their N-oxides or the salts of their N-oxides, wherein A is a radical A-9.16 and R¹ has one of the meanings given in Table B.
Table 489: Methods and uses comprising compounds of the formula Ia′, their salts, their N-oxides or the salts of their N-oxides, wherein A is a radical A-9.17 and R¹ has one of the meanings given in Table B.
Table 490: Methods and uses comprising compounds of the formula Ia′, their salts, their N-oxides or the salts of their N-oxides, wherein A is a radical A-9.18 and R¹ has one of the meanings given in Table B.
Table 491: Methods and uses comprising compounds of the formula Ia′, their salts, their N-oxides or the salts of their N-oxides, wherein A is a radical A-9.19 and R¹ has one of the meanings given in Table B.
Table 492: Methods and uses comprising compounds of the formula Ia′, their salts, their N-oxides or the salts of their N-oxides, wherein A is a radical A-9.20 and R¹ has one of the meanings given in Table B.
Table 493: Methods and uses comprising compounds of the formula Ia′, their salts, their N-oxides or the salts of their N-oxides, wherein A is a radical A-9.21 and R¹ has one of the meanings given in Table B.
Table 494: Methods and uses comprising compounds of the formula Ia′, their salts, their N-oxides or the salts of their N-oxides, wherein A is a radical A-9.22 and R¹ has one of the meanings given in Table B.
Table 495: Methods and uses comprising compounds of the formula Ia′, their salts, their N-oxides or the salts of their N-oxides, wherein A is a radical A-9.23 and R¹ has one of the meanings given in Table B.
Table 496: Methods and uses comprising compounds of the formula Ia′, their salts, their N-oxides or the salts of their N-oxides, wherein A is a radical A-9.24 and R¹ has one of the meanings given in Table B.
Table 497: Methods and uses comprising compounds of the formula Ia′, their salts, their N-oxides or the salts of their N-oxides, wherein A is a radical A-9.25 and R¹ has one of the meanings given in Table B.

Examples of for compounds of the formula Ia″ which are suitable in the methods and uses of the present invention are the compounds of the formula Ia″, wherein A is as defined in tables 1 to 497 and wherein R¹ has one of the meanings given in Table B (tables 498 to 994). Tables 498 to 994 themselves represent particular embodiments of compounds for formula Ia″ of the invention with regard to R¹ and B.

TABLE B

| line | radical R¹ |
|---|---|
| 1 | hydrogen |
| 2 | methyl |
| 3 | ethyl |
| 4 | n-propyl |
| 5 | isopropyl |
| 6 | n-butyl |
| 7 | tert.-butyl |
| 8 | 2-methylpropyl |
| 9 | 2-fluoroethyl |
| 10 | 2-chloroethyl |
| 11 | 2-bromethyl |
| 12 | 2,2-difluoroethyl |
| 13 | 2,2-dichloroethyl |
| 14 | 2,2-dibromoethyl |
| 15 | 2,2,2-trifluoroethy |
| 16 | cyanomethyl |
| 17 | cyanoethyl |
| 18 | methoxymethyl |
| 19 | ethoxymethyl |
| 20 | 2-methoxyethyl |
| 21 | 2-ethoxyethyl; |
| 22 | cyclopropylmethyl |
| 23 | cyclobutylmethyl |
| 24 | cyclopentylmethyl |
| 25 | benzyl |
| 26 | oxetan-2-ylmethyl |
| 27 | oxetan-3-ylmethyl |
| 28 | thietan-3-ylmethyl |
| 29 | 3,3-dioxathietan-3-ylmethyl |
| 30 | oxolan-2-ylmethyl |
| 31 | oxolan-3-ylmethyl |
| 32 | oxazolin-2-ylmethyl |
| 33 | thiazolin-2-ylmethyl |
| 34 | 1H-imidazolin-2-ylmethyl |
| 35 | 2-furylmethyl |
| 36 | 3-furylmethyl |
| 37 | 2-thienylmethyl |
| 38 | 3-thienylmethyl |
| 39 | isothiazol-3-ylmethyl |
| 40 | isothiazol-4-ylmethyl |
| 41 | isothiazol-5-ylmethyl |
| 42 | isoxazol-3-ylmethyl |
| 43 | oxazol-2-ylmethyl |
| 44 | oxazol-4-ylmethyl |
| 45 | oxazol-5-ylmethyl |
| 46 | thiazol-2-ylmethyl |
| 47 | thiazol-4-ylmethyl |
| 48 | thiazol-5-ylmethyl |
| 49 | 1H-pyrazol-3-ylmethyl |
| 50 | 1H-pyrazol-4-ylmethyl |
| 51 | 2H-pyrazol-3-ylmethyl |
| 52 | 1H-imidazol-2-ylmethyl |
| 53 | 1H-imidazol-4-ylmethyl |
| 54 | 1H-imidazol-5-ylmethyl |

The compounds of the formulae I or II can be prepared by the standard methods of organic chemistry, e.g. by the methods described hereinafter or in the working examples:

The compounds of the formula I, wherein X¹ is O and X³ is a lone pair (compounds of the formula Ia), can be prepared e.g. according to the method depicted in scheme 1 by reacting an activated carboxylic acid derivative III with a 3-aminopyridine, compound IV (see e.g. Houben-Weyl: “Methoden der organ. Chemie” [Methods of Organic Chemistry], Georg-Thieme-Verlag, Stuttgart, New York 1985, Volume E5, pp. 941-1045). Activated carboxylic acid derivatives III are, for example, acyl halides, activated esters, anhydrides, acyl azides, wherein the leaving group X is for example chlorine, fluorine, bromine, N₃, para-nitrophenoxy, pentafluorophenoxy, N-hydroxysuccinimides or hydroxybenzotriazol-1-yl. In scheme 1, the radicals A, R¹, R² and R³ have the meanings mentioned above and in particular the meanings mentioned as being preferred.

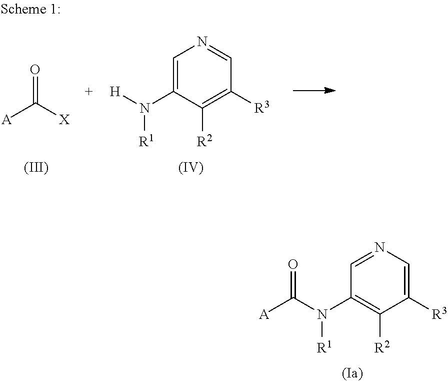

The compounds of the formula I, wherein X¹ is O and X³ is a lone pair (compounds of the formula Ia), can also be prepared, for example, by reacting the carboxylic acid V and the 3-aminopyridine compound IV, in the presence of a coupling agent according to scheme 2. In scheme 2, the radicals A, R¹, R² and R³ have the meaning given above and in particular the meanings given as being preferred.

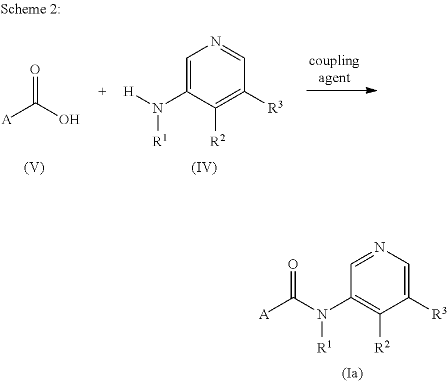

Suitable coupling agents are, for example:
coupling agents based on carbodiimides, for example N,N′-dicyclohexylcarbodiimide [J. C. Sheehan, G. P. Hess, J. Am. Chem. Soc. 1955, 77, 1067], N-(3-dimethylaminopropyl)-N′-ethylcarbodiimide;
coupling agents which form mixed anhydrides with carbonic esters, for example 2-ethoxy-1-ethoxycarbonyl-1,2-dihydroquinoline [B. Belleau, G. Malek, J. Amer. Chem. Soc. 1968, 90, 1651], 2-isobutyloxy-1-isobutyloxycarbonyl-1,2-dihydroquinoline [Y. Kiso, H. Yajima, J. Chem. Soc., Chem. Commun. 1972, 942];
coupling agents based on phosphonium salts, for example (benzotriazol-1-yloxy)tris(dimethylamino)phosphonium hexafluorophosphate [B. Castro, J. R. Domoy, G. Evin, C. Selve, Tetrahedron Lett. 1975, 14, 1219], (benzotriazol-1-yloxy)tripyrrolidinophosphonium hexafluorophosphate [J. Coste et al., Tetrahedron Lett. 1990, 31, 205];
coupling agents based on uronium salts or having a guanidinium N-oxide structure, for example N,N,N′,N′-tetramethyl-O-(1H-benzotriazol-1-yl)uronium hexafluorophosphate [R. Knorr, A. Trzeciak, W. Bannwarth, D. Gillessen, Tetrahedron Lett. 1989, 30, 1927], N,N,N′,N′-tetramethyl-O-(benzotriazol-1-yl)uronium tetrafluoroborate (TBTU), (benzotriazol-1-yloxy)dipiperidinocarbenium hexafluorophosphate [S. Chen, J. Xu, Tetrahedron Lett. 1992, 33, 647];
coupling agents which form acid chlorides, for example bis-(2-oxooxazolidinyl)phosphinic chloride [J. Diago-Mesequer, Synthesis 1980, 547].

Compounds of formula Ia, wherein R¹ is different from hydrogen can also be prepared by alkylating the amides Ia (in which R¹ is hydrogen and which can be obtained according to scheme 1 or 2) using suitable alkylating agents in the presence of bases in accordance to scheme 3.

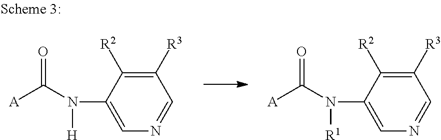

The carboxylic acids V and their activated derivatives III as well as 3-aminopyridine compounds IV are known in the art or are commercially available or can be prepared by methods known from the literature.

Compounds of the formula I, wherein X¹ is different from oxygen, can be prepared from the compounds of formula Ia by standard methods:

Compounds of the formula I, wherein X¹ is S, can be prepared e.g. by reacting a compound of formula Ia with 2,4-bis(4-methoxyphenyl)-1,3,2,4-dithiadiphosphetane-2,4-disulfide or phorphorus pentasulfide according to the method described by M. Jesberger et al. in Synthesis 2003, 1929.

Compounds of the formula I, wherein X¹ is NR^{1a}, can be prepared e.g. by reacting a compound Ia with 2,4-bis(4-methoxyphenyl)-1,3,2,4-dithiadiphosphetane-2,4-disulfide to obtain the corresponding thioamide (compound I, wherein X¹ is S) which is then reacted with an appropriate amine according to the method described by V. Glushkov et al. in Pharmaceutical Chemistry Journal 2005, 39(10), 533-536.

Compounds of formula II, wherein X²═SR^{2d}, can be prepared by alkylation of the corresponding thioamide (compound I, wherein X¹ is S) by reaction with an alkylating agent according to the method described by V. Glushkov et al. in Pharmaceutical Chemistry Journal 2005, 39(10), 533-536. Compounds of the formula II, wherein X² is OR^{2a} or NR^{2b}R^{2c}, can be obtained in a similar manner. Compounds of the formula II, wherein X²═SOR^{2d} or SO₂R^{2d} can be obtained by oxidation of compounds II wherein X²═SR^{2d}.

Compounds of the formulae I and II, wherein X³ is O, can be prepared by oxidation of compounds I, wherein X³ is a lone pair, according to standard methods of preparing pyridine N-oxides, e.g. by the method described by C. Botteghi et al. in Journal of Organometallic Chemistry 1989, 370, 17-31.

As a rule, the compounds of the formulae I or II can be prepared by the methods described above. If individual compounds can not be prepared via the above-described routes, they can be prepared by derivatization of other compounds I or II or by customary modifications of the synthesis routes described. For example, in individual cases, certain compounds I or II can advantageously be prepared from other compounds I or II by ester hydrolysis, amidation, esterification, ether cleavage, olefination, reduction, oxidation and the like.

The reaction mixtures are worked up in the customary manner, for example by mixing with water, separating the phases, and, if appropriate, purifying the crude products by chromatography, for example on alumina or on silica gel. Some of the intermediates and end products may be obtained in the form of colorless or pale brown viscous oils which are freed or purified from volatile components under reduced pressure and at moderately elevated temperature. If the intermediates and end products are obtained as solids, they may be purified by recrystallization or trituration.

Due to their excellent activity, the compounds of the general formulae I or II may be used for controlling invertebrate pests.

Accordingly, the present invention provides a method for controlling invertebrate pests which method comprises treating the pests, their food supply, their habitat or their breeding ground or a cultivated plant, plant propagation materials (such as seed), soil, area, material or environment in which the pests are growing or may grow, or the materials, cultivated plants, plant propagation materials (such as seed), soils, surfaces or spaces to be protected from pest attack or infestation with a pesticidally effective amount of a compound of formulae I or II or a salt or N-oxide thereof or a composition as defined above.

Preferably, the method of the invention serves for protecting plant propagation material (such as seed) and the plant which grows therefrom from invertebrate pest attack or infestation and comprises treating the plant propagation material (such as seed) with a pesticidally effective amount of a compound of formulae I or II or an agriculturally acceptable salt or N-oxide thereof as defined above or with a pesticidally effective amount of an agricultural composition as defined above and below. The method of the invention is not limited to the protection of the “substrate” (plant, plant propagation materials, soil material etc.) which has been treated according to the invention, but also has a preventive effect, thus, for example, according protection to a plant which grows from a treated plant propagation materials (such as seed), the plant itself not having been treated.

In the sense of the present invention, “invertebrate pests” are preferably selected from arthropods and nematodes, more preferably from harmful insects, arachnids and nematodes, and even more preferably from insects, acarids and nematodes. In the sense of the present invention, “invertebrate pests” are most preferably insects preferably insects of the order Homoptera.

The invention further provides an agricultural composition for combating such invertebrate pests, which comprises such an amount of at least one compound of the general formulae I or II or at least one agriculturally useful salt or N-oxide thereof and at least one inert liquid and/or solid agronomically acceptable carrier that has a pesticidal action and, if desired, at least one surfactant.

Such a composition may contain a single active compound of the formulae I or II or a salt or N-oxide thereof or a mixture of several active compounds I or II or their salts according to the present invention. The composition according to the present invention may comprise an individual isomer or mixtures of isomers as well as individual tautomers or mixtures of tautomers.

The compounds of the formulae I or II and the pestidicidal compositions comprising them are effective agents for controlling arthropod pests and nematodes. Invertebrate pests controlled by the compounds of formulae I or II include for example

insects from the order of the lepidopterans (Lepidoptera), for example Agrotis ypsilon, Agrotis segetum, Alabama argillacea, Anticarsia gemmatalis, Argyresthia conjugella, Autographa gamma, Bupalus piniarius, Cacoecia murinana, Capua reticulana, Cheimatobia brumata, Choristoneura fumiferana, Choristoneura occidentalis, Cirphis unipuncta, Cydia pomonella, Dendrolimus pini, Diaphania nitidalis, Diatraea grandiosella, Earias insulana, Elasmopalpus lignosellus, Eupoecilia ambiguella, Evetria bouliana, Feltia subterranea, Galleria mellonella, Grapholitha funebrana, Grapholitha molesta, Heliothis armigera, Heliothis virescens, Heliothis zea, Hellula undalis, Hibernia defoliaria, Hyphantria cunea, Hyponomeuta malinellus, Keiferia lycopersicella, Lambdina fiscellaria, Laphygma exigua, Leucoptera coffeella, Leucoptera scitella, Lithocolletis blancardella, Lobesia botrana, Loxostege sticticalis, Lymantria dispar, Lymantria monacha, Lyonetia clerkella, Malacosoma neustria, Mamestra brassicae, Orgyia pseudotsugata, Ostrinia nubilalis, Panolis flammea, Pectinophora gossypiella, Peridroma saucia, Phalera bucephala, Phthorimaea operculella, Phyllocnistis citrella, Pieris brassicae, Plathypena scabra, Plutella xylostella, Pseudoplusia includens, Rhyacionia frustrana, Scrobipalpula absoluta, Sitotroga cerealella, Sparganothis pilleriana, Spodoptera frugiperda, Spodoptera littoralis, Spodoptera litura, Thaumatopoea pityocampa, Tortrix viridana, Trichoplusiani and Zeiraphera canadensis;

beetles (Coleoptera), for example Agrilus sinuatus, Agriotes lineatus, Agriotes obscurus, Amphimallus solstitialis, Anisandrus dispar, Anthonomus grandis, Anthonomus pomorum, Atomaria linearis, Blastophagus piniperda, Blitophaga undata, Bruchus rufimanus, Bruchus pisorum, Bruchus lentis, Byctiscus betulae, Cassida nebulosa, Cerotoma trifurcata, Ceuthorrhynchus assimilis, Ceuthorrhynchus napi, Chaetocnema tibialis, Conoderus vespertinus, Crioceris asparagi, Diabrotica longicornis, Diabrotica 12 punctata, Diabrotica virgifera, Epilachna varivestis, Epitrix hirtipennis, Eutinobothrus brasiliensis, Hylobius abietis, Hypera brunneipennis, Hypera postica, Ips typographus, Lema bilineata, Lema melanopus, Leptinotarsa decemlineata, Limonius californicus, Lissorhoptrus oryzophilus, Melanotus communis, Meligethes aeneus, Melolontha hippocastani, Melolontha melolontha, Oulema oryzae, Ortiorrhynchus sulcatus, Otiorrhynchus ovatus, Phaedon cochleariae, Phyllotreta chrysocephala, Phyllophaga sp., Phyllopertha horticola, Phyllotreta nemorum, Phyllotreta striolata, Popillia japonica, Sitona lineatus and Sitophilus granaria;

dipterans (Diptera), for example Aedes aegypti, Aedes vexans, Anastrepha ludens, Anopheles maculipennis, Ceratitis capitata, Chrysomya bezziana, Chrysomya hominivorax, Chrysomya macellaria, Contarinia sorghicola, Cordylobia anthropophaga, Culex pipiens, Dacus cucurbitae, Dacus oleae, Dasineura brassicae, Fannia canicularis, Gasterophilus intestinalis, Glossina morsitans, Haematobia irritans, Haplodiplosis equestris, Hylemyia platura, Hypoderma lineata, Liriomyza sativae, Liriomyza trifolii, Lucilia caprina, Lucilia cuprina, Lucilia sericata, Lycoria pectoralis, Mayetiola destructor, Musca domestica, Muscina stabulans, Oestrus ovis, Oscinella frit, Pegomya hysocyami, Phorbia antiqua, Phorbia brassicae, Phorbia coarctata, Rhagoletis cerasi, Rhagoletis pomonella, Tabanus bovinus, Tipula oleracea and Tipula paludosa;

thrips (Thysanoptera), e.g. Dichromothrips corbetti, Frankliniella fusca, Frankliniella occidentalis, Frankliniella tritici, Scirtothrips citri, Thrips oryzae, Thrips palmi and Thrips tabaci;

hymenopterans (Hymenoptera), e.g. Athalia rosae, Atta cephalotes, Atta sexdens, Atta texana, Hoplocampa minuta, Hoplocampa testudinea, Monomorium pharaonis, Solenopsis geminata and Solenopsis invicta;

heteropterans (Heteroptera), e.g. Acrosternum hilare, Blissus leucopterus, Cyrtopeltis notatus, Dysdercus cingulatus, Dysdercus intermedius, Eurygaster integriceps, Euschistus impictiventris, Leptoglossus phyllopus, Lygus lineolaris, Lygus pratensis, Nezara viridula, Piesma quadrata, Solubea insularis and Thyanta perditor;

homopterans (Homoptera), e.g. Acyrthosiphon onobrychis, Adelges laricis, Aphidula nasturtii, Aphis fabae, Aphis forbesi, Aphis pomi, Aphis gossypii, Aphis grossulariae, Aphis schneideri, Aphis spiraecola, Aphis sambuci, Acyrthosiphon pisum, Aulacorthum solani, Bemisia argentifolii, Bemisia tabaci, Brachycaudus cardui, Brachycaudus helichrysi, Brachycaudus persicae, Brachycaudus prunicola, Brevicoryne brassicae, Capitophorus horni, Cerosipha gossypii, Chaetosiphon fragaefolii, Cryptomyzus ribis, Dreyfusia nordmannianae, Dreyfusia piceae, Dysaphis radicola, Dysaulacorthum pseudosolani, Dysaphis plantaginea, Dysaphis pyri, Empoasca fabae, Hyalopterus pruni, Hyperomyzus lactucae, Macrosiphum avenae, Macrosiphum euphorbiae, Macrosiphon rosae, Megoura viciae, Melanaphis pyrarius, Metopolophium dirhodum, Myzodes persicae, Myzus ascalonicus, Myzus cerasi, Myzus persicae, Myzus varians, Nasonovia ribisnigri, Nilaparvata lugens, Pemphigus bursarius, Perkinsiella saccharicida, Phorodon humuli, Psylla mali, Psylla piri, Rhopalomyzus ascalonicus, Rhopalosiphum maidis, Rhopalosiphum padi, Rhopalosiphum insertum, Sappaphis mala, Sappaphis mali, Schizaphis graminum, Schizoneura lanuginosa, Sitobion avenae, Sogatella furcifera Trialeurodes vaporariorum, Toxoptera aurantiiand, and Viteus vitifolii;

termites (Isoptera), e.g. Calotermes flavicollis, Leucotermes flavipes, Reticulitermes flavipes, Reticulitermes lucifugus und Termes natalensis;

orthopterans (Orthoptera), e.g. Acheta domestica, Blatta orientalis, Blattella germanica, Forficula auricularia, Gryllotalpa gryllotalpa, Locusta migratoria, Melanoplus bivittatus, Melanoplus femurrubrum, Melanoplus mexicanus, Melanoplus sanguinipes, Melanoplus spretus, Nomadacris septemfasciata, Periplaneta americana, Schistocerca americana, Schistocerca peregrina, Stauronotus maroccanus and Tachycines asynamorus;

arachnoidea, such as arachnids (Acarina), e.g. of the families Argasidae, Ixodidae and Sarcoptidae, such as Amblyomma americanum, Amblyomma variegatum, Argas persicus, Boophilus annulatus, Boophilus decoloratus, Boophilus microplus, Dermacentor silvarum, Hyalomma truncatum, Ixodes ricinus, Ixodes rubicundus, Ornithodorus moubata, Otobius megnini, Dermanyssus gallinae, Psoroptes ovis, Rhipicephalus appendiculatus, Rhipicephalus evertsi, Sarcoptes scabiei, and Eriophyidae spp. such as Aculus schlechtendali, Phyllocoptrata oleivora and Eriophyes sheldoni; Tarsonemidae spp. such as Phytonemus pallidus and Polyphagotarsonemus latus; Tenuipalpidae spp. such as Brevipalpus phoenicis; Tetranychidae spp. such as Tetranychus cinnabarinus, Tetranychus kanzawai, Tetranychus pacificus, Tetranychus telarius and Tetranychus urticae, Panonychus ulmi, Panonychus citri, and oligonychus pratensis;

siphonatera, e.g. Xenopsylla cheopsis, Ceratophyllus spp.

The compositions and compounds of formulae I or II are useful for the control of nematodes, especially plant parasitic nematodes such as root knot nematodes, Meloidogyne hapla, Meloidogyne incognita, Meloidogyne javanica, and other Meloidogyne species;

cyst-forming nematodes, Globodera rostochiensis and other Globodera species; Heterodera avenae, Heterodera glycines, Heterodera schachtii, Heterodera trifolii, and other Heterodera species; Seed gall nematodes, Anguina species; Stem and foliar nematodes, Aphelenchoides species; Sting nematodes, Belonolaimus longicaudatus and other Belonolaimus species; Pine nematodes, Bursaphelenchus xylophilus and other Bursaphelenchus species; Ring nematodes, Criconema species, Criconemella species, Criconemoides species, Mesocriconema species; Stem and bulb nematodes, Ditylenchus destructor, Ditylenchus dipsaci and other Ditylenchus species; Awl nematodes, Dolichodorus species; Spiral nematodes, Heliocotylenchus multicinctus and other Helicotylenchus species; Sheath and sheathoid nematodes, Hemicycliophora species and Hemicriconemoides species; Hirshmanniella species; Lance nematodes, Hoploaimus species; false rootknot nematodes, Nacobbus species; Needle nematodes, Longidorus elongatus and other Longidorus species; Pin nematodes, Paratylenchus species; Lesion nematodes, Pratylenchus neglectus, Pratylenchus penetrans, Pratylenchus curvitatus, Pratylenchus goodeyi and other Pratylenchus species; Burrowing nematodes, Radopholus similis and other Radopholus species; Reniform nematodes, Rotylenchus robustus and other Rotylenchus species; Scutellonema species; Stubby root nematodes, Trichodorus primitivus and other Trichodorus species, Paratrichodorus species; Stunt nematodes, Tylenchorhynchus claytoni, Tylenchorhynchus dubius and other Tylenchorhynchus species; Citrus nematodes, Tylenchulus species; Dagger nematodes, Xiphinema species; and other plant parasitic nematode species.

In a preferred embodiment of the invention the compounds of formulae I or II are used for controlling insects or arachnids, in particular insects of the orders Lepidoptera, Coleoptera, Thysanoptera and Homoptera and arachnids of the order Acarina. The compounds of the formulae I or II according to the present invention are particularly useful for controlling insects of the order Thysanoptera and Homoptera.

The compounds of formula formulae I or II or the pesticidal compositions comprising them may be used to protect growing plants and crops from attack or infestation by invertebrate pests, especially insects, acaridae or arachnids by contacting the plant/crop with a pesticidally effective amount of compounds of formulae I or II. The term “crop” refers both to growing and harvested crops.

The compounds of formulae I or II can be converted into the customary formulations, for example solutions, emulsions, suspensions, dusts, powders, pastes and granules.

The use form depends on the particular intended purpose; in each case, it should ensure a fine and even distribution of the compound according to the invention.

The formulations are prepared in a known manner (see e.g. for review U.S. Pat. No. 3,060,084, EP-A 707 445 (for liquid concentrates), Browning, “Agglomeration”, Chemical Engineering, Dec. 4, 1967, 147-48, Perry's Chemical Engineer's Handbook, 4th Ed., McGraw-Hill, New York, 1963, pages 8-57 and et seq. WO 91/13546, U.S. Pat. No. 4,172,714, U.S. Pat. No. 4,144,050, U.S. Pat. No. 3,920,442, U.S. Pat. No. 5,180,587, U.S. Pat. No. 5,232,701, U.S. Pat. No. 5,208,030, GB 2,095,558, U.S. Pat. No. 3,299,566, Klingman, Weed Control as a Science, John Wiley and Sons, Inc., New York, 1961, Hance et al., Weed Control Handbook, 8th Ed., Blackwell Scientific Publications, Oxford, 1989 and Mollet, H., Grubemann, A., Formulation technology, Wiley VCH Verlag GmbH, Weinheim (Germany), 2001, 2. D. A. Knowles, Chemistry and Technology of Agrochemical Formulations, Kluwer Academic Publishers, Dordrecht, 1998 (ISBN 0-7514-0443-8), for example by extending the active compound with auxiliaries suitable for the formulation of agrochemicals, such as solvents and/or carriers, if desired emulsifiers, surfactants and dispersants, preservatives, anti-foaming agents, anti-freezing agents, for seed treatment formulation also optionally colorants and/or binders and/or gelling agents.

Examples of suitable solvents are water, aromatic solvents (for example Solvesso products, xylene), paraffins (for example mineral oil fractions), alcohols (for example methanol, butanol, pentanol, benzyl alcohol), ketones (for example cyclohexanone, gamma-butyrolactone), pyrrolidones (N-methylpyrrolidone [NMP], N-octylpyrrolidone [NOP]), acetates (glycol diacetate), glycols, fatty acid dimethylamides, fatty acids and fatty acid esters. In principle, solvent mixtures may also be used.

Suitable emulsifiers are non-ionic and anionic emulsifiers (for example polyoxyethylene fatty alcohol ethers, alkylsulfonates and arylsulfonates).

Examples of dispersants are ligninsulfite waste liquors and methylcellulose.

Suitable surfactants used are alkali metal, alkaline earth metal and ammonium salts of lignosulfonic acid, naphthalenesulfonic acid, phenolsulfonic acid, dibutylnaphthalenesulfonic acid, alkylarylsulfonates, alkyl sulphates, alkylsulfonates, fatty alcohol sulfates, fatty acids and sulphated fatty alcohol glycol ethers, furthermore condensates of sulfonated naphthalene and naphthalene derivatives with formaldehyde, condensates of naphthalene or of naphthalenesulfonic acid with phenol and formaldehyde, polyoxyethylene octylphenol ether, ethoxylated isooctylphenol, octylphenol, nonylphenol, alkylphenol polyglycol ethers, tributylphenyl polyglycol ether, tristearylphenyl polyglycol ether, alkylaryl polyether alcohols, alcohol and fatty alcohol ethylene oxide condensates, ethoxylated castor oil, polyoxyethylene alkyl ethers, ethoxylated polyoxypropylene, lauryl alcohol polyglycol ether acetal, sorbitol esters, lignosulfite waste liquors and methylcellulose.

Substances which are suitable for the preparation of directly sprayable solutions, emulsions, pastes or oil dispersions are mineral oil fractions of medium to high boiling point, such as kerosene or diesel oil, furthermore coal tar oils and oils of vegetable or animal origin, aliphatic, cyclic and aromatic hydrocarbons, for example toluene, xylene, paraffin, tetrahydronaphthalene, alkylated naphthalenes or their derivatives, methanol, ethanol, propanol, butanol, cyclohexanol, cyclohexanone, isophorone, highly polar solvents, for example dimethyl sulfoxide, N-methylpyrrolidone or water.

Also anti-freezing agents such as glycerin, ethylene glycol, propylene glycol and bactericides such as can be added to the formulation.

Suitable antifoaming agents are for example antifoaming agents based on silicon or magnesium stearate.

A suitable preservative is e.g. dichlorophen.

Seed treatment formulations may additionally comprise binders and optionally colorants.

Binders can be added to improve the adhesion of the active materials on the seeds after treatment. Suitable binders are block copolymers EO/PO surfactants but also polyvinylalcoholsl, polyvinylpyrrolidones, polyacrylates, polymethacrylates, polybute-nes, polyisobutylenes, polystyrene, polyethyleneamines, polyethyleneamides, polyethyleneimines (Lupasol®, Polymin®), polyethers, polyurethans, polyvinylacetate, tylose and copolymers derived from these polymers.

Optionally, also colorants can be included in the formulation. Suitable colorants or dyes for seed treatment formulations are Rhodamin B, C.I. Pigment Red 112, C.I. Solvent Red 1, pigment blue 15:4, pigment blue 15:3, pigment blue 15:2, pigment blue 15:1, pigment blue 80, pigment yellow 1, pigment yellow 13, pigment red 112, pigment red 48:2, pigment red 48:1, pigment red 57:1, pigment red 53:1, pigment orange 43, pigment orange 34, pigment orange 5, pigment green 36, pigment green 7, pigment white 6, pigment brown 25, basic violet 10, basic violet 49, acid red 51, acid red 52, acid red 14, acid blue 9, acid yellow 23, basic red 10, basic red 108.

An example of a gelling agent is carrageen (Satiagel®).

Powders, materials for spreading and dustable products can be prepared by mixing or concomitantly grinding the active substances with a solid carrier.

Granules, for example coated granules, impregnated granules and homogeneous granules, can be prepared by binding the active compounds to solid carriers.

Examples of solid carriers are mineral earths such as silica gels, silicates, talc, kaolin, attaclay, limestone, lime, chalk, bole, loess, clay, dolomite, diatomaceous earth, calcium sulfate, magnesium sulfate, magnesium oxide, ground synthetic materials, fertilizers, such as, for example, ammonium sulfate, ammonium phosphate, ammonium nitrate, ureas, and products of vegetable origin, such as cereal meal, tree bark meal, wood meal and nutshell meal, cellulose powders and other solid carriers.

In general, the formulations comprise from 0.01 to 95% by weight, preferably from 0.1 to 90% by weight, of the active compound(s). In this case, the active compound(s) are employed in a purity of from 90% to 100% by weight, preferably 95% to 100% by weight (according to NMR spectrum).

For seed treatment purposes, respective formulations can be diluted 2- to 10-fold leading to concentrations in the ready to use preparations of 0.01 to 60% by weight active compound by weight, preferably 0.1 to 40% by weight.

The compounds of formulae I or II can be used as such, in the form of their formulations or the use forms prepared therefrom, for example in the form of directly sprayable solutions, powders, suspensions or dispersions, emulsions, oil dispersions, pastes, dustable products, materials for spreading, or granules, by means of spraying, atomizing, dusting, spreading or pouring. The use forms depend entirely on the intended purposes; they are intended to ensure in each case the finest possible distribution of the active compound(s) according to the invention.

Aqueous use forms can be prepared from emulsion concentrates, pastes or wetable powders (sprayable powders, oil dispersions) by adding water. To prepare emulsions, pastes or oil dispersions, the substances, as such or dissolved in an oil or solvent, can be homogenized in water by means of a wetting agent, tackifier, dispersant or emulsifier. However, it is also possible to prepare concentrates composed of active substance, wetting agent, tackifier, dispersant or emulsifier and, if appropriate, solvent or oil, and such concentrates are suitable for dilution with water.

The active compound concentrations in the ready-to-use preparations can be varied within relatively wide ranges. In general, they are from 0.0001 to 10%, preferably from 0.01 to 1% per weight.

The active compound(s) may also be used successfully in the ultra-low-volume process (ULV), it being possible to apply formulations comprising over 95% by weight of active compound, or even to apply the active compound without additives.

The following are examples of formulations:

1. Products for dilution with water for foliar applications. For seed treatment purposes, such products may be applied to the seed diluted or undiluted.

A) Water-Soluble Concentrates (SL, LS)

10 parts by weight of the active compound(s) are dissolved in 90 parts by weight of water or a water-soluble solvent. As an alternative, wetting agents or other auxiliaries are added. The active compound(s) dissolves upon dilution with water, whereby a formulation with 10% (w/w) of active compound(s) is obtained.

B) Dispersible Concentrates (DC)

20 parts by weight of the active compound(s) are dissolved in 70 parts by weight of cyclohexanone with addition of 10 parts by weight of a dispersant, for example polyvinylpyrrolidone. Dilution with water gives a dispersion, whereby a formulation with 20% (w/w) of active compound(s) is obtained.

C) Emulsifiable Concentrates (EC)

15 parts by weight of the active compound(s) are dissolved in 7 parts by weight of xylene with addition of calcium dodecylbenzenesulfonate and castor oil ethoxylate (in each case 5 parts by weight). Dilution with water gives an emulsion, whereby a formulation with 15% (w/w) of active compound(s) is obtained.

D) Emulsions (EW, EO, ES)

25 parts by weight of the active compound(s) are dissolved in 35 parts by weight of xylene with addition of calcium dodecylbenzenesulfonate and castor oil ethoxylate (in each case 5 parts by weight). This mixture is introduced into 30 parts by weight of water by means of an emulsifier machine (e.g. Ultraturrax) and made into a homogeneous emulsion. Dilution with water gives an emulsion, whereby a formulation with 25% (w/w) of active compound(s) is obtained.

E) Suspensions (SC, OD, FS)

In an agitated ball mill, 20 parts by weight of the active compound(s) are comminuted with addition of 10 parts by weight of dispersants, wetting agents and 70 parts by weight of water or of an organic solvent to give a fine active compound(s) suspension. Dilution with water gives a stable suspension of the active compound(s), whereby a formulation with 20% (w/w) of active compound(s) is obtained.

F) Water-Dispersible Granules and Water-Soluble Granules (WG, SG)

50 parts by weight of the active compound(s) are ground finely with addition of 50 parts by weight of dispersants and wetting agents and made as water-dispersible or water-soluble granules by means of technical appliances (for example extrusion, spray tower, fluidized bed). Dilution with water gives a stable dispersion or solution of the active compound(s), whereby a formulation with 50% (w/w) of active compound(s) is obtained.

G) Water-Dispersible Powders and Water-Soluble Powders (WP, SP, SS, WS)

75 parts by weight of the active compound(s) are ground in a rotor-stator mill with addition of 25 parts by weight of dispersants, wetting agents and silica gel. Dilution with water gives a stable dispersion or solution of the active compound(s), whereby a formulation with 75% (w/w) of active compound(s) is obtained.

H) Gel-Formulation (GF)

In an agitated ball mill, 20 parts by weight of the active compound(s) are comminuted with addition of 10 parts by weight of dispersants, 1 part by weight of a gelling agent wetting agents and 70 parts by weight of water or of an organic solvent to give a fine active compound(s) suspension. Dilution with water gives a stable suspension of the active compound(s), whereby a formulation with 20% (w/w) of active compound(s) is obtained.

2. Products to be applied undiluted for foliar applications. For seed treatment purposes, such products may be applied to the seed diluted or undiluted.

I) Dustable Powders (DP, DS)

5 parts by weight of the active compound(s) are ground finely and mixed intimately with 95 parts by weight of finely divided kaolin. This gives a dustable product having 5% (w/w) of active compound(s)

J) Granules (GR, FG, GG, MG)

0.5 parts by weight of the active compound(s) is ground finely and associated with 95.5 parts by weight of carriers, whereby a formulation with 0.5% (w/w) of active compound(s) is obtained. Current methods are extrusion, spray-drying or the fluidized bed. This gives granules to be applied undiluted for foliar use.

K) ULV Solutions (UL)

10 parts by weight of the active compound(s) are dissolved in 90 parts by weight of an organic solvent, for example xylene. This gives a product having 10% (w/w) of active compound(s), which is applied undiluted for foliar use.

The compounds of formulae I or II are also suitable for the treatment of plant propagation materials (such as seed). Conventional seed treatment formulations include for example flowable concentrates FS, solutions LS, powders for dry treatment DS, water dispersible powders for slurry treatment WS, water-soluble powders SS and emulsion ES and EC and gel formulation GF. These formulations can be applied to the seed diluted or undiluted. Application to the seeds is carried out before sowing, either directly on the seeds or after having pregerminated the latter

In a preferred embodiment a FS formulation is used for seed treatment. Typically, a FS formulation may comprise 1 to 800 g/l of active ingredient, 1 to 200 g/l surfactant, 0 to 200 g/l antifreezing agent, 0 to 400 g/l of binder, 0 to 200 g/l of a pigment and up to 1 liter of a solvent, preferably water.

Other preferred FS formulations of compounds of formulae I or II for seed treatment comprise from 0.5 to 80% wt of the active ingredient, from 0.05 to 5% wt of a wetting agent, from 0.5 to 15% wt of a dispersing agent, from 0.1 to 5% wt of a thickener, from to 20% wt of an anti-freeze agent, from 0.1 to 2% wt of an anti-foam agent, from 1 to 20% wt of a pigment and/or a dye, from 0 to 15% wt of a sticker/adhesion agent, from 0 to 75% wt of a filler/vehicle, and from 0.01 to 1% wt of a preservative.

Various types of oils, wetting agents, adjuvants, herbicides, fungicides, other pesticides, or bactericides may be added to the active ingredients, if appropriate just immediately prior to use (tank mix). These agents usually are admixed with the agents according to the invention in a weight ratio of 1:10 to 10:1.

The compounds of formulae I or II are effective through both contact (via soil, glass, wall, bed net, carpet, plant parts or animal parts), and ingestion (bait, or plant part).

For use against ants, termites, wasps, flies, mosquitoes, crickets, or cockroaches, compounds of formulae I or II are preferably used in a bait composition.

The bait can be a liquid, a solid or a semisolid preparation (e.g. a gel). Solid baits can be formed into various shapes and forms suitable to the respective application e.g. granules, blocks, sticks, disks. Liquid baits can be filled into various devices to ensure proper application, e.g. open containers, spraying devices, droplet sources, or evaporation sources. Gels can be based on aqueous or oily matrices and can be formulated to particular necessities in terms of stickiness, moisture retention or aging characteristics.

The bait employed in the composition is a product, which is sufficiently attractive to incite insects such as ants, termites, wasps, flies, mosquitoes, crickets etc. or cockroaches to eat it. The attractiveness can be manipulated by using feeding stimulants or sex pheromones. Food stimulants are chosen, for example, but not exclusively, from animal and/or plant proteins (meat-, fish- or blood meal, insect parts, egg yolk), from fats and oils of animal and/or plant origin, or mono-, oligo- or polyorganosaccharides, especially from sucrose, lactose, fructose, dextrose, glucose, starch, pectin or even molasses or honey. Fresh or decaying parts of fruits, crops, plants, animals, insects or specific parts thereof can also serve as a feeding stimulant. Sex pheromones are known to be more insect specific. Specific pheromones are described in the literature and are known to those skilled in the art.

Formulations of compounds of formulae I or II as aerosols (e.g. in spray cans), oil sprays or pump sprays are highly suitable for the non-professional user for controlling pests such as flies, fleas, ticks, mosquitos or cockroaches. Aerosol recipes are preferably composed of the active compound, solvents such as lower alcohols (e.g. methanol, ethanol, propanol, butanol), ketones (e.g. acetone, methyl ethyl ketone), paraffin hydrocarbons (e.g. kerosenes) having boiling ranges of approximately 50 to 250° C., dimethyl-formamide, N-methylpyrrolidone, dimethyl sulphoxide, aromatic hydrocarbons such as toluene, xylene, water, furthermore auxiliaries such as emulsifiers such as sorbitol monooleate, oleyl ethoxylate having 3 to 7 mol of ethylene oxide, fatty alcohol ethoxylate, perfume oils such as ethereal oils, esters of medium fatty acids with lower alcohols, aromatic carbonyl compounds, if appropriate stabilizers such as sodium benzoate, amphoteric surfactants, lower epoxides, triethyl orthoformate and, if required, propellants such as propane, butane, nitrogen, compressed air, dimethyl ether, carbon dioxide, nitrous oxide, or mixtures of these gases.

The oil spray formulations differ from the aerosol recipes in that no propellants are used.

The compounds of formulae I or II and their respective compositions can also be used in mosquito and fumigating coils, smoke cartridges, vaporizer plates or long-term vaporizers and also in moth papers, moth pads or other heat-independent vaporizer systems.

Methods to control infectious diseases transmitted by insects (e.g. malaria, dengue and yellow fever, lymphatic filariasis, and leishmaniasis) with compounds of formulae I or II and its respective compositions also comprise treating surfaces of huts and houses, air spraying and impregnation of curtains, tents, clothing items, bed nets, tsetse-fly trap or the like. Insecticidal compositions for application to fibers, fabric, knitgoods, nonwovens, netting material or foils and tarpaulins preferably comprise a mixture including the insecticide, optionally a repellent and at least one binder. Suitable repellents for example are N,N-diethyl-meta-toluamide (DEET), N,N-diethylphenylacetamide (DEPA), 1-(3-cyclohexan-1-yl-carbonyl)-2-methylpiperine, (2-hydroxymethylcyclohexyl)acetic acid lactone, 2-ethyl-1,3-hexandiol, indalone, Methylneodecanamide (MNDA), a pyrethroid not used for insect control such as {(+/−)-3-allyl-2-methyl-4-oxocyclopent-2-(+)-enyl-(+)-trans-chrysantemate (Esbiothrin), a repellent derived from or identical with plant extracts like limonene, eugenol, (+)-Eucamalol (1), (−)-1-epi-eucamalol or crude plant extracts from plants like Eucalyptus maculata, Vitex rotundifolia, Cymbopogan martinii, Cymbopogan citratus (lemon grass), Cymopogan nartdus (citronella). Suitable binders are selected for example from polymers and copolymers of vinyl esters of aliphatic acids (such as such as vinyl acetate and vinyl versatate), acrylic and methacrylic esters of alcohols, such as butyl acrylate, 2-ethylhexylacrylate, and methyl acrylate, mono- and diethylenically unsaturated hydrocarbons, such as styrene, and aliphatic diens, such as butadiene.

The impregnation of curtains and bednets is done in general by dipping the textile material into emulsions or dispersions of the active compounds of formulae I or II or spraying them onto the nets.

Methods which can be employed for treating the seed are, in principle, all suitable seed treatment and especially seed dressing techniques known in the art, such as seed coating (e.g. seed pelleting), seed dusting and seed imbibition (e.g. seed soaking). Here, “seed treatment” refers to all methods that bring seeds and the compounds of formulae I or II into contact with each other, and “seed dressing” to methods of seed treatment which provide the seeds with an amount of the compounds of formulae I or II, i.e. which generate a seed comprising the compound of formulae I or II. In principle, the treatment can be applied to the seed at any time from the harvest of the seed to the sowing of the seed. The seed can be treated immediately before, or during, the planting of the seed, for example using the “planter's box” method. However, the treatment may also be carried out several weeks or months, for example up to 12 months, before planting the seed, for example in the form of a seed dressing treatment, without a substantially reduced efficacy being observed.

Expediently, the treatment is applied to unsown seed. As used herein, the term “unsown seed” is meant to include seed at any period from the harvest of the seed to the sowing of the seed in the ground for the purpose of germination and growth of the plant.

Specifically, a procedure is followed in the treatment in which the seed is mixed, in a suitable device, for example a mixing device for solid or solid/liquid mixing partners, with the desired amount of seed treatment formulations, either as such or after previous dilution with water, until the composition is distributed uniformly on the seed. If appropriate, this is followed by a drying step.

The compounds of formulae I or II or the enantiomers diastereomers or veterinarily acceptable salts thereof are in particular also suitable for being used for combating parasites in and on animals.

A further object of the present invention is therefore also to provide new methods for controlling parasites in and on animals. Another object of the invention is to provide safer pesticides for animals. Another object of the invention is further to provide pesticides for animals that may be used in lower doses than existing pesticides. An another object of the invention is to provide pesticides for animals, which provide a long residual control of the parasites.

The invention also relates to compositions containing a parasiticidally effective amount of compounds of formulae I or II or the enantiomers or veterinarily acceptable salts thereof and an acceptable carrier, for combating parasites in and on animals.

The present invention also provides a method for treating, controlling, preventing and protecting animals against infestation and infection by parasites, which comprises orally, topically or parenterally administering or applying to the animals a parasiticidally effective amount of compounds of formulae I or II or the enantiomers or veterinarily acceptable salts thereof and an acceptable carrier or a composition comprising it.

The present invention also provides a non-therapeutic method for treating, controlling, preventing and protecting animals against infestation and infection by parasites, which comprises applying to a locus-P a parasiticidally effective amount of a compound of formulae I or II or the enantiomers or veterinarily acceptable salts thereof and an acceptable carrier or a composition comprising it.

The invention also provides a process for the preparation of a composition for treating, controlling, preventing or protecting animals against infestation or infection by parasites which comprises including a parasiticidally effective amount of a compound of formulae I or II or the enantiomers or veterinarily acceptable salts thereof and an acceptable carrier or a composition comprising it.

The invention relates further to the use of compounds of formulae I or II for treating, controlling, preventing or protecting animals against infestation or infection by parasites.

The invention relates also to the use of a compound of formulae I or II or the enantiomers or veterinarily acceptable salts thereof and an acceptable carrier or a composition comprising it, for the manufacture of a medicament for the therapeutic treatment of animals against infections or infestions by parasites.

Activity of compounds against agricultural pests does not suggest their suitability for control of endo- and ectoparasites in and on animals which requires, for example, low, nonemetic dosages in the case of oral application, metabolic compatibility with the animal, low toxicity, and a safe handling.

Surprisingly, it has been found that compounds of formulae I or II are suitable for combating endo- and ectoparasites in and on animals. The compounds of formulae I or II or II or the enantiomers or veterinarily acceptable salts thereof and compositions comprising them are suitable for systemic and/or non-systemic control of ecto- and/or endoparasites. They are active against all or some stages of development.

Compounds of formulae I or II or the enantiomers or veterinarily acceptable salts thereof and compositions comprising them are preferably used for controlling and preventing infestations and infections in animals including warm-blooded animals (including humans) and fish. They are for example suitable for controlling and preventing infestations and infections in mammals such as cattle, sheep, swine, camels, deer, horses, pigs, poultry, rabbits, goats, dogs and cats, water buffalo, donkeys, fallow deer and reindeer, and also in fur-bearing animals such as mink, chinchilla and raccoon, birds such as hens, geese, turkeys and ducks and fish such as fresh- and salt-water fish such as trout, carp and eels.

Compounds of formulae I or II or the enantiomers or veterinarily acceptable salts thereof and compositions comprising them are preferably used for controlling and preventing infestations and infections in domestic animals, such as dogs or cats.

Infestations in warm-blooded animals and fish include, but are not limited to, lice, biting lice, ticks, nasal bots, keds, biting flies, muscoid flies, flies, myiasitic fly larvae, chiggers, gnats, mosquitoes and fleas.

The compounds of formulae I or II are especially useful for combating ectoparasites.

The compounds of formulae I or II are especially useful for combating endoparasites.

The compounds of formulae I or II are especially useful for combating parasites of the following orders and species, respectively:

fleas (Siphonaptera), e.g. Ctenocephalides felis, Ctenocephalides canis, Xenopsylla cheopis, Pulex irritans, Tunga penetrans, and Nosopsyllus fasciatus,

cockroaches (Blattaria—Blattodea), e.g. Blattella germanica, Blattella asahinae, Periplaneta americana, Periplaneta japonica, Periplaneta brunnea, Periplaneta fuligginosa, Periplaneta australasiae, and Blatta orientalis,

flies, mosquitoes (Diptera), e.g. Aedes aegypti, Aedes albopictus, Aedes vexans, Anastrepha ludens, Anopheles maculipennis, Anopheles crucians, Anopheles albimanus, Anopheles gambiae, Anopheles freeborni, Anopheles leucosphyrus, Anopheles minimus, Anopheles quadrimaculatus, Calliphora vicina, Chrysomya bezziana, Chrysomya hominivorax, Chrysomya macellaria, Chrysops discalis, Chrysops silacea, Chrysops atlanticus, Cochliomyia hominivorax, Cordylobia anthropophaga, Culicoides furens, Culex pipiens, Culex nigripalpus, Culex quinquefasciatus, Culex tarsalis, Culiseta inornata, Culiseta melanura, Dermatobia hominis, Fannia canicularis, Gasterophilus intestinalis, Glossina morsitans, Glossina palpalis, Glossina fuscipes, Glossina tachinoides, Haematobia irritans, Haplodiplosis equestris, Hippelates spp., Hypoderma lineata, Leptoconops torrens, Lucilia caprina, Lucilia cuprina, Lucilia sericata, Lycoria pectoralis, Mansonia spp., Musca domestica, Muscina stabulans, Oestrus ovis, Phlebotomus argentipes, Psorophora columbiae, Psorophora discolor, Prosimulium mixtum, Sarcophaga haemorrhoidalis, Sarcophaga sp., Simulium vittatum, Stomoxys calcitrans, Tabanus bovinus, Tabanus atratus, Tabanus lineola, and Tabanus similis,

lice (Phthiraptera), e.g. Pediculus humanus capitis, Pediculus humanus corporis, Pthirus pubis, Haematopinus eurysternus, Haematopinus suis, Linognathus vituli, Bovicola bovis, Menopon gallinae, Menacanthus stramineus and Solenopotes capillatus,

ticks and parasitic mites (Parasitiformes): ticks (Ixodida), e.g. Ixodes scapularis, Ixodes holocyclus, Ixodes pacificus, Rhiphicephalus sanguineus, Dermacentor andersoni, Dermacentor variabilis, Amblyomma americanum, Ambryomma maculatum, Ornithodorus hermsi, Ornithodorus turicata and parasitic mites (Mesostigmata), e.g. Ornithonyssus bacoti and Dermanyssus gallinae,

Actinedida (Prostigmata) and Acaridida (Astigmata) e.g. Acarapis spp., Cheyletiella spp., Ornithocheyletia spp., Myobia spp., Psorergates spp., Demodex spp., Trombicula spp., Listrophorus spp., Acarus spp., Tyrophagus spp., Caloglyphus spp., Hypodectes spp., Pterolichus spp., Psoroptes spp., Chorioptes spp., Otodectes spp., Sarcoptes spp., Notoedres spp., Knemidocoptes spp., Cytodites spp., and Laminosioptes spp,

Bugs (Heteropterida): Cimex lectularius, Cimex hemipterus, Reduvius senilis, Triatoma spp., Rhodnius ssp., Panstrongylus ssp. and Arilus critatus,

Anoplurida, e.g. Haematopinus spp., Linognathus spp., Pediculus spp., Phtirus spp., and Solenopotes spp,

Mallophagida (suborders Arnblycerina and Ischnocerina), e.g. Trimenopon spp., Menopon spp., Trinoton spp., Bovicola spp., Werneckiella spp., Lepikentron spp., Trichodectes spp., and Felicola spp,

Roundworms Nematoda:

Wipeworms and Trichinosis (Trichosyringida), e.g. Trichinellidae (Trichinella spp.), (Trichuridae) Trichuris spp., Capillaria spp,

Rhabditida, e.g. Rhabditis spp, Strongyloides spp., Helicephalobus spp,

Strongylida, e.g. Strongylus spp., Ancylostoma spp., Necator americanus, Bunostomum spp. (Hookworm), Trichostrongylus spp., Haemonchus contortus., Ostertagia spp., Cooperia spp., Nematodirus spp., Dictyocaulus spp., Cyathostoma spp., Oesophagostomum spp., Stephanurus dentatus, Ollulanus spp., Chabertia spp., Stephanurus dentatus, Syngamus trachea, Ancylostoma spp., Uncinaria spp., Globocephalus spp., Necator spp., Metastrongylus spp., Muellerius capillaris, Protostrongylus spp., Angiostrongylus spp., Parelaphostrongylus spp. Aleurostrongylus abstrusus, and Dioctophyma renale,

Intestinal roundworms (Ascaridida), e.g. Ascaris lumbricoides, Ascaris suum, Ascaridia galli, Parascaris equorum, Enterobius vermicularis (Threadworm), Toxocara canis, Toxascaris leonine, Skrjabinema spp., and Oxyuris equi,

Camallanida, e.g. Dracunculus medinensis (guinea worm),

Spirurida, e.g. Thelazia spp. Wuchereria spp., Brugia spp., Onchocerca spp., Dirofilari spp.a, Dipetalonema spp., Setaria spp., Elaeophora spp., Spirocerca lupi, and Habronema spp.,

Thorny headed worms (Acanthocephala), e.g. Acanthocephalus spp., Macracanthorhynchus hirudinaceus and Oncicola spp,

Planarians (Plathelminthes):

Flukes (Trematoda), e.g. Faciola spp., Fascioloides magna, Paragonimus spp., Dicrocoelium spp., Fasciolopsis buski, Clonorchis sinensis, Schistosoma spp., Trichobilharzia spp., Alaria alata, Paragonimus spp., and Nanocyetes spp,

Cercomeromorpha, in particular Cestoda (Tapeworms), e.g. Diphyllobothrium spp., Tenia spp., Echinococcus spp., Dipylidium caninum, Multiceps spp., Hymenolepis spp., Mesocestoides spp., Vampirolepis spp., Moniezia spp., Anoplocephala spp., Sirometra spp., Anoplocephala spp., and Hymenolepis spp.

The compounds of formulae I or II and compositions containing them are particularly useful for the control of pests from the orders Diptera, Siphonaptera and Ixodida.

Moreover, the use of the compounds of formulae I or II and compositions containing them for combating mosquitoes is especially preferred.

The use of the compounds of formulae I or II and compositions containing them for combating flies is a further preferred embodiment of the present invention.

Furthermore, the use of the compounds of formulae I or II and compositions containing them for combating fleas is especially preferred.

The use of the compounds of formulae I or II and compositions containing them for combating ticks is a further preferred embodiment of the present invention.

The compounds of formulae I or II and compositions containing them also are especially useful for combating endoparasites (roundworms nematoda, thorny headed worms and planarians).

The compounds of formulae I or II and compositions containing them can be effective through both contact (via soil, glass, wall, bed net, carpet, blankets or animal parts) and ingestion (e.g. baits).

The present invention relates to the therapeutic and the non-therapeutic use of compounds of formulae I or II and compositions containing them for controlling and/or combating parasites in and/or on animals.

The compounds of formulae I or II and compositions containing them may be used to protect the animals from attack or infestation by parasites by contacting them with a parasitically effective amount of compounds of formulae I or II and compositions containing them.

As such, “contacting” includes both direct contact (applying the pesticidal mixtures/compositions containing the compounds of formulae I or II according to the present invention directly on the parasite, which may include an indirect contact at it's locus-P, and optionally also administrating the pesticidal mixtures/composition directly on the animal to be protected) and indirect contact (applying the compounds/compositions to the locus of the parasite). The contact of the parasite through application to its locus is an example of a non-therapeutic use of compounds of formulae I or II.

“Locus-P” as used above means the habitat, food supply, breeding ground, area, material or environment in which a parasite is growing or may grow outside of the animal. The compounds of the invention can also be applied preventively to places at which occurrence of the pests or parasites are expected.

The compounds of formulae I or II can be effective through both contact (via soil, glass, wall, bed net, carpet, blankets or animal parts) and ingestion (e.g. baits).

Administration can be carried out prophylactically, therapeutically or nontherapeutically.

Administration of the active compounds is carried out directly or in the form of suitable preparations, orally, topically/dermally or parenterally.

In general, “parasiticidally effective amount” means the amount of active ingredient needed to achieve an observable effect on growth, including the effects of necrosis, death, retardation, prevention, and removal, destruction, or otherwise diminishing the occurrence and activity of the target organism. The parasiticidally effective amount can vary for the various compounds/compositions used in the invention. A parasiticidally effective amount of the compositions will also vary according to the prevailing conditions such as desired parasiticidal effect and duration, target species, mode of application, and the like.

Generally it is favorable to apply the compounds of formulae I or II in total amounts of 0.5 mg/kg to 100 mg/kg per day, preferably 1 mg/kg to 50 mg/kg per day.

Formulations

For oral administration to warm-blooded animals, the compounds of formulae I or II may be formulated as animal feeds, animal feed premixes, animal feed concentrates, pills, solutions, pastes, suspensions, drenches, gels, tablets, boluses and capsules. In addition, the compounds of formulae I or II may be administered to the animals in their drinking water. For oral administration, the dosage form chosen should provide the animal with 0.01 mg/kg to 100 mg/kg of animal body weight per day of the formulae I or II compound, preferably with 0.5 mg/kg to 100 mg/kg of animal body weight per day.

Alternatively, the compounds of formulae I or II may be administered to animals parenterally, for example, by intraruminal, intramuscular, intravenous or subcutaneous injection. The compounds of formulae I or II may be dispersed or dissolved in a physiologically acceptable carrier for subcutaneous injection. Alternatively, the compounds of formulae I or II may be formulated into an implant for subcutaneous administration. In addition the compounds of formulae I or II may be transdermally administered to animals. For parenteral administration, the dosage form chosen should provide the animal with 0.01 mg/kg to 100 mg/kg of animal body weight per day of the compounds of formulae I or II.

The compounds of formulae I or II may also be applied topically to the animals in the form of dips, dusts, powders, collars, medallions, sprays, shampoos, spot-on and pouron formulations and in ointments or oil-in-water or water-in-oil emulsions. For topical application, dips and sprays usually contain 0.5 ppm to 5 000 ppm and preferably 1 ppm to 3 000 ppm of the compounds of formulae I or II. In addition, the compounds of formulae I or II may be formulated as ear tags for animals, particularly quadrupeds such as cattle and sheep.

Suitable preparations are:

Solutions such as oral solutions, concentrates for oral administration after dilution, solutions for use on the skin or in body cavities, pouring-on formulations, gels;

Emulsions and suspensions for oral or dermal administration; semi-solid preparations; Formulations in which the active compound is processed in an ointment base or in an oil-in-water or water-in-oil emulsion base;

Solid preparations such as powders, premixes or concentrates, granules, pellets, tablets, boluses, capsules; aerosols and inhalants, and active compound-containing shaped articles.

Compositions suitable for injection are prepared by dissolving the active ingredient in a suitable solvent and optionally adding further ingredients such as acids, bases, buffer salts, preservatives, and solubilizers. The solutions are filtered and filled sterile. Suitable solvents are physiologically tolerable solvents such as water, alkanols such as ethanol, butanol, benzyl alcohol, glycerol, propylene glycol, polyethylene glycols, N-methylpyrrolidone, 2-pyrrolidone, and mixtures thereof.

The active compounds can optionally be dissolved in physiologically tolerable vegetable or synthetic oils which are suitable for injection.

Suitable solubilizers are solvents which promote the dissolution of the active compound in the main solvent or prevent its precipitation. Examples are polyvinylpyrrolidone, polyvinyl alcohol, polyoxyethylated castor oil, and polyoxyethylated sorbitan ester.

Suitable preservatives are benzyl alcohol, trichlorobutanol, p-hydroxybenzoic acid esters, and n-butanol.

Oral solutions are administered directly. Concentrates are administered orally after prior dilution to the use concentration. Oral solutions and concentrates are prepared according to the state of the art and as described above for injection solutions, sterile procedures not being necessary.

Solutions for use on the skin are trickled on, spread on, rubbed in, sprinkled on or sprayed on.

Solutions for use on the skin are prepared according to the state of the art and according to what is described above for injection solutions, sterile procedures not being necessary.

Further suitable solvents are polypropylene glycol, phenyl ethanol, phenoxy ethanol, ester such as ethyl or butyl acetate, benzyl benzoate, ethers such as alkyleneglycol alkylether, e.g. dipropylenglycol monomethylether, ketons such as acetone, methylethylketone, aromatic hydrocarbons, vegetable and synthetic oils, dimethylformamide, dimethylacetamide, transcutol, solketal, propylencarbonate, and mixtures thereof.

It may be advantageous to add thickeners during preparation. Suitable thickeners are inorganic thickeners such as bentonites, colloidal silicic acid, aluminium monostearate, organic thickeners such as cellulose derivatives, polyvinyl alcohols and their copolymers, acrylates and methacrylates.

Gels are applied to or spread on the skin or introduced into body cavities. Gels are prepared by treating solutions which have been prepared as described in the case of the injection solutions with sufficient thickener that a clear material having an ointment-like consistency results. The thickeners employed are the thickeners given above. Pour-on formulations are poured or sprayed onto limited areas of the skin, the active compound penetrating the skin and acting systemically.

Pour-on formulations are prepared by dissolving, suspending or emulsifying the active compound in suitable skin-compatible solvents or solvent mixtures. If appropriate, other auxiliaries such as colorants, bioabsorption-promoting substances, antioxidants, light stabilizers, adhesives are added.

Suitable solvents are: water, alkanols, glycols, polyethylene glycols, polypropylene glycols, glycerol, aromatic alcohols such as benzyl alcohol, phenylethanol, phenoxyethanol, esters such as ethyl acetate, butyl acetate, benzyl benzoate, ethers such as alkylene glycol alkyl ethers such as dipropylene glycol monomethyl ether, diethylene glycol mono-butyl ether, ketones such as acetone, methyl ethyl ketone, cyclic carbonates such as propylene carbonate, ethylene carbonate, aromatic and/or aliphatic hydrocarbons, vegetable or synthetic oils, DMF, dimethylacetamide, N-alkylpyrrolidones such as N-methylpyrrolidone, N-butylpyrrolidone or N-octylpyrrolidone, 2-pyrrolidone, 2,2-dimethyl-4-oxy-methylene-1,3-dioxolane and glycerol formal.

Suitable colorants are all colorants permitted for use on animals and which can be dissolved or suspended.

Suitable absorption-promoting substances are, for example, DMSO, spreading oils such as isopropyl myristate, dipropylene glycol pelargonate, silicone oils and copolymers thereof with polyethers, fatty acid esters, triglycerides, fatty alcohols.

Suitable antioxidants are sulfites or metabisulfites such as potassium metabisulfite, ascorbic acid, butylhydroxytoluene, butylhydroxyanisole, tocopherol.

Suitable light stabilizers are, for example, novantisolic acid.

Suitable adhesives are, for example, cellulose derivatives, starch derivatives, polyacrylates, natural polymers such as alginates, gelatin.

Emulsions can be administered orally, dermally or as injections.

Emulsions are either of the water-in-oil type or of the oil-in-water type.

They are prepared by dissolving the active compound either in the hydrophobic or in the hydrophilic phase and homogenizing this with the solvent of the other phase with the aid of suitable emulsifiers and, if appropriate, other auxiliaries such as colorants, absorption-promoting substances, preservatives, antioxidants, light stabilizers, viscosity-enhancing substances.

Suitable hydrophobic phases (oils) are:

liquid paraffins, silicone oils, natural vegetable oils such as sesame oil, almond oil, castor oil, synthetic triglycerides such as caprylic/capric biglyceride, triglyceride mixture with vegetable fatty acids of the chain length C₈-C₁₂ or other specially selected natural fatty acids, partial glyceride mixtures of saturated or unsaturated fatty acids possibly also containing hydroxyl groups, mono- and diglycerides of the C₈-C₁₀ fatty acids, fatty acid esters such as ethyl stearate, di-n-butyryl adipate, hexyl laurate, dipropylene glycol perlargonate, esters of a branched fatty acid of medium chain length with saturated fatty alcohols of chain length C₁₆-C₁₈, isopropyl myristate, isopropyl palmitate, caprylic/capric acid esters of saturated fatty alcohols of chain length C₁₂-C₁₈, isopropyl stearate, oleyl oleate, decyl oleate, ethyl oleate, ethyl lactate, waxy fatty acid esters such as synthetic duck coccygeal gland fat, dibutyl phthalate, diisopropyl adipate, and ester mixtures related to the latter, fatty alcohols such as isotridecyl alcohol, 2-octyldodecanol, cetylstearyl alcohol, oleyl alcohol, and fatty acids such as oleic acid and mixtures thereof.

Suitable hydrophilic phases are: water, alcohols such as propylene glycol, glycerol, sorbitol and mixtures thereof.

Suitable emulsifiers are:

non-ionic surfactants, e.g. polyethoxylated castor oil, polyethoxylated sorbitan monooleate, sorbitan monostearate, glycerol monostearate, polyoxyethyl stearate, alkylphenol polyglycol ether; ampholytic surfactants such as di-sodium N-lauryl-p-iminodipropionate or lecithin; anionic surfactants, such as sodium lauryl sulfate, fatty alcohol ether sulfates, mono/dialkyl polyglycol ether orthophosphoric acid ester monoethanolamine salt; cation-active surfactants, such as cetyltrimethylammonium chloride. Suitable further auxiliaries are: substances which enhance the viscosity and stabilize the emulsion, such as carboxymethylcellulose, methylcellulose and other cellulose and starch derivatives, polyacrylates, alginates, gelatin, gum arabic, polyvinylpyrrolidone, polyvinyl alcohol, copolymers of methyl vinyl ether and maleic anhydride, polyethylene glycols, waxes, colloidal silicic acid or mixtures of the substances mentioned.

Suspensions can be administered orally or topically/dermally. They are prepared by suspending the active compound in a suspending agent, if appropriate with addition of other auxiliaries such as wetting agents, colorants, bioabsorption-promoting substances, preservatives, antioxidants, light stabilizers.

Liquid suspending agents are all homogeneous solvents and solvent mixtures. Suitable wetting agents (dispersants) are the emulsifiers given above.

Other auxiliaries which may be mentioned are those given above.

Semi-solid preparations can be administered orally or topically/dermally. They differ from the suspensions and emulsions described above only by their higher viscosity. For the production of solid preparations, the active compound is mixed with suitable excipients, if appropriate with addition of auxiliaries, and brought into the desired form. Suitable excipients are all physiologically tolerable solid inert substances. Those used are inorganic and organic substances. Inorganic substances are, for example, sodium chloride, carbonates such as calcium carbonate, hydrogencarbonates, aluminium oxides, titanium oxide, silicic acids, argillaceous earths, precipitated or colloidal silica, or phosphates. Organic substances are, for example, sugar, cellulose, foodstuffs and feeds such as milk powder, animal meal, grain meals and shreds, starches.

Suitable auxiliaries are preservatives, antioxidants, and/or colorants which have been mentioned above.

Other suitable auxiliaries are lubricants and glidants such as magnesium stearate, stearic acid, talc, bentonites, disintegration-promoting substances such as starch or crosslinked polyvinylpyrrolidone, binders such as starch, gelatin or linear polyvinylpyrrolidone, and dry binders such as microcrystalline cellulose.

In general, “parasiticidally effective amount” means the amount of active ingredient needed to achieve an observable effect on growth, including the effects of necrosis, death, retardation, prevention, and removal, destruction, or otherwise diminishing the occurrence and activity of the target organism. The parasiticidally effective amount can vary for the various compounds/compositions used in the invention. A parasiticidally effective amount of the compositions will also vary according to the prevailing conditions such as desired parasiticidal effect and duration, target species, mode of application, and the like.

The compositions which can be used in the invention can comprise generally from about 0.001 to 95% of the compound of formulae I or II.

Generally, it is favorable to apply the compounds of formulae I or II in total amounts of 0.5 mg/kg to 100 mg/kg per day, preferably 1 mg/kg to 50 mg/kg per day.

Ready-to-use preparations contain the compounds acting against parasites, preferably ectoparasites, in concentrations of 10 ppm to 80% by weight, preferably from 0.1 to 65% by weight, more preferably from 1 to 50% by weight, most preferably from 5 to 40 percent by weight.

Preparations which are diluted before use contain the compounds acting against ectoparasites in concentrations of 0.5 to 90 percent by weight, preferably of 1 to 50 percent by weight.

Furthermore, the preparations comprise the compounds of formulae I or II against endoparasites in concentrations of 10 ppm to 2 percent by weight, preferably of 0.05 to 0.9 percent by weight, very particularly preferably of 0.005 to 0.25 percent by weight.

In a preferred embodiment of the present invention, the compositions comprising the compounds of formulae I or II are applied dermally/topically.

In a further preferred embodiment, the topical application is conducted in the form of compound-containing shaped articles such as collars, medallions, ear tags, bands for fixing at body parts, and adhesive strips and foils.

Generally, it is favorable to apply solid formulations which release compounds of formulae I or II in total amounts of 10 mg/kg to 300 mg/kg, preferably 20 mg/kg to 200 mg/kg, most preferably 25 mg/kg to 160 mg/kg body weight of the treated animal in the course of three weeks.

For the preparation of the shaped articles, thermoplastic and flexible plastics as well as elastomers and thermoplastic elastomers are used. Suitable plastics and elastomers are polyvinyl resins, polyurethane, polyacrylate, epoxy resins, cellulose, cellulose derivatives, polyamides and polyester which are sufficiently compatible with the compounds of formulae I or II. A detailed list of plastics and elastomers as well as preparation procedures for the shaped articles is given e.g. in WO 03/086075.

The active compounds can be applied solely or in a mixture with synergists or with other active compounds which act against pathogenic endo- and ectoparasites.

For example, the active compounds of formulae I or II can be applied in mixtures with synthetic coccidiosis compounds, polyetherantibiotics as Amprolium, Robenidin, Toltrazuril, Monensin, Salinomycin, Maduramicin, Lasalocid, Narasin or Semduramicin or with other pesticides which are described in the list M below.

Compositions to be used according to this invention may also contain other active ingredients, for example other pesticides, insecticides, herbicides, fungicides, other pesticides, or bactericides, fertilizers such as ammonium nitrate, urea, potash, and superphosphate, phytotoxicants and plant growth regulators, safeners and nematicides. These additional ingredients may be used sequentially or in combination with the above-described compositions, if appropriate also added only immediately prior to use (tank mix). For example, the plant(s) may be sprayed with a composition of this invention either before or after being treated with other active ingredients.

These agents can be admixed with the agents used according to the invention in a weight ratio of 1:10 to 10:1. Mixing the compounds of formulae I or II or the compositions comprising them in the use form as pesticides with other pesticides frequently results in a broader pesticidal spectrum of action.

The following list M of pesticides together with which the compounds of formulae I or II the invention can be used and with which potential synergistic effects might be produced, is intended to illustrate the possible combinations, but not to impose any limitation:

M.1. Organo(thio)phosphates compounds: acephate, azamethiphos, azinphos-ethyl, azinphos-methyl, chlorethoxyfos, chlorfenvinphos, chlormephos, chlorpyrifos, chlorpyrifos-methyl, coumaphos, cyanophos, demeton-S-methyl, diazinon, dichlorvos/DDVP, dicrotophos, dimethoate, dimethylvinphos, disulfoton, EPN, ethion, ethoprophos, famphur, fenamiphos, fenitrothion, fenthion, flupyrazophos, fosthiazate, heptenophos, isoxathion, malathion, mecarbam, methamidophos, methidathion, mevinphos, monocrotophos, naled, omethoate, oxydemeton-methyl, parathion, parathion-methyl, phenthoate, phorate, phosalone, phosmet, phosphamidon, phoxim, pirimiphos-methyl, profenofos, propetamphos, prothiofos, pyraclofos, pyridaphenthion, quinalphos, sulfotep, tebupirimfos, temephos, terbufos, tetrachlorvinphos, thiometon, triazophos, trichlorfon, vamidothion;

M.2. Carbamates compounds: aldicarb, alanycarb, bendiocarb, benfuracarb, butocarboxim, butoxycarboxim, carbaryl, carbofuran, carbosulfan, ethiofencarb, fenobucarb, formetanate, furathiocarb, isoprocarb, methiocarb, methomyl, metolcarb, oxamyl, pirimicarb, propoxur, thiodicarb, thiofanox, trimethacarb, XMC, xylylcarb, triazamate;

M.3. Pyrethroid compounds: acrinathrin, allethrin, d-cis-trans allethrin, d-trans allethrin, bifenthrin, bioallethrin, bioallethrin S-cylclopentenyl, bioresmethrin, cycloprothrin, cyfluthrin, beta-cyfluthrin, cyhalothrin, lambda-cyhalothrin, gamma-cyhalothrin, cypermethrin, alpha-cypermethrin, beta-cypermethrin, theta-cypermethrin, zetacypermethrin, cyphenothrin, deltamethrin, empenthrin, esfenvalerate, etofenprox, fenpropathrin, fenvalerate, flucythrinate, flumethrin, tau-fluvalinate, halfenprox, imiprothrin, metofluthrin, permethrin, phenothrin, prallethrin, profluthrin, pyrethrin (pyrethrum), resmethrin, silafluofen, tefluthrin, tetramethrin, tralomethrin, transfluthrin;

M.4. Juvenile hormone mimics: hydroprene, kinoprene, methoprene, fenoxycarb, pyriproxyfen;

M.5. Nicotinic receptor agonists/antagonists compounds: acetamiprid, bensultap, cartap hydrochloride, clothianidin, dinotefuran, imidacloprid, thiamethoxam, nitenpyram, nicotine, spinosad (allosteric agonist), spinetoram (allosteric agonist), thiacloprid, thiocyclam, thiosultap-sodium and AKD1022.

M.6. GABA gated chloride channel antagonist compounds: chlordane, endosulfan, gamma-HCH (lindane); ethiprole, fipronil, pyrafluprole, pyriprole

M.7. Chloride channel activators: abamectin, emamectin benzoate, milbemectin, lepimectin;

M.8. METI I compounds: fenazaquin, fenpyroximate, pyrimidifen, pyridaben, tebufenpyrad, tolfenpyrad, flufenerim, rotenone;

M.9. METI II and III compounds: acequinocyl, fluacyprim, hydramethylnon;

M.10. Uncouplers of oxidative phosphorylation: chlorfenapyr, DNOC;

M.11. Inhibitors of oxidative phosphorylation: azocyclotin, cyhexatin, diafenthiuron, fenbutatin oxide, propargite, tetradifon;

M.12. Moulting disruptors: cyromazine, chromafenozide, halofenozide, methoxyfenozide, tebufenozide;

M.13. Synergists: piperonyl butoxide, tribufos;

M.14. Sodium channel blocker compounds: indoxacarb, metaflumizone;

M.15. Fumigants: methyl bromide, chloropicrin sulfuryl fluoride;

M.16. Selective feeding blockers: crylotie, pymetrozine, flonicamid;

M.17. Mite growth inhibitors: clofentezine, hexythiazox, etoxazole;

M.18. Chitin synthesis inhibitors: buprofezin, bistrifluoron, chlorfluazuron, diflubenzuron, flucycloxuron, flufenoxuron, hexaflumuron, lufenuron, novaluron, noviflumuron, teflubenzuron, triflumuron;

M.19. Lipid biosynthesis inhibitors: spirodiclofen, spiromesifen, spirotetramat;

M.20. Octapaminergic agonists: amitraz;

M.21. Ryanodine receptor modulators: flubendiamide; (R)-, (S)-3-Chlor-N-1-{2-methyl-4-[1,2,2,2-tetrafluor-1-(trifluormethyl)ethyl]phenyl}-N2-(1-methyl-2-methylsulfonylethyl)phthalamid (M21.1);

M.22. Isoxazoline,

4-[5-(3,5-Dichloro-phenyl)-5-trifluoromethyl-4,5-dihydro-isoxazol-3-yl]-2-methyl-N-(2,2,2-trifluoro-ethyl)-benzamide (M22.2), 4-[5-(3,5-Dichloro-phenyl)-5-trifluoromethyl-4,5-dihydro-isoxazol-3-yl]-2-methyl-N-[(2,2,2-trifluoro-ethylcarbamoyl)-methyl]-benzamide (M22.3), 4-[5-(3,5-Dichloro-phenyl)-5-trifluoromethyl-4,5-dihydro-isoxazol-3-yl]-naphthalene-1-carboxylic acid [(2,2,2-trifluoro-ethylcarbamoyl)-methyl]-amide (M22.4) and 4-[5-(3,5-Dichlorophenyl)-5-trifluoromethyl-4,5-dihydro-isoxazol-3-yl]-N-[(methoxyimino)methyl]-2-methylbenzamide (M22.5), 4-[5-(3-Chloro-5-trifluoromethylphenyl)-5-trifluoromethyl-4,5-dihydro-isoxazol-3-yl]-2-methyl-N-[(2,2,2-trifluoroethylcarbamoyl)-methyl]-benzamide (M22.6); 4-[5-(3-Chloro-5-trifluoromethyl-phenyl)-5-trifluoromethyl-4,5-dihydro-isoxazol-3-yl]-naphthalene-1-carboxylic acid [(2,2,2-trifluoro-ethylcarbamoyl)-methyl]-amide (M22.7) and 5-[5-(3,5-Dichloro-4-fluoro-phenyl)-5-trifluoromethyl-4,5-dihydro-isoxazol-3-yl]-2-[1,2,4]triazol-1-yl-benzonitrile (M22.8);

M.23. Anthranilamide compounds: chloranthraniliprole, cyantraniliprole, 5-Bromo-2-(3-chloro-pyridin-2-yl)-2H-pyrazole-3-carboxylic acid [4-cyano-2-(1-cyclopropyl-ethylcarbamoyl)-6-methyl-phenyl]-amide (M23.1), 5-Bromo-2-(3-chloropyridin-2-yl)-2H-pyrazole-3-carboxylic acid [2-chloro-4-cyano-6-(1-cyclopropylethylcarbamoyl)-phenyl]-amide (M23.2), 5-Bromo-2-(3-chloro-pyridin-2-yl)-2H-pyrazole-3-carboxylic acid [2-bromo-4-cyano-6-(1-cyclopropyl-ethylcarbamoyl)-phenyl]-amide (M23.3), 5-Bromo-2-(3-chloro-pyridin-2-yl)-2H-pyrazole-3-carboxylic acid [2-bromo-4-chloro-6-(1-cyclopropyl-ethylcarbamoyl)-phenyl]-amide (M23.4), 5-Bromo-2-(3-chloro-pyridin-2-yl)-2H-pyrazole-3-carboxylic acid [2,4-dichloro-6-(1-cyclopropyl-ethylcarbamoyl)-phenyl]-amide (M23.5), 5-Bromo-2-(3-chloro-pyridin-2-yl)-2H-pyrazole-3-carboxylic acid [4-chloro-2-(1-cyclopropyl-ethylcarbamoyl)-6-methylphenyl]-amide (M23.6), N′-(2-{[5-Bromo-2-(3-chloro-pyridin-2-yl)-2H-pyrazole-3-carbonyl]-amino}-5-chloro-3-methyl-benzoyl)-hydrazinecarboxylic acid methyl ester (M23.7), N′-(2-{[5-Bromo-2-(3-chloro-pyridin-2-yl)-2H-pyrazole-3-carbonyl]-amino}-5-chloro-3-methyl-benzoyl)-N′-methyl-hydrazinecarboxylic acid methyl ester (M23.8), N′-(2-{[5-Bromo-2-(3-chloro-pyridin-2-yl)-2H-pyrazole-3-carbonyl]-amino}-5-chloro-3-methyl-benzoyl)-N,N′-dimethyl-hydrazinecarboxylic acid methyl ester (M23.9), N′-(3,5-Dibromo-2-{[5-bromo-2-(3-chloro-pyridin-2-yl)-2H-pyrazole-3-carbonyl]-amino}-benzoyl)-hydrazinecarboxylic acid methyl ester (M23.10), N′-(3,5-Dibromo-2-{[5-bromo-2-(3-chloro-pyridin-2-yl)-2H-pyrazole-3-carbonyl]-amino}-benzoyl)-N′-methyl-hydrazinecarboxylic acid methyl ester (M23.11) and N′-(3,5-Dibromo-2-{[5-bromo-2-(3-chloro-pyridin-2-yl)-2H-pyrazole-3-carbonyl]-amino}-benzoyl)-N,N′-dimethyl-hydrazinecarboxylic acid methyl ester (M23.12);

M.24. Malononitrile compounds: 2-(2,2,3,3,4,4,5,5-octafluoropentyl)-2-(3,3,3-trifluoropropyl)malononitrile (CF₂H—CF₂—CF₂—CF₂—CH₂—C(CN)₂—CH₂—CH₂—CF₃) (M24.1) and 2-(2,2,3,3,4,4,5,5-octafluoropentyl)-2-(3,3,4,4,4-pentafluorobutyl)-malonodinitrile (CF₂H—CF₂—CF₂—CF₂—CH₂—C(CN)₂—CH₂—CH₂—CF₂—CF₃) (M24.2);

M.25. Microbial disruptors: Bacillus thuringiensis subsp. Israelensi, Bacillus sphaericus, Bacillus thuringiensis subsp. Aizawai, Bacillus thuringiensis subsp. Kurstaki, Bacillus thuringiensis subsp. Tenebrionis;

M.26. Aminofuranone compounds:
4-{[(6-Bromopyrid-3-yl)methyl](2-fluoroethyl)amino}furan-2(5H)-on (M26.),
4-{[(6-Fluoropyrid-3-yl)methyl](2,2-difluoroethyl)amino}furan-2(5H)-on (M26.2),
4-{[(2-Chloro-1,3-thiazolo-5-yl)methyl](2-fluoroethyl)amino}furan-2(5H)-on (M26.3),
4-{[(6-Chloropyrid-3-yl)methyl](2-fluoroethyl)amino}furan-2(5H)-on (M26.4),
4-{[(6-Chloropyrid-3-yl)methyl](2,2-difluoroethyl)amino}furan-2(5H)-on (M26.5),
4-{[(6-Chloro-5-fluoropyrid-3-yl)methyl](methyl)amino}furan-2(5H)-on (M26.6),
4-{[(5,6-Dichloropyrid-3-yl)methyl](2-fluoroethyl)amino}furan-2(5H)-on (M26.7),
4-{[(6-Chloro-5-fluoropyrid-3-yl)methyl](cyclopropyl)amino}furan-2(5H)-on),
4-{[(6-Chloropyrid-3-yl)methyl](cyclopropyl)amino}furan-2(5H)-on (M26.9) and
4-{[(6-Chloropyrid-3-yl)methyl](methyl)amino}furan-2(5H)-on (M26.10);

M.27. Various compounds: aluminium phosphide, amidoflumet, benclothiaz, benzoximate, bifenazate, borax, bromopropylate, cyanide, cyenopyrafen, cyflumetofen, chinomethionate, dicofol, fluoroacetate, phosphine, pyridalyl, pyrifluquinazon, sulfur, organic sulfur compounds, tartar emetic, sulfoxaflor, N—R′-2,2-dihalo-1-R″cyclopropanecarboxamide-2-(2,6-dichloro-α,α,α-trifluoro-p-tolyl)hydrazone or N—R′-2,2-di(R′″)propionamide-2-(2,6-dichloro-α,α,α-trifluoro-p-tolyl)-hydrazone, wherein R′ is methyl or ethyl, halo is chloro or bromo, R″ is hydrogen or methyl and R′″ is methyl or ethyl, 4-But-2-ynyloxy-6-(3,5-dimethyl-piperidin-1-yl)-2-fluoro-pyrimidine (M27.1), Cyclopropaneacetic acid, 1,1′-[(3S,4R,4aR,6S,6aS,12R,12aS,12bS)-4-[[(2-cyclopropylacetyl)oxy]methyl]-1,3,4,4a,5,6,6a,12,12a,12b-decahydro-12-hydroxy-4,6a,12b-trimethyl-11-oxo-9-(3-pyridinyl)-2H,11H-naphtho[2,1-b]pyrano[3,4-e]pyran-3,6-diyl]ester (M27.2) and 8-(2-Cyclopropylmethoxy-4-trifluoromethyl-phenoxy)-3-(6-trifluoromethyl-pyridazin-3-yl)-3-aza-bicyclo[3.2.1]octane (M27.3).

The commercially available compounds of the group M may be found in The Pesticide Manual, 14th Edition, British Crop Protection Council (2006) among other publications.

Paraoxon and their preparation have been described in Farm Chemicals Handbook, Volume 88, Meister Publishing Company, 2001. Flupyrazofos has been described in Pesticide Science 54, 1988, p. 237-243 and in U.S. Pat. No. 4,822,779. AKD 1022 and its preparation have been described in U.S. Pat. No. 6,300,348. The compounds (M22.6) and (M22.7) are known from WO 2009/126668 and the compound (M22.8) is known from WO 2009/051956. The anthranilamides M23.1 to M23.6 have been described in WO 2008/72743 and WO 2008/72783, those M23.7 to M23.12 in WO 2007/043677. The phthalamide M 21.1 is known from WO 2007/101540. The alkynylether compound M27.1 is described e.g. in JP 2006/131529. Organic sulfur compounds have been described in WO 2007/060839. The isoxazoline compounds M 22.1 to M 22.5 have been described in e.g. WO 2005/085216, WO 2007/079162 and WO 2007/026965 The aminofuranone compounds M 26.1 to M 26.10 have been described eg. in WO 2007/115644. The pyripyropene derivative M 27.2 has been described in WO 2008/66153 and WO 2008/108491. The pyridazin compound M 27.3 has been described in JP 2008/115155. Malononitrile compounds as those (M24.1) and (M24.2) have been described in WO 2002/089579, WO 2002/090320, WO 2002/090321, WO 2004/006677, WO 2005/068423, WO 2005/068432 and WO 2005/063694.

Fungicidal mixing partners are in particular those selected from the group consisting of acylalanines such as benalaxyl, metalaxyl, ofurace, oxadixyl, amine derivatives such as aldimorph, dodine, dodemorph, fenpropimorph, fenpropidin, guazatine, iminoctadine, spiroxamin, tridemorph, anilinopyrimidines such as pyrimethanil, mepanipyrim or cyrodinyl, antibiotics such as cycloheximid, griseofulvin, kasugamycin, natamycin, polyoxin or streptomycin,

azoles such as bitertanol, bromoconazole, cyproconazole, difenoconazole, diniconazole, epoxiconazole, fenbuconazole, fluquiconazole, flusilazole, hexaconazole, imazalil, metconazole, myclobutanil, penconazole, propiconazole, prochloraz, prothioconazole, tebuconazole, triadimefon, triadimenol, triflumizol, triticonazole, flutriafol, dicarboximides such as iprodion, myclozolin, procymidon, vinclozolin, dithiocarbamates such as ferbam, nabam, maneb, mancozeb, metam, metiram, propineb, polycarbamate, thiram, ziram, zineb,

heterocyclic compounds such as anilazine, benomyl, boscalid, carbendazim, carboxin, oxycarboxin, cyazofamid, dazomet, dithianon, famoxadon, fenamidon, fenarimol, fuberidazole, flutolanil, furametpyr, isoprothiolane, mepronil, nuarimol, probenazole, proquinazid, pyrifenox, pyroquilon, quinoxyfen, silthiofam, thiabendazole, thifluzamid, thiophanate-methyl, tiadinil, tricyclazole, triforine, copper fungicides such as Bordeaux mixture, copper acetate, copper oxychloride, basic copper sulfate,

nitrophenyl derivatives such as binapacryl, dinocap, dinobuton, nitrophthalisopropyl, phenylpyrroles such as fenpiclonil or fludioxonil,

sulfur,

other fungicides such as acibenzolar-S-methyl, benthiavalicarb, carpropamid, chlorothalonil, cyflufenamid, cymoxanil, diclomezin, diclocymet, diethofencarb, edifen-phos, ethaboxam, fenhexamid, fentin-acetate, fenoxanil, ferimzone, fluazinam, fosetyl, fosetyl-aluminum, iprovalicarb, hexachlorobenzene, metrafenon, pencycuron, propamocarb, phthalide, toloclofos-methyl, quintozene, zoxamid,

strobilurins such as azoxystrobin, dimoxystrobin, enestroburin, fluoxastrobin, kresoxim-methyl, metominostrobin, orysastrobin, picoxystrobin, pyraclostrobin, pyribencarb or trifloxystrobin,

sulfenic acid derivatives such as captafol, captan, dichlofluanid, folpet, tolylfluanid, cinnemamides and analogs such as dimethomorph, flumetover or flumorph.

The invertebrate pest, i.e. arthropodes and nematodes, the plant, soil or water in which the plant is growing can be contacted with the compound(s) of formulae I or II or composition(s) containing them by any application method known in the art. As such, “contacting” includes both direct contact (applying the compounds/compositions directly on the invertebrate pest or plant—typically to the foliage, stem or roots of the plant) and indirect contact (applying the compounds/compositions to the locus of the invertebrate pest or plant).

Moreover, invertebrate pests may be controlled by contacting the target pest, its food supply, habitat, breeding ground or its locus with a pesticidally effective amount of compounds of formulae I or II. As such, the application may be carried out before or after the infection of the locus, growing crops, or harvested crops by the pest.

“Locus” in general means a habitat, breeding ground, cultivated plants, plant propagation material (such as seed), soil, area, material or environment in which a pest or parasite is growing or may grow.

In general “pesticidally effective amount” means the amount of active ingredient needed to achieve an observable effect on growth, including the effects of necrosis, death, retardation, prevention, and removal, destruction, or otherwise diminishing the occurrence and activity of the target organism. The pesticidally effective amount can vary for the various compounds/compositions used in the invention. A pesticidally effective amount of the compositions will also vary according to the prevailing conditions such as desired pesticidal effect and duration, weather, target species, locus, mode of application, and the like.

The compounds of formulae I or II and the compositions comprising said compounds can be used for protecting wooden materials such as trees, board fences, sleepers, etc. and buildings such as houses, outhouses, factories, but also construction materials, furniture, leathers, fibers, vinyl articles, electric wires and cables etc. from ants and/or termites, and for controlling ants and termites from doing harm to crops or human being (e.g. when the pests invade into houses and public facilities). The compounds of are applied not only to the surrounding soil surface or into the under-floor soil in order to protect wooden materials but it can also be applied to lumbered articles such as surfaces of the under-floor concrete, alcove posts, beams, plywood, furniture, etc., wooden articles such as particle boards, half boards, etc. and vinyl articles such as coated electric wires, vinyl sheets, heat insulating material such as styrene foams, etc. In case of application against ants doing harm to crops or human beings, the ant controller of the present invention is applied to the crops or the surrounding soil, or is directly applied to the nest of ants or the like.

The compounds of formulae I or II can also be applied preventively to places at which occurrence of the pests is expected.

The compounds of formulae I or II may also be used to protect growing plants from attack or infestation by pests by contacting the plant with a pesticidally effective amount of compounds of formulae I or II. As such, “contacting the plant” includes both direct contact (applying the compounds/compositions directly on the pest and/or plant—typically to the foliage, stem or roots of the plant) and indirect contact (applying the compounds/compositions to the locus of the pest and/or plant).

In the case of soil treatment or of application to the pests dwelling place or nest, the quantity of active ingredient ranges from 0.0001 to 500 g per 100 m², preferably from 0.001 to 20 g per 100 m².

Customary application rates in the protection of materials are, for example, from 0.01 g to 1000 g of active compound per m² treated material, desirably from 0.1 g to 50 g per m².

Insecticidal compositions for use in the impregnation of materials typically contain from 0.001 to 95% by weight, preferably from 0.1 to 45% by weight, and more preferably from 1 to 25% by weight of at least one repellent and/or insecticide.

For use in bait compositions, the typical content of active ingredient is from 0.001% by weight to 15% by weight, desirably from 0.001% by weight to 5% by weight of active compound.

For use in spray compositions, the content of active ingredient is from 0.001 to 80% by weight, preferably from 0.01 to 50% by weight and most preferably from 0.01 to 15% by weight.

For use in treating crop plants, the rate of application of the active ingredients of this invention may be in the range of 0.1 g to 4000 g per hectare, desirably from 5 g to 600 g per hectare, more desirably from 10 g to 300 g per hectare.

In the treatment of seed, the application rates of the active ingredients are generally from 0.1 g to 10 kg per 100 kg of seed, preferably from 1 g to 1 kg per 100 kg of seed, in particular from 1 g to 250 g per 100 kg of seed, in particular from 10 g to 150 g per 100 kg of seed.

The present invention is now illustrated in further detail by the following examples. However, the purpose of the following examples is only illustrative and is not intended to limit the present invention to them.

### I. PREPARATION EXAMPLES

The procedure described in the following synthesis example was used to prepare further compounds of the formula I by appropriate modification of the starting materials. The resulting compounds, together with physical data, are listed below in Table I.

Products were characterized by melting point determination, by NMR spectroscopy or by the masses ([m/z]) or retention times (r.t.; [min]) determined via HPLC-MS (High Performance Liquid Chromatography Mass Spectrometry).

HPLC was carried out using an analytic RP-18 column (Chromolith® Speed ROD from Merck KgaA, Germany), 50×4.6 mm, which was operated at 40° C. The mobile phase consisted of acetonitrile with 0.1% by volume of trifluoroacetic acid (TFA) and an aqueous solution of TFA (0.1% by volume), using a gradient of 5:95 to 100:0 (vol/vol) over 5 minutes at a flow rate of 1.8 mL/min.

HPLC for examples 21 to 24, 44, 46 and 48 to 50 was carried out using an analytic RP-18 column (Kinetex™ XB C18, 1.7 μm, from Phenomenex, Germany), 50×2.0 mm, which was operated at 60° C. The mobile phase consisted of acetonitrile with 0.1% by volume of TFA and an aqueous solution of TFA (0.1% by volume), using a gradient 5:95 to 100:0 (vol/vol) over 1.5 minutes at a flow rate of 0.8 mL/min to 1.0 mL/min. MS analyses were performed using quadrupole electrospray ionization, 80 V (positive mode).

### Example 18

### N-Pyridin-3-yl-5-trifluoromethylnicotinamide

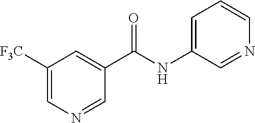 [SMILES: O=C(Nc1cccnc1)c1cncc(C(F)(F)F)c1]

842 mg (2.63 mmol, 1.05 eq) of N,N,N′,N′-tetramethyl-O-(benzotriazol-1-yl)uronium tetrafluoroborate (TBTU) were added to an ice-cooled solution of 5-trifluoromethyl-nicotinic acid (475 mg, 2.50 mmol), 3-aminopyridine (235 mg, 2.50 mmol, 1.00 eq), 1-hydroxybenzotriazole hydrate (403 mg, 2.63 mmol, 1.05 eq) and triethylamine (0.52 ml, 0.38 g, 3.8 mmol, 1.5 eq) in tetrahydrofurane (50 ml). The ice bath was removed after 5 min and the reaction mixture was stirred at room temperature over night. Afterwards the volatiles were removed in vacuo and the remainder was dissolved in dichloromethane. The solution was washed twice with a saturated solution of NaHCO₃ and dried over Na₂SO₄. Removal of the volatiles in vacuo and purification by flash chromatography (silica gel, ethyl acetate/methanol 1:1 (vol/vol)) yielded 220 mg (33%) of the title compound.

TABLE I
Compounds of formula I′
(I′)

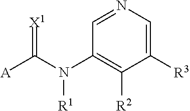

| | | | | | | Physico- | |
|---|---|---|---|---|---|---|---|
| | | | | | | chemical data: | |
| | | | | | | r.t. | |
| Ex. | A | X¹ | R¹ | R² | R³ | [min] ^{a)} | m/z ^{b)} |
| 1 | Pyridin-2-yl | O | H | H | H | 1.257 | 199.2 |
| 2 | 6-Fluoropyridin-2-yl | O | H | H | H | 1.386 | 217.2 |
| 3 | 5-Butylpyridin-2-yl | O | H | H | H | 2.423 | 255.3 |
| 4 | Pyridin-2-yl | O | H | H | CF₃ | 2.755 | 267.2 |
| 5 | 5-Trifluoromethyl- | O | H | H | H | 1.808 | 268.2 |
| | pyridin-2-yl | | | | | | |
| 6 | 6-Trifluoromethyl- | O | H | H | H | 1.794 | 267.2 |
| | pyridin-2-yl | | | | | | |
| 7 | 3-Chloro-5-tri- | O | H | H | H | 2.024 | 301.7 |
| | fluoromethyl- | | | | | | |
| | pyridin-2-yl | | | | | | |
| 8 | Pyridin-2-yl | S | H | H | H | 1.738 | 215.3 |
| 9 | 5-Butylpyridin-2-yl | S | H | H | H | 2.955 | 271.4 |
| 10 | 6-Fluoropyridin-2-yl | S | H | H | H | 1.869 | 233.3 |
| 11 | Pyridin-2-yl | S | H | H | CF₃ | 3.098 | 284.3 |
| 12 | 4-Trifluoromethyl- | O | H | H | H | 1.419 | 267.2 |
| | pyridin-3-yl | | | | | | |
| 13 | 2-Trifluoromethyl- | O | H | H | H | 1.369 | 267.2 |
| | pyridin-3-yl | | | | | | |
| 14 | 6-Chloro-4- | O | H | H | H | 1.824 | 301.7 |
| | trifluoromethyl- | | | | | | |
| | pyridin-3-yl | | | | | | |
| 15 | 2-Methyl-6- | O | H | H | H | 1.768 | 281.2 |
| | trifluoromethyl- | | | | | | |
| | pyridin-3-yl | | | | | | |
| 16 | 2-Chloro-6- | O | H | H | H | 1.898 | 301.7 |
| | trifluoromethyl- | | | | | | |
| | pyridin-3-yl | | | | | | |
| 17 | 6-Trifluoromethyl- | O | H | H | H | 1.704 | 267.2 |
| | pyridin-3-yl | | | | | | |
| 18 | 5-Trifluoromethyl- | O | H | H | H | 1.669 | 268.0 |
| | pyridin-3-yl | | | | | | |
| 18 | 2-Trifluoromethyl- | O | H | H | H | 1.875 | 267.2 |
| | pyridin-4-yl | | | | | | |
| 20 | 3-Trifluoromethyl- | O | H | H | H | 1.427 | 267.2 |
| | pyridin4-yl | | | | | | |
| 21 | pyrazine-2-yl | O | H | H | H | 0.570 | 201.1 |
| 22 | 2-phenylsulfanyl-N- | O | H | H | H | 0.803 | 308.0 |
| | pyridin-3-yl | | | | | | |
| 23 | 4-methyl-2- | O | H | H | H | 0.771 | 283.0 |
| | trifluoromethyl- | | | | | | |
| | pyrimidine-5-yl | | | | | | |
| 24 | 5-bromo-2-ethylsulfanyl- | O | H | H | H | 0.877 | 338.9 |
| | pyrimidine-4-yl | | | | | | |
| 25 | 2-isobutyl-4-methyl- | O | H | H | H | 1.947 | 271.2 |
| | pyrimidine-5-yl | | | | | | |
| 26 | 2-cyclopropylmethyl-4- | O | H | H | H | 1.797 | 269.2 |
| | methyl-pyrimidine-5-yl | | | | | | |
| 27 | 5,6-dimethyl-pyrimidine- | O | H | H | H | 1.435 | 229.1 |
| | 4-yl | | | | | | |
| 28 | 6-ethyl-5-methyl- | O | H | H | H | 1.698 | 243.1 |
| | pyrimidine-4-yl | | | | | | |
| 29 | 5-methyl-6-trifluoromethyl- | O | H | H | H | 2.047 | 283.1 |
| | pyrimidine-4-yl | | | | | | |
| 30^{c)} | 3-[(6-cyclopropyl-5-methyl- | O | H | H | H | 1.913 | 255.1 |
| | pyrimidine-4-yl | | | | | | |
| 31 | 2-isopropyl-4-methyl- | O | H | H | H | 1.795 | 257.1 |
| | pyrimidine-5-yl | | | | | | |
| 32 | 2-tert-butyl-4-methyl- | O | H | H | H | 2.279 | 271.2 |
| | pyrimidine-5-yl | | | | | | |
| 33 | 4-methyl-pyrimidine-5-yl | O | H | H | H | 1.013 | 215.1 |
| 34 | 2-methyl-pyrimidine-5-yl | O | H | H | H | 1.134 | 215.1 |
| 35 | 2-isobutyl-4-methyl- | O | Me | H | H | 1.957 | 285.2 |
| | pyrimidine-5- | | | | | | |
| 36 | 2-cyclopropylmethyl-4- | O | Me | H | H | 1.790 | 283.2 |
| | methyl-pyrimidine-5-yl | | | | | | |
| 37 | 6-ethyl-5-methyl- | O | Me | H | H | 1.552 | 257.2 |
| | pyrimidine-4-yl | | | | | | |
| 38 | 5-methyl-6-trifluoromethyl- | O | Me | H | H | 1.753 | 269.2 |
| | pyrimidine-4-yl | | | | | | |
| 39 | 2-isopropyl-4-methyl- | O | Me | H | H | 1.784 | 271.2 |
| | pyrimidine-5-yl | | | | | | |
| 40 | 2-tert-butyl-4-methyl- | O | Me | H | H | 2.284 | 285.2 |
| | pyrimidine-5-yl | | | | | | |
| 41 | 2-methyl-pyrimidine-5-yl | O | Me | H | H | 1.017 | 229.1 |
| 42^{c)} | pyrimidine-5-yl | O | Me | H | H | 0.787 | 215.1 |
| 43^{c)} | pyridazine-4-yl | O | Me | H | H | 0.735 | 215.1 |
| 44^{c)} | 2-methyl-4-trifluoromethyl- | O | Me | H | H | 0.789 | 297.1 |
| | pyrimidine-5-yl | | | | | | |
| 45^{c)} | 4-methyl-2-trifluoromethyl- | O | Me | H | H | 1.957 | 297.1 |
| | pyrimidine-5-yl | | | | | | |
| 46^{c)} | pyrimidine-5-yl | O | H | H | H | 0.575 | 201.1 |
| 47^{c)} | pyridazine-4-yl | O | H | H | H | 0.794 | 201.1 |
| 48 | pyridazine-3-yl | O | H | H | H | 0.608 | 201.1 |
| 49 | 2-methyl-4-trifluoromethyl- | O | H | H | H | 0.730 | 283.0 |
| | pyrimidine-5-yl | | | | | | |
| 50 | 1-oxy-pyridine-2-yl | O | H | H | H | 0.603 | 216.0 |

^{a)} r.t. = HPLC retention time
^{b)} m/z of the [M]⁺ peaks
^{c)}isolated as triflate

### II. EVALUATION OF PESTICIDAL ACTIVITY

### II.1 Cotton Aphid (Aphis gossypii, Mixed Life Stages)

Method a)

The active compounds were formulated in 50:50 (vol/vol) acetone:water and 100 ppm Kinetica™ surfactant.

Cotton plants at the cotyledon stage (one plant per pot) were infested by placing a heavily infested leaf from the main colony on top of each cotyledon. The aphids were allowed to transfer to the host plant overnight, and the leaf used to transfer the aphids was removed. The cotyledons were dipped in the test solution and allowed to dry. After days, mortality counts were made.

In this test, the compounds of examples 3, 5, 7, 8, 9, 12, 14, 15, 17, 18, 19, 20 and 50, respectively, at 300 ppm showed a mortality of at least 75% in comparison with untreated controls.

Method b)

The active compounds were formulated in cyclohexanone as a 10,000 ppm solution supplied in 1.3 ml ABgene® tubes. These tubes were inserted into an automated electrostatic sprayer equipped with an atomizing nozzle and they served as stock solutions for which lower dilutions were made in 50% acetone:50% water (vol/vol). A nonionic surfactant (Kinetic®) was included in the solution at a volume of 0.01% (vol/vol). Cotton plants at the cotyledon stage were infested with aphids prior to treatment by placing a heavily infested leaf from the main aphid colony on top of each cotyledon. Aphids were allowed to transfer overnight to accomplish an infestation of 80-100 aphids per plant and the host leaf was removed. The infested plants were then sprayed by an automated electrostatic plant sprayer equipped with an atomizing spray nozzle. The plants were dried in the sprayer fume hood, removed from the sprayer, and then maintained in a growth room under fluorescent lighting in a 24-hr photoperiod at 25° C. and 20-40% relative humidity. Aphid mortality on the treated plants, relative to mortality on untreated control plants, was determined after 5 days.

In this test, the compounds 23, 26, 30, 31, 38, 42, 45, 46 and 47, respectively, at 300 ppm showed a mortality of at least 75% in comparison with untreated controls.

### II.2 Green Peach Aphid (Myzus persicae, Mixed Life Stages)

Method a)

The active compounds were formulated in 50:50 (vol/vol) acetone:water and 100 ppm Kinetica™ surfactant.

Pepper plants in the 2^{nd} leaf-pair stage (variety ‘California Wonder’) were infested with approximately 40 laboratory-reared aphids by placing infested leaf sections on top of the test plants. The leaf sections were removed after 24 hr. The leaves of the intact plants were dipped into gradient solutions of the test compound and allowed to dry. Test plants were maintained under fluorescent light (24 hour photoperiod) at about 25° C. and 20-40% relative humidity. Aphid mortality on the treated plants, relative to mortality on check plants, was determined after 5 days.

In this test, the compounds of examples 3, 5, 7, 15, 17, 18, and 19, respectively, at 300 ppm showed a mortality of at least 90% in comparison with untreated controls.

Method b)

The active compounds were formulated in cyclohexanone as a 10,000 ppm solution supplied in 1.3 ml ABgene® tubes. These tubes were inserted into an automated electrostatic sprayer equipped with an atomizing nozzle and they served as stock solutions for which lower dilutions were made in 50% acetone:50% water (vol/vol). A nonionic surfactant (Kinetic®) was included in the solution at a volume of 0.01% (vol/vol). Bell pepper plants at the first true-leaf stage were infested prior to treatment by placing heavily infested leaves from the main colony on top of the treatment plants. Aphids were allowed to transfer overnight to accomplish an infestation of 30-50 aphids per plant and the host leaves were removed. The infested plants were then sprayed by an automated electrostatic plant sprayer equipped with an atomizing spray nozzle. The plants were dried in the sprayer fume hood, removed, and then maintained in a growth room under fluorescent lighting in a 24-hr photoperiod at 25° C. and 20-40% relative humidity. Aphid mortality on the treated plants, relative to mortality on untreated control plants, was determined after 5 days.

In this test, the compounds 23, 25, 26, 30, 31, 38, 42, 45, 46, 47 and 49, respectively, at 300 ppm showed a mortality of at least 90% in comparison with untreated controls.

### II.3 Cowpea Aphid (Aphis craccivora)

The active compounds were formulated in 50:50 (vol/vol) acetone:water. The test solution was prepared at the day of use.

Potted cowpea plants colonized with 100-150 aphids of various stages were sprayed after the pest population had been recorded. Population reduction was assesed after 24, 72, and 120 hours.

In this test, the compounds of examples 3, 5, 7, 12, 14, 15, 16, 17, 18, 19, 23, 25, 26, 28, 30, 31, 35, 36, 38, 39, 41, 42, 43, 45, 46, 47, 49 and 50, respectively, at 300 ppm showed a mortality of at least 90% in comparison with untreated controls.

### II.4 Vetch Aphid (Megoura viciae)

The active compounds were formulated in 1:3 (vol/vol) DMSO:water with different concentrations of formulated compounds.

Bean leaf disks were placed into microtiterplates filled with 0.8% agar-agar and 2.5 ppm OPUS™. The leaf disks were sprayed with 2.5 μl of the test solution and 5 to 8 adult aphids were placed into the microtiterplates which were then closed and kept at 23±1° C. and 50±5% relative humidity under fluorescent light for 6 days. Mortality was assessed on the basis of vital, reproduced aphids. Aphid mortality and fecundity was then visually assessed.

In this test, the compounds of examples 4, 5, 7, 10, 11, 12, 13, 14, 15, 17, 18, 19, 20, 22, 23, 24, 25, 26, 27, 28, 29, 31, 32, 33, 34, 35, 36, 38, 39, 40, 41, 42, 43, 44, 45, 46, 47 and 49, respectively, at a concentration of the test solution of 2500 mg/L showed a mortality of at least 90%.

### II.5 Boll Weevil (Anthonomus grandis)

The compounds were formulated in 75:25 (vol/vol) water:DMSO.

For evaluating control of boll weevil (Anthonomus grandis) the test unit consisted of 24-well-microtiter plates containing an insect diet and 20-30 A. grandis eggs. Different concentrations of formulated compounds were sprayed onto the insect diet at 20 μl, using a custom built micro atomizer, at two replications. After application, the microtiter plates were incubated at 23±1° C. and 50±5% relative humidity for 5 days. Egg and larval mortality was then visually assessed.

In this test, the compounds of examples 2, 6, 8, 9, 11, 14, 15, 16, 19, 20, 25, 26, 29, 32, 36 and 37, respectively, at a concentration of the test solution of 2500 mg/L showed a mortality of at least 50%.

### II.6 Activity Against Green Peach Aphid (Myzus persicae)

For evaluating control of green peach aphid (Myzus persicae) through systemic means the test unit consisted of 96-well-microtiter plates containing liquid artificial diet under an artificial membrane.

The compounds were formulated using a solution containing 75% vol/vol water and 25% vol/vol DMSO. Different concentrations of formulated compounds were pipetted into the aphid diet, using a custom built pipetter, at two replications. After application, 5 to 8 adult aphids were placed on the artificial membrane inside the microtiter plate wells. The aphids were then allowed to suck on the treated aphid diet and incubated at about 23+1° C. and about 50+5% relative humidity for 3 days. Aphid mortality and fecundity was then visually assessed.

In this test, the compounds of examples 1, 2, 3, 12, 15, 17, 18, 21, 23, 31, 36, 39, 41, 42, 43, 44, 45, 46, 47, 48 and 49, respectively, at 2500 ppm showed 100% mortality in comparison with untreated controls.

### II.7 Activity Against Brown Planthopper (Nilaparvata lugens)

The active compounds were formulated as a 50:50 (vol/vol) acetone:water solution. Surfactant (Alkamuls EL 620) was added at the rate of 0.1% (vol/vol).

Rice seedlings were cleaned and washed 24 hours before spraying. Potted rice seedlings were sprayed with 5 ml test solution, air dried, placed in cages and inoculated with 10 adults. Treated rice plants were kept at 28-29° C. and relative humidity of 50-60%. Percent mortality was recorded after 72 hours.

In this test, the compounds of examples 3 and 11, respectively, at 300 ppm showed a mortality of at least 50% in comparison with untreated controls.

1-32. (canceled)

33. A method for controlling invertebrate pests which method comprises treating the pests, their food supply, their habitat or their breeding ground or a plant, seed, soil, area, material or environment in which the pests are growing or may grow, or the materials, plants, seeds, soils, surfaces or spaces to be protected from pest attack or infestation with a pesticidally effective amount of a compound of the formula I or II or a salt or an N-oxide thereof: 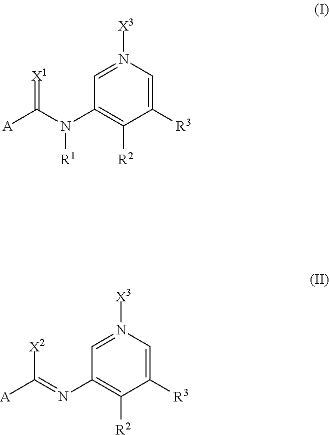
where the radical A is selected from the radicals of the formula A-1, A-2, A-3, A-4, A-6, A-7, A-8 and A-9: 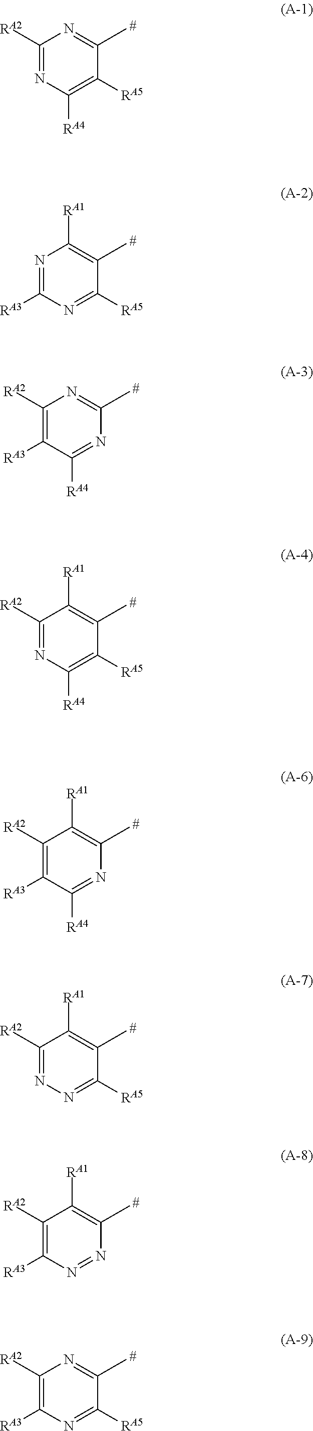
wherein:
# denotes the point of attachment to the remainder of formulae I or II, and wherein
R^{A1}, R^{A5} are independently of each other selected from the group consisting of hydrogen, halogen, CN, NO₂, OR^{a1}, C(Y)R^{b1}, S(O)ₖR^{d1} with k being 1 or 2, C₁-C₆-alkyl, C₂-C₆-alkenyl, C₂-C₆-alkynyl, wherein the 3 last mentioned radicals may be unsubstituted or may be partially or fully halogenated, C₁-C₅-alkylen-CN, C₁-C₅-alkylen-OR^{a}, C₁-C₅-alkylen-C(Y)R^{b}, C₁-C₅-alkylen-C(Y)OR^{c} C₃-C₁₀-cycloalkyl-C₁-C₅-alkyl, C₅-C₁₀-cycloalkenyl-C₁-C₅-alkyl, 3- to 10-membered heterocyclyl-C₁-C₅-alkyl, saturated 3 to 10 membered heterocyclyl, C₃-C₁₀-cycloalkyl and C₅-C₁₀-cycloalkenyl, wherein cycloalkyl, cycloalkenyl and heterocyclyl in the 6 last mentioned radicals may be unsubstituted or may carry 1, 2, 3, 4 or 5 identical or different substituents R^{y};
R^{A2}, R^{A4} are independently of each other selected from the group consisting of hydrogen, halogen, CN, NO₂, OR^{a2}, C(Y)R^{b2}, S(O)ₘR^{d2} with m being 0, 1 or 2,
C₁-C₁₀-alkyl, C₂-C₁₀-alkenyl, C₂-C₁₀-alkynyl, wherein the 3 last mentioned radicals may be unsubstituted or may be partially or fully halogenated,
C₁-C₅-alkylen-CN, C₁-C₅-alkylen-OR^{a}, C₁-C₅-alkylen-C(Y)R^{b}, C₁-C₅-alkylen-C(Y)OR^{c} C₃-C₁₀-cycloalkyl-C₁-C₅-alkyl, C₅-C₁₀-cycloalkenyl-C₁-C₅-alkyl, 3- to 10-membered heterocyclyl-C₁-C₅-alkyl, saturated 3 to 10 membered heterocyclyl, C₃-C₁₀-cycloalkyl and C₅-C₁₀-cycloalkenyl, wherein cycloalkyl, cycloalkenyl and heterocyclyl in the 6 last mentioned radicals may be unsubstituted or may carry 1, 2, 3, 4 or 5 identical or different substituents R^{y};
R^{A3} is selected from the group consisting of hydrogen, halogen, CN, NO₂, OR^{a3}, C(Y)R^{b3}, S(O)ₘR^{d3} with m being 0, 1 or 2,
C₁-C₁₀-alkyl, C₂-C₁₀-alkenyl, C₂-C₁₀-alkynyl, wherein the 3 last mentioned radicals may be unsubstituted or may be partially or fully halogenated,
C₁-C₅-alkylen-CN, C₁-C₅-alkylen-OR^{a}, C₁-C₅-alkylen-C(Y)R^{b}, C₁-C₅-alkylen-C(Y)OR^{c} C₃-C₁₀-cycloalkyl-C₁-C₅-alkyl, C₅-C₁₀-cycloalkenyl-C₁-C₅-alkyl, 3- to 10-membered heterocyclyl-C₁-C₅-alkyl, saturated 3 to 10 membered heterocyclyl, C₃-C₁₀-cycloalkyl and C₅-C₁₀-cycloalkenyl, wherein cycloalkyl, cycloalkenyl and heterocyclyl in the 6 last mentioned radicals may be unsubstituted or may carry 1, 2, 3, 4 or 5 identical or different substituents R^{y};
X¹ is S, O or NR^{1a}, wherein
R^{1a} is selected from the group consisting of hydrogen, C₁-C₁₀-alkyl, C₁-C₄-haloalkyl, C₃-C₁₀-cycloalkyl, C₃-C₁₀-cycloalkylmethyl, C₃-C₁₀-halocycloalkyl, C₂-C₁₀-alkenyl, C₂-C₁₀-haloalkenyl, C₂-C₁₀-alkynyl, C₁-C₁₀-alkoxy-C₁-C₄-alkyl, OR^{a}, phenyl, hetaryl, heterocyclyl, phenyl-C₁-C₄-alkyl, hetaryl-C₁-C₄-alkyl, and heterocyclyl-C₁-C₄-alkyl wherein the ring in the six last mentioned radicals may be unsubstituted or may carry 1, 2, 3, 4 or 5 substituents which, independently of each other, are selected from the group consisting of halogen, cyano, nitro, C₁-C₄-alkyl, C₁-C₄-haloalkyl, C₁-C₄-alkoxy and C₁-C₄-haloalkoxy;
X² is OR^{2a}, NR^{2b}R^{2c}, or S(O)ₘR^{2d}, wherein m is 0, 1 or 2, wherein
R^{2a} is selected from the group consisting of C₁-C₄-alkyl, C₁-C₄-haloalkyl, C₃-C₆-cycloalkyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, phenyl, hetaryl, heterocyclyl, phenyl-C₁-C₄-alkyl, hetaryl-C₁-C₄-alkyl and heterocyclyl-C₁-C₄-alkyl, wherein the ring in the six last mentioned radicals may be unsubstituted or may carry 1, 2, 3, 4 or 5 substituents which, independently of each other, are selected from the group consisting of halogen, cyano, nitro, C₁-C₄-alkyl, C₁-C₄-haloalkyl, C₁-C₄-alkoxy and C₁-C₄-haloalkoxy, and wherein
R^{2b}, R^{2c} are independently of each other selected from the group consisting of hydrogen, C₁-C₄-alkyl, C₁-C₄-haloalkyl, C₃-C₆-cycloalkyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, C₁-C₄-alkylcarbonyl, C₁-C₄-haloalkylcarbonyl, C₁-C₄-alkylsulfonyl, C₁-C₄-haloalkylsulfonyl, phenyl, phenylcarbonyl, phenylsulfonyl, hetaryl, hetarylcarbonyl, hetarylsulfonyl, heterocyclyl, heterocyclylcarbonyl, heterocyclylsulfonyl, phenyl-C₁-C₄-alkyl, hetaryl-C₁-C₄-alkyl and heterocyclyl-C₁-C₄-alkyl wherein the ring in the twelve last mentioned radicals may be unsubstituted or may carry 1, 2, 3, 4 or 5 substituents which, independently of each other, are selected from the group consisting of halogen, cyano, nitro, C₁-C₄-alkyl, C₁-C₄-haloalkyl, C₁-C₄-alkoxy and C₁-C₄-haloalkoxy, or
R^{2b} and R^{2c} together with the nitrogen atom to which they are bound form a 5- or 6-membered, saturated or unsaturated heterocycle, which may carry a further heteroatom being selected from the group consisting of O, S and N as a ring member atom and wherein the heterocycle may be unsubstituted or may carry 1, 2, 3, 4 or 5 substituents which, independently of each other, are selected from the group consisting of halogen, cyano, nitro, C₁-C₄-alkyl, C₁-C₄-haloalkyl, C₁-C₄-alkoxy and C₁-C₄-haloalkoxy, and wherein
R^{2d} is selected from the group consisting of C₁-C₄-alkyl, C₁-C₄-haloalkyl, C₃-C₆-cycloalkyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, phenyl, hetaryl, heterocyclyl, phenyl-C₁-C₄-alkyl, hetaryl-C₁-C₄-alkyl and heterocyclyl-C₁-C₄-alkyl, wherein the ring in the six last mentioned radicals may be unsubstituted or may carry 1, 2, 3, 4 or 5 substituents which, independently of each other, are selected from the group consisting of halogen, cyano, nitro, C₁-C₄-alkyl, C₁-C₄-haloalkyl, C₁-C₄-alkoxy and C₁-C₄-haloalkoxy;
X³ is absent or oxygen;
R¹ is hydrogen, CN, C₁-C₁₀-alkyl, C₁-C₁₀-haloalkyl, C₃-C₁₀-cycloalkyl, C₃-C₁₀-halocycloalkyl, C₂-C₁₀-alkenyl, C₂-C₁₀-haloalkenyl, C₂-C₁₀-alkynyl, C₃-C₁₀-haloalkynyl, OR^{a}, C(Y)R^{b}, C(Y)OR^{c}, S(O)₂R^{d}, NR^{e}R^{f}, C(Y)NR^{g}R^{h}, S(O)ₘNR^{e}R^{f}, C(Y)NRⁱNR^{e}R^{f}, C₁-C₅-alkylen-OR^{a}, C₁-C₅-alkylen-CN, C₁-C₅-alkylen-C(Y)R^{b}, C₁-C₅-alkylen-C(Y)OR^{c}, C₁-C₅-alkylen-NR^{e}R^{f}, C₁-C₅-alkylen-C(Y)NR^{g}R^{h}, C₁-C₅-alkylen-S(O)₂R^{d}, C₁-C₅-alkylen-S(O)ₘNR^{e}R^{d}, C₁-C₅-alkylen-C(Y)NRⁱNR^{e}R^{f},
phenyl, hetaryl, saturated or partially unsaturated heterocyclyl, phenyl-C₁-C₅-alkyl, hetaryl-C₁-C₅-alkyl, saturated or partially unsaturated heterocyclyl-C₁-C₅-alkyl, C₃-C₁₀-cycloalkyl-C₁-C₅-alkyl or C₅-C₁₀-cycloalkenyl-C₁-C₅-alkyl, wherein the ring in the last ten mentioned radicals may be unsubstituted or may carry 1, 2, 3, 4 or 5 identical or different substituents R^{y};
m is 0, 1 or 2;
Y is O or S;
R² is hydrogen, halogen, methyl, halomethyl, methoxy, halomethoxy, methylthio, halomethylthio, methylsulfinyl, halomethylsulfinyl, methylsulfonyl or halomethylsulfonyl;
R³ is hydrogen, halogen, C₁-C₄-alkyl, C₁-C₄-haloalkyl, C₁-C₄-alkoxy, C₁-C₄-haloalkoxy, C₁-C₄-alkylthio, C₁-C₄-haloalkylthio, C₁-C₄-alkylsulfinyl, C₁-C₄-haloalkylsulfinyl, C₁-C₄-alkylsulfonyl, C₁-C₄-haloalkylsulfonyl, C₃-C₆-cycloalkyl, C₃-C₆-halocycloalkyl, C₂-C₄-alkenyl, C₂-C₄-haloalkenyl, C₂-C₄-alkynyl or C₁-C₄-alkoxy-C₁-C₄-alkyl;
R^{a}, R^{b}, R^{c} are independently of each other selected from the group consisting of hydrogen, C₁-C₄-alkyl, C₁-C₄-haloalkyl, C₃-C₆-cycloalkyl, C₃-C₆-cycloalkylmethyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, phenyl, hetaryl, heterocyclyl, phenyl-C₁-C₄-alkyl, hetaryl-C₁-C₄-alkyl and heterocyclyl-C₁-C₄-alkyl, wherein the ring in the six last mentioned radicals may be unsubstituted or may carry 1, 2, 3, 4 or 5 substituents which, independently of each other, are selected from the group consisting of halogen, cyano, nitro, C₁-C₄-alkyl, C₁-C₄-haloalkyl, C₁-C₄-alkoxy and C₁-C₄-haloalkoxy;
R^{d} is selected from the group consisting of C₁-C₄-alkyl, C₁-C₄-haloalkyl, C₃-C₆-cycloalkyl, C₃-C₆-cycloalkylmethyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, phenyl, hetaryl, heterocyclyl, phenyl-C₁-C₄-alkyl, hetaryl-C₁-C₄-alkyl and heterocyclyl-C₁-C₄-alkyl wherein the ring in the six last mentioned radicals may be unsubstituted or may carry 1, 2, 3, 4 or 5 substituents which are independently of each other selected from halogen, cyano, nitro, C₁-C₄-alkyl, C₁-C₄-haloalkyl, C₁-C₄-alkoxy and C₁-C₄-haloalkoxy;
R^{e}, R^{f} are independently of each other selected from the group consisting of hydrogen, C₁-C₄-alkyl, C₁-C₄-haloalkyl, C₃-C₆-cycloalkyl, C₃-C₆-cycloalkylmethyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, C₁-C₄-alkylcarbonyl, C₁-C₄-haloalkylcarbonyl, C₁-C₄-alkylsulfonyl, C₁-C₄-haloalkylsulfonyl, phenyl, phenylcarbonyl, phenylsulfonyl, hetaryl, hetarylcarbonyl, hetarylsulfonyl, heterocyclyl, heterocyclylcarbonyl, heterocyclylsulfonyl, phenyl-C₁-C₄-alkyl, hetaryl-C₁-C₄-alkyl and heterocyclyl-C₁-C₄-alkyl wherein the ring in the twelve last mentioned radicals may be unsubstituted or may carry 1, 2, 3, 4 or 5 substituents which, independently of each other, are selected from the group consisting of halogen, cyano, nitro, C₁-C₄-alkyl, C₁-C₄-haloalkyl, C₁-C₄-alkoxy and C₁-C₄-haloalkoxy; or
R^{e} and R^{f} together with the nitrogen atom to which they are bound form a 5- or 6-membered, saturated or unsaturated heterocycle, which may carry a further heteroatom being selected from the group consisting of O, S and N as a ring member atom and wherein the heterocycle may be unsubstituted or may carry 1, 2, 3, 4 or 5 substituents which are independently of each other selected from the group consisting of halogen, cyano, nitro, C₁-C₄-alkyl, C₁-C₄-haloalkyl, C₁-C₄-alkoxy and
C₁-C₄-haloalkoxy;
R^{g}, R^{h} are independently of each other selected from the group consisting of hydrogen, C₁-C₄-alkyl, C₁-C₄-haloalkyl, C₃-C₆-cycloalkyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, phenyl, hetaryl, heterocyclyl, phenyl-C₁-C₄-alkyl, hetaryl-C₁-C₄-alkyl and heterocyclyl-C₁-C₄-alkyl wherein the ring in the six last mentioned radicals may be unsubstituted or may carry 1, 2, 3, 4 or 5 substituents which are independently of each other selected from the group consisting of halogen, cyano, nitro, C₁-C₄-alkyl, C₁-C₄-haloalkyl, C₁-C₄-alkoxy and C₁-C₄-haloalkoxy;
Rⁱ is selected from the group consisting of hydrogen, C₁-C₄-alkyl, C₁-C₄-haloalkyl, C₃-C₆-cycloalkyl, C₃-C₆-cycloalkylmethyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, phenyl and phenyl-C₁-C₄-alkyl wherein the phenyl ring in the two last mentioned radicals may be unsubstituted or may carry 1, 2, 3, 4 or 5 substituents which are independently of each other selected from the group consisting of halogen, cyano, nitro, C₁-C₄-alkyl, C₁-C₄-haloalkyl, C₁-C₄-alkoxy and C₁-C₄-haloalkoxy;
R^{a1}, R^{a2} are independently of each other selected from the group consisting of C₁-C₄-alkyl, C₁-C₄-haloalkyl, C₃-C₆-cycloalkyl, C₃-C₆-cycloalkylmethyl, C₃-C₆-halocycloalkyl, C₂-C₄-alkenyl, C₂-C₄-haloalkenyl, C₂-C₄-alkynyl and C₁-C₄-alkoxy-C₁-C₄-alkyl;
R^{b1}, R^{b2} are independently of each other selected from the group consisting of hydrogen, C₁-C₄-alkyl, C₁-C₄-haloalkyl, C₃-C₆-cycloalkyl, C₃-C₆-cycloalkylmethyl, C₃-C₆-halocycloalkyl, C₂-C₄-alkenyl, C₂-C₄-haloalkenyl, C₂-C₄-alkynyl, and C₁-C₄-alkoxy-C₁-C₄-alkyl;
R^{d1}, R^{d2} are independently of each other selected from the group consisting of C₁-C₄-alkyl, C₁-C₄-haloalkyl, C₃-C₆-cycloalkyl, C₃-C₆-cycloalkylmethyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, phenyl, hetaryl, heterocyclyl, phenyl-C₁-C₄-alkyl, hetaryl-C₁-C₄-alkyl and heterocyclyl-C₁-C₄-alkyl, wherein the ring in the six last mentioned radicals may be unsubstituted or may carry 1, 2, 3, 4 or 5 substituents which are independently of each other selected from the group consisting of halogen, cyano, nitro, C₁-C₄-alkyl, C₁-C₄-haloalkyl, C₁-C₄-alkoxy and C₁-C₄-haloalkoxy;
R^{a3} has one of the meanings given for R^{a}, except for hydrogen;
R^{b3} has one of the meanings given for R^{b};
R^{d3} has one of the meanings given for R^{d};
R^{y} is selected from the group consisting of halogen, cyano, nitro, C₁-C₄-alkyl, C₁-C₄-haloalkyl, C₁-C₄-alkoxy, C₁-C₄-haloalkoxy, C₁-C₄-haloalkylthio, C₁-C₄-alkylsulfinyl, C₁-C₄-haloalkylsulfinyl, C₁-C₄-alkylsulfonyl, C₁-C₄-haloalkylsulfonyl, SO₂NH₂, C₁-C₄-alkylaminosulfonyl, di-(C₁-C₄-alkyl)aminosulfonyl, C₁-C₄-haloalkylaminosulfonyl, C₁-C₄-alkylcarbonyl, C₁-C₄-haloalkylcarbonyl, C₁-C₄-alkoxycarbonyl, C₁-C₄-haloalkoxycarbonyl, C₃-C₆-cycloalkyl, C₃-C₆-halocycloalkyl, C₂-C₄-alkenyl, C₂-C₄-haloalkenyl, C₂-C₄-alkynyl and C₁-C₄-alkoxy-C₁-C₄-alkyl.

34. The method as claimed in claim 33, wherein the 3-pyridyl compound is a compound of formula I.

35. The method as claimed in claim 34, wherein X¹ is oxygen.

36. The method as claimed in claim 34, wherein R¹ is hydrogen, CN, C₁-C₁₀-alkyl, C₁-C₁₀-haloalkyl, C₂-C₁₀-alkenyl, C₂-C₁₀-haloalkenyl, C₂-C₁₀-alkynyl, C₁-C₄-alkylene-CN, C₁-C₅-alkylen-OR^{a}, phenyl-C₁-C₅-alkyl, hetaryl-C₁-C₅-alkyl, heterocyclyl-C₁-C₅-alkyl, C₃-C₁₀-cycloalkyl-C₁-C₅-alkyl, C₁-C₅-alkylen-C(Y)R^{b}, C₁-C₅-alkylen-C(Y)OR^{c}, OR^{a}, C(Y)R^{b}, C(Y)OR^{c} or S(O)₂R^{d}.

37. The method as claimed in claim 36, wherein R¹ is hydrogen, C₁-C₁₀-alkyl, C₁-C₁₀-haloalkyl, C₁-C₄-alkylene-CN, C₁-C₅-alkylen-OR^{a}, hetaryl-C₁-C₅-alkyl, heterocyclyl-C₁-C₅-alkyl or C₃-C₁₀-cycloalkyl-C₁-C₅-alkyl.

38. The method as claimed in claim 37, wherein R¹ is hydrogen, C₁-C₄-alkyl, C₁-C₄-haloalkyl, C₁-C₃-alkylen-O—C₁-C₃-alkyl or C₁-C₄-alkylene-CN.

39. The method as claimed in claim 33, wherein R² is hydrogen, fluorine, chlorine, bromine, methyl, difluoromethyl, trifluoromethyl, methoxy, difluoromethoxy or trifluoromethoxy.

40. The method as claimed in claim 33, wherein R³ is hydrogen, fluorine, chlorine, bromine, methyl, difluoromethyl, trifluoromethyl, methoxy, difluoromethoxy or trifluoromethoxy.

41. The method as claimed in claim 33, wherein R² is hydrogen.

42. The method as claimed in claim 33, wherein R³ is hydrogen.

43. The method as claimed in claim 33, wherein both radicals R² and R³ are hydrogen.

44. The method as claimed in claim 33, wherein the radical A is selected from the radicals of the formula A-1, A-2 and A-3:

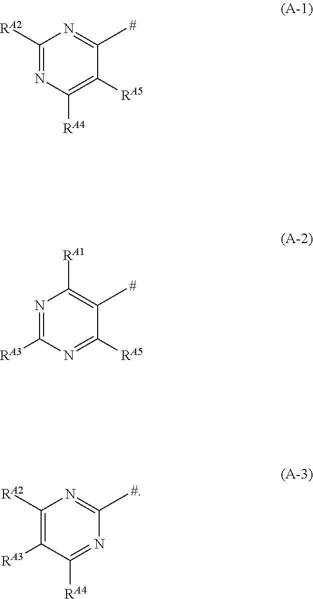

45. The method as claimed in claim 33, wherein the radical A is selected from the radicals of the formula A-4 and A-6:

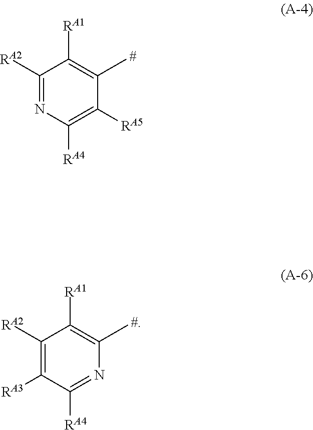

46. The method as claimed in claim 33, wherein the radical A is selected from the radicals of the formula A-7 and A-8:

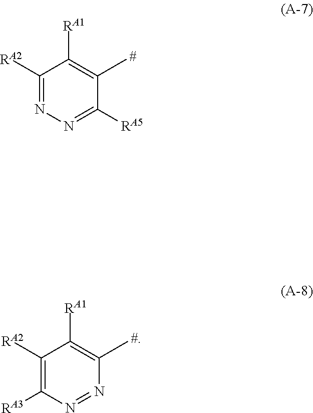

47. The method as claimed in claim 33, wherein the radical A is a radical of the formula A-9:

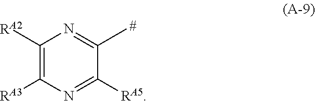

48. The method as claimed in claim 33, wherein R^{A1} and R^{A5}, if present, are selected independently of each other from the group consisting of hydrogen, halogen, CN, NO₂, C₁-C₄-alkyl, C₁-C₄-haloalkyl, C₁-C₄-alkoxy, C₁-C₄-haloalkoxy, C₁-C₄-alkylsulfinyl, C₁-C₄-haloalkylsulfinyl, C₁-C₄-alkylsulfonyl, C₁-C₄-haloalkylsulfonyl, C₁-C₅-alkylen-CN, C₁-C₅-alkylen-OR^{a}, C₁-C₅-alkylen-C(Y)R^{b}, C₁-C₅-alkylen-C(Y)OR^{c}, C₃-C₁₀-cycloalkyl, C₅-C₁₀-cycloalkenyl, saturated 3 to 10 membered heterocyclyl, C₃-C₁₀-cycloalkyl-C₁-C₅-alkyl, C₅-C₁₀-cycloalkenyl-C₁-C₅-alkyl, and 3- to 10-membered heterocyclyl-C₁-C₅-alkyl, wherein cycloalkyl, cycloalkenyl and heterocyclyl in the 6 last mentioned radicals may be unsubstituted or may carry 1, 2, 3, 4 or 5 identical or different substituents R^{y}.

49. The method as claimed in claim 48, wherein R^{A1} and R^{A5}, if present, are selected independently of each other from the group consisting of hydrogen, halogen, C₁-C₄-alkyl, C₁-C₄-haloalkyl, C₁-C₄-alkoxy, C₁-C₄-haloalkoxy, C₁-C₃-alkylen-CN, C₁-C₃-alkylen-OR^{a}, C₃-C₇-cycloalkyl, C₃-C₇-cycloalkyl-C₁-C₃-alkyl, and 3- to 7-membered saturated heterocyclyl-C₁-C₃-alkyl, wherein cycloalkyl and heterocyclyl in the 3 last mentioned radicals may be unsubstituted or may carry 1, 2, 3, 4 or 5 identical or different substituents R^{y}.

50. The method as claimed in claim 49, wherein R^{A1} and R^{A5}, if present, are selected independently of each other from the group consisting of hydrogen, fluorine, chlorine, bromine, methyl, ethyl, n-propyl, isopropyl, cyclopropyl, isobutyl, cyclopropylmethyl, fluoromethyl, difluoromethyl, trifluoromethyl, 1-fluoroethyl, 2-fluoroethyl, 2,2,2-trifluoroethyl, methoxymethyl, difluoromethoxymethyl, trifluoromethoxymethyl, cyanomethyl, 2-methoxy-1-ethyl, 2-difluoromethoxy-1-ethyl, 2-trifluoromethoxy-1-ethyl, and 2-cyano-1-ethyl.

51. The method as claimed in claim 33, wherein R^{A2} and R^{A4}, if present, are selected independently of each other from the group consisting of hydrogen, halogen, CN, NO₂, C₁-C₄-alkyl, C₁-C₄-haloalkyl, C₁-C₄-alkoxy, C₁-C₄-haloalkoxy, C₁-C₄-alkylthio, C₁-C₄-haloalkylthio, C₁-C₄-alkylsulfinyl, C₁-C₄-haloalkylsulfinyl, C₁-C₄-alkylsulfonyl, C₁-C₄-haloalkylsulfonyl, C₁-C₅-alkylen-CN, C₁-C₅-alkylen-OR^{a}, C₁-C₅-alkylen-C(Y)R^{b}, C₁-C₅-alkylen-C(Y)OR^{c}, C₃-C₁₀-cycloalkyl, C₅-C₁₀-cycloalkenyl, saturated 3 to 10 membered heterocyclyl, C₃-C₁₀-cycloalkyl-C₁-C₅-alkyl, C₅-C₁₀-cycloalkenyl-C₁-C₅-alkyl, and saturated or partially unsaturated 3- to 10-membered heterocyclyl-C₁-C₅-alkyl, wherein cycloalkyl, cycloalkenyl and heterocyclyl in the 6 last mentioned radicals may be unsubstituted or may carry 1, 2, 3, 4 or 5 identical or different substituents R^{y}.

52. The method as claimed in claim 51, wherein R^{A2} and R^{A4}, if present, are selected independently of each other from the group consisting of hydrogen, halogen, C₁-C₄-alkyl, C₁-C₄-haloalkyl, C₁-C₄-alkoxy, C₁-C₄-haloalkoxy, C₁-C₃-alkylen-CN, C₁-C₃-alkylen-OR^{a}, C₃-C₇-cycloalkyl, C₃-C₇-cycloalkyl-C₁-C₃-alkyl, and 3- to 7-membered saturated heterocyclyl-C₁-C₃-alkyl, wherein cycloalkyl and heterocyclyl in the 3 last mentioned radicals may be unsubstituted or may carry 1, 2, 3, 4 or 5 identical or different substituents R^{y}.

53. The method as claimed claim 51, wherein R^{A2} and R^{A4}, if present, are selected independently of each other from the group consisting of hydrogen, fluorine, chlorine, bromine, methyl, ethyl, n-propyl, isopropyl, cyclopropyl, isobutyl, cyclopropylmethyl, fluoromethyl, difluoromethyl, trifluoromethyl, 1-fluoroethyl, 2-fluoroethyl, 2,2,2-trifluoroethyl, methoxymethyl, difluoromethoxymethyl, trifluoromethoxymethyl, cyanomethyl, 2-methoxy-1-ethyl, 2-difluoromethoxy-1-ethyl, 2-trifluoromethoxy-1-ethyl, and 2-cyano-1-ethyl.

54. The method as claimed in claim 33, wherein R^{A3}, if present, is selected from the group consisting of hydrogen, halogen, CN, NO₂, C₁-C₄-alkyl, C₁-C₄-haloalkyl, C₁-C₄-alkoxy, C₁-C₄-haloalkoxy, C₁-C₄-alkylthio, C₁-C₄-haloalkylthio, C₁-C₄-alkylsulfinyl, C₁-C₄-haloalkylsulfinyl, C₁-C₄-alkylsulfonyl, C₁-C₄-haloalkylsulfonyl, C₁-C₅-alkylen-CN, C₁-C₅-alkylen-OR^{a}, C₁-C₅-alkylen-C(Y)R^{b}, C₁-C₅-alkylen-C(Y)OR^{c}, C₃-C₁₀-cycloalkyl, C₅-C₁₀-cycloalkenyl, saturated or partially unsaturated 3 to 10 membered heterocyclyl, C₃-C₁₀-cycloalkyl-C₁-C₅-alkyl, C₅-C₁₀-cycloalkenyl-C₁-C₅-alkyl and 3- to 10-membered heterocyclyl-C₁-C₅-alkyl, wherein cycloalkyl, cycloalkenyl and heterocyclyl in the 6 last mentioned radicals may be unsubstituted or may carry 1, 2, 3, 4 or 5 identical or different substituents R^{y}.

55. The method as claimed in claim 53, wherein R^{A3}, if present, is selected from the group consisting of hydrogen, halogen, C₁-C₄-alkyl, C₁-C₄-haloalkyl, C₁-C₄-alkoxy, C₁-C₄-haloalkoxy, C₁-C₃-alkylen-CN, C₁-C₃-alkylen-OR^{a}, C₃-C₇-cycloalkyl, C₃-C₇-cycloalkyl-C₁-C₃-alkyl, and 3- to 7-membered saturated heterocyclyl-C₁-C₃-alkyl, wherein cycloalkyl and heterocyclyl in the 3 last mentioned radicals may be unsubstituted or may carry 1, 2, 3, 4 or 5 identical or different substituents R^{y}.

56. The method as claimed in claim 54, wherein R^{A3}, if present, is selected from the group consisting of hydrogen, fluorine, chlorine, bromine, methyl, ethyl, n-propyl, isopropyl, cyclopropyl, isobutyl, cyclopropylmethyl, fluoromethyl, difluoromethyl, trifluoromethyl, 1-fluoroethyl, 2-fluoroethyl, 2,2,2-trifluoroethyl, methoxymethyl, difluoromethoxymethyl, trifluoromethoxymethyl, cyanomethyl, 2-methoxy-1-ethyl, 2-difluoromethoxy-1-ethyl, 2-trifluoromethoxy-1-ethyl, and 2-cyano-1-ethyl.

57. The method as claimed in claim 33, wherein the invertebrate pests are insects.

58. The method as claimed in claim 33, wherein the invertebrate pests are insects of the order Homoptera.

59. The method as claimed in claim 33, which is a method for combating arthropod pests in plants.

60. A method for protecting plants from infestation with arthropod pests, which method comprises treating the plants with a pesticidally effective amount of a compound of formula I or II or a salt or an N-oxide thereof: 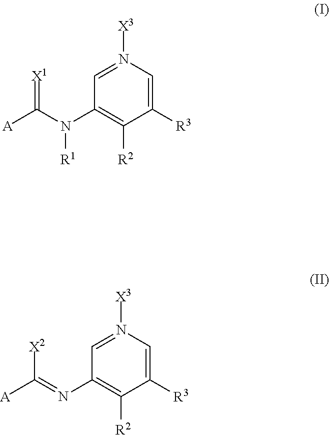
where the radical A is selected from the radicals of the formula A-1, A-2, A-3, A-4, A-6, A-7, A-8 and A-9: 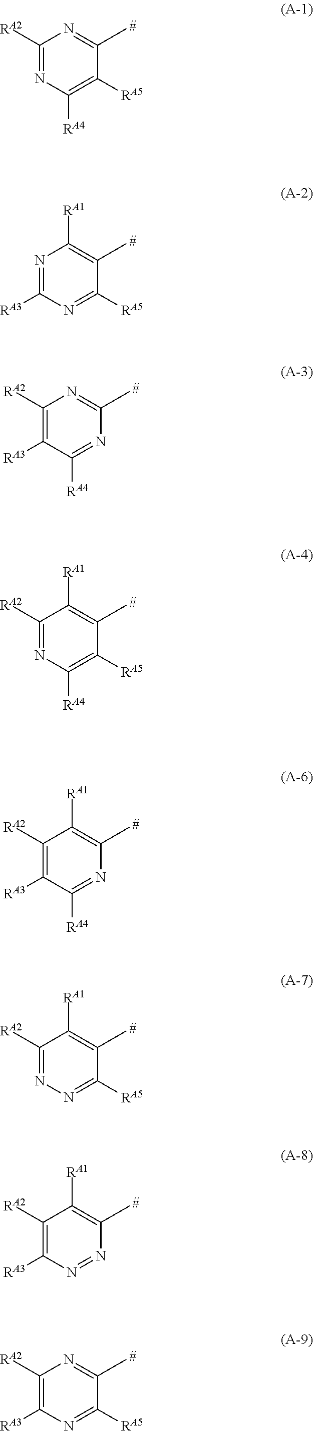
wherein:
# denotes the point of attachment to the remainder of formulae I or II, and wherein
R^{A1}, R^{A5} are independently of each other selected from the group consisting of hydrogen, halogen, CN, NO₂, OR^{a1}, C(Y)R^{b1}, S(O)ₖR^{d1} with k being 1 or 2, C₁-C₆-alkyl, C₂-C₆-alkenyl, C₂-C₆-alkynyl, wherein the 3 last mentioned radicals may be unsubstituted or may be partially or fully halogenated, C₁-C₅-alkylen-CN, C₁-C₅-alkylen-OR^{a}, C₁-C₅-alkylen-C(Y)R^{b}, C₁-C₅-alkylen-C(Y)OR^{c} C₃-C₁₀-cycloalkyl-C₁-C₅-alkyl, C₅-C₁₀-cycloalkenyl-C₁-C₅-alkyl, 3- to 10-membered heterocyclyl-C₁-C₅-alkyl, saturated 3 to 10 membered heterocyclyl, C₃-C₁₀-cycloalkyl and C₅-C₁₀-cycloalkenyl, wherein cycloalkyl, cycloalkenyl and heterocyclyl in the 6 last mentioned radicals may be unsubstituted or may carry 1, 2, 3, 4 or 5 identical or different substituents R^{y};
R^{A2}, R^{A4} are independently of each other selected from the group consisting of hydrogen, halogen, CN, NO₂, OR^{a2}, C(Y)R^{b2}, S(O)ₘR^{d2} with m being 0, 1 or 2,
C₁-C₁₀-alkyl, C₂-C₁₀-alkenyl, C₂-C₁₀-alkynyl, wherein the 3 last mentioned radicals may be unsubstituted or may be partially or fully halogenated,
C₁-C₅-alkylen-CN, C₁-C₅-alkylen-OR^{a}, C₁-C₅-alkylen-C(Y)R^{b}, C₁-C₅-alkylen-C(Y)OR^{c} C₃-C₁₀-cycloalkyl-C₁-C₅-alkyl, C₅-C₁₀-cycloalkenyl-C₁-C₅-alkyl, 3- to 10-membered heterocyclyl-C₁-C₅-alkyl, saturated 3 to 10 membered heterocyclyl, C₃-C₁₀-cycloalkyl and C₅-C₁₀-cycloalkenyl, wherein cycloalkyl, cycloalkenyl and heterocyclyl in the 6 last mentioned radicals may be unsubstituted or may carry 1, 2, 3, 4 or 5 identical or different substituents R^{y};
R^{A3} is selected from the group consisting of hydrogen, halogen, CN, NO₂, OR^{a3}, C(Y)R^{b3}, S(O)ₘR^{d3} with m being 0, 1 or 2, C₁-C₁₀-alkyl, C₂-C₁₀-alkenyl, C₂-C₁₀-alkynyl, wherein the 3 last mentioned radicals may be unsubstituted or may be partially or fully halogenated,
C₁-C₅-alkylen-CN, C₁-C₅-alkylen-OR^{a}, C₁-C₅-alkylen-C(Y)R^{b}, C₁-C₅-alkylen-C(Y)OR^{c} C₃-C₁₀-cycloalkyl-C₁-C₅-alkyl, C₅-C₁₀-cycloalkenyl-C₁-C₅-alkyl, 3- to 10-membered heterocyclyl-C₁-C₅-alkyl, saturated 3 to 10 membered heterocyclyl, C₃-C₁₀-cycloalkyl and C₅-C₁₀-cycloalkenyl, wherein cycloalkyl, cycloalkenyl and heterocyclyl in the 6 last mentioned radicals may be unsubstituted or may carry 1, 2, 3, 4 or 5 identical or different substituents R^{y};
X¹ is S, O or NR^{1a}, wherein
R^{1a} is selected from the group consisting of hydrogen, C₁-C₁₀-alkyl, C₁-C₄-haloalkyl, C₃-C₁₀-cycloalkyl, C₃-C₁₀-cycloalkylmethyl, C₃-C₁₀-halocycloalkyl, C₂-C₁₀-alkenyl, C₂-C₁₀-haloalkenyl, C₂-C₁-alkynyl, C₁-C₁₀-alkoxy-C₁-C₄-alkyl, OR^{a}, phenyl, hetaryl, heterocyclyl, phenyl-C₁-C₄-alkyl, hetaryl-C₁-C₄-alkyl, and heterocyclyl-C₁-C₄-alkyl wherein the ring in the six last mentioned radicals may be unsubstituted or may carry 1, 2, 3, 4 or 5 substituents which, independently of each other, are selected from the group consisting of halogen, cyano, nitro, C₁-C₄-alkyl, C₁-C₄-haloalkyl, C₁-C₄-alkoxy and C₁-C₄-haloalkoxy;
X² is OR^{2a}, NR^{2b}R^{2c}, or S(O)ₘR^{2d}, wherein m is 0, 1 or 2, wherein
R^{2a} is selected from the group consisting of C₁-C₄-alkyl, C₁-C₄-haloalkyl, C₃-C₆-cycloalkyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, phenyl, hetaryl, heterocyclyl, phenyl-C₁-C₄-alkyl, hetaryl-C₁-C₄-alkyl and heterocyclyl-C₁-C₄-alkyl, wherein the ring in the six last mentioned radicals may be unsubstituted or may carry 1, 2, 3, 4 or 5 substituents which, independently of each other, are selected from the group consisting of halogen, cyano, nitro, C₁-C₄-alkyl, C₁-C₄-haloalkyl, C₁-C₄-alkoxy and C₁-C₄-haloalkoxy, and wherein
R^{2b}, R^{2c} are independently of each other selected from the group consisting of hydrogen, C₁-C₄-alkyl, C₁-C₄-haloalkyl, C₃-C₆-cycloalkyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, C₁-C₄-alkylcarbonyl, C₁-C₄-haloalkylcarbonyl, C₁-C₄-alkylsulfonyl, C₁-C₄-haloalkylsulfonyl, phenyl, phenylcarbonyl, phenylsulfonyl, hetaryl, hetarylcarbonyl, hetarylsulfonyl, heterocyclyl, heterocyclylcarbonyl, heterocyclylsulfonyl, phenyl-C₁-C₄-alkyl, hetaryl-C₁-C₄-alkyl and heterocyclyl-C₁-C₄-alkyl wherein the ring in the twelve last mentioned radicals may be unsubstituted or may carry 1, 2, 3, 4 or 5 substituents which, independently of each other, are selected from the group consisting of halogen, cyano, nitro, C₁-C₄-alkyl, C₁-C₄-haloalkyl, C₁-C₄-alkoxy and C₁-C₄-haloalkoxy, or
R^{2b} and R^{2c} together with the nitrogen atom to which they are bound form a 5- or 6-membered, saturated or unsaturated heterocycle, which may carry a further heteroatom being selected from the group consisting of O, S and N as a ring member atom and wherein the heterocycle may be unsubstituted or may carry 1, 2, 3, 4 or 5 substituents which, independently of each other, are selected from the group consisting of halogen, cyano, nitro, C₁-C₄-alkyl, C₁-C₄-haloalkyl, C₁-C₄-alkoxy and C₁-C₄-haloalkoxy, and wherein
R^{2d} is selected from the group consisting of C₁-C₄-alkyl, C₁-C₄-haloalkyl, C₃-C₆-cycloalkyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, phenyl, hetaryl, heterocyclyl, phenyl-C₁-C₄-alkyl, hetaryl-C₁-C₄-alkyl and heterocyclyl-C₁-C₄-alkyl, wherein the ring in the six last mentioned radicals may be unsubstituted or may carry 1, 2, 3, 4 or 5 substituents which, independently of each other, are selected from the group consisting of halogen, cyano, nitro, C₁-C₄-alkyl, C₁-C₄-haloalkyl, C₁-C₄-alkoxy and C₁-C₄-haloalkoxy;
X³ is absent or oxygen;
R¹ is hydrogen, CN, C₁-C₁₀-alkyl, C₁-C₁₀-haloalkyl, C₃-C₁₀-cycloalkyl, C₃-C₁₀-halocycloalkyl, C₂-C₁₀-alkenyl, C₂-C₁₀-haloalkenyl, C₂-C₁₀-alkynyl, C₃-C₁₀-haloalkynyl, OR^{a}, C(Y)R^{b}, C(Y)OR^{c}, S(O)₂R^{d}, NR^{e}R^{f}, C(Y)NR^{g}R^{h}, S(O)ₘNR^{e}R^{f}, C(Y)NRⁱNR^{e}R^{f}, C₁-C₅-alkylen-OR^{a}, C₁-C₅-alkylen-CN, C₁-C₅-alkylen-C(Y)R^{b}, C₁-C₅-alkylen-C(Y)OR^{c}, C₁-C₅-alkylen-NR^{e}R^{d}, C₁-C₅-alkylen-C(Y)NR^{g}R^{h}, C₁-C₅-alkylen-S(O)₂R^{d}, C₁-C₅-alkylen-S(O)ₘNR^{e}R^{d}, C₁-C₅-alkylen-C(Y)NRⁱNR^{e}R^{f},
phenyl, hetaryl, saturated or partially unsaturated heterocyclyl, phenyl-C₁-C₅-alkyl, hetaryl-C₁-C₅-alkyl, saturated or partially unsaturated heterocyclyl-C₁-C₅-alkyl, C₃-C₁₀-cycloalkyl-C₁-C₅-alkyl or C₅-C₁₀-cycloalkenyl-C₁-C₅-alkyl, wherein the ring in the last ten mentioned radicals may be unsubstituted or may carry 1, 2, 3, 4 or 5 identical or different substituents R^{y};
m is 0, 1 or 2;
Y is O or S;
R² is hydrogen, halogen, methyl, halomethyl, methoxy, halomethoxy, methylthio, halomethylthio, methylsulfinyl, halomethylsulfinyl, methylsulfonyl or halomethylsulfonyl;
R³ is hydrogen, halogen, C₁-C₄-alkyl, C₁-C₄-haloalkyl, C₁-C₄-alkoxy, C₁-C₄-haloalkoxy, C₁-C₄-alkylthio, C₁-C₄-haloalkylthio, C₁-C₄-alkylsulfinyl, C₁-C₄-haloalkylsulfinyl, C₁-C₄-alkylsulfonyl, C₁-C₄-haloalkylsulfonyl, C₃-C₆-cycloalkyl, C₃-C₆-halocycloalkyl, C₂-C₄-alkenyl, C₂-C₄-haloalkenyl, C₂-C₄-alkynyl or C₁-C₄-alkoxy-C₁-C₄-alkyl;
R^{a}, R^{b}, R^{c} are independently of each other selected from the group consisting of hydrogen, C₁-C₄-alkyl, C₁-C₄-haloalkyl, C₃-C₆-cycloalkyl, C₃-C₆-cycloalkylmethyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, phenyl, hetaryl, heterocyclyl, phenyl-C₁-C₄-alkyl, hetaryl-C₁-C₄-alkyl and heterocyclyl-C₁-C₄-alkyl, wherein the ring in the six last mentioned radicals may be unsubstituted or may carry 1, 2, 3, 4 or 5 substituents which, independently of each other, are selected from the group consisting of halogen, cyano, nitro, C₁-C₄-alkyl, C₁-C₄-haloalkyl, C₁-C₄-alkoxy and C₁-C₄-haloalkoxy;
R^{d} is selected from the group consisting of C₁-C₄-alkyl, C₁-C₄-haloalkyl, C₃-C₆-cycloalkyl, C₃-C₆-cycloalkylmethyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, phenyl, hetaryl, heterocyclyl, phenyl-C₁-C₄-alkyl, hetaryl-C₁-C₄-alkyl and heterocyclyl-C₁-C₄-alkyl wherein the ring in the six last mentioned radicals may be unsubstituted or may carry 1, 2, 3, 4 or 5 substituents which are independently of each other selected from halogen, cyano, nitro, C₁-C₄-alkyl, C₁-C₄-haloalkyl, C₁-C₄-alkoxy and C₁-C₄-haloalkoxy;
R^{e}, R^{f} are independently of each other selected from the group consisting of hydrogen, C₁-C₄-alkyl, C₁-C₄-haloalkyl, C₃-C₆-cycloalkyl, C₃-C₆-cycloalkylmethyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, C₁-C₄-alkylcarbonyl, C₁-C₄-haloalkylcarbonyl, C₁-C₄-alkylsulfonyl, C₁-C₄-haloalkylsulfonyl, phenyl, phenylcarbonyl, phenylsulfonyl, hetaryl, hetarylcarbonyl, hetarylsulfonyl, heterocyclyl, heterocyclylcarbonyl, heterocyclylsulfonyl, phenyl-C₁-C₄-alkyl, hetaryl-C₁-C₄-alkyl and heterocyclyl-C₁-C₄-alkyl wherein the ring in the twelve last mentioned radicals may be unsubstituted or may carry 1, 2, 3, 4 or 5 substituents which, independently of each other, are selected from the group consisting of halogen, cyano, nitro, C₁-C₄-alkyl, C₁-C₄-haloalkyl, C₁-C₄-alkoxy and C₁-C₄-haloalkoxy; or
R^{e} and R^{f} together with the nitrogen atom to which they are bound form a 5- or 6-membered, saturated or unsaturated heterocycle, which may carry a further heteroatom being selected from the group consisting of O, S and N as a ring member atom and wherein the heterocycle may be unsubstituted or may carry 1, 2, 3, 4 or 5 substituents which are independently of each other selected from the group consisting of halogen, cyano, nitro, C₁-C₄-alkyl, C₁-C₄-haloalkyl, C₁-C₄-alkoxy and
C₁-C₄-haloalkoxy;
R^{g}, R^{h} are independently of each other selected from the group consisting of hydrogen, C₁-C₄-alkyl, C₁-C₄-haloalkyl, C₃-C₆-cycloalkyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, phenyl, hetaryl, heterocyclyl, phenyl-C₁-C₄-alkyl, hetaryl-C₁-C₄-alkyl and heterocyclyl-C₁-C₄-alkyl wherein the ring in the six last mentioned radicals may be unsubstituted or may carry 1, 2, 3, 4 or 5 substituents which are independently of each other selected from the group consisting of halogen, cyano, nitro, C₁-C₄-alkyl, C₁-C₄-haloalkyl, C₁-C₄-alkoxy and C₁-C₄-haloalkoxy;
Rⁱ is selected from the group consisting of hydrogen, C₁-C₄-alkyl, C₁-C₄-haloalkyl, C₃-C₆-cycloalkyl, C₃-C₆-cycloalkylmethyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, phenyl and phenyl-C₁-C₄-alkyl wherein the phenyl ring in the two last mentioned radicals may be unsubstituted or may carry 1, 2, 3, 4 or 5 substituents which are independently of each other selected from the group consisting of halogen, cyano, nitro, C₁-C₄-alkyl, C₁-C₄-haloalkyl, C₁-C₄-alkoxy and C₁-C₄-haloalkoxy;
R^{a1}, R^{a2} are independently of each other selected from the group consisting of C₁-C₄-alkyl, C₁-C₄-haloalkyl, C₃-C₆-cycloalkyl, C₃-C₆-cycloalkylmethyl, C₃-C₆-halocycloalkyl, C₂-C₄-alkenyl, C₂-C₄-haloalkenyl, C₂-C₄-alkynyl and C₁-C₄-alkoxy-C₁-C₄-alkyl;
R^{b1}, R^{b2} are independently of each other selected from the group consisting of hydrogen, C₁-C₄-alkyl, C₁-C₄-haloalkyl, C₃-C₆-cycloalkyl, C₃-C₆-cycloalkylmethyl, C₃-C₆-halocycloalkyl, C₂-C₄-alkenyl, C₂-C₄-haloalkenyl, C₂-C₄-alkynyl, and C₁-C₄-alkoxy-C₁-C₄-alkyl;
R^{d1}, R^{d2} are independently of each other selected from the group consisting of C₁-C₄-alkyl, C₁-C₄-haloalkyl, C₃-C₆-cycloalkyl, C₃-C₆-cycloalkylmethyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, phenyl, hetaryl, heterocyclyl, phenyl-C₁-C₄-alkyl, hetaryl-C₁-C₄-alkyl and heterocyclyl-C₁-C₄-alkyl, wherein the ring in the six last mentioned radicals may be unsubstituted or may carry 1, 2, 3, 4 or 5 substituents which are independently of each other selected from the group consisting of halogen, cyano, nitro, C₁-C₄-alkyl, C₁-C₄-haloalkyl, C₁-C₄-alkoxy and C₁-C₄-haloalkoxy;
R^{a3} has one of the meanings given for R^{a}, except for hydrogen;
R^{b3} has one of the meanings given for R^{b};
R^{d3} has one of the meanings given for Rd;
R^{y} is selected from the group consisting of halogen, cyano, nitro, C₁-C₄-alkyl, C₁-C₄-haloalkyl, C₁-C₄-alkoxy, C₁-C₄-haloalkoxy, C₁-C₄-haloalkylthio, C₁-C₄-alkylsulfinyl, C₁-C₄-haloalkylsulfinyl, C₁-C₄-alkylsulfonyl, C₁-C₄-haloalkylsulfonyl, SO₂NH₂, C₁-C₄-alkylaminosulfonyl, di-(C₁-C₄-alkyl)aminosulfonyl, C₁-C₄-haloalkylaminosulfonyl, C₁-C₄-alkylcarbonyl, C₁-C₄-haloalkylcarbonyl, C₁-C₄-alkoxycarbonyl, C₁-C₄-haloalkoxycarbonyl, C₃-C₆-cycloalkyl, C₃-C₆-halocycloalkyl, C₂-C₄-alkenyl, C₂-C₄-haloalkenyl, C₂-C₄-alkynyl and C₁-C₄-alkoxy-C₁-C₄-alkyl.

61. A method for protecting plant propagation material and/or the plants which grow therefrom, which method comprises treating the plant propagation material with a pesticidally effective amount of a compound of formula I or II or a salt or an N-oxide thereof: 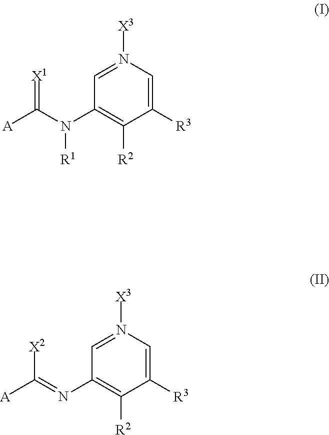
where the radical A is selected from the radicals of the formula A-1, A-2, A-3, A-4, A-6, A-7, A-8 and A-9: 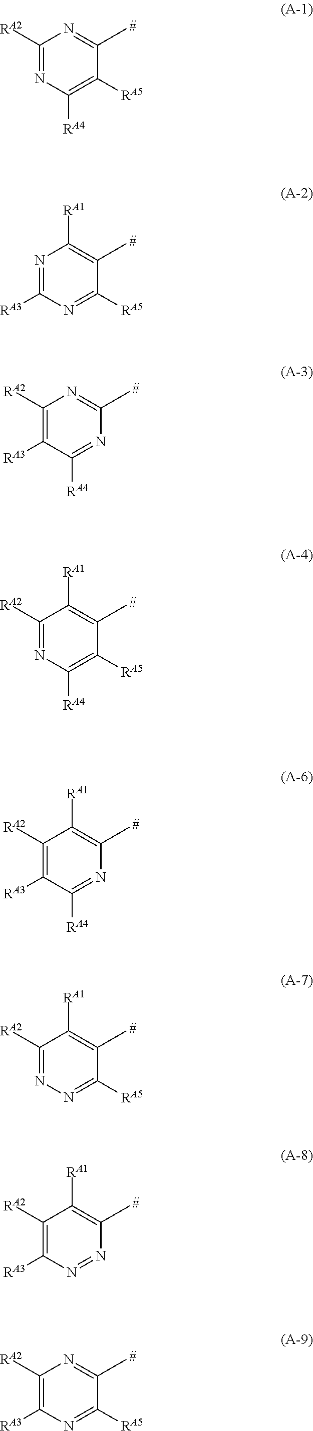
wherein:
# denotes the point of attachment to the remainder of formulae I or II, and wherein
R^{A1}, R^{A5} are independently of each other selected from the group consisting of hydrogen, halogen, CN, NO₂, OR^{a1}, C(Y)R^{b1}, S(O)ₖR^{d1} with k being 1 or 2, C₁-C₆-alkyl, C₂-C₆-alkenyl, C₂-C₆-alkynyl, wherein the 3 last mentioned radicals may be unsubstituted or may be partially or fully halogenated, C₁-C₅-alkylen-CN, C₁-C₅-alkylen-OR^{a}, C₁-C₅-alkylen-C(Y)R^{b}, C₁-C₅-alkylen-C(Y)OR^{c} C₃-C₁₀-cycloalkyl-C₁-C₅-alkyl, C₅-C₁₀-cycloalkenyl-C₁-C₅-alkyl, 3- to 10-membered heterocyclyl-C₁-C₅-alkyl, saturated 3 to 10 membered heterocyclyl, C₃-C₁₀-cycloalkyl and C₅-C₁₀-cycloalkenyl, wherein cycloalkyl, cycloalkenyl and heterocyclyl in the 6 last mentioned radicals may be unsubstituted or may carry 1, 2, 3, 4 or 5 identical or different substituents R^{y};
R^{A2}, R^{A4} are independently of each other selected from the group consisting of hydrogen, halogen, CN, NO₂, OR^{a2}, C(Y)R^{b2}, S(O)ₘR^{d2} with m being 0, 1 or 2,
C₁-C₁₀-alkyl, C₂-C₁₀-alkenyl, C₂-C₁₀-alkynyl, wherein the 3 last mentioned radicals may be unsubstituted or may be partially or fully halogenated,
C₁-C₅-alkylen-CN, C₁-C₅-alkylen-OR^{a}, C₁-C₅-alkylen-C(Y)R^{b}, C₁-C₅-alkylen-C(Y)OR^{c} C₃-C₁₀-cycloalkyl-C₁-C₅-alkyl, C₅-C₁₀-cycloalkenyl-C₁-C₅-alkyl, 3- to 10-membered heterocyclyl-C₁-C₅-alkyl, saturated 3 to 10 membered heterocyclyl, C₃-C₁₀-cycloalkyl and C₅-C₁₀-cycloalkenyl, wherein cycloalkyl, cycloalkenyl and heterocyclyl in the 6 last mentioned radicals may be unsubstituted or may carry 1, 2, 3, 4 or 5 identical or different substituents R^{y};
R^{A3} is selected from the group consisting of hydrogen, halogen, CN, NO₂, OR^{a3}, C(Y)R^{b3}, S(O)ₘR^{d3} with m being 0, 1 or 2, C₁-C₁₀-alkyl, C₂-C₁₀-alkenyl, C₂-C₁₀-alkynyl, wherein the 3 last mentioned radicals may be unsubstituted or may be partially or fully halogenated,
C₁-C₅-alkylen-CN, C₁-C₅-alkylen-OR^{a}, C₁-C₅-alkylen-C(Y)R^{b}, C₁-C₅-alkylen-C(Y)OR^{c} C₃-C₁₀-cycloalkyl-C₁-C₅-alkyl, C₅-C₁₀-cycloalkenyl-C₁-C₅-alkyl, 3- to 10-membered heterocyclyl-C₁-C₅-alkyl, saturated 3 to 10 membered heterocyclyl, C₃-C₁₀-cycloalkyl and C₅-C₁₀-cycloalkenyl, wherein cycloalkyl, cycloalkenyl and heterocyclyl in the 6 last mentioned radicals may be unsubstituted or may carry 1, 2, 3, 4 or 5 identical or different substituents R^{y};
X¹ is S, O or NR^{1a}, wherein
R^{1a} is selected from the group consisting of hydrogen, C₁-C₁₀-alkyl, C₁-C₄-haloalkyl, C₃-C₁₀-cycloalkyl, C₃-C₁₀-cycloalkylmethyl, C₃-C₁₀-halocycloalkyl, C₂-C₁₀-alkenyl, C₂-C₁₀-haloalkenyl, C₂-C₁₀-alkynyl, C₁-C₁₀-alkoxy-C₁-C₄-alkyl, OR^{a}, phenyl, hetaryl, heterocyclyl, phenyl-C₁-C₄-alkyl, hetaryl-C₁-C₄-alkyl, and heterocyclyl-C₁-C₄-alkyl wherein the ring in the six last mentioned radicals may be unsubstituted or may carry 1, 2, 3, 4 or 5 substituents which, independently of each other, are selected from the group consisting of halogen, cyano, nitro, C₁-C₄-alkyl, C₁-C₄-haloalkyl, C₁-C₄-alkoxy and C₁-C₄-haloalkoxy;
X² is OR^{2a}, NR^{2b}R^{2c}, or S(O)ₘR^{2d}, wherein m is 0, 1 or 2, wherein
R^{2a} is selected from the group consisting of C₁-C₄-alkyl, C₁-C₄-haloalkyl, C₃-C₆-cycloalkyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, phenyl, hetaryl, heterocyclyl, phenyl-C₁-C₄-alkyl, hetaryl-C₁-C₄-alkyl and heterocyclyl-C₁-C₄-alkyl, wherein the ring in the six last mentioned radicals may be unsubstituted or may carry 1, 2, 3, 4 or 5 substituents which, independently of each other, are selected from the group consisting of halogen, cyano, nitro, C₁-C₄-alkyl, C₁-C₄-haloalkyl, C₁-C₄-alkoxy and C₁-C₄-haloalkoxy, and wherein
R^{2b}, R^{2c} are independently of each other selected from the group consisting of hydrogen, C₁-C₄-alkyl, C₁-C₄-haloalkyl, C₃-C₆-cycloalkyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, C₁-C₄-alkylcarbonyl, C₁-C₄-haloalkylcarbonyl, C₁-C₄-alkylsulfonyl, C₁-C₄-haloalkylsulfonyl, phenyl, phenylcarbonyl, phenylsulfonyl, hetaryl, hetarylcarbonyl, hetarylsulfonyl, heterocyclyl, heterocyclylcarbonyl, heterocyclylsulfonyl, phenyl-C₁-C₄-alkyl, hetaryl-C₁-C₄-alkyl and heterocyclyl-C₁-C₄-alkyl wherein the ring in the twelve last mentioned radicals may be unsubstituted or may carry 1, 2, 3, 4 or 5 substituents which, independently of each other, are selected from the group consisting of halogen, cyano, nitro, C₁-C₄-alkyl, C₁-C₄-haloalkyl, C₁-C₄-alkoxy and C₁-C₄-haloalkoxy, or
R^{2b} and R^{2c} together with the nitrogen atom to which they are bound form a 5- or 6-membered, saturated or unsaturated heterocycle, which may carry a further heteroatom being selected from the group consisting of O, S and N as a ring member atom and wherein the heterocycle may be unsubstituted or may carry 1, 2, 3, 4 or 5 substituents which, independently of each other, are selected from the group consisting of halogen, cyano, nitro, C₁-C₄-alkyl, C₁-C₄-haloalkyl, C₁-C₄-alkoxy and C₁-C₄-haloalkoxy, and wherein
R^{2d} is selected from the group consisting of C₁-C₄-alkyl, C₁-C₄-haloalkyl, C₃-C₆-cycloalkyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, phenyl, hetaryl, heterocyclyl, phenyl-C₁-C₄-alkyl, hetaryl-C₁-C₄-alkyl and heterocyclyl-C₁-C₄-alkyl, wherein the ring in the six last mentioned radicals may be unsubstituted or may carry 1, 2, 3, 4 or 5 substituents which, independently of each other, are selected from the group consisting of halogen, cyano, nitro, C₁-C₄-alkyl, C₁-C₄-haloalkyl, C₁-C₄-alkoxy and C₁-C₄-haloalkoxy;
X³ is absent or oxygen;
R¹ is hydrogen, CN, C₁-C₁₀-alkyl, C₁-C₁₀-haloalkyl, C₃-C₁₀-cycloalkyl, C₃-C₁₀-halocycloalkyl, C₂-C₁₀-alkenyl, C₂-C₁₀-haloalkenyl, C₂-C₁₀-alkynyl, C₃-C₁₀-haloalkynyl, OR^{a}, C(Y)R^{b}, C(Y)OR^{c}, S(O)₂R^{d}, NR^{e}R, C(Y)NR^{g}R^{h}, S(O)ₘNR^{e}R^{f}, C(Y)NRⁱNR^{e}R^{f}, C₁-C₅-alkylen-OR^{a}, C₁-C₅-alkylen-CN, C₁-C₅-alkylen-C(Y)R^{b}, C₁-C₅-alkylen-C(Y)OR^{c}, C₁-C₅-alkylen-NR^{e}R^{f}, C₁-C₅-alkylen-C(Y)NR^{g}R^{h}, C₁-C₅-alkylen-S(O)₂R^{d}, C₁-C₅-alkylen-S(O)ₘNR^{e}R^{d}, C₁-C₅-alkylen-C(Y)NRⁱNR^{e}R^{f},
phenyl, hetaryl, saturated or partially unsaturated heterocyclyl, phenyl-C₁-C₅-alkyl, hetaryl-C₁-C₅-alkyl, saturated or partially unsaturated heterocyclyl-C₁-C₅-alkyl, C₃-C₁₀-cycloalkyl-C₁-C₅-alkyl or C₅-C₁₀-cycloalkenyl-C₁-C₅-alkyl, wherein the ring in the last ten mentioned radicals may be unsubstituted or may carry 1, 2, 3, 4 or 5 identical or different substituents R^{y};
m is 0, 1 or 2;
Y is O or S;
R² is hydrogen, halogen, methyl, halomethyl, methoxy, halomethoxy, methylthio, halomethylthio, methylsulfinyl, halomethylsulfinyl, methylsulfonyl or halomethylsulfonyl;
R³ is hydrogen, halogen, C₁-C₄-alkyl, C₁-C₄-haloalkyl, C₁-C₄-alkoxy, C₁-C₄-haloalkoxy, C₁-C₄-alkylthio, C₁-C₄-haloalkylthio, C₁-C₄-alkylsulfinyl, C₁-C₄-haloalkylsulfinyl, C₁-C₄-alkylsulfonyl, C₁-C₄-haloalkylsulfonyl, C₃-C₆-cycloalkyl, C₃-C₆-halocycloalkyl, C₂-C₄-alkenyl, C₂-C₄-haloalkenyl, C₂-C₄-alkynyl or C₁-C₄-alkoxy-C₁-C₄-alkyl;
R^{a}, R^{b}, R^{c} are independently of each other selected from the group consisting of hydrogen, C₁-C₄-alkyl, C₁-C₄-haloalkyl, C₃-C₆-cycloalkyl, C₃-C₆-cycloalkylmethyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, phenyl, hetaryl, heterocyclyl, phenyl-C₁-C₄-alkyl, hetaryl-C₁-C₄-alkyl and heterocyclyl-C₁-C₄-alkyl, wherein the ring in the six last mentioned radicals may be unsubstituted or may carry 1, 2, 3, 4 or 5 substituents which, independently of each other, are selected from the group consisting of halogen, cyano, nitro, C₁-C₄-alkyl, C₁-C₄-haloalkyl, C₁-C₄-alkoxy and C₁-C₄-haloalkoxy;
R^{d} is selected from the group consisting of C₁-C₄-alkyl, C₁-C₄-haloalkyl, C₃-C₆-cycloalkyl, C₃-C₆-cycloalkylmethyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, phenyl, hetaryl, heterocyclyl, phenyl-C₁-C₄-alkyl, hetaryl-C₁-C₄-alkyl and heterocyclyl-C₁-C₄-alkyl wherein the ring in the six last mentioned radicals may be unsubstituted or may carry 1, 2, 3, 4 or 5 substituents which are independently of each other selected from halogen, cyano, nitro, C₁-C₄-alkyl, C₁-C₄-haloalkyl, C₁-C₄-alkoxy and C₁-C₄-haloalkoxy;
R^{e}, R^{f} are independently of each other selected from the group consisting of hydrogen, C₁-C₄-alkyl, C₁-C₄-haloalkyl, C₃-C₆-cycloalkyl, C₃-C₆-cycloalkylmethyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, C₁-C₄-alkylcarbonyl, C₁-C₄-haloalkylcarbonyl, C₁-C₄-alkylsulfonyl, C₁-C₄-haloalkylsulfonyl, phenyl, phenylcarbonyl, phenylsulfonyl, hetaryl, hetarylcarbonyl, hetarylsulfonyl, heterocyclyl, heterocyclylcarbonyl, heterocyclylsulfonyl, phenyl-C₁-C₄-alkyl, hetaryl-C₁-C₄-alkyl and heterocyclyl-C₁-C₄-alkyl wherein the ring in the twelve last mentioned radicals may be unsubstituted or may carry 1, 2, 3, 4 or 5 substituents which, independently of each other, are selected from the group consisting of halogen, cyano, nitro, C₁-C₄-alkyl, C₁-C₄-haloalkyl, C₁-C₄-alkoxy and C₁-C₄-haloalkoxy; or
R^{e} and R^{f} together with the nitrogen atom to which they are bound form a 5- or 6-membered, saturated or unsaturated heterocycle, which may carry a further heteroatom being selected from the group consisting of O, S and N as a ring member atom and wherein the heterocycle may be unsubstituted or may carry 1, 2, 3, 4 or 5 substituents which are independently of each other selected from the group consisting of halogen, cyano, nitro, C₁-C₄-alkyl, C₁-C₄-haloalkyl, C₁-C₄-alkoxy and
C₁-C₄-haloalkoxy;
R^{g}, R^{h} are independently of each other selected from the group consisting of hydrogen, C₁-C₄-alkyl, C₁-C₄-haloalkyl, C₃-C₆-cycloalkyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, phenyl, hetaryl, heterocyclyl, phenyl-C₁-C₄-alkyl, hetaryl-C₁-C₄-alkyl and heterocyclyl-C₁-C₄-alkyl wherein the ring in the six last mentioned radicals may be unsubstituted or may carry 1, 2, 3, 4 or 5 substituents which are independently of each other selected from the group consisting of halogen, cyano, nitro, C₁-C₄-alkyl, C₁-C₄-haloalkyl, C₁-C₄-alkoxy and C₁-C₄-haloalkoxy;
Rⁱ is selected from the group consisting of hydrogen, C₁-C₄-alkyl, C₁-C₄-haloalkyl, C₃-C₆-cycloalkyl, C₃-C₆-cycloalkylmethyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, phenyl and phenyl-C₁-C₄-alkyl wherein the phenyl ring in the two last mentioned radicals may be unsubstituted or may carry 1, 2, 3, 4 or 5 substituents which are independently of each other selected from the group consisting of halogen, cyano, nitro, C₁-C₄-alkyl, C₁-C₄-haloalkyl, C₁-C₄-alkoxy and C₁-C₄-haloalkoxy;
R^{a1}, R^{a2} are independently of each other selected from the group consisting of C₁-C₄-alkyl, C₁-C₄-haloalkyl, C₃-C₆-cycloalkyl, C₃-C₆-cycloalkylmethyl, C₃-C₆-halocycloalkyl, C₂-C₄-alkenyl, C₂-C₄-haloalkenyl, C₂-C₄-alkynyl and C₁-C₄-alkoxy-C₁-C₄-alkyl;
R^{b1}, R^{b2} are independently of each other selected from the group consisting of hydrogen, C₁-C₄-alkyl, C₁-C₄-haloalkyl, C₃-C₆-cycloalkyl, C₃-C₆-cycloalkylmethyl, C₃-C₆-halocycloalkyl, C₂-C₄-alkenyl, C₂-C₄-haloalkenyl, C₂-C₄-alkynyl, and C₁-C₄-alkoxy-C₁-C₄-alkyl;
R^{dl}, R^{d2} are independently of each other selected from the group consisting of C₁-C₄-alkyl, C₁-C₄-haloalkyl, C₃-C₆-cycloalkyl, C₃-C₆-cycloalkylmethyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, phenyl, hetaryl, heterocyclyl, phenyl-C₁-C₄-alkyl, hetaryl-C₁-C₄-alkyl and heterocyclyl-C₁-C₄-alkyl, wherein the ring in the six last mentioned radicals may be unsubstituted or may carry 1, 2, 3, 4 or 5 substituents which are independently of each other selected from the group consisting of halogen, cyano, nitro, C₁-C₄-alkyl, C₁-C₄-haloalkyl, C₁-C₄-alkoxy and C₁-C₄-haloalkoxy;
R^{a3} has one of the meanings given for R^{a}, except for hydrogen;
R^{b3} has one of the meanings given for R^{b};
R^{d3} has one of the meanings given for R^{d};
R^{y} is selected from the group consisting of halogen, cyano, nitro, C₁-C₄-alkyl, C₁-C₄-haloalkyl, C₁-C₄-alkoxy, C₁-C₄-haloalkoxy, C₁-C₄-haloalkylthio, C₁-C₄-alkylsulfinyl, C₁-C₄-haloalkylsulfinyl, C₁-C₄-alkylsulfonyl, C₁-C₄-haloalkylsulfonyl, SO₂NH₂, C₁-C₄-alkylaminosulfonyl, di-(C₁-C₄-alkyl)aminosulfonyl, C₁-C₄-haloalkylaminosulfonyl, C₁-C₄-alkylcarbonyl, C₁-C₄-haloalkylcarbonyl, C₁-C₄-alkoxycarbonyl, C₁-C₄-haloalkoxycarbonyl, C₃-C₆-cycloalkyl, C₃-C₆-halocycloalkyl, C₂-C₄-alkenyl, C₂-C₄-haloalkenyl, C₂-C₄-alkynyl and C₁-C₄-alkoxy-C₁-C₄-alkyl.

62. Plant propagation material treated with at least one compound of formula I or II or a salt or an N-oxide thereof: 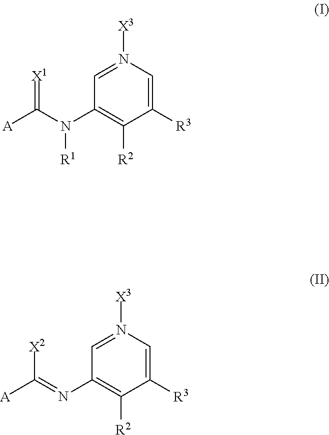
where the radical A is selected from the radicals of the formula A-1, A-2, A-3, A-4, A-6, A-7, A-8 and A-9: 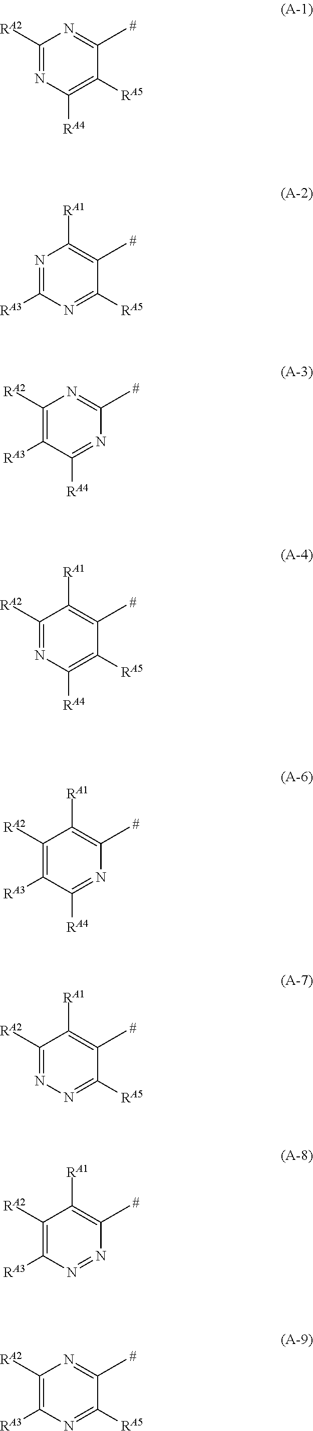
wherein:
# denotes the point of attachment to the remainder of formulae I or II, and wherein
R^{A1}, R^{A5} are independently of each other selected from the group consisting of hydrogen, halogen, CN, NO₂, OR^{a1}, C(Y)R^{b1}, S(O)ₖR^{d1} with k being 1 or 2, C₁-C₆-alkyl, C₂-C₆-alkenyl, C₂-C₆-alkynyl, wherein the 3 last mentioned radicals may be unsubstituted or may be partially or fully halogenated, C₁-C₅-alkylen-CN, C₁-C₅-alkylen-OR^{a}, C₁-C₅-alkylen-C(Y)R^{b}, C₁-C₅-alkylen-C(Y)OR^{c} C₃-C₁₀-cycloalkyl-C₁-C₅-alkyl, C₅-C₁₀-cycloalkenyl-C₁-C₅-alkyl, 3- to 10-membered heterocyclyl-C₁-C₅-alkyl, saturated 3 to 10 membered heterocyclyl, C₃-C₁₀-cycloalkyl and C₅-C₁₀-cycloalkenyl, wherein cycloalkyl, cycloalkenyl and heterocyclyl in the 6 last mentioned radicals may be unsubstituted or may carry 1, 2, 3, 4 or 5 identical or different substituents R^{y};
R^{A2}, R^{A4} are independently of each other selected from the group consisting of hydrogen, halogen, CN, NO₂, OR^{a2}, C(Y)R^{b2}, S(O)ₘR^{d2} with m being 0, 1 or 2,
C₁-C₁₀-alkyl, C₂-C₁₀-alkenyl, C₂-C₁₀-alkynyl, wherein the 3 last mentioned radicals may be unsubstituted or may be partially or fully halogenated,
C₁-C₅-alkylen-CN, C₁-C₅-alkylen-OR^{a}, C₁-C₅-alkylen-C(Y)R^{b}, C₁-C₅-alkylen-C(Y)OR^{c} C₃-C₁₀-cycloalkyl-C₁-C₅-alkyl, C₅-C₁₀-cycloalkenyl-C₁-C₅-alkyl, 3- to 10-membered heterocyclyl-C₁-C₅-alkyl, saturated 3 to 10 membered heterocyclyl, C₃-C₁₀-cycloalkyl and C₅-C₁₀-cycloalkenyl, wherein cycloalkyl, cycloalkenyl and heterocyclyl in the 6 last mentioned radicals may be unsubstituted or may carry 1, 2, 3, 4 or 5 identical or different substituents R^{y};
R^{A3} is selected from the group consisting of hydrogen, halogen, CN, NO₂, OR^{a3}, C(Y)R^{b3}, S(O)ₘR^{d3} with m being 0, 1 or 2, C₁-C₁₀-alkyl, C₂-C₁₀-alkenyl, C₂-C₁₀-alkynyl, wherein the 3 last mentioned radicals may be unsubstituted or may be partially or fully halogenated,
C₁-C₅-alkylen-CN, C₁-C₅-alkylen-OR^{a}, C₁-C₅-alkylen-C(Y)R^{b}, C₁-C₅-alkylen-C(Y)OR^{c} C₃-C₁₀-cycloalkyl-C₁-C₅-alkyl, C₅-C₁₀-cycloalkenyl-C₁-C₅-alkyl, 3- to 10-membered heterocyclyl-C₁-C₅-alkyl, saturated 3 to 10 membered heterocyclyl, C₃-C₁₀-cycloalkyl and C₅-C₁₀-cycloalkenyl, wherein cycloalkyl, cycloalkenyl and heterocyclyl in the 6 last mentioned radicals may be unsubstituted or may carry 1, 2, 3, 4 or 5 identical or different substituents R^{y};
X¹ is S, O or NR^{1a}, wherein
R^{1a} is selected from the group consisting of hydrogen, C₁-C₁₀-alkyl, C₁-C₄-haloalkyl, C₃-C₁₀-cycloalkyl, C₃-C₁₀-cycloalkylmethyl, C₃-C₁₀-halocycloalkyl, C₂-C₁₀-alkenyl, C₂-C₁₀-haloalkenyl, C₂-C₁₀-alkynyl, C₁-C₁₀-alkoxy-C₁-C₄-alkyl, OR^{a}, phenyl, hetaryl, heterocyclyl, phenyl-C₁-C₄-alkyl, hetaryl-C₁-C₄-alkyl, and heterocyclyl-C₁-C₄-alkyl wherein the ring in the six last mentioned radicals may be unsubstituted or may carry 1, 2, 3, 4 or 5 substituents which, independently of each other, are selected from the group consisting of halogen, cyano, nitro, C₁-C₄-alkyl, C₁-C₄-haloalkyl, C₁-C₄-alkoxy and C₁-C₄-haloalkoxy;
X² is OR^{2a}, NR^{2b}R^{2c}, or S(O)ₘR^{2d}, wherein m is 0, 1 or 2, wherein
R^{2a} is selected from the group consisting of C₁-C₄-alkyl, C₁-C₄-haloalkyl, C₃-C₆-cycloalkyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, phenyl, hetaryl, heterocyclyl, phenyl-C₁-C₄-alkyl, hetaryl-C₁-C₄-alkyl and heterocyclyl-C₁-C₄-alkyl, wherein the ring in the six last mentioned radicals may be unsubstituted or may carry 1, 2, 3, 4 or 5 substituents which, independently of each other, are selected from the group consisting of halogen, cyano, nitro, C₁-C₄-alkyl, C₁-C₄-haloalkyl, C₁-C₄-alkoxy and C₁-C₄-haloalkoxy, and wherein
R^{2b}, R^{2c} are independently of each other selected from the group consisting of hydrogen, C₁-C₄-alkyl, C₁-C₄-haloalkyl, C₃-C₆-cycloalkyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, C₁-C₄-alkylcarbonyl, C₁-C₄-haloalkylcarbonyl, C₁-C₄-alkylsulfonyl, C₁-C₄-haloalkylsulfonyl, phenyl, phenylcarbonyl, phenylsulfonyl, hetaryl, hetarylcarbonyl, hetarylsulfonyl, heterocyclyl, heterocyclylcarbonyl, heterocyclylsulfonyl, phenyl-C₁-C₄-alkyl, hetaryl-C₁-C₄-alkyl and heterocyclyl-C₁-C₄-alkyl wherein the ring in the twelve last mentioned radicals may be unsubstituted or may carry 1, 2, 3, 4 or 5 substituents which, independently of each other, are selected from the group consisting of halogen, cyano, nitro, C₁-C₄-alkyl, C₁-C₄-haloalkyl, C₁-C₄-alkoxy and C₁-C₄-haloalkoxy, or
R^{2b} and R^{2c} together with the nitrogen atom to which they are bound form a 5- or 6-membered, saturated or unsaturated heterocycle, which may carry a further heteroatom being selected from the group consisting of O, S and N as a ring member atom and wherein the heterocycle may be unsubstituted or may carry 1, 2, 3, 4 or 5 substituents which, independently of each other, are selected from the group consisting of halogen, cyano, nitro, C₁-C₄-alkyl, C₁-C₄-haloalkyl, C₁-C₄-alkoxy and C₁-C₄-haloalkoxy, and wherein
R^{2d} is selected from the group consisting of C₁-C₄-alkyl, C₁-C₄-haloalkyl, C₃-C₆-cycloalkyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, phenyl, hetaryl, heterocyclyl, phenyl-C₁-C₄-alkyl, hetaryl-C₁-C₄-alkyl and heterocyclyl-C₁-C₄-alkyl, wherein the ring in the six last mentioned radicals may be unsubstituted or may carry 1, 2, 3, 4 or 5 substituents which, independently of each other, are selected from the group consisting of halogen, cyano, nitro, C₁-C₄-alkyl, C₁-C₄-haloalkyl, C₁-C₄-alkoxy and C₁-C₄-haloalkoxy;
X³ is absent or oxygen;
R¹ is hydrogen, CN, C₁-C₁₀-alkyl, C₁-C₁₀-haloalkyl, C₃-C₁₀-cycloalkyl, C₃-C₁₀-halocycloalkyl, C₂-C₁₀-alkenyl, C₂-C₁₀-haloalkenyl, C₂-C₁₀-alkynyl, C₃-C₁₀-haloalkynyl, OR^{a}, C(Y)R^{b}, C(Y)OR^{c}, S(O)₂R^{d}, NR^{e}R^{f}, C(Y)NR^{g}R^{h}, S(O)ₘNR^{e}R^{f}, C(Y)NRⁱNR^{e}R^{f}, C₁-C₅-alkylen-OR^{a}, C₁-C₅-alkylen-CN, C₁-C₅-alkylen-C(Y)R^{b}, C₁-C₅-alkylen-C(Y)OR^{c}, C₁-C₅-alkylen-NR^{e}R^{f}, C₁-C₅-alkylen-C(Y)NR^{g}R^{h}, C₁-C₅-alkylen-S(O)₂R^{d}, C₁-C₅-alkylen-S(O)ₘNR^{e}R^{d}, C₁-C₅-alkylen-C(Y)NRⁱNR^{e}R^{f},
phenyl, hetaryl, saturated or partially unsaturated heterocyclyl, phenyl-C₁-C₅-alkyl, hetaryl-C₁-C₅-alkyl, saturated or partially unsaturated heterocyclyl-C₁-C₅-alkyl, C₃-C₁₀-cycloalkyl-C₁-C₅-alkyl or C₅-C₁₀-cycloalkenyl-C₁-C₅-alkyl, wherein the ring in the last ten mentioned radicals may be unsubstituted or may carry 1, 2, 3, 4 or 5 identical or different substituents R^{y};
m is 0, 1 or 2;
Y is O or S;
R² is hydrogen, halogen, methyl, halomethyl, methoxy, halomethoxy, methylthio, halomethylthio, methylsulfinyl, halomethylsulfinyl, methylsulfonyl or halomethylsulfonyl;
R³ is hydrogen, halogen, C₁-C₄-alkyl, C₁-C₄-haloalkyl, C₁-C₄-alkoxy, C₁-C₄-haloalkoxy, C₁-C₄-alkylthio, C₁-C₄-haloalkylthio, C₁-C₄-alkylsulfinyl, C₁-C₄-haloalkylsulfinyl, C₁-C₄-alkylsulfonyl, C₁-C₄-haloalkylsulfonyl, C₃-C₆-cycloalkyl, C₃-C₆-halocycloalkyl, C₂-C₄-alkenyl, C₂-C₄-haloalkenyl, C₂-C₄-alkynyl or C₁-C₄-alkoxy-C₁-C₄-alkyl;
R^{a}, R^{b}, R^{c} are independently of each other selected from the group consisting of hydrogen, C₁-C₄-alkyl, C₁-C₄-haloalkyl, C₃-C₆-cycloalkyl, C₃-C₆-cycloalkylmethyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, phenyl, hetaryl, heterocyclyl, phenyl-C₁-C₄-alkyl, hetaryl-C₁-C₄-alkyl and heterocyclyl-C₁-C₄-alkyl, wherein the ring in the six last mentioned radicals may be unsubstituted or may carry 1, 2, 3, 4 or 5 substituents which, independently of each other, are selected from the group consisting of halogen, cyano, nitro, C₁-C₄-alkyl, C₁-C₄-haloalkyl, C₁-C₄-alkoxy and C₁-C₄-haloalkoxy;
R^{d} is selected from the group consisting of C₁-C₄-alkyl, C₁-C₄-haloalkyl, C₃-C₆-cycloalkyl, C₃-C₆-cycloalkylmethyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, phenyl, hetaryl, heterocyclyl, phenyl-C₁-C₄-alkyl, hetaryl-C₁-C₄-alkyl and heterocyclyl-C₁-C₄-alkyl wherein the ring in the six last mentioned radicals may be unsubstituted or may carry 1, 2, 3, 4 or 5 substituents which are independently of each other selected from halogen, cyano, nitro, C₁-C₄-alkyl, C₁-C₄-haloalkyl, C₁-C₄-alkoxy and C₁-C₄-haloalkoxy;
R^{e}, R^{f} are independently of each other selected from the group consisting of hydrogen, C₁-C₄-alkyl, C₁-C₄-haloalkyl, C₃-C₆-cycloalkyl, C₃-C₆-cycloalkylmethyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, C₁-C₄-alkylcarbonyl, C₁-C₄-haloalkylcarbonyl, C₁-C₄-alkylsulfonyl, C₁-C₄-haloalkylsulfonyl, phenyl, phenylcarbonyl, phenylsulfonyl, hetaryl, hetarylcarbonyl, hetarylsulfonyl, heterocyclyl, heterocyclylcarbonyl, heterocyclylsulfonyl, phenyl-C₁-C₄-alkyl, hetaryl-C₁-C₄-alkyl and heterocyclyl-C₁-C₄-alkyl wherein the ring in the twelve last mentioned radicals may be unsubstituted or may carry 1, 2, 3, 4 or 5 substituents which, independently of each other, are selected from the group consisting of halogen, cyano, nitro, C₁-C₄-alkyl, C₁-C₄-haloalkyl, C₁-C₄-alkoxy and C₁-C₄-haloalkoxy; or
R^{e} and R^{f} together with the nitrogen atom to which they are bound form a 5- or 6-membered, saturated or unsaturated heterocycle, which may carry a further heteroatom being selected from the group consisting of O, S and N as a ring member atom and wherein the heterocycle may be unsubstituted or may carry 1, 2, 3, 4 or 5 substituents which are independently of each other selected from the group consisting of halogen, cyano, nitro, C₁-C₄-alkyl, C₁-C₄-haloalkyl, C₁-C₄-alkoxy and
C₁-C₄-haloalkoxy;
R^{g}, R^{h} are independently of each other selected from the group consisting of hydrogen, C₁-C₄-alkyl, C₁-C₄-haloalkyl, C₃-C₆-cycloalkyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, phenyl, hetaryl, heterocyclyl, phenyl-C₁-C₄-alkyl, hetaryl-C₁-C₄-alkyl and heterocyclyl-C₁-C₄-alkyl wherein the ring in the six last mentioned radicals may be unsubstituted or may carry 1, 2, 3, 4 or 5 substituents which are independently of each other selected from the group consisting of halogen, cyano, nitro, C₁-C₄-alkyl, C₁-C₄-haloalkyl, C₁-C₄-alkoxy and C₁-C₄-haloalkoxy;
Rⁱ is selected from the group consisting of hydrogen, C₁-C₄-alkyl, C₁-C₄-haloalkyl, C₃-C₆-cycloalkyl, C₃-C₆-cycloalkylmethyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, phenyl and phenyl-C₁-C₄-alkyl wherein the phenyl ring in the two last mentioned radicals may be unsubstituted or may carry 1, 2, 3, 4 or 5 substituents which are independently of each other selected from the group consisting of halogen, cyano, nitro, C₁-C₄-alkyl, C₁-C₄-haloalkyl, C₁-C₄-alkoxy and C₁-C₄-haloalkoxy;
R^{a1}, R^{a2} are independently of each other selected from the group consisting of C₁-C₄-alkyl, C₁-C₄-haloalkyl, C₃-C₆-cycloalkyl, C₃-C₆-cycloalkylmethyl, C₃-C₆-halocycloalkyl, C₂-C₄-alkenyl, C₂-C₄-haloalkenyl, C₂-C₄-alkynyl and C₁-C₄-alkoxy-C₁-C₄-alkyl;
R^{b1}, R^{b2} are independently of each other selected from the group consisting of hydrogen, C₁-C₄-alkyl, C₁-C₄-haloalkyl, C₃-C₆-cycloalkyl, C₃-C₆-cycloalkylmethyl, C₃-C₆-halocycloalkyl, C₂-C₄-alkenyl, C₂-C₄-haloalkenyl, C₂-C₄-alkynyl, and C₁-C₄-alkoxy-C₁-C₄-alkyl;
R^{d1}, R^{d2} are independently of each other selected from the group consisting of C₁-C₄-alkyl, C₁-C₄-haloalkyl, C₃-C₆-cycloalkyl, C₃-C₆-cycloalkylmethyl, C₃-C₆-halocycloalkyl, C₂-C₄-alkenyl, C₂-C₄-haloalkenyl, C₂-C₄-alkynyl, C₁-C₄-alkoxy-C₁-C₄-alkyl, phenyl, hetaryl, heterocyclyl, phenyl-C₁-C₄-alkyl, hetaryl-C₁-C₄-alkyl and heterocyclyl-C₁-C₄-alkyl, wherein the ring in the six last mentioned radicals may be unsubstituted or may carry 1, 2, 3, 4 or 5 substituents which are independently of each other selected from the group consisting of halogen, cyano, nitro, C₁-C₄-alkyl, C₁-C₄-haloalkyl, C₁-C₄-alkoxy and C₁-C₄-haloalkoxy;
R^{a3} has one of the meanings given for R^{a}, except for hydrogen;
R^{b3} has one of the meanings given for R^{b};
R^{d3} has one of the meanings given for R^{d};
R^{y} is selected from the group consisting of halogen, cyano, nitro, C₁-C₄-alkyl, C₁-C₄-haloalkyl, C₁-C₄-alkoxy, C₁-C₄-haloalkoxy, C₁-C₄-haloalkylthio, C₁-C₄-alkylsulfinyl, C₁-C₄-haloalkylsulfinyl, C₁-C₄-alkylsulfonyl, C₁-C₄-haloalkylsulfonyl, SO₂NH₂, C₁-C₄-alkylaminosulfonyl, di-(C₁-C₄-alkyl)aminosulfonyl, C₁-C₄-haloalkylaminosulfonyl, C₁-C₄-alkylcarbonyl, C₁-C₄-haloalkylcarbonyl, C₁-C₄-alkoxycarbonyl, C₁-C₄-haloalkoxycarbonyl, C₃-C₆-cycloalkyl, C₃-C₆-halocycloalkyl, C₂-C₄-alkenyl, C₂-C₄-haloalkenyl, C₂-C₄-alkynyl and C₁-C₄-alkoxy-C₁-C₄-alkyl.
